(19) United States
(12) Patent Application Publication
(10) Pub. No.: US 2007/0162365 A1
(43) Pub. Date: Jul. 12, 2007

(54) Securities aid

(76) Inventor: Earl J. Weinreb, New York, NY (US)

Correspondence Address: EARL J. WEINREB, 72-10 112TH STREET, FOREST HILLS, NY, 11375, US

(21) Appl. No.: 11/190,588

(22) Filed: Jul. 27, 2005

(51) Int. Cl. G06Q 40/00

(52) U.S. Cl. 705/35

(57) ABSTRACT

A computer-implemented method and system for a systematic trading of financial securities consistent with investment strategies which in turn inherently dictates the time to sell such securities. A method utilizing a computer system for inputting investment portfolio parameters pertaining to a security of interest and interactively utilizing the computer to output investment and performance information, providing the user with general securities trading informational popups and a screening of financial information for securities to be tailored to particular strategies.

### BACKGROUND OF THE INVENTION

Speculators Always Want Action—At any Cost

Other “investors” out there with gaming instincts are really speculators at heart. They essentially like to play the market the way they do the Las Vegas tables and slots. They love action with the hope or being lucky in bucking the odds. At the same time they feel they will be fortunate enough to amass enough winnings to keep them on Easy Street for the rest of their lives.

My proposed Business System has a solution for many of such folks as well. At the same time, it will teach them the fundamentals of conservative investing in easy-to-take dosages.

A Realistic Look at the Investment Community

About 40% of money managers in one survey admit to buying stocks on the basis of low P/E or price/earnings. This is a tricky strategy if taken raw because it can be entirely relative. What is too high or too low is subject entirely to the prevailing moods and sentiments of the individual or the market.

Other studies show that those who buy on the basis of low P/E strategy will hold on to a stock well past the time the stock becomes overpriced on the precepts of the original price/earnings standard used. Obviously discipline is required and the current invention was developed with this objective in mind.

Price earnings is not a pure strategy that leads to genuine discipline. Research shows it is a weak crutch in itself unless there is selling discipline. of selling. And to those, professional or nonprofessional, who select their own securities, my proposed Business System can made selection and sale, are simpler.

As another example: of how professions fail at their tasks: Managers who actively trade in taxable accounts are estimated to spend another 1.5 percent to 2 percent to buy and sell their stocks each year, which makes it virtually impossible for them to beat the unmanaged stock indexes

And for those who do wish to time the sale of what they have bought, the use of my Business System, (as will be noted later) will make the odds of success, better.

Means of Competing Among Friends

The current invention is therefore the practical means of introducing the proposed Business System. In an alternative embodiment, current invention can also take the form of a fantasy game to provide a way of having friendly competitions. Ordinary investors and even professionals can test each others' ability to show how well they invest without having to put up actual funds.

They can, in effect, create so-called fantasy portfolios among themselves. This can be comparable to competitions in fantasy baseball and football leagues.

The proposed Business System has produced the current invention as a solution for folks seeking action. At the same time, however, it will teach them the all the fundamentals of conservative investing in easy-to-take dosages. And it will offer a Game not available in any other contest.

When do they most often sell? When they come up with a new hot stock and need cash with which to make the purchase. That does not indicate it is actually the correct time to sell what they originally bought. But they sell most likely sell when they lose interest or they get holding jitters and thus they finally do get rid of the security impulsively.

In short, in the usual contests you rarely impose responsibility upon the contestant for having completed buy/sell transactions which, after all, is the normal lot of all everyday investors.

Stock Selection and Market Timing

My proposed Business System in real life or in the STRATEGY DISCIPLINE GAME has a solution to aid those who insist, including the pros, that market timing and stock selection, is the main avenue to investment success. And by the way, market timing and stock selection is the professionals' chief rationale behind asking for steep management fees.

However, well-qualified research has determined and the financial industry has not been able to successfully counter the fact that 90% or more of the success of an investment portfolio. can be attributed to asset allocation. Only the paltry 10% or so of the rest can be applied o security selection and market timing. This is a major blow to those whose stock in trade is its ability to create heroes who claim they can constantly outsmart each other with securities selection and market timing.

Outsmarting the Rest of the Market

A common theme that makes little sense has prevailed for decades among investment professionals. According to the noted researcher Daniel Kahneman, most studies show that 80% or 90% of money managers think that they are above average, in a business where every participant is sure he/she is better than average. All the “experts,” are trying to outguess each other. You just know that has to be a Zero Sum Game. There can't be that many geniuses around.

There is another fact that you arc not supposed to question too much—the obvious success of index funds. These arc unmanaged funds or baskets of securities, which generally greatly outperform those who attempt to outfox those averages. Furthermore, this feat is done at far less cost.

The proposed Business System is designed to increase the odds for success by improving discipline. It does this in a manner that has nothing to do with outsmarting others. It merely tends to assist all investors by improving discipline and thus reduces losses due to inconsistencies, duplications, replications, etc.

The Cost of Redundant “Expertise”

Take the increasing role of investment advisers. Unfortunately their actions are not always in the interest of the customer. There often is a conflict of interest. Some advisers get commissions from brokers. Others may be influenced to do business with favored brokers or investment companies. (Fees at 1½% of assets for instance may be as much as 25%, or more or what the client is actually earning each year on his or her portfolio.)

The bottom line: Advisers too often have an incestuous investing relationship among themselves and clients.

Moreover, layers of added costs are being loaded into every conceivable facet of investment advisory, including: Mutual fund advisory; 401 Ks; Pension funds

Wall Street “Noise”

One of the ways investors get distracted from their original strategic intentions owes to the constant bombardment of analytical reports they receive. Were these reports all top-grade, they would still be distractions. The fact most are inferior and have doubtful investment intentions, they can prove disastrous for investor discipline.

Just a few additional examples of how analysts compound the problem:

a) Most or the analysts on Wall Street fail to accomplish their mission because they are incompetent when it comes to basic research. Good, effective work mostly comes from academe, not Wall Street. Scant serious research takes place in the financial community. None of the in-depth variety disseminates widely. In fact, pure research publications are lucky to have a few measly thousand in circulation or read. And what gets read is a lot of meaningless fluff. What is more, analysts will not rock the boat when that can possibly gut their income source.

b) Analysts have little time to get into the deep-down research Wall Street's restrictive budgeting makes it impossible for analysts to spend much time on companies they cover, least of all, the effort that could sway their preconceived notions.

c) Wall Street analysts have little, if any, hands-on management experience. Those who could not operate their own pushcart are in a daily position where they pass highly influential commentary on the management ability of CEOs of Fortune 500 companies.

When you realize that most of the advice you pay so much for in the investment community can be acquired for so little elsewhere, the effort to make a change is certainly worthwhile. My proposed Business System provides easy-to-get at and simple educational tools.

The System will help eliminate many of these problems by presenting a program of timely Screening and Notification only when required.

The Distraction Effects of Information “Noise”

While more information may be excellent for science and other endeavors, this is definitely not the case when it comes to investing. because of the mass confusion it produces. The constant barrage or superfluous information often makes disciplined strategy a near-impossibility.

Serious in-depth research. clearly shows that these distractions confuse and hurt the investor and nothing is usually done to remedy the matter. Yet, It is not in the interest of the financial community that anything be done about it. If anything, Wall Street continues to add to the noise.

If the term flip flop has ever earned its place in our lexicon, it belongs on Wall Street. Everyone in the investment community gives lip service to disciplined strategy. The financial community is the prime example of flip-flop, par excellence.

Research shows that no one starts out with a strategy with a purchase and remains with it for very long. The investor flips the strategy while holding the investment and certainly well before selling, despite the intention at time of purchase. The vast majority of experts agree that the best results occur when you stick to an Investment Game Plan at all times. Moreover, extensive research over the years has shown the risks of changing strategy in midstream.

Less information is best because it enhances discipline. In football, this discipline is referred to as sticking to the Game Plan. There is no such discipline in the investment field and with the increase in data, the situation constantly gets worse.

The lack of discipline is costly in more than mere direct poor investment outcome, it results in
1) extra brokerage fees because of more transactions
2) extra transaction costs due to additional bid/ask differentials
3) termination of contract fees when cancellations are made
4) cancellation fees if operative

These fees are only incidental to the distraction of having disrupted original planning and possibly having too re-orientate fresh strategy amid doubts and uncertainty for the future.

The current Business System will help eliminate many of these problems by presenting a program of timely Screening and Notification only when required.

Misdirection of Type of Financial News

Another way whereby financial news is misused is by its indiscriminate distribution:
a) Information aimed at professionals is offered to those who cannot possibly handle the skills of the particular techniques involved.
b) Information aimed at those who can sustain certain risks is being picked up for use by those who should not undertake those risks, for any number of personal reasons
c) Information aimed at those with longer investment horizons, because of youth, for example, are being influenced to take investment actions that are dangerous, owing to shorter investment horizons.
d) Information aimed at the public never contemplates tax and trust or estate consequences of their advice. In fact, much buy and sell advice never heeds the tax bites that result from too-frequent buying and selling recommendations.

Most investment publications and financial sources provide information that have a harmful one-size-fits all approach to financial topics they cover.

So what may be beneficial to one reader or observer may be investment poison for the other. When you think or it, almost everything you read or hear in financial publications unfortunately fails to meet proper financial standards because of a lack of distinction of the varying objective needs of the investing public.

The Market Effect of Concerted Action

When investors rely on such public reports disseminated to thousands, perhaps hundreds of thousands, or even millions of investors at one time, a drastic imbalance results. That is because pricing must always be dependent on the law of supply and demand. This herd-like effect NEVER works in the investor's favor.

Yet, most of the information the public relies on comes from newspapers, magazines and other forms of media where “hot tips” are daily fare. One reporter, one analyst, one report, accurate or honest or not, will drive the actions of those who are ready to trade or invest securities and even those who are sitting on the sidelines, but whose net assets are being affected by the news.

My proposed Business System will help eliminate many of these problems by presenting a program of timely Screening and Notification only when required.

Financial Strategies

How do you get started resolving these financial industry problems?

Mathematical scholars have formulated well-known models on the best possible strategies to use, all of which have failed during notable market crashes. Until the scholars can come up with anything more practical than they already have to date, research indicates that only discipline does tend to keep odds in favor of those investors who can stick with the strategy they started with. No matter the strategy being used. Why? Because of the actual measurable damage done by the ensuing flip Flops, after an original investment is made with the use of that strategy.

Flip flops are the bane or professional investing. They invariably are hurt by the inability to come up with consistent strategy that keep the odds for investment success in their favor even when they are on in the inside of all the worthwhile information there is to know about investing.

It goes without saying that nonprofessionals who are on the outside looking in are bound to suffer even worse odds in achieving optimum investment success.

The most damaging flaw that exists in professional use or, more to the point, misuse, or strategy, has to do with the fact that most practitioners use more than one strategy at a time when investing buying a particular security.

Example: Using Price earnings or P/E is one strategy. Buying a common stock that has hit a new high for the year is another. Buying a stock because it's earnings are expected to rise 20% by next year is yet another. Many pros say they will buy a stock, for example, because they like the level of its P/E, the fact it just hit a new high and it's earnings appear to be growing.

That is what you call a classic example of mixed strategies. What is wrong? You are left in the dark as to when you are going to sell what you have bought. You have left it open to conjecture and lots of future opinions that will keep you guessing as you ride that stock up and up and down and down amid the usual confusion that afflicts the average investor, Pro or Mr. and Mrs. Main Street

Attempts at Alerting Investors as to when to Sell

There are currently attempts made online (e.g. by Yahoo Finance) to ostensibly create a measure of investing discipline by creating “Alerts” whereby an investor can track a portfolio by the percentage of price movement of securities held. That percentage is adjusted from time to time by the investor. Presumably the notification of those movements can allow the investor to make timely decisions as to when to sell.

Unfortunately, this attempt indicates the lack of concrete strategy and discipline and merely represents haphazard attempts being made to remedy current problems that confront investors. Those using the service are still at a loss to determine when to sell the security that they had bought.
a) They had most likely not employed a specific strategy for having made each selection and thus have had no idea of the sensitivity of the percentage to be allocated for the “alert” chosen in the notification.
b) They have the ability to keep changing the “alert” to conform to their whims, which in keeping with the lack or confirmed strategy in the first place, is tantamount to demonstrating a lack of discipline in the securities transaction.

Moreover, the package of services they are receiving entails a massive amount of securities information which is destined to confuse them with often extraneous and superfluous securities news trivia. The latter will add to the bewilderment that blankets the professional as well as average investor.

There is ordinarily no effective screen to help the investor cope with this avalanche of financial news, much of it used to move markets for those interests that invariably do not coincide with that of the particular investor.

The Unusual Interactive Coding/Search System

The current invention also has an absolutely unusual, unique method to accommodate recognized research that has been overwhelming in establishing almost incontrovertible investment fact since it was first brought to the attention of the financial world. It is that market timing and security selection are but minor Factors in long-term investing success.

The current invention has a system of interactive coding and search that structures strategic discipline and focuses it away from the usual primary emphasis on stock selection and market timing, that researchers have shown to be these aforementioned minor considerations. THE CURRENT INVENTION is thus a major enabling system for professional and ordinary investors.

To Sum Up Problems to be Corrected

In short, my Business System is devised for those who are unhappy or happy with the results they now get from conventional means, whether they are conservative in their investment methods or not.

Also, a large percentage of investors currently have gambling instincts that rule their investing habits and thus their savings outlays. My Business System can interest them while performing an important service—educating them in a seamless, effortless and entertaining manner.

### SUMMARY OF THE INVENTION

1) A Corporate Mode (tm) which has to do With Corporate Operations,

Some of my collected strategies have to do with how a corporation operates its business, day to day, month-to month, year-to-year. They have nothing to do with the everyday workings of the stock market. When you buy stock under such strategy you are buying a part of the business and your concerns have to do solely with the operations of that business.

and

2) A Market Mode (tm) which has to do with Market Moods and Sentiments.

When you buy a company in the market mode your concern has little to do with your actual ownership in that company. Instead, the market's moods and sentiments become important to the particular strategy you have used to buy that company's stock. Examples: Price earnings or P/E is related to market moods or sentiments. So is buying a stock that has hit a new high. Or one that has just hit a new low. Or one that is selling at what you think is a low multiple to book value.

Most professionals fail to achieve disciplined strategy because they never get to even this simple first step. That indicates how far removed most investors are from a disciplined strategy despite the much-offered lip service to that ort-stated ideal.

NOTIFICATION after a strategy is chosen and the time arises when the strategy calls for a possible sale, the extent of COMMUNICATION requested about strategy, the utility of SCREENING of news pertaining to strategy, and the practicality and CONCEPT of the INVESTING PORTFOLIO GAME that pertains to the whole system and other unique and newly developed work.

What I provide now that is brand new is what I call the specific “intrinsic Selling Character” of each strategy. That represents a full investigation of what each strategies about. It is a specific for buying and makes up the reason for selling a security. It incorporates sensitivity of the strategy and for that reason becomes the technical trigger; the focus for creating the Selling emphasis which will be mentioned under Eight that follows.

Subdivision Classification—Technique Strategies

This Subdivision Classification was classified into sixteen separate sections of Investor Technique strategies. This is a means of Facilitating the use of tools or instruments for investing.

Subdivision Classification—Market Mood—Indicator Strategies

This market mode type of strategy was additionally classified into eighteen Indicator Strategy sections. This was a means of facilitating the use and the classification of distinctive strategies that are particularly sensitive to market conditions. They provide the investor with alternative choices in addition to those provided by other market mood strategies.

Indicator Strategies have unique qualities in that they can be more easily utilized both for buying securities and for selling with minimal effort. And they, too, each are provided with their own, specific Intrinsic Selling Character, based on undisclosed Pros and Cons.

What I provided is what I called the specific “Intrinsic Selling Character” of each strategy, a full investigation of what each strategy is about. It provided the specific for buying and also makes up the reason for selling the security. It was created from prior undisclosed information on the Pros and Cons of each researched strategy. That reason becomes the technical trigger, the focus for creating the Selling purpose.

What makes the THE CURRENT INVENTION INVESTMENT SYSTEM further unusual is that the ENFORCED FOCUS on the details of the strategies used, the sensitivity of each to the market and a written determination of the trigger for selling what has been bought.

As mentioned in Claim SEVEN: What I provide is what I call the specific “Intrinsic Selling Character” of each strategy, behind which is a full investigation of each.

That trigger is in the form of a written notification created at the time of purchase. It is not varied from time to time at the whim of the investor, though it can be changed at the investor's option.

Many investors hope to sell a security the way they hope to fulfill a New Year's Resolution. The decision here, however, is put into writing, as a form/request.

There is a built-in enforced form-mechanism where the objective is put into writing, for the express purpose of reminding the investor of the his/her specific reason behind buying the security. This could eventually involve the use of digital, sound and printout facilities for input and verification.

The Enforced Selling/Reminder Memo (though it can be rewritten or erased by the investor in the future) becomes the FOCUS and STRUCTURE for the strategy or game plan behind the ultimate sale of the security.

This could involve the use of digital, sound and printout facilities for input and verification.

The THE CURRENT INVENTION INVESTMENT SYSTEM uses a combination of special strategy for creating and periodically selling, and therefore readjusting asset allocation ratios or securities held.

Proper Asset allocation investing has been thoroughly overlooked by the investment community. That is because most financial practitioners find that proper discipline in this area often produces less fees and trading commissions.

The THE CURRENT INVENTION INVESTMENT SYSTEM would make asset allocation easier to use for even greater profit, because frequent portfolio changes do not have to be made as they are today. With the use or simple, easy-to-use-strategy in creating asset classes, and simple strategy for periodic readjustments, the investor can now easily perform what may have appeared complicated in the past and with less taxation in taxable accounts. Example:

The THE CURRENT INVENTION SYSTEM, unlike others, ties allocation to a Retirement Option which uses Bonds tied to the Duration Principle which gets
a) Maximum common stock return advantage
b) Maximum bond income with minimal risk from interest rate fluctuation and
c) Minimal bond holding Inflation risk

The THE CURRENT INVENTION SYSTEM use could also involve the use of digital, sound and printout facilities for input and verification.

The THE CURRENT INVENTION INVESTMENT SYSTEM will screen out important news notifications from unimportant trivia, to allow the investor to digest. Important information to get through to the Client.

The THE CURRENT INVENTION INVESTMENT SYSTEM will permit pertinent security and strategy news to reach a Client but to avoid or screen unsolicited and unrelated news and recommendations.

Unlike other forms of massive information, the Screen employed by Communication/News Watch Screening will be directly tied to the particular security and strategy bought under the System, to the exclusion of any information which may be superfluous.

Unsolicited information typifies the “noise” that comes from the rest of the media and brokerages, and which distracts, entices and sways the investor from what he/she may have originally been planning with the original security purchase.

Financial news has become a torrent of useless information for the most part. What used to be printed in dribs and drabs so it could be easily digested has now become a veritable Noah's flood of unfathomable, meaningless blather that is better best forgotten.

Up to now there has never been any attempt or possibility by to prevent concerted action in the financial industry. Whenever any media report is made, especially with Email, the internet and allied technology, hundreds of thousands, if not millions of prospective investors get the exact information at the same time. They are often asked to take action to buy or sell and this is harmful to their financial interests because it interferes with the supply/demand equation.

With the way THE CURRENT INVENTION INVESTMENT SYSTEM strategy is constructed and disseminated, information is automatically segmented in hundreds of different ways. There NEVER is and cannot be concerted action because much of the activity is instituted by the individual investor.

Throughout the THE CURRENT INVENTION INVESTMENT SYSTEM, buttons are designed for usage to help both instruct the investor in how to best use the program, or the corresponding THE CURRENT INVENTION INVESTMENT STRATEGY DISCIPLINE GAME.

But more important, the buttons will be spaced on each page, as required, to keep the Client from backtracking to conventional, outmoded habits which researchers have found tend to result-in lack of discipline.

Not only does the use of buttons, strategically placed, remind the visitor to the site of the necessary research about strategy, but there is sufficient information to prevent overuse of market timing and trading overactivity. The interactive buttons could involve the use of digital, sound and printout facilities for input.

The purpose is to slowly but surely wean investors away from bad habits they have been subjected to over many years. The use of the Glossary and Bibliography can get the public more involved with ever-fresh investment ideas.

### BRIEF DESCRIPTION OF THE DRAWINGS

FIG. 1 is the flowchart of the high level functions and databases

FIG. 2 is the flowchart of the buying of securities

FIG. 3 is the flowchart of the selling of securities

FIG. 4 is the flowchart of the portfolio transactions

FIG. 5 is the flowchart of the asset allocation transactions

### DETAILED DESCRIPTION OF THE INVENTION

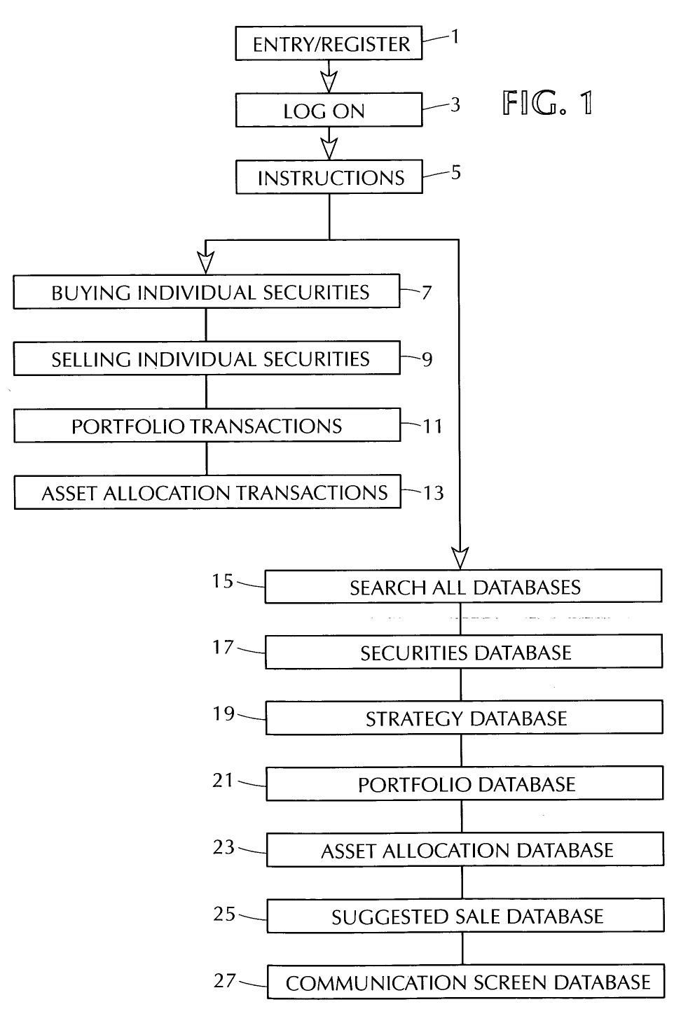

As in FIG. 1 the overview of the system is seen. Whereas the user comes to an entry/registration 1 screen to enter or register to be a user of the system. A security password is required in the logon 3 screen to secure the integrity of the user's personal securities information. The user is provided with general instructions 5 on the usage of the system. The user is then routed to screen to buy securities 7, sell securities 9, make miscellaneous portfolio transactions 11, or adjust/define asset allocations 13.

Alternately, users can search or view all informational databases 15 pertaining to their securities portfolio. Such databases store all information and user settings relating to their account. In a preferred embodiment the securities database 17 stores all securities in which the user decides to include within his/her portfolio. Alternately, the securities database may include a listing of suggested securities for a user to select. which may be categorized in relation to the type of strategy selected. The strategy database 19 contains predefined strategies suggested by the system. The strategy database 19 can also be customized to include user defined strategies. The portfolio database 21 contains all information relating to the securities and strategies chosen by the user. The asset allocation database 23 contains securities held by special user arranged formulas. The suggested sale database 25 tracks the performance of securities within a user's portfolio in relation to the associated strategies to suggest a time of sale. Finally, the communications screen database 27 houses news and financial information and screens based on strategy and other choices selected. The object of such screening is to prevent the user from utilizing and making judgments based upon information which has little relation to the original specific strategies and choices selected. Nevertheless, such informational screening and news preferences can be customized by the user to include information which would otherwise be removed. Throughout the whole process of using such system, the user is constantly updated with educational popups such as 43 and instructions such as 47. Such information may include general trading information, trading strategies tutorials, system usage instructions, suggested time of sale, and other types of investment vehicles. In addition to such information, current screened general and financial news are always available to the user via the communications screen database 27.

Such information can also be updated to the user through at least one methodology: conventional internet Email, wireless Email, satellite radio, television, cellular technology, Really Simple Syndication, internet and video blogs, satellite transmissions, streaming data, cable transmissions, audio terminals, video terminals, portable handhelds, pagers, text messaging, internet popups, and other forms of instantaneous or semi-instantaneous forms of communication.

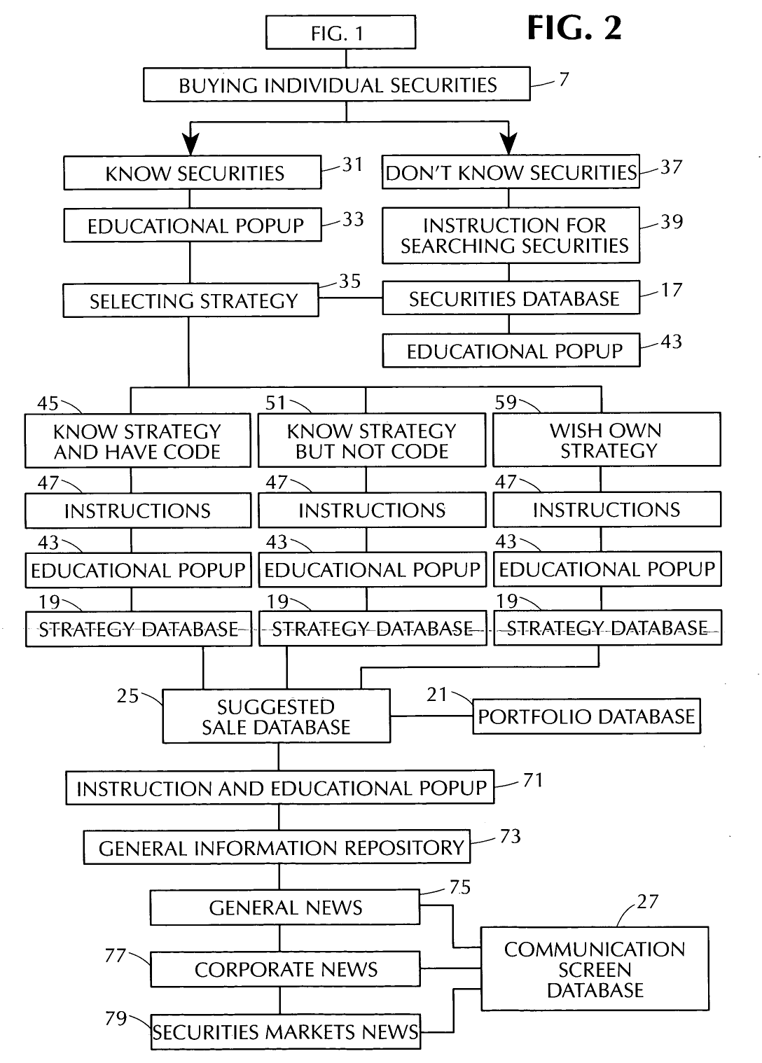

Detailed in FIG. 2, the method to buy securities 7. In the preferred embodiment, this stage can occur with either a new user or an existing user wishing to add securities to their existing portfolios. If the user already has a predetermination of a particular security to be added 31, the person enters the security and selects a particular strategy 35 to be associated with such a security. If a security has not been predetermined 37, the user can search 17 and select securities listed in the securities database 17. Strategies can be selected either by code 45 or not 51, alternatively a search of the strategies database can be made to determine the particular strategy to be associated with such securities. Furthermore the user can define and enter their own strategies 59 into the strategies database for their own use. The suggested sale database 25 and portfolio database 21 is updated with all such newly entered information. The suggested sale database 25 will notify the user on the time to sell such newly added security based on the strategy selected.

The general information repository 73 contains and stores all financial information from a myriad of sources. A high level categorization of such information can be general news 75, corporate news 77, and security markets news 79. The communication screen database 27 screens out information from the general information repository 73. Such screened information are tailored towards the particular strategies selected for each particular securities.

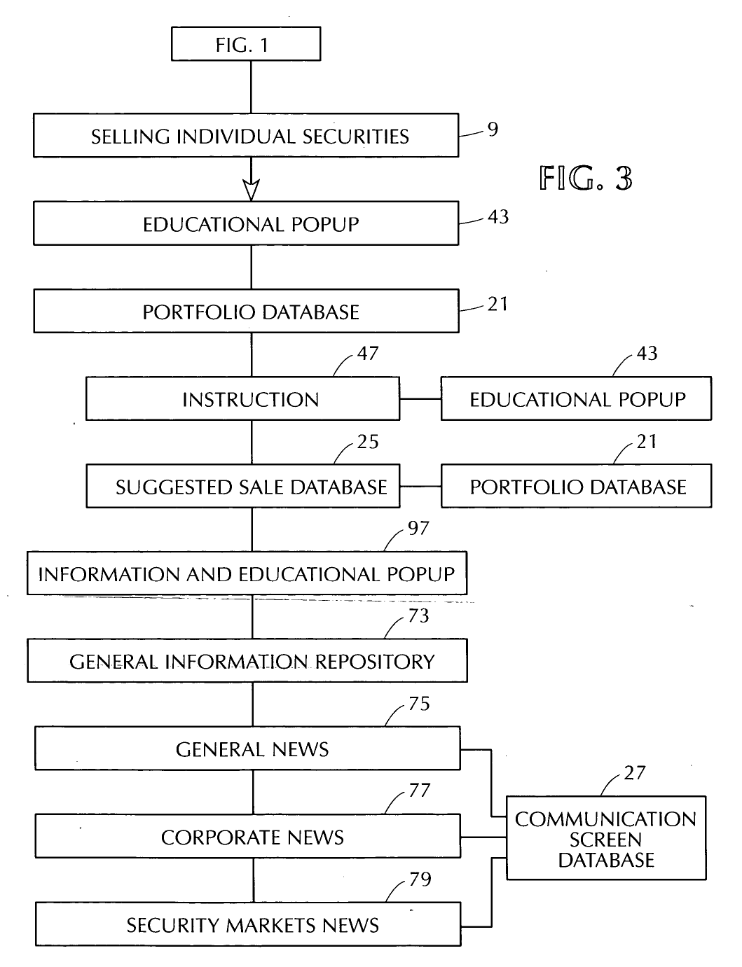

As in FIG. 3. details the flow of the sale of a securities 9. Preferably the user, is notified by the system to sell by the suggested sale database 25. Alternatively, the user can either sell the securities earlier than the suggested time to sell or later. However, the system suggests that users adhere to the time of sale indicated by the system. In conjunction, the user can also access current screened information provided by the communication screen database 27.

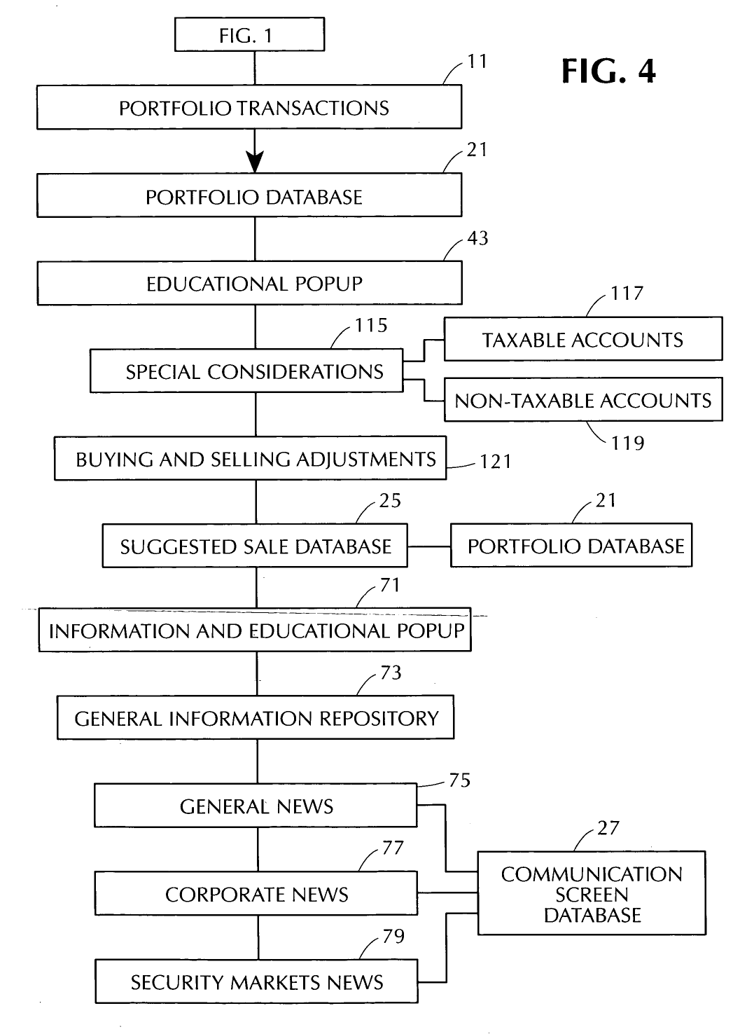

As in FIG. 4, the portfolio transactions are detailed 11. When users require portfolio transactions 11, their individual portfolio information is accessed in the portfolio database 21. Securities can be grouped amongst special considerations 115 such as but not limited to taxable accounts 117 and non-taxable accounts. Adjustments can be made for buying and selling securities 121 which may be based selecting new strategies or securities. At any time the user decides to change anything regarding their portfolio, securities, asset allocations, investment strategies, the portfolio database 21, suggested sale database and the communication screen database are updated.

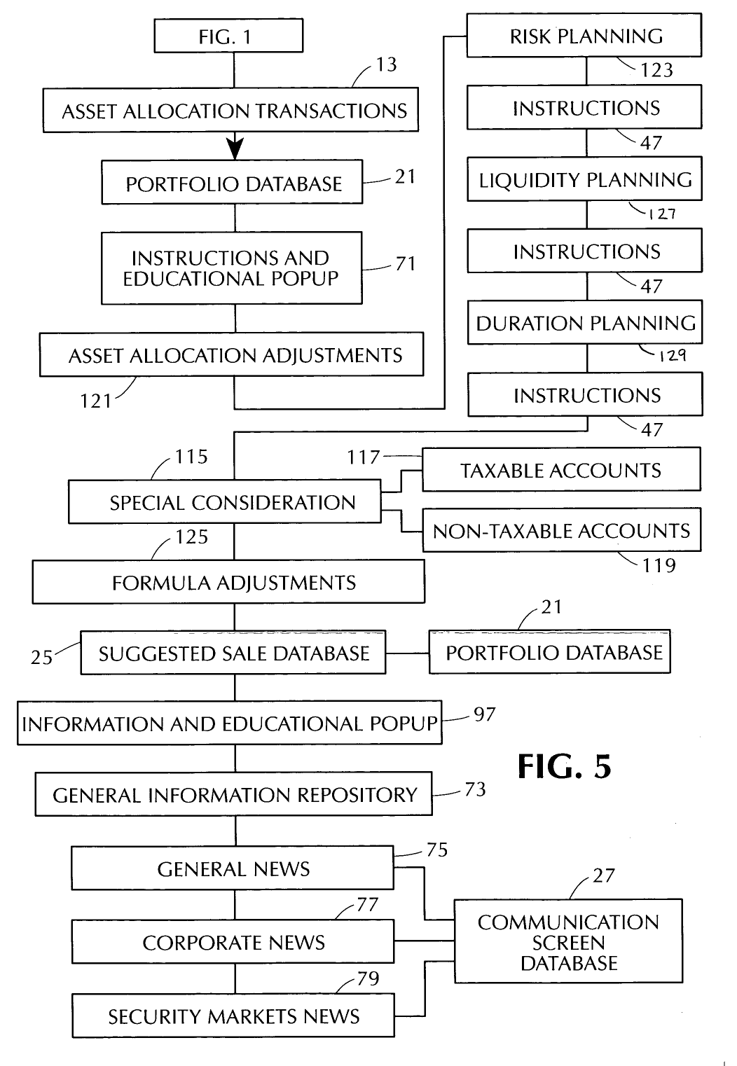

As in FIG. 5, the asset allocation transactions are detailed 13. If transactions are desired the user enters their portfolio database 21. The user then selects the desired adjustments to the asset allocations 121 which may include but not limited to risk planning 123, liquidity planning 127, and duration planning 129 along with any special consideration adjustments 115. In turn formula adjustments 125 are made to the suggested sale database 25, and the portfolio database 21.

In the preferred embodiment disclosed herein, the computer network is the Internet, it is fully contemplated that a wide variety of other types of local or wide area networks (“LANS” or “WANS”) are suitable for the uses contemplated herein. It should be readily appreciated that the Internet is comprised of a plurality of nodes, at each of which one or more of a wide variety of devices reside. Of course, it should be clearly understood that the foregoing description of the Internet and the various devices which reside at nodes thereof has been greatly simplified and that numerous technical details not necessary for an understanding of the invention have been omitted. It should be further understood that, strictly speaking, Trading Server and personal computer and/or internet terminal (“PC”) are Internet nodes operate as the point of origination and/or point of destination in data exchanges.

Node is a router which, as will be more fully described below, routes data between locations, typically, between nodes, within the Internet. Both the Trading Server and the PC are shown as having a direct connection to the router of the Internet. Of course, the manner in which the Trading Server and the PC are connected to the Internet, as well as whether one or both of the Trading Server and the PC have permanent or temporary connections to the Internet would depend on a number of factors, including the respective computing power of the Trading Server and the PC and the respective financial resources of the operator of the Trading Server and the PC. The Trading Server is a larger scale computer with sufficient processing and memory capacity to host a web site, maintain various databases and perform the processing, data transfer and Email messaging functions described herein. The PC is a standard mini-tower, desktop, laptop or similarly sized computer having, as minimum system requirements. The PC can also be an internet terminal which accesses the internet through a cable television connection, etc. in most configurations, the physical connection between the PC and the node would be through one or more intermediate devices such as a larger scale computing device such as those operated by an Internet service provider (“ISP”).

Further, while all of the illustrated members of the target audience are PCs, it is fully contemplated that other types of computer systems, as well as other intelligent devices, for example, PDAs, Cellular phones, and other electronic devices capable of receiving and displaying data received from a computer network and having an interface from which a user may transmit data and/or commands to a device residing on the computer network, may also be used. Finally, while the present disclosure further provides that all of the computer-implemented initiations and analysis of gaming are executed by software residing in the Trading Server, it is fully contemplated that one or more databases processes executed thereby may be off-loaded from the Trading Server.

As may now be seen, the Trading Server is a computer system having at least one port for coupling to the router or other devices of the Internet via a transmission medium such as a twisted pair of conductors. The Trading Server includes a processor subsystem sized to execute plural applications of the types described herein, including, but not limited to, initiating one or more E-mail-type individualized information campaigns to each user, providing general popup trading information to guide the user, keeping track of trades, constantly updating databases in relation to the actual stock and bond markets, etc. Such communications may be sent to users via one way receiving devices or devices also capable of transmitting data.

A memory subsystem is coupled to the processor subsystem by a bidirectional address, data and control bus. Thus, by the term “processor subsystem”, it is intended to refer to the collective processing capability within the Trading Server. As such, it is fully contemplated that the processor subsystem encompasses plural processing devices and/or circuits variously located within the Trading Server. Similarly, by the term “memory subsystem”, it is intended to refer to the total available memory within the Trading Server. As such, it is fully contemplated that the memory subsystem encompasses all of the main, auxiliary, as well as any auxiliary memories, within the Trading Server. Typically, information frequently needed by the processor subsystem is stored in a main memory of the memory subsystem while information less frequently needed by the Trading Server is stored in an auxiliary memory of the memory subsystem. Finally, for most computer systems, the main memory resides on a local bus while the auxiliary memory resides on the system bus, typically either an industry standard architecture (or “ISA”) bus, an extended ISA (or “EISA”) bus or a peripheral connection interface (or “PCI”) bus. Accordingly, it should be readily apparent that the address, data and control bus encompasses the various local and system buses within the Trading Server.

Residing on the processor subsystem are plural software applications, hereafter referred to as “software modules”. As illustrated herein, the software modules include a campaign selection (“CS”) module, a campaign Email (“CM”) module, a campaign media (“CM”) module, a campaign report (“CR”). The modules are all discrete components of the processor subsystem, like the vast majority of software currently in use, the various software modules are all maintained in the memory subsystem, typically, in the auxiliary memory thereof, until executed by the main processor unit, typically, a microprocessor, of the processor subsystem.

Trading Server includes a network core connected with a plurality of message origination elements and a plurality of message termination elements. Message origination elements include, for example, an email/browser, an instant message unit, an interactive TV unit, a web cast unit, a VoIP (voice over Internet protocol) unit, a telephone unit, a facsimile unit, a video conference unit, a pager/PDA (personal digital assistant) unit, an xMS/message terminal (xMS encompasses short message services, enhanced message services, and multimedia message services), a mobile telephone, RSS (Really Simple Syndication), and other message origination elements. Any electronic device capable of receiving or receiving and transmitting data can be utilized in conjunction with this system.

Network core components include a pager network, an Internet/email server, a plurality of private networks, a PSTN (public switched telephone network), a broadcast network, a MSC/HLR/VLR/SMSC (mobile switching center/home location register/visitor location register/short message service center) facility, a plurality of gateways, and other network core components.

The message originator from the Trading Server must compose different broadcast messages, with different formats and form factors, and obtain separate network connectivity for each respective incompatible system element or component to effect message delivery to all recipients.

C-119-BX

Select a Company on its Management and Innate Company Characteristic

Background

Buy Good Management

The investment industry's use of the term “good management” is perhaps the most misunderstood on Wall Street and the financial media. To them, good management makes money while poor management loses money.

Simplistic definitions may sound logical but investors have to go beyond management's recent performance. The question ought to be the question of how management will fare in the future. And there could be valid reasons why past performance may not be a satisfactory yardstick.

Good management may have lost money but it was astute enough to keep losses at a minimum. Bad management may have made money but it could have been more, had management been more astute. Management, in fact, cannot be quantified. It has to be appraised. And unfortunately, Wall Street analysts and observers often aren't qualified to discern good management from bad.

Most analysts by far have had no management experience. They are simply reporters of corporate and securities markets events. They are more entitled than most to have opinions, however, because it is their job to critique management. Very few are able to do this with expertise, despite the hoopla and publicity they may get as “experts” in the media.

Time and again management is lauded for what it has apparently accomplished, only to be lambasted later. This is shortsighted on the part of analysts, but worse, it does have a deleterious effect on top managers. Though it is imperative that top management take a long term view of its corporate prospects, often CEOs must look to the short term to please Wall Street. Quarter-to-quarter results are what really count. Yet, statistics and numbers can also be misleading. And they tend to create problems that may not even exist or exaggerate those that are minor.

If top managers cannot produce good short term numbers their own jobs will be on the line. The lessons they must observe are obvious: When stock performance is good, a lot of managerial errors can be hidden. When stock prices are down, the astute steps the CEO may take will be meaningless.

What is Good Management?

Background

The real trick is to recognize relative ability. To do this, consider the following:

1) Do not depend on one top executive to make a big difference when new on the job. It never works that way in real life with the way large corporate structure operates.

2) Tradition dictates that a new corporate broom sweeps clean, yet cutting employment costs and drastic reduction of losing operations or redeployment of assets are not necessarily a sign of brilliant management. It is easy to cut back to the bone. The faster you cut the better with the analysts, even though managers may thereby disable potential growth for years to come. These steps are basic for the genius and non-genius alike. But Wall Street feel something has to be done and quickly. Or else.

3) Beware of managers who pass the buck by employing high level management consultants to look for problems they should see on their own. No consultant can know your business better than you, especially when consulting firms use relatively inexperienced account executives to furnish their opinions. Consultants often serve as an insurance policy for managers and their boards who need reassurance or who want to show that their hiring of outside counseling is proof of their intention to turn the company around

4): Look for the ego factor. A study of top management qualities often points to ego as a driving force in managerial performance. Yet, it is excessive management actions, urged on by ego, that does lead managers astray. It shows up in acquisitions for acquisition sake. Top managers will take on more and more companies though they may not have been able to fully digest those from the past. Many times, the new deals are used to cover the fiasco of the past.

Ego also shows up in unrealistic marketing campaigns that fritter away hundreds of millions and billions and corporate opportunity. Frequent write-offs are testimony to inept management that has created the need for them. Some CEO's can be readily identified as having huge egos. They will be erratic at best and can be considered relatively poor management.

What to do when the Company's Top Officer Gets Very Sick

Background

There is a tendency on Wall Street to make more of the CEO's influence on a company than it warrants. This can be explained primarily by the fact most Wall Street analyst are poor management evaluators. There are times when the CEO is the main cog in the managerial picture. There are often times when the CEO is not that important, but only a true management evaluation can evaluate whether this is so. It is a job beyond the ability of most of the analysts and money managers, including some of the big names that get media attention as “experts.” If you invest in the corporate mode and the CEO is an important cog, news of the serious illness of the CEO can trigger a sale. But only if that is the strategy you are buying with and you are certain that there is no depth of top[-management to take over in an emergency.

Buy Management That Has Strong Incentive

Background

What would you consider a strong incentive for top managers? Obviously, a manager who directly or indirectly owns a substantial percentage of a business has all the incentive in the world to be interested on doing the best job possible. Any amount over 10% is large. In a large capitalization company amounts below that can still represent several hundred million in stock ownership.

The ownership of a substantial option to take down stock at a relatively low price is another good incentive. The presence of a bonus plan can be a powerful incentive but many bonus plans have become a sweetheart deal when even mediocre results are forthcoming.

Remember that top managers with strong ownership may still be wheeler dealers who may have incentive but poor ability to perform. So, it isn't enough to seek out managers with lots of stock and bonuses and options, but also those with the ability to do something constructive with that incentive.

Beware too, of managers who also own a good deal of equity, who may issue more debt than they ought to. This may be an alternative to issuing more common stock. But when you do that you dilute equity of shareholders, including your own. It will be relatively more costly to any large shareholder. Debt does not dilute equity but it can be a risky measure for the corporation.

And look for the golden parachutes and anti-take over provisions which tend to slow up incentive. When managers cannot be easily fired or pushed out of the way during a takeover of dull management, you have weakened one of the shareholders' best tools for better management. Doing well enough so you are not fired is one of the best incentives in the world, and has nothing to do with how many shares a manager needs to do a good job.

You should distinguish between managerial and entrepreneurial types of managers. Often entrepreneurial types need not have too large an ownership percentage to provide the spark that gets them off and running at top acceleration. That spark is built into the entrepreneurial character.

Buy Securities of Companies You Know Best

Background

There are many good securities to buy. After all, about 95% of Wall Street recommendations are for purchases. And even poor companies can be bought with the use of some of the strategies we follow. (The trick is to know when you will sell, no matter what you have bought.)

To make investing simpler for the smaller investor on Main Street, it is best that you invest in a company or a security with which you are familiar. That means you can invest in a company in which a member of your family or a friend works. Or the company may relate to a hobby of yours or a close acquaintance. You will get insights this way that your reading of the media and other news sources may have missed or did not fully present.

You may get information on product quality, or production problems and a variety of legitimate information that could be unattainable otherwise.

Be careful, if you use this strategy that you do not get too close to the forest so that you miss the trees. Be certain the information you get is not rumor but is fundamentally correct.

And beware: When you use a corporate strategy of this type, be certain that you do not use a non-corporate strategy that involves the moods and sentiments of the marketplace. You will have to employ a definitive corporate strategy. Whether it be sales or earnings growth, dividend policy, etc. Go over other corporate mode strategies to see which can be readily adapted to this.

Buy Management That Focuses Industry Sector Attention

Background

As a rule, companies who focus their attention on one type of business will do far better than those who are in a couple of major fields, none of which are related.

It stands to reason. Management usually cannot do well in more than one or two industries. Expertise is hard to find on one type of business, let alone two and more. It is why conglomerates have not generally done well.

There are two reasons:

One: Some conglomerates pride themselves on their ability to decentralize operations—to sit back in the home office and let their individual general managers or subsidiary presidents run his or her own show. It does sound good on paper. The subsidiary submits a budget, the parent company doles out the funds and runs the ship with a loose rein.

Managerial life does not operate this way in the real world. Invariably, a loose rein translates into eventual problems. And oftentimes problems arise merely because the top managers sitting from afar have not been able to grasp problems that are inimical to the type of business. Besides, they may not have suitable controls due to inferior or substandard expertise.

A corporation may not exactly be a conglomerate but may, however, have a number of subsidiaries or divisions that are dissimilar. And there may be little expertise in one or more subsidiaries or divisions and this shows up negatively on the bottom line.

Reason two: Stock prices are subject to the perceptions and the evaluations made by industry analysts on Wall Street. Analysts usually are not attracted to multi-industry stocks. Analysts may look down on the choice of such corporations. The reasoning is this: Conglomerates are not easy to follow. Analysts follow industries and a company with no distinctive classification as to industry is neither fish nor fowl on Wall Street. These multi-industry companies are therefore often overlooked or they fall through the analytical cracks. Stocks that are overlooked get little attention in the media and analytical reports. Their share prices thus suffer from too little demand on the market.

As a result, surveys have shown that the stockholders get a valuation from the market when their operations are focused. Even better for the company than leveraged finances might provide. And economic efficiencies are more important over the long run to companies than is diversification. It may have been true in the past but more recent research shows otherwise.

C-125-AX

Should the Company Stick to its Core Business?

Background

The, fashion among analysts and money managers who often know little about business itself, often puts pressure on CEOs and the company boards to do their bidding. This has resulted in a tendency for companies to unload valuable subsidiaries under the guise that “being focused” will be better than having a number of businesses in different industries.

It wasn't too long ago when Wall Street pundits loved diversification for diversification sake. Every now and then the emphasis returns to “focus” and top management's of companies have gone along to please the Street by complying with the fashion.

The truth of the matter is that many of such companies have done poorly, relative to the performance of those who do diversify for a logical purpose.

Consider Pros/Cons of Conglomerates for Diversification

Background

Conglomerates get their name from holding majority and sometimes minority interests in other companies, in a number of different industries. The companies are usually not dependent upon each other for their operations. The parent handles the finances and central administration varies from very strong to moderate. Financing is generally supplied by the parent.

The pros:
Theoretically, the conglomerate is well diversified. A downturn in one industry is supposed to be counterbalanced by the success of another industry, and this is said to be one of the benefits of being so diversified.
Administration can be centralized for efficiency and cost savings.
Subsidiaries, it is claimed, do better under looser rein from headquarters.
The sum of the parts of the conglomerate are generally supposed to be worth more on breakup than the total value given to the stock by the market.

The cons:
In practice diversification is not as beneficial as thought. When business and the economy are in recession, few industries prosper. A conglomerate will generally have more than its share of industry problems, despite the variety of industries in its holdings.
There appear to be few benefits from the centralization of administration.
Conglomerates are not easy to manage. Top managers will find themselves in industries with which they are not familiar, especially during economic downturns
Stock analysts do not like conglomerates for another reason. They are not easy to categorize by industry, while analysts cover industries. As a result, many conglomerates are relatively neglected by Wall Street and their stock prices suffer accordingly.
While the sum of the parts of the conglomerate are generally supposed to be worth more on breakup than the total value given to the stock by the market, it is not easy to sell off all the arts. And if you do, there will be no conglomerate left.
The lure of conglomerates is faddish. There was a time a decade or two ago when it was fashionable to create them for all the advantages cited above. When the disadvantages became apparent the fad waned. Every once in awhile, the fad comes full circle.
The strategy as such is not sensitive. It should be used in conjunction with another corporate strategy that can be flagged for selling signals. However, if the strategy is employed on a feasible expectation that parts will eventually be sold off, it can be a bit more sensitive.

What do you do if company management suddenly wants to buy and sell like the others? And how effective are mergers and acquisitions?

Background

More than half of mergers and acquisitions do not produce shareholder value. Many observers feel the figure may be closer to about two thirds. Still companies continue this mad rush to get together.

This is constantly reflected in shareholder return in study after study. It appears the pressure is due to short-term aims that Wall Street has and the investment banker advice which, to many, adds to the peer pressure to conform.

Management often seeks spinoffs as well. It's now very fashionable for a company to create a spinoff—a division that a company believes would be better off separated from the parent, even given its own stock-market listing.

Consider Smaller Capitalization for Better Growth

Background

The smaller the corporate capitalization, the better earnings growth will be. This is due, in part, to psychological reasons, business logic and mathematical fact. And it is also owes to the type of following the company's stock may get.

In the public's view, there is greater growth when the pie appears to be smaller. Put another way. A business making $1 million that has 1 million shares is earning $1 a share. As long as you don't add to the capitalization the pie remains small.

If there were 5 million shares outstanding, the earnings would be only 20 cents a share. The same pie but sliced differently. Psychologically, it makes better sense for the investor to keep that pie small.

Business logic comes into play in another way. Smaller companies have more room to grow. The percentage gain with a small company will be far greater in five years, for example, than it could be with an established large company

And then there is the mathematical limitations of endless growth. A small company can grow at an accelerated growth of, let's say, 25% a year, but this cannot go on forever. It's like savings a penny one day, doubling it for savings the next. Doubling the savings rate the third day, and so on. In a relatively short period of time you will have run out of personal funds. Mathematics is a limiting factor as well when it comes to corporate earnings growth.

As far as following a small capitalization stock, institutions such as mutual funds and large pension funds cannot easily manage the purchase or the eventual sale of these issues. They must buy or sell large amounts of stock at a time because of the relatively large portfolios they manage. This fact leaves the small capitalization issues to smaller investors.

But when small capitalization companies do grow into larger companies, the mutual funds and the pension funds will look at these stocks once more. And when they do come in to buy they will boost demand for those issues.

When that time comes, the demand will boost prices to the benefit of existing long term shareholders. When prices go up, there may be stock dividends or stock splits. The latter merely increase the number of shares in one fell swoop.

For instance, if there are two million shares outstanding and a 2 for 1 split is announced, there will then be 4 million shares.

(Note there can also be reverse splits. A company with 10 million shares can have a 1 for 10 reverse split, resulting in total capitalization of only 1 million shares after the procedure.)

Consider Pros/Cons of Younger Companies

Background

Younger companies grow faster, percentage-wise, than larger, more mature companies. They have a smaller sales and earnings base on which to accelerate growth. One survey showed that earnings growth of smaller company stocks averaged a 5% point advantage over that of larger company growth stocks.

While this is not a scientific comparison, it pretty much parallels the advantage of size among growth companies. However, smaller companies are generally riskier than those larger. They may not have the financial resources, or the management, or administrative backup to perform well over the years.

The mathematics is also a factor. A young company's growth rate for the past 5 years will be hard to duplicate in the following five years. Increased size may have limiting effects. And no matter what growth can be attributed to today, you can be sure that competition and changing demographics will make rapid changes necessary for that growth to continue.

A marketing success plan that worked wonders for the past few years may be meaningless in the face of the need for future marketing plans. No business is a static entity. so the growth success of the past may mean absolutely nothing, unless management can constantly come up with new and successful products and services.

The aforementioned growth assumptions therefore are based on the fact the company will be able to continue to grow rapidly. Many small companies are high tech or they are in an industry with fast-developing products. Many of those products become obsolete quickly, so only an assumption has to be made for the company's excellent past growth rates to continue.

Secondly, growth may require infusion of capital. The ability to get that capital at decent cost may alter the growth projections that were made on past growth. Remember, the company that produced the previous growth may not be the same company that will be in place for the projected growth.

The following thoughts relate to smaller corporate capitalization. The same psychological, business logic and mathematical reasons also apply.

In the public's view, A business making $1 million that has 1 million shares is earning $1 a share. As long as you don't add to the capitalization the pie remains small. And younger companies tend to have smaller capitalization unless they are penny stocks that are more a play on speculation than they can be considered viable younger companies with an operational business plan.

Smaller, younger companies have more room to grow. The percentage gain with a small company will be far greater in five years than it could be with an established large company And there are the mathematical limitations of endless growth. A small company can grow at an accelerated growth rate,

Institutions such as mutual funds and large pension funds cannot easily manage the purchase or the eventual sale of small capitalization issues. They must buy or sell large amounts of stock at a time because of the relatively large portfolios they manage. This leaves the small capitalization issues to smaller investors.

Consider Corporate Capital Gains or Income Goals

Background

Many investors feel common stocks ought to be bought with but one goal: Capital appreciation. They feel that income objectives can be attained in other ways, and more amply at that. They feel that securities cannot offer sufficient income in the form of dividends. And that it is capital appreciation that provides the real incentive for holding common stocks. (There may also be income tax advantages. for holding dividend-paying stocks.)

Yet, there are stocks, e.g. utilities, which do pay dividends high enough to satisfy income objectives. While they are the exception (most stocks pay a few percentage points, if they do pay any dividends) folks who require income will buy bonds income-producing real estate, etc. Money market funds and certificates of deposit from banks will pay more income. They do not appeal to investors who are seeking capital appreciation over the long run.

What should you capital gains goals be? Appreciation should approximate 8% to 10% a year, looking over 70 years or so. That is in addition to any dividends the stocks may pay. Growth stocks may be expected to average higher than 10%, but dividends will be lower or nonexistent.

When you compare returns of bonds or CDs or money market funds and growth stocks look at total return. That is, what the stocks will be worth over the years in addition to any dividends, as compared to the total return on bonds and other instruments. Bonds can also grow in value. They rise in inverse proportion to a drop in interest rates. (Should interest rates rise, you will lost principal on bonds).

Most important: Any comparison between capital gains potential and income must be predicted on after-tax results. When you pay full tax each year on an investment which averages 10% a year before tax, you will be receiving only 6% or 7% return after tax, If you were to compare such a return with a 7% tax free bond to maturity, you will be getting no more return for all the risk of holding the stock.

Consider Companies which Buy Back Their Shares

Background

Many companies buy back their stock from the open market. Companies who buy back stock usually do better than average in the marketplace.

This practice has two main and several tangential purposes. Some for the benefit of the company itself and its shareholders, and some for the benefit of executives at the company.

1) The company and shareholder benefit:
The company management may find its own stock is a better investment for its cash than the company putting the cash into equipment or into working capital. They may rightfully feel that the return from owning the stock will be better for their future planing,
The stock is taken in as treasury stock, and can be used for purposes other than holding for investment. It can be issued in the future for acquisitions of other companies. And some can be used as stock awarded to executives and employees under option and profit sharing plans.
The companies who buy back stock often do this because they feel the stock is being undervalued by the market. If management feels the stock is a good buy, no matter what the investing public may think, management will buy it up. It helps that the stock is a worthwhile investment.
Another purpose management may have in buying back stock would be to bolster the price. Companies usually want their stock to be relatively strong. For future acquisitions using a better valued stock, and for the benefit of executives in the company who want the stock to be strong.
The less stock there is to divvy up earnings, the higher the earnings per share will be. Stockholders want less outstanding shares so that the same earnings for the company will translate into higher earnings per share.
The company may be acting as an investment vehicle rather than an ongoing, operating business, but stockholders want positive results: higher earnings per share and better market price as a result.

2) The top executive and management's benefit:
If the company could do better using the funds to bring in capital equipment for investment, then that should have been the plan. Where return on capital is high, buying back stock can be foolish. This may be a cynical look at the reasons behind a buy back. But there is no doubt, there have been buy backs where the company should have taken the long term outlook, and used the funds to put back into the business.
Another purpose for the benefit of management only would be to limit the ability of outsiders to acquire stock in the market for the intention of buying control of the company. The more stock the company buys in, the less there is for unfriendly outsiders to buy and gain control.

Caution: Many companies who resort to buybacks are primarily interested in getting stock for their Treasury, to be used for acquisitions. On balance, they may not have too much stock taken off the market. Also be certain that the buy backs are not over book value. The Cash flow per share may improve with the buyback, but they may in the process be reducing their book value per share. And there is no guarantee the advantages will be anything but fleeting, good for the first couple of years and no longer. What do you do when Companies fail to live up to stock buyback commitments? When a publicly traded company says it will buy back some of its stock, the reaction is usually positive.

The usual positive reaction from investors has helped the number of buybacks surge The main attraction of buyback programs comes when the programs retire shares. That reduces the number outstanding and leaving the company's earnings pie to be divided into fewer, bigger slices. But programs whose purpose is to gather shares for use in employee incentive and stock purchase plans are much less favorable for shareholders than other buybacks, because the shares aren't retired.

Company announcements do not always make clear whether shares will be retired, so investors may want to call the company's investor relations office before buying So are the buybacks flashing a “buy” signal is a question The numbers in the announcement can sound good, but repurchase plans may take years to complete, and companies are under no obligation to make good on them. There is little that shareholders or regulators can do if management reneges on its plans. The SEC does restrict when a company can buy its own shares, to prevent price manipulation. A company may not make the first trade of the day or trade in the final half hour, may not buy on an uptick (when the most recent price change has been upward) and must limit any one day's repurchases to 25 percent of the average daily volume for the previous four weeks. Not everyone on Wall Street is enthusiastic about buybacks, preferring to see a company use its cash to make acquisitions or to share its wealth with stockholders by issuing dividends.

Consider Buying an Already Bankrupt Promising Company

Background

A careful review of the corporate fundamentals of bankrupt companies can often produce excellent capital appreciation possibilities. There is no hard and fast formula for the issuance of securities to debt holders and stockholders of a bankrupt company.

Under Chapter 11, a company continues to operate under protection of the courts. In the meanwhile, it attempts to work out a plan with creditors. The latter would hope to get 100 cents on the dollar but often settles for less, sometimes far less. And repayment is extended to make payments easier to meet.

Bondholders are creditors also but down the line in priority, especially those whose holdings are not collateralized by company assets. Common stockholders are the last in line as far as repayment priority is concerned.

The risk: The company may not be able to operate profitably even after debt is rescheduled or reduced in size. If that eventually happens, the company will liquidate and the creditors and bondholders will get what is left, if anything.

Securities may be in the form of bonds may be offered to pre-bankruptcy common stockholders or other classes of securities as well as the common stock. They may have value which will depend on the nature and amount of assets, the type of debt, and what can be arranged by a bankruptcy referee with the different parties and their negotiated interests. The study and research that must go into this is arcane and somewhat of a crap shoot. But investors may be able to profit after agreements are made among creditors.

Corporate mode investors have less of a risk, but still a complex research job is needed. Sophisticated insights into bankruptcy law is a plus. An estimate must be made to see what will be left to different classes of bondholders, and what may remain for the company and its stockholders. Perhaps profitable company subsidiaries may be spun off for cash. Or left for the benefit of stockholders.

If you are not able to do the research yourself or your financial interest is too small for you to invest the time required, you can glean whatever information you can from media, or better still, court reports and legal documents on the bankruptcy filing. Another solution is to invest in mutual funds that specialize in buying securities in bankruptcy. Specialized funds have managers whose job it is to investigate these securities, and are more adept at this type of analysis than you could be.

Consider a Company on Future Demographics

Background

Demography is a tool for researching growth industries and companies. It helps avoid problems with stocks you may own but are not sure about nor do you have strategy for holding them. (That strategy should have been known at the outset, but we assume you have just learned of the need of a game plan and you never had one.)

However, always remember that the more analytical the demographic forecasts become, the further off the mark they may seem to go.

Demographics take into account the social, economic and political effects and conditions that people create, or that they react to. The demographer has an eye on kids, teenagers, mid-life groups, senior citizens, and their buying sand savings habits.

The groups have their own characteristics. Examples of current demographics and what they had been for the same groups in earlier years:
Young college graduates are more oriented to luxuries than their parents were at the same age
If a falling birth rate is discernible, future home sales may be adversely affected, and the sales of home equipment and furnishings can be hurt. In the decade after World War II, the birthrate kept climbing.
More women are entering the work force, as compared to women of an earlier generation. This governs the way food is presented at supermarkets. Convenience foods are taking over and It affects the dining out industry.

Yet caution is essential. Long term forecasts can be erroneous. People expected a short baby boom after World War II and the boom lasted for twenty years. When the prognosticators then predicted it would continue unabated, the birth rate suddenly fell.

These studies are engaged in the world of constant changes. Discovery of a new, or soon-to-be- trend requires an extensive background in extensive areas of expertise: Marketing, science, medicine and so on. And it requires painstaking time with cause and effect analysis. The best way for the layman to accomplish this is by reading as much as possible in both popular and industrial periodicals.

Be Wary of a Company's Extensive Expansion Plan

Background

Investors are easily attracted to companies who are actively expanding their business or acquiring other companies at a rapid pace. An exhilarating sense of prospective growth and optimism arises when expansion news is leased. The statements from management are usually upbeat and the Wall Street analysts get caught up in the fervor. The investor, especially one who is undisciplined, will be en mired in this optimistic this bullish ardor.

However, experience tells otherwise. While some risk is innate in business expansion at all times, too rapid expansion generally magnifies that risk. Companies who make acquisitions often, or are quick to open new offices, or who come up with an unusually large number of new products or services, they all ultimately experience administrative and management difficulties.

Too rapid expansion will also require funding that many actively- expanding companies cannot find in sufficient amounts. They plan to have the funding but unexpected corporate problems will change their plans drastically.

Then too, an unexpected recession or economic stagnation can change the business picture quickly and impact cash flow projections.

As a result, extensive expansion plans may work only for the short term. There is generally not enough consistency in the best of managerial plans because there are simply too many chances for future goals to go awry. By the law of averages, there are bound to be problems when projecting for the future. When you project something to occur and there may be two more dependent factors which may not prove to be as expected, the odds for success are thus vastly diminished.

This strategy can easily be incorporated as a screen for companies to avoid. This is especially true in capital-intensive industries where an error in judgment, or some unforeseen difficulty can create a financial disaster. Lots of capital investment can be impaired almost overnight.

Note: Trading of fast-expanding companies ought to be considered primarily in the trading mode. There are inherent corporate mode problems which indicate that you avoid buying in that mode. But the shifting moods and sentiments make several trading strategies very feasible.

Avoid a Company with Fully Regulated Operation

Background

Regulated companies operate in what is called the “public interest.” That type of company can easily get involved with government regulatory problems. And there is little recourse they can muster from the public or the media. The government with its bureaucratic ways and its often inept bureaucrats can take over a company's managerial planning and time, and present traps that are time-consuming and costly.

Pressure can come from government legislators and politicians on the federal, state and local levels who are looking to make companies a scapegoat. Corporations do not vote, but millions of consumers they deal with, do vote. So, blaming companies for ills that afflict the consumer and ultimate voter, can be an easy way for politicians and government to get off the hook for their own inadequacies. Public utilities and local phone and cable companies have always been in this sad predicament.

Pricing is always a political battle, rather than a marketing plan that can appeal to the customer in the form of service and quality.

Public interest companies do not have recourse to the marketplace the way conventional companies do. The struggle is different. The public, aided by government and politicians on one side; the company on the other. The necessary public relations to counter the pressures can be almost insurmountable.

The other side of the coin may show an advantage, After all, public regulatory agencies do set price and eliminate competition. Some prices can be set higher than market competition would allow. Many corporations would love to have government reduce competition despite the lip service they give to the free-market principles. Studies show, however, that more often than not, fully regulated companies have a decided disadvantage.

Also, many public utilities are able to pay relatively high dividends, though they are disadvantaged when it comes to growth of revenues and earnings. (This is currently changing where more competition has been introduced into the fortunes of utilities and local phone companies.)

Avoid Vertical Mergers

Background

It is logical for many top executives to believe that vertical mergers will help their companies facilitate growth at lower cost. The logic is clear. Have an organization which produces the raw material you need, Have the ability to use that raw material efficient;y in a manufacturing process. Then have the ability to market and sell what you have made.

In the ultimate vertical entity, the advertising agency you use to help market and sell, can also be within your organization.

In reality, studies have shown that you do not get extra profit margins by going up the distribution line by producing product and service within your own organization. That may happen only if you have a near monopoly. And that is impossible when the FTC and U.S., Justice departments look askance at takeovers that are perceived to be in restraint of trade.

Invest in companies that operate out of low-tax states.

Background

The strategy makes sense. Companies domiciled or doing a good deal of business in a low or lower-tax state will have a competitive advantage. Usually the cost of labor is lower in these areas. That eliminates some well-known high-tax states. This is especially true of smaller companies who are unduly burdened by taxes and state regulation and high labor costs.

The existing level of taxes and regulation are not as important as the trend towards lightening the restrictions takes over and many states compete with each other. Nevertheless, there are distinct cost advantages for many companies by selecting where they opt to do business.

The strategy is not sensitive except for basic selection, especially for smaller companies and those that are labor intensive.

Buy New Issues (IPOs)

Background

New issues are usually hard to get because they are often priced to sell for a premium soon after they are traded for the first time. Only preferred clients of the underwriters were permitted to buy them years ago. Stricter regulatory policing has made stock allocations more equitable.

But assuming you are able to get the shares, should you buy? Unless you are allowed to sell them quickly chances are the prices will soon fall below your purchase level. Larger new issue companies do better than the routine- type. The smaller new issues can sometimes be disasters.

The strategy is not very practical in the corporate mode. Most new issues are not long-term viable, Most are highly speculative and you would avoid them in the corporate mode unless you are intimately aware of their favorable prospects.

Intrinsic Selling Character

Your rationale for selling the stock is a reversal in the reason for buying. Absent that, the selling flag could be a major percentage market loss from a predetermined market high.

C-173-BX

Accounting Principles to Observe

Background

Be Alert to Companies Where Officials Suddenly Quit

There is generally a problem—a major problem—if a top level officer of a company quits in a huff, or may be forced to quit. Especially if a number of top officers quit at one time. This is usually a serious indication of trouble and is highly suspicious.

This entails not just to a change of management at the top. It can involve top managers near the top, managers who are instrumental in the proper day-to-day function of the business.

There may be several reasons for such mass leaves.

1) Top managers have been lured away en mass by a head hunter. One top manager may have decided to take some of his or her understudies. While it is not a healthy corporate incident, and managerial replacements will be required, the departures may not reflect a major management problem at the company. In some industries (notably stock brokerage) wholesale job migration can be one of the facts of life.

2) Top managers who have been lured away may not be readily replaced. If they were a crucial segment of management there can be a replacement problem.

3) Top managers may have become fed up with the top brass and have decided to quit. This can reflect a serious management problem. It can be a sign that top management may be poor, at least in the way they communicate with high-level executives. You may get indications in this way that does not come from Wall Street analysts. The latter often attempt to report on management matters from a very restricted viewpoint.

4) The CEO quits or is suddenly fired. When somebody who is entirely optimistic about business on a Friday, happens to quit the following Monday, there is a major problem.

Avoid a Major “Loser”

Background

Investors make money by avoiding bad mistakes. Sudden bankruptcies, the abrupt banning by the FDA of a major drug product or a food additive, or the onset of a catastrophic liability lawsuit may be classic examples. But there are less obvious mistakes to be avoided, if you can.

The truth is, some mistakes may be unavoidable, but if possible you attempt to stay away from them. There are some basic rules for you to follow in this regard:

1) Stay away from thinly capitalized companies. Their balance sheets leave little margin for error. The proverbial shoe strong can snap, and with it the entire business. And your entire investment too.

2) Stay away from companies with just one or two products. Government edicts or a bit more vigorous competition and those companies are in deep trouble.

3) Stay away from entrepreneurs whose sole claim to fame or position is running the publicly owned business Their ability is the use of a sharp pencil. Their mistakes are usually big ones

4) Stay away from business run solely by techies. Sooner or later they will run out of the limited management depth they possess. There are exceptions but generally those who can develop the most intricate software may not be able to run the resulting big business.

5) Stay away from companies who stray into industries with which they are not familiar. This is particularly true of acquisitions which bring in subsidiaries other than the major operational target the company had been seeking. Those throw-ins may prove to be disasters the acquiring company had not anticipated.

Observe Industry Accounting Quirks

Background

Some businesses have accounting specialization and customs or traditions that complicate their understanding.

Take insurance. Fire and casualty and life insurance insurers have complex accounting procedures that vary from each other, but they are equally complex. The insurance industry methods of reserving for claims make a major impact on the profit and loss bottom line, more so in many ways than is possible with conventional reserve accounting. What you therefore see on the statements is not what is actually happening in the business. You must take the time and the effort to discover what the figures really mean.

Another example: Companies in the defense or contracting business can throw off income that does not allow for future tax bites. Also: Banks can report earnings growth by under-reserving their bad loan accounts. And the treatment of securities gains and losses help mask their operating results.

A business may have lots of bricks and mortar showing up on the balance sheet. Or extensive, expensive equipment. There may be valuable fixed assets that are fully depreciated, yet in use. Such companies will have a higher value than the books show. On the other hand, the assets may be slightly depreciated, but obsolete and underused. Such books may show overstated values.

The company may have lots of goodwill on its books. Goodwill is created in an takeover when the acquirer pays more than tangible book value for the other business. Tangible book value may be inventories, factories, receivables, buildings, etc., as compared to brand names, marketing and distribution systems and customer lists.

Brand names may be worth a lot, or they may be nothing of real value. Much of that figure does not belong on the books where it is supposed to measure a company's basic value. Yet, some companies would have no book value if you eliminated the intangible portion of book value.

By the way, some industries with problems nevertheless have lots of tangible book value which cannot translate into ready production and profits. You can have an old steel mill with high book value but with little prospects.

The fact is, every industry has its own accounting quirks. The investor who wants to evaluate a company using a corporate mode strategy must realize this and take precautions. He or she must know about these quirks. You do not have to be an accountant, but merely be aware of them in a practical manner.

A further example: Legal accounting tactics are being used to make REITs income look better. Be careful of what is reported as “Funds from Operations.” It has become the industry's main performance measure instead of net income. Yet, FFO can be misleading. REITs use FFO because they say that conventional accounting has them use non-cash charges for depreciation and amortization and that depresses earnings. Those charges are to be taken for from 5 to 25 years and more.

FFO is determined when the depreciation is added back to net income. But in addition to that, the REITS may add back a variety of other recurring cash expenses. Such as the cost of carpeting and improvements and leasing commissions.

REITs use a method of accounting called “straight-lining” when they report their rent revenues. Rather than the cash paid in rents, they report instead how much average rent they are going to get over the life of the lease, including rent increases. Not all the REITs disclose the method of accounting they use. Problems come about when the FFO accounting has REITs paying out dividends which are exceeding their flow of cash.

Buy a Company with Conservative Accounting

Background

In most instances nasty surprises can be avoided when a company employs conservative accounting principles. Good accounting practice is an indication the company is consciously running its operations properly. When accounting is free and easy and slipshod, chances are the company will eventually get into financial trouble. Some time in the future sloppy accounting may have to be restated. When that occurs, the stock price will be severely hurt. Restated earnings can prove disastrous for the stock price.

Here are some rules you can observe when you look at a company's accounting methods:

1) Look for accounting of inventory on a LIFO (Last-in-First-Out) basis. It is more reliable than Fist-in-First-Out accounting. LIFO more accurately reflects the real cost of sales.

2) Look at the way development costs are bring charged off against income. Are they being spread over a number of years or written off the year they are incurred, the more conservative way?

3) How are pension funds being handled? An assumption that the funds will earn higher returns in the future may mean less funds are being put aside today.

4) How are pension funds being invested? Some companies invest primarily in their own stock, possibly to ward off takeovers. Pension funds should be segregated and diversified.

5) How much are any unfunded pension liabilities? The higher that figure, the less conservative it is.

6) What is the cost of providing retirees' medical and life insurance?

7) How dated is the inventory? This isn't an easy calculation but reports of poor sales or model discontinuation should bring on immediate, major write-offs. If the write-offs are being held off to keep profits from deteriorating, the company is signaling future surprises.

8) Are dividends paid out of earnings with a sufficient amount of earnings left for reinvestment in the operations and expansion of the business?

9) Look at the clarity of the earnings statement. How good were sales? Was the profit figure enhanced with the payment of lower tax rates?

10) Look for non-recurring and non-operating income in relation to total income. In other words, are the earnings reflecting the direction of the business?

11) Is the company using huge corporate write-offs to show a rosy operating income figure for operations not subject to the write-off? Many restructuring charges of this kind should be expensed from normal operations and not treated as non-recurring.

12) Look to see if the corporation is shifting to a longer period of depreciation from a shorter one. This is often done to artificially increase earnings.

13) See whether the company is using future payments as income in the current years. (Some finance companies take future interest and accumulate it as having been paid currently.)

And learn the knack of reading audit statements. Auditor opinions must be clearly favorable. Auditors have four choices when making their opinion statements. There ought to be an assertion in which the auditor has found them to “present fairly the financial condition in accordance with generally accepted accounting principles.”

Avoid audit statements that refer to “subject to” or “except for” disclaimers.

Be Alert to Corporate Bond Rating Changes

Background

A rating change can make a significant difference in the market value of a security. Whether a preferred stock, a bond, or note, a sudden revision by a credit ranking service will substantially move the market value up or down.

Standard & Poor's, and Moody's, and Fitch Ratings for example, are three major services which make credit ratings and update them from time to time.

When this happens on the downside some holders are forced to sell because of their fiduciary responsibility. Other investors will get jittery and sell, whether they ought to or not. Still others will sell because their strategy is to hold only higher-grade issues. As a result, the market price of the issue can be placed under considerable pressure when there is a downgrade.

A revision on the upside will do the opposite. Those who can hold better gradings may be interested in buying. The easily influenced investor will be more inclined to buy because of the news. As a result, buying pressure will push up the market price.

The symbols of ranking, whether AAA to C (Standard & Poors) or Aaa to C (Moody's) give just the opinion of the rating agencies. The latter are not infallible. But they are better than what ordinary investors may impute to the prospects for the issue.

Rating service investigations on bonds and notes are made not so much of the issuer's past than they are as projections into the future. The major question to be answered: Are the issuers expected to easily pay the principal and interest of the bonds notes in the years ahead?

Rankings are especially important for the purchase and trading of complex corporate issues. They are most helpful for those who deal with corporations that have issued several layers of debt. (e.g. utilities) That makes analysis more difficult.

State and municipal bonds are hard for an individual or average analyst to evaluate financially. The service rankings are thus a good indicator strategy for those who will retain the issues solely on credit ratings.

Companies that Restate Earnings

Background

Every once in a while a company will restate its earnings—usually much lower than it has been. That occurs when their auditors object to the way a previous auditor may have done the books but that is not frequent. Auditors don't get the job from a company by acting as a critical judge and jury. By the work may be thrust upon them when the board of directors is faced with an apparent major ac counting scandal.

The restatement usually comes about when lawsuit is threatened or the SEC or a securities exchange takes issue with the way the books are being kept.

When that happens, and you have had a corporate mode strategy, it probably is time to immediately unload your investment. If it is a market mode strategy, a downward move in price may signal a selling flag. What is more, the restatement itself may be a harbinger of further problems to be uncovered, so holding the stock may remain unwise.

Intrinsic Selling Character

Your rationale for selling the stock is a reversal in the reason for buying. Absent that, the selling flag could be a major percentage market loss from a predetermined market high.

C-194-BY

Marketing Abilities

Background

A number of factors contribute to marketing abilities of a corporation:

Buy a Company with Excellent Market Position

Having a good percentage of the total market for a product or service helps control the profit picture. Profit margins then become easier to maintain. Being number ONE or number TWO than offers a better franchise for doing business.

A small market share translates into a highly competitive cutthroat business where margins can become minimal, even where none of the competitors predominate.

Questions to ask of management:
If the company is not first or second in its industry or in product sales, are the larger competitors always aggressively trying to take away market share? If so, the company has a chronic problem it may not be able to solve.
Is the company able to raise unit sales volume, in bad times as well as good? What has the company done at the bottom of the last economic cycle? A company should be able to hold its own in unit sales, though it may not temporarily be able to grow in a poor economic environment.
Are the company's future prospects as good as they currently are? If not, earnings growth will shortly be severely affected.
Is the company making acquisitions for products they do not produce at present, but which may well burden their current marketing efforts? Adding new products without enhancing marketing ability is not a corporate sinecure. In fact, it is bound to make matters worse.

An example of how a company can control its market: Take a daily newspaper in a one newspaper city. Apart from TV, radio and other forms of mass communication, that newspaper will have sewn up its market pretty well.

Another example: Consider household name products which enjoy a market-controlling franchise. Companies with products a that are instantly recognized when seen on a store shelf enjoy an intangible asset. Competitors may not have a comparable asset though they may have many millions more with which to promote and advertise their wares. When you have a product with such controlling franchise, you need only minimal advertising to keep public recognition intact.

A reason why good market share is so essential. Greater market share gives a company cost advantages which enable management to cut prices whenever a competitor chooses to make sales inroads. Furthermore, lower costs give an ability to improve product quality. This protects the market even more against competition.

However, a survey of money managers has indicated that only about 4% actually worried about a company's product position when making a decision in recommending the stock. Other quantifying factors retain analysts' attention.

Buy a Company with Increasing Operating Margins

Background

The company's operating margins are too often overlooked by investors. Yet, operating margins are a better measurement of company management and fortunes than are net profit margins.

It makes sense to be conscious at all times of net profits and you can have a corporate mode strategy based on net earnings. Operating margins can be a harbinger of net income to come—a sort of early warning system. It gives you a line on the company's operating costs and its productivity. It can be more important to a company's prospects than merely the net profit margin. Sometimes it is easier to control interest charges and taxation than it is operating margins.

So you can look for a company whose operating margins are on the increase. Operating income is what is left from continuing operations before depreciation, taxes, interest and extraordinary items. That will show whether the basics are sound. It's true the company may have lots of debt and depreciation and write-offs and taxes that are holding it down but the business itself may be a good one.

Buy a Company with Value-Added Products

Background

Companies who get away from basic commodity aspects of their business with “value added” products are often better able to withstand downside cycles.

Basic chemical producers have for years been subject to the booms and busts of an industry overly influenced by the business cycle. When the economy nosed down basic chemical demand would automatically fall along with it. Chemical producers had to wait out the economic storm for their fortunes to improve. For an industry so capital intensive the periodic overcapacity brought on by recessions plagued the companies. They were hard-put to contend with the problem.

The chemical industry eventually learned its lessons. There are still problems from cycles but not as severe as they had been. By adding value to a basic commodity, chemicals producers were able to manufacture specialties. These are not so closely tied to business cycles as are basic chemical raw materials. Value-added products are therefore the answer.

Whenever excess capacity can be used to keep plants operating as close to normal as possible, such value added expansion makes sense.

Other examples of value-added products: Middle eastern oil producers have been converting their crude into chemicals instead of shipping the crude overseas where someone else has been producing the converted product. Or harvesters of fruit such as pineapples and grapes are making juices or versions of the fruit for ultimate consumer use.

Be Wary of a One or Two Product Company

Background

To traders using market mode strategies one- or two- product companies can be dangerous, notably when the product can be regulated out of existence overnight. Pharmaceutical products are an excellent example how the Food & Drug Administration can wreak havoc when it questions side effects of new drugs.

On the other hand, a corporate mode investor will find that one- product companies do not entail as much in surprise problems. The problem may not be a surprise but inevitable. (Note: There may be more than one product, but only one constitutes the bulk of that corporation's marketing thrust.) They are, however, a poor concept as an investment selection for the longer horizon.

In marketing terms, a one-product company falls behind the first day the product goes on the market. Unless it is thoroughly protected by patents and few are, that product is going to be

a) reproduced by competitors in some legal form, or

b) replaced by competitors with similar products.

And what is more, the competitor may be better financed to out-market the company and accomplish its own competitive aims.

Since an investor using the corporate mode is in for the longer term and concerned with the company's growth, a one-product company always has a sizable obstacle. Sooner or later competition will change the company's sales position, and will destroy any pricing advantages or cut earnings potential. The company will be headed for trouble unless new products or services are placed on market.

Buy a Company with Smaller Market Niches

Background

Companies who enjoy large shares of the market, specifically those who are not well-financed, will frequently find their well-financed competitors closely at their heels. It is easy to lose that market dominance.

There is a lot to be said for companies who do not have a large share of the market, so that they are not targets of those who want to take over a part of their market. Otherwise you are a constant target, especially if you haven't the wherewithal to fund your position.

Your goal may be to find products or services that can produce relatively smaller market volume. That is, if your company is not big and you can live with smaller market niches. Your competitors, on the other hand, may be larger than you. They may not bother chasing after you with your smaller markets, since it may not pay for them to do so. They may consider smaller markets a waste of corporate effort.

Make a container of coffee or a bar of soap, and you are in a tough competitive fight all the time. Make a specialty item and those Big Boys' attention may soon be gone.

As a smaller company perhaps you do not mind these niches. Moreover, if you have several products or services that fill this bill for you, you may create total volume that can parallel what you may have had with one or two major market positions. And you may be able to achieve corporate growth in your own way.

While some investors seek out major companies with major market position, others will look for niche players.

Buy a Company Spending for Research/Development

Background

Investors prefer to buy into companies where sufficient research and development provides a good source of new products. R & D takes from current profits to ensure its future. You must research and develop or there is no future.

In fact, this ability to produce new products is almost mandatory. You buy a company considered cheap when it sells for only ten times annual earnings. Some growth stocks are bought at much higher multiples. Yet, many of the major products they use to generate revenues and earnings have a major growth life of five years or less. You cannot be a growth company unless new products come on line and generate earnings per share as your strategy.

Investors are often impressed by the percentage of revenues a company may put back into R&D. However, this ratio by itself can be misleading since it is not necessarily a parameter of excellence. Some companies can more successfully innovate products to market economically than do others. So R&D numbers by themselves is not a screening factor for a strategy.

And there are investors who are not happy with a company that must constantly spend on R&D just to keep abreast of competition or stay a little ahead.

R&D as a percentage of sales or pretax profit will vary with industry. In food and beverages it may sometimes account for 1% of sales and about 10% or a bit more, on pretax profits. The figures run higher in other high-tech industries.

Buy a Company Able to Introduce New Products

Background

As noted in corporate mode strategy where new products are introduced from the use of research and development, investors prefer to buy into companies that produce a good source of new products. The companies may have product cycles where you must create new products or there is no future.

This ability to produce is mandatory. You cannot invest profitably in them unless new products generate earnings per share. Investors are attracted by the percentage of revenues a company may put back into R&D. But new products can be developed and placed on the market with relatively little cost at some companies. compared to others. Expensive R&D numbers can or cannot be an integral part of screening for strategy to find a growth company. There are, in fact, investors who are not happy with a company that must constantly spend on

R&D just to keep abreast of competition or stay a little ahead. R&D as a percentage of sales or pretax profit will vary with industry. It may account for 1% to as much as 10% and much higher in some companies, as a percentage of sales. The figures can be steep in high-tech industries.

Buy a Company with Increasing Market Share

Background

Most good managers feel that it doesn't make sense to fight for market share in an industry. It's the profit you make that counts, after all, and not how much of the market you own. There must be a mix of quality, service and price along with suitable marketing attempts.

There is yet another consideration, what has been called the “experience-curve” or the cost of adding value. The cost of market share will decline with accumulated experience. And to get this accumulation of experience it is imperative that you continue or grow your market share. This cost advantage can be translated into more profits and/or lower prices to the consumer.

As noted with other related strategies, aggressive marketing will attract competition in a growth market. That's because grabbing market share of this type will attract more price cutters. All corporate competitors will be thinking the same way, if a price war breaks out. The best margins will require reducing.

Yet, there are industries where market share, at a decent margin, is important. Once you have it you may be able to acquire an ability to reduce operating costs that competitors will find hard to match. It depends on the industry. It depends also on the size of the company. Usually, it would have to be a large, perhaps multinational behemoth. And if this is your philosophy for a particular company in a specific industry, you can use increasing market share as your strategy.

Intrinsic Selling Character

Your rationale for selling the stock is a reversal in the reason for buying. Absent that, the selling flag could be a major percentage market loss from a predetermined market high.

C-207-CZ

Investigation of Accounting Principles

Background

Some relatively easy investigations can get at important information about companies whose securities may be of interest.

Use Credit-Rating Companies for Common and Preferred Stocks

Background

As with bonds and notes, credit rating services (e.g. Standard & Poor's and Moody's) rate common and preferred stocks. These private credit-rating companies provide estimates of credits only but they can be useful. Investors who work with them, are concerned with a limited perspective

If companies under analyses appear to be having problems they may be put under a Credit Watch. It means there could be difficulties ahead and more frequent reviews will be made of the company and its issues.

Here are examples of the Standard & Poor's ratings:

Common Stock

| | |
|---|---|
| A+ | Highest |
| A | High |
| A− | Above average |
| B+ | Average |
| B | Below average |
| B− | Lower |
| C | Lowest |
| D | In reorganization |

Preferred Stock

| | |
|---|---|
| AAA | Highest |
| AA | High quality |
| A | Sound status |
| BBB | Adequate |
| BB | Speculative |
| B | More speculative |
| CCC | More speculative |
| CC | Shrinking dividend |
| C | Nonpaying dividend |
| D | In default |
| NR | Not rated |

Buy a Financially Liquid Company

Background

There are many factors which establish a financial liquidity guideline. Here are several standards:
Adequate cash flow to pay bills on time and earn discounts for promptness, expand the business, and pay reasonable dividends. “Free cash flow” is the figure to look for. This is what is left after the figure for capital outlays is deducted.
A good assets-to-liability ratio. Some investors want at least twice as much assets as liabilities.
An ample cash position measured by the equation: Accounts Receivables plus Cash plus Short Term Investments, divided by Current Liabilities
A comfortable debt load. That is, Long Term Debt, as a percentage of Shareholders' Equity. Some avoid a ratio that is over one third.
A dividend that is easily covered by real earnings from operations. Cash dividends paid from non-recurring earnings or the sale of assets are not qualified for this definition.
Seasonal Short-term Debt, as compared to Total Debt.
Minimal interest costs to cover debt.

Note: Even financially liquid companies can be undone almost overnight. You must be certain the accounting is sound and the figures used for liquidity observation can be relied upon. In addition, cash can be a luring temptation. Some managers feel they must use cash to make acquisitions and they may do this impulsively. Also, cash can be tempting to would-be takeover artists. They hope to take over the target company using the cash as well as free assets to finance the transaction.

Be Wary of a Company with Heavy Debt

Background

Companies with heavy debt are clearly an investment risk, not so much for that condition alone. They may also harbor contingent dilemmas that can arise because of the debt, and not just what appears on the balance sheet.

Corporate management finds heavy debt a mixed blessing. The purpose is commendable: Borrowing permits leveraged earnings. You can expand the business to bring in earnings faster and in greater amounts.

The income tax regulations favor the use of debt. You pay interest before you calculate corporate income taxes. (Dividends are paid to stockholders after taxes.)

Also, the issuance of stock instead of borrowing will dilute earnings per share. In addition, borrowing tends to increase the return shareholders get on their equity. There is little doubt that borrowing can have its valid points.

The point is: When does the blessing of debt become a curse that can destroy the company? Accordingly, some investors have come up with guidelines that can be followed.

Here are a few. None are hard and fast but they can be helpful.
Don't buy into a company whose debt is more than one third the shareholders' equity. Remember that normal debt requirements vary by industry. Set your limits on debt by taking industry averages. Heavy debt requires heavy finance payments and amortization out of earnings. It sometimes precludes all corporate expansion. All resources must go into paying down the principal obligations and the interest buildup.
Beware of short term debt. As dangerous as long term debt can be, short term obligations can be suicidal. You may ask why management uses short term borrowing? One, they may have no alternative as their long term borrowing credit standing may be poor. and two, short term debt usually (but not always) costs less than long term debt. Thirdly, management may feel that interest rate s will be soon falling. They may be planning to lock in lower long term rates later on. Unfor-tunately, latter on may come and go and rates have not dropped. Management may therefore find itself trapped into short term debt that must be constantly refinanced.

Buy a Company Ability to Finance Expansion

Background

Though not in dire straits, many corporations are limited in their ability to finance the expansion they would prefer. This corporate mode strategy will help select which companies can avoid this predicament.

Look for:
Finance sheets with little current debt and contingent debt. The latter is not easily gotten at, even if you go though the footnotes in the balance sheets. Sometimes you hear about contingent debt only when you hear about it in the financial media and by then it is too late to easily rectify your position. (There may be a solution in the event of a major contingent liability) But at this point you see a company that may be able to safely expand its business.
Ample cash flow. It denotes the ability to buy at best credit terms and accommodate expansion needs. If the company already pays a dividend it will indicate how safe continued dividend flows will be.
The ability to sell more stock to the public to finance expansion. The public has been known to buy near-bankrupt new issues, but if you want a decent underwriting for future funds, the presence of good finances and cash will make the underwriting more doable. And if the company is not desperately seeking funds to stay in business, its underwriting terms can be reasonable. It is also likely the current shareholders' equity will be diluted as little as is necessary.
The ability to sell preferred stock to expand financing. Preferred stock does not dilute common stockholder interests. Only the preferred dividends need be paid until the shares are mature. There may also be a call on preferred so that the shares can be redeemed whenever the company has the cash to do so.

(By the way, Investors can always call management if they have questions. Often, it is the middle managers who can offer the details that make the most sense).

Avoid a Company with Little Cash for Plants

Background

Check cash flow adequacy to see if you ought to avoid the company. The figure of cash flow is after taxes and interest costs and after making capital expenditures. on a year to year basis. The ratio measures a company's cash flow, compared to its annual debt obligations. This gives you a valuable indication of trends. You can tell if the situation is getting worse.

By the way, Investors can always call management if they have questions. Often, it is the middle managers who can offer the details that make the most sense.

Warning: A corporation, especially one in a capital intensive industry, may readily appear to be able to have enough cash flow with which to pay its bills and its dividends. But if the amount cannot replace the corporate plants and equipment in them, the future growth pattern can be a disaster. Bills must be paid but dividend payments in the face of a shortage of replacement of capital can eventually become a calamity.

Factories and equipment must be constantly modernized and maintained. There is currently no opportunity in any industry to simply sit back for a year or two and save on such payments you should make. Do it too many times and you are at the back of the competitive pack.

If investors look closely they will find such companies. The latter often use depreciation to produce more after tax income, while neglecting to update their equipment on which they have taken the depreciation. Chances are they will in the future be called upon to finance equipment for which they have already spent depreciation funds.

Check to see what expansion programs are on tap. The shortage of capital for existing operations will be further exacerbated, should the company have outside expansion plans of a grandiose nature.

Buy Realistic Earnings and Cash Flow

Background

Reported earnings are always subject to variations and elections that tend to invite manipulation. The same amount of earnings can be expressed in different ways, with different bottom line numbers.

In most cases this is not due to chicanery. The normal latitude given auditors and management creates this variation in the reported range of income. Only when a hoax is involved will these differences be overly substantial.

There are telltale signs you can look for:
Investigate non-recurring expenses. The reasons are usually given with the corporate report. Consider whether these are truly non-recurring or merely operational blunders which are being written off to mask a managerial catastrophe. Write-offs that reduce a worthless or near worthless asset due to a marketing change may be one excuse. But repeated write-offs in an annual pattern for products which cannot be sold, is really a recurring event.
Look also for write-offs which are put back in subsequent years. They may be a means of adding to income when they ought not to be.
Check for inventory accounting changes.
Check income which has come from subsidiaries or other corporate stock holdings.
Check the loss reserves being used. Their importance will depend on credit the company extends. They may be a major aspect of the financial statement and may be under-reserved.
Check for changes in pension funding: You can underfund a pension this year by assuming a greater rate of return on your portfolio in the future. If you are too optimistic today, you may find yourself in a financial snag in the future.
Check the accounts receivables and order backlog trends
Check for slower margin growth which can be most revealing of future financial problems.

Investors can always call management if they have questions. Often, it is the middle managers who can offer the details that make the most sense.

Note: there are four different kinds of cash flow. The definition is solely in the mind of the company producing the numbers. Ordinarily, you take net income and add back non-cash items such as depreciation, amortization and deferred taxes. Some companies reduce the figure using increases in accounts receivables and inventories. Some companies use increases in accounts payable to add to cash flow.

Consider a Company's New Proxy Statements

Background

Proxy statements are sent to shareholders for conventional annual meetings or those called for special meetings: Whether you attend the meeting or merely send back the proxy, read the document because it can tell you much about the company.

Some of the things you should look for:
Shareholder rights plans

These offer shareholders the “rights” to purchase shares at a discount. The plan goes into operation if a minimum amount is subscribed to. If they do not take up the rights, their interest will be diluted. If they do take up the rights, their interest is kept intact. (They are sometimes referred to as “poison pills.”
Executive compensation

Top executive salaries and bonuses, incentives, stock options, pensions loans, etc. are listed here. The more incentives you see, the more you ought to question if all of them are absolutely necessary. Stock options of more than 5% in a mature company may be too high. In a younger growth company options that represent more than 10% to 15% of the stock is high.
Golden parachute provisions.

These are compensation packages for executives who may lose their jobs due to takeovers. These are really not in the interest of the stockholders.
Antitakeover provisions.

These are primarily for the benefit of top management. It has been found that the presence of such provisions is bound to eat into the market value of the stock. Many trading strategies are predicated on the promise of takeovers which boost stockholder value. These premiums can be 25% and more. If it is hard to take over a company, its value on the market will be reduced.
Change of auditors.

Auditors contracts come up for renewal annually. There is significance only if there is a change in auditors. That is done for a number of reasons, most of which are bad. The current auditor may have quit due to pressure on what the auditor felt the report should be. Or perhaps the company wants a more agreeable auditor who could go along with company suggestions. The idea is always to make earnings look good, sometimes at the expense of accuracy. A compliant auditor will often make the difference when management wants to resort to chicanery

Companies which are dependent on a franchising business principles

Background

Because Wall Street analysts are not good at evaluating managerial questions as they profess to be, many recommend the shares of companies which are dependent on their ability to franchise new units. The franchising business is not what it appears at first blush. Many franchisers find

a) that franchisees are hard to control,

b) that franchisees are not happy, as a rule, with the royalties they pay

c) that franchisees are unhappy with the management assistance they get

d) that franchisees are disturbed by the royalties they pay in return.

In fact, franchisee organizations are usually always active, much as labor unions are active fighting management in unionized companies.

Where franchisees represent a large segment of a company's business, be careful of potential problems. Franchisee organizations can be a literal house of cards but you don't get that from much of the news about franchise investments.

Furthermore, where franchisers also operate their own units, many investors do not distinguish the earnings that franchisers make from their own operations as distinguished from royalties earned as franchisers. There is quite a difference. Royalties are not as stabile as in-house operational income, for the fact that franchisees are often so unhappy with their lot and are fighting for contractual revisions.

One-Time Write-offs and Accounting Permanency

Background

To give you an idea of how the investment community is being taken in all the time, you need go no further than the way companies use the write-off ruse to make their earnings look better. And how analysts are letting them get away with it.

It's not that all these write-offs are being done secretly. Everyone appears to know about them. But analysts either can't comprehend the enormity of write-offs, or they simply do not care enough to fully take them into analytical consideration. To care would mean they would have to get real figures denoting them down to the bottom line. The fact that we see analysts overuse price/earnings in the face of write-off abuse indicates that little is being done to stop the practice from getting out of hand

Write-offs conducted by companies is often not penalized in terms of stock market values. And it certainly doesn't hurt top executive bonuses. Companies frequently use a euphemism such as “restructuring” to get away with the practice. In fact, some companies make an annual habit of restructuring losses as one-time write-offs.

The nub is this. One-time charges and write-offs are becoming more prevalent. The charges are no longer occasional. The write-offs don;t hurt current or future earnings. In fact, if part of the current write-off is not used, the restoration in the future will count as future earnings, to further complicate analysis.

There has come a point where a company can name its profit for the years ahead and simply manipulate its future write-offs to make sure reported earnings are as predicted.

Select a Company with High Productivity

Background

Relatively slow growing companies still can improve their profit picture with steady, increasing productivity. They are able to combine labor, capital and inventory in a manner that brings more of their revenues to the bottom line.

Augmenting its sales volume is only one way of adding to profits. The advantage of low production costs is that productivity is easier to attain. But productivity has also to do with utilization of labor, capital and inventory as part of a complex managerial plan.

Take the gold mining industry. While the price of gold can fluctuate, many gold mines have been able to profit no matter the price level. All they need is the ability to produce the product at a below-market price. They have a ready market within reason. (They do not dump product all at once to see that supply and demand for gold are pretty much in balance.)

The location and the type of ore and where the mines are located have a bearing on costs of production, They may have more modern equipment and lower labor costs as well. Above all, companies in this industry need maneuverability. Example: Higher labor costs in one area can be overcome by other advantages that area provides.

The strategy s not sensitive unless you get a good idea of the productivity and what costs can actually be. The practice is eminently useful in the gold mining industry. The market price is known; it is quoted in the financial pages every day. The past trends of gold price are known. So, once you get to know how much it costs a company to produce an ounce of gold, you have a good idea of gross margins.

Unfortunately, analysts on Wall Street are primarily focussed on the short term. That has impacted the top executive ranks of management to a point where productivity does not enjoy the priority it should.

Buy a Company that can Easily Increase Production

Background

Productivity is the new buzzword. It can be the answer to a fast increase in company earnings. Find a company with the productive infrastructure and you get at those earnings.

There are companies who can increase their earnings with ease, using their existing capacity. No need for new factories. They need not gear up with time-consuming and expensive equipment. They may have the added advantage of not having to build up an order inventory because they can increase production readily when required. Others may have to accumulate backlogs in order to take orders. Once a company is in this delightful position it can easily cut back when demand for the product stalls in a recession.

Remember: Productivity has also to do with utilization of labor, capital and inventory as part of a complex managerial plan.

This comfortable position of being able to increase corporate productivity is why a high productivity corporation is a selection that makes sense. However, you do have to work to find it.

The strategy also requires an investigation into the corporation's cash flow. Compare the most current with the past two or three years. Select a major product for the study. Determine the possibility of increased or sudden demand due to a marketing possibility you may have come across. Find out when new equipment was installed. Will much more have to be bought. Are they really well set for massive orders for the product? You may have to further inquire of management—middle managers can help you. Find out, if you can, how up-to-date equipment is, how much has been spent to maintain and create the current equipment, and its modernity. Also add an inflation factor if some equipment may still be required. And are there ample funds?

Intrinsic Selling Character

Your rationale for selling the stock is a reversal in the reason for buying. Absent that, the selling flag could be a major percentage market loss from a predetermined market high.

C-226-CZ

Buying Cheap Assets

Background

Buy Cheap Assets in Terms of Replacement

Whenever buying or using a corporate mode strategy the investor is obligated to look at the company and forget about market moods and sentiments. It is as if you were shopping for a business. That means you must be concerned about buying assets as cheaply as possible. These cheap assets have to do with the way they are employed, to a far greater extent than they would in buying trading strategies where the market uses those moods and sentiments to gauge what the market feels are cheap.

There are hard-nosed questions that can produce hard-nosed figures.

1) What are the assets worth if they have to be replaced today? These could includes ores and reserves in the ground.

2) What is the cash that would remain if assets were sold at leisure?

3) What would be the cash if the company were actually liquidated?

The figure you get may not be realistic in that assets are not being sold off nor the company liquidated. But you will get a ballpark figure for value that has little to do with market moods and sentiments.

Then eliminate intangible assets such as good will, unless any of the items have a ready market value. If there is a valuable brand name or franchise that can be sold in the open market include that in liquidation value. “Soft assets” can be valuable but the small investor may get bogged down trying to evaluate what they truly represent.

A Point: You do not have to send out an appraiser to see how accurate your figures will be. All you need is a ball park figure. You can be off quite a bit in your estimates but still have a number that tells you the company has or hasn't cheap assets in terms of replacement.

And besides, many analytical reports on Wall Street are available where breakup value is reported to the public. Remember, these studies are available for those who are thinking of buy-outs where they want to use cheap assets. They look for depreciated assets that do not appear on the books as true value.

Buy a Company with Good Return on Equity (ROE)

Background

The better the return on equity, the more earnings and cash flow that come down the bottom line. In this sense, seeking the highest ROE can be a prime investment strategy. If it is done correctly.

How much the return ought be will depend on the industry.

Examples: In the food processing field, the average ROE may range around 17%. Food and lodging ROEs may run under 17%. In the instrument and controls field, about 14%, and leisure time industry under 10%. High tech industries run much higher. These are approximations.

Many companies have seen their true ROEs shrink well below 10% to where some researchers have remarked how corporate stock in many ways can be related to corporate debt.

Caution: While many investors use this valuable strategy, the figure is easily manipulated with the use of corporate debt. The more a company borrows, the better return it will get on its equity. That stands to reason.

Note: When calculating Return on Equity use the latest four quarters of financial reports. And subtract any preferred stock dividends from net income, as the figure must relate to equity of the common shareholders.

The Return on Equity theoretically should approximate the growth in earnings per share. If a stock yielding 5% grows 10% a year, the return without the interest compounding figure would be 15%. With the interest compounding included the return would be higher, depending on the time estimate into the future. But since many companies vary their dividends, the Return on Equity numbers have been considered a better yardstick. If a five year increase is 100%, each year's growth (without interest compounding) is 20%.

However, a ten year study of over 100 companies indicates ROE practicality and significance to be an exception, rather than the rule in evaluating the company. Nevertheless Wall Street analysts make extensive research use of the ROE factor, but often misinterpret its significance. The primary culprit is their lip service only to the role of debt in skewing the numbers.

Some researchers feel that an even better standard would be the ratio obtained from dividing cash flow by net current assets. Or, to get a more accurate tool, use Return on Assets or Return on Investments as your guide. To get at the figure, add back inventory and fixed assets for Return on Assets. For Return on Investments, add back borrowed funds.

Buy a Company with Good Reinvestment Rates

Background

Some investors like to use a strategy that considers the ability of a company to get a suitable return on reinvested earnings or RIE. It makes sense to invest in a company who can put its earnings to good use, in order to avoid having to frequently borrow or issue new stock and thus dilute shareholder equity.

There is another angle to this question of companies who can get a good return on its reinvestment. If the company is good at it, investors ask whether it should be paying dividends of any size.

A company paying dividends will not have the use of the funds after the pay out. If a company earns $3.00 a share and pays $1.00 in dividend, it has only $2.00 a share left for reinvestment for operations or expansion. What the company does with that $2.00 is important to these strategists. How much return will that $2.00 a share produce?

Obviously, investors who are seeking exceptional corporate growth ought to avoid dividend paying stocks. The assumption should be that the company needs all the funds it can get for internal growth. Paying out dividends defeats that objective.

Company management is often in a dilemma on this matter. A token dividend, at least, assuages the need that some investors have for minimal income. Corporate tradition may also dictate that dividends be paid. Yet, that dividend can be costly if the company needs expansion capital

Buy Increasing Book Value

Background

Investors who like to select stocks on the basis of increasing book value must be certain they are using consistent yardsticks. That's because the definition of book value can be skewed from year to year. If the corporate version of book value remains the same each year, this can be a somewhat selective screen. If, however, the company changes the definition of what it considers book value, the strategy can be useless.

Book value can include good will. Sometimes that goodwill number can be significant, when it involves a famous brand name that could be sold. At other times good will is merely a number that indicates an acquisition of a company for more than its book value.

Eliminate intangible assets in your calculation unless any of the items has a ready market value. “Soft assets” can be valuable but the small investor may get bogged down trying to evaluate what they truly represent.

If you can more or less have a consistent method of calculating the company's book value from year to year, you can use it as an investment screening tool. But this is often problematical.

Note: Adjusted book value is the book value on a company's balance sheet after assets and liabilities are adjusted to market value. it also is called modified book value

Buy a Company with Good Breakup Value

Background

The break up value of a stock is essentially its Book Value. That is, the assets of the company, minus its liabilities. It is the figure used to compute the Return on Equity. You get that from Earnings divided by the Book Value.

Book Value is not easy to find. Because real estate and equipment on the company books may be worth more or less than what they are listed for on the books. Then you have good will. That may appear on the books for a dollar or tens and hundreds of millions of dollars. So is that figure actually realistic?

Some analysts get around this bundle of questions about Book or Breakup Value by analyzing what they feel is a company's Fair Market Value. This adjusts for asset valuations and the good will that is not good will. But how do you get wind of these numbers?

Periodically, you get reports, from brokers and in the financial media that give lists of Breakup Values of the larger companies. You can go to the library to see what's been published. If you have some accounting or bookkeeping ability, however, you can do the work yourself. It's not difficult. Again, if you are prepared to go to the library and get to read published material on the company, you can come up with the numbers. Narrow in on only those companies that you feel are good candidates for such strategy.

The idea is that companies with good breakup value will tend to increase in market value. So long as these numbers grow from year to year, you can continue to hold the stock.

Buy Natural Resource Companies for Future Value

Background

Resource companies are those which hold value in the form of assets. They may be oil and gas companies with heavy reserves. Or timber or mining companies. Or gold producers with heavy reserve interests.

They are in demand when inflation is rampant because they tend to act as inflation hedges. When inflation is not a factor, investors often forget about them.

They are not sensitive selection strategies except when inflation gets everyone's attention.

Intrinsic Selling Character

Your rationale for selling the stock is a reversal in the reason for buying. Absent that, the selling flag could be a major percentage market loss from a predetermined market high.

C-235-CZ

Seeking Corporate Earnings Growth

Background

Buy a Company With Fast, Sound Sales Growth

Companies with fast sales growth will more quickly add to earnings.

Whether it be new or existing markets, sales growth can consistently put earnings on the bottom line. Note, however, that some sales increases of high-flying stock may not produce the needed break-even for earnings.

To set up useful selection parameters, investors can look for companies where sales growth has averaged at least 15% to 20% a year for a period of three to five years. Careful: A company that is maturing may not produce the same growth over the following three to five year period. But many corporations, notably those in high-tech industries, can grow extremely fast. As long as they do, you have a viable investment strategy.

Take these complicating factors into account:

a) Sales growth may not be achieving a sufficient net income or cash flow. It may, in fact, be producing losses. Profit margins may be too low and fixed expenses or operating expenses too far out of line.

b) The break-even point for profit may be elusive. Break-even points are often variable and hard to determine. The utilization of productive capacity can be an influencing factor. Unstable fixed costs may also increase to a point where previous break-evens are unattainable.

c) The break-even point may be unduly corrupted where inflationary costs are present. Constantly increasing costs make break-even a movable target.

Whatever the cause, sales increases can become meaningless. Over expansion can result and unwise use of fresh capital may raise interest charges that cut into profits.

You have an option of waiting for actual sales to be reported, or to rely on sales estimates. If a company has reported sales growth of over 20% a year for the past three years, and the estimate from Wall Street analysts is for another 20% in the year ahead, any change in estimate can be taken as a change in corporate fortunes. It's preferable to take estimates from the company because analysts' projections are less accurate. However, analysts estimates can effect the market for implementation of the selling flags.

Buy Fast, True Earnings Growth

Background

Earnings growth can often be deceiving. Companies can buy it with acquisitions. Others create it internally as normal business operations. Still others produce earnings growth from a combination of acquired and internal sources. The investor has to determine where the actual growth comes from.

Corporate management which acquires its growth from acquisitions will tell you that it makes no difference where their growth comes from, so long as the results are favorable. Many analysts on Wall Street seem to feel the same way about such acquisitive growth.

Other managers say that internal growth is more stable, that it is more consistent from year to year. And that it reflects organizational structure that has been developed painstakingly for growth. Corporations in that category are actually the better candidates for growth. Those who acquire earnings are shown by research to be more apt to run into problems.

Unfortunately, not many analysts attempt to make this distinction, The type of earnings growth is indistinguishable to them. But a longer term corporate mode investor has more assurance of growth when it is internal.

Note: You must always be aware that earnings may not be what they seem. If the company has various important products that contribute to profits, it is essential that you have a handle on which of the products are contributing to what extent.

A company, for example, has five major profit centers. One or two are doing exceedingly well. The rest are so-so or doing poorly. By grouping the figures together you may have missed an important evaluation of where earnings are really headed.

And what happens if impaired assets are to be written off for a particular line of operation? How will that affect future earnings for that product and for the company?

Furthermore: Do you rely on reported earnings or estimates? Or a combination of both? And when it concerns estimates, do you use those that analysts provide? Analyst projects are sometimes all over the lot, so rely primarily on the company's. However, analyst changes in estimates can be used if they happen to be on the downside.

You always have an option of waiting for actual earnings to be reported, or to rely on earnings estimates. If a company has reported earnings growth of over 20% a year for the past three years, and the estimate from Wall Street analysts is for another 20% in growth n the year ahead, any change in estimate can be taken as a change in corporate fortunes. It's preferable to take estimates form the company because analysts' projections are less accurate.

There are yet other facets of evaluating earnings growth.

Examples: Growth can come from increased sales and/or decreased operating costs. Usually you look for earnings growth to come from both. Productivity is an important factor in that it reduces costs. But what happens when a good deal of that earnings growth comes from accounting or accounting dodges?

Or consider tax manipulation; fewer write-offs for depreciation; heavy write-offs of old buildings and equipment. And also, interest rates may have been unusually low and subnormal. Much of the increased earnings therefore may have little to do with corporate ability rather than with accounting and accountant's magic.

Buy a Company with Good Cash Flow Growth

Background

Wall Street always appreciates growth, usually taken as earnings. To a lesser degree it makes little difference whether the growth is acquired internally or via acquisition. Investors are generally not as interested in growth of cash flow.

Yet, it should be pointed out that cash flow is more than a mere viable alternative to earnings growth. After all, cash flow can even be more important than earnings. It's less difficult to play bookkeeping games with cash flow, although some companies have an ingenious way of calculating and reporting what they feel their cash flow is. When it isn't reported, an investor without too much sophistication but with a basic knowledge of bookkeeping, can still arrive at a cash flow figure on which to make investment decisions.

Why bother with cash flow? Because it is the cash that pays the bills and dividends. Some earnings, on the other hand, do not put a penny into the company bank account.

Cash flow is important in some industries than in others. Where there is heavy depreciation of equipment and tax savings are a factor, it materially changes bottom line comparisons.

Note: You must always be aware that cash flow may not be what it seems. If the company has various important products that contribute to cash flow, it is essential that you have an idea which of the products are contributing

Example: A company has five major profit centers. One or two are doing exceedingly well. The rest are so-so or doing poorly. By grouping the figures together you may have missed an important evaluation of where cash flow is headed.

What happens if impaired assets are to be written off for a particular line of operation? How will that affect future cash flows for that product and for the company?

In certain industries, such as real estate, oil and gas, and where substantial assets are employed, cash flow is the overriding parameter. It is what the companies thrive on.

The maturity of a company will help determine an investor's expectations. A mature company may not increase its cash flow as rapidly as a younger operation, due to normal industry limitations. So if a company increases its cash flow at a rate of 30% a year in the previous three to five years, it would make sense not to expect the same over the next three to five year segment. But the strategy to select a company on past growth is still viable, so long as you watch for some downtrend. And when it does occurs, look for the selling flag

You have the option of waiting for actual cash flow to be reported, or to rely on estimates. If a company has reported cash flow growth of over 20% a year for the past three years, and the estimate from Wall Street analysts is for another 20% growth n the year ahead, any change in estimate can be taken as a change in corporate fortunes. It's preferable to take estimates form the company because analysts' projections are less accurate. However, analysts estimates can effect the market for implementation of the selling flags.

Buy Where Cash Flow is Faster Than Capital Needed

Background

Investors in the corporate mode can employ this strategy that checks net operating profit before taxes, in relation to capital expenditure requirements. This is the manner in which corporate management ordinarily finances its operations.

There is usually an historical rate of internal growth. A fairly good estimate can be made of capital spending that it takes to produce this growth. Naturally, the idea is to expend optimal amounts for expanding those profits.

The strategy is highly sophisticated but not really market sensitive. Nevertheless, it can provide a good inkling of how efficiently and soundly the company is expanding.

Net profit predictions for the future should take into consideration the size of the company and its ability to keep profits growing. Here too, growth trends of maturing companies are bound to be less than would be the case with younger operations. When estimating what the growth rate ought to be in relation to capital needs, corporate maturity will determine how much comparative profits can be expected

Be aware that cash flow may not be what it seems. If the company has various important products that contribute to profits, it is essential that you have a handle on which of the products are contributing what. A company has five major profit cash flow centers. One or two may be doing exceedingly well. The rest just so-so or poorly. By grouping the figures together you may have missed an important evaluation of where cash flow is really trending.

What happens if impaired assets are to be written off for a particular line of operation? How will that affect future cash flow?

Analyst estimates for the calculation of cash flow can be awfully misleading. That is due in part to the calculation of cash flow itself. What is more, capital needed can be subjective.

Intrinsic Selling Character

Your rationale for selling the stock is a reversal in the reason for buying. Absent that, the selling flag could be a major percentage market loss from a predetermined market high.

C-241-BY

Special Corporate Guidelines

Background

Several guidelines can help management and also permit the corporate investor to know when to buy and also when it may be time to sell securities in the corporation.

Buy Companies on Special Industry Indicators

Background

In certain industries you can gauge how well a company is operating by the size of its sales, or bookings, and its delivery of supplies. The semiconductor business is an excellent example. The semiconductor Industry association has records it keeps of Book-to-Bill Ratios.

Example: If the ratio is 0.95, it means that for every $100 in chips shipped to customers, they got $95 in new orders. That is a so-so statistic. When there is a rise in shipment levels and orders of better than 1 to 1, it means the industry will be rapidly growing. Order rates are evidently growing beyond shipments. The other way round, shipments faster than orders, and there could be stagnation in the near picture.

Buy Growth Companies Hit by a Moody-Sentiment Market

Background

There are many aspects of growth that can be measured in the corporate strategy mode, whether it be predicated on forms of sales, or earnings or cash flow, sometimes in conjunction with capital expenditures, etc. You may decide on a selection strategy in order to get at a security in which you may be interested.

You can, for example, be drawn to a company which is excellent for the corporate mode strategy you seek, but which is particularly cheap in terms of having been hit by the moods and sentiments of the market.

You are not really interested in market moods and sentiments because they are in the trading mode of strategies. Your interest is in the corporate mode. So, any lower price due to a moody market produces a buying opportunity for you.

Buy a Stock on The Basis of Dividend Growth

Background

Investors who buy common stock with a dividend growth strategy feel that growing dividends furnish two substantial advantages for them:

1) The ability to not only get a dividend but to increase the amount they get at a fast pace. That indicates the business is rapidly growing.

2) The dividend makes holding the stock worthwhile. You can be sure of the dividend more than you can be sure of the company's growth.

In other words, the strategy gives the investor the benefits of income and of growth, It provides yet another plus: Ample earnings with which to make the pay out. The dividend increase does not have to occur every year. Check to see how frequently it is raised. Every two or even three years may be sufficient to qualify for dividend growth.

The margin of earnings over pay out should also be ample, to make the dividend more assured. Future earnings prospects must also be favorable. If it appears dividends are not being properly earned in the year they are declared, do not select the company for this strategy.

What is more, the dividend ought to be able to take care of the current inflation rate. The higher the inflation rate, the higher the dividend ought to be. So that it covers the risk and perhaps exceeds inflation

Remember the investor in this strategy is also seeking growth in the form of increasing dividends. The strategy is not just looking at dividends, but the company's ability to raise the dividends over the years.

Note the downside on using dividends as compared with growth stocks. Unless the securities are kept in a tax deferred or pension account, you must pay current taxes on the dividend. Capital gains taxes are paid only when the stock is sold.

Caution: Look to the balance sheet for reassurance that the dividend is protected. Lots of debt could impair future pay outs. About 30% to 40% long term debt, in relation to stockholders equity, should be the maximum. The greater the debt the less likely dividend growth is assured.

What is more important—earnings or dividends?

It has been often said that dividend growth is the more important factor in the increase of stock prices, and not merely earrings. However, dividend increases can only come from increases in earnings levels. You may well ask, how can dividends be more important a factor?

Buy a Company with an Increasing Pay out Ratio

Background

This corporate mode strategy seeks out a company which has decided to increase its dividend pay out. They may have been traditionally paying 50% of earnings, and have decided to go to 60% or 65%. Some corporations are consistent in their pay out, so you can gauge what they will pay as a dividend. When they increase the pay out, you get a leveraged type of payment.

The only way to anticipate a higher percentage pay out is to understand the company's working capital position, and its possible capital requirements. If management is talking about expanded growth possibilities, you are not likely to see a change in dividend policy.

Companies who increase their pay out rate do not need capital as they once did. If you are not searching for growth but need the income, these can be ideal vehicles.

Note the downside on using dividends as compared with growth stocks. Unless the securities are kept in a tax deferred or pension account, you must pay current taxes on the dividend. (There are tax advantages on dividends.) Capital gains taxes are paid only when the stock is sold.

Buy a Company on its Dividend Coverage

Background

If you are buying a company for its dividend you must be certain it will continue to pay that dividend. You can be more certain if the dividend coverage is ample. As a rule, a company dividend should never exceed two thirds its operating earnings for the period.

Generally the dividends are paid out quarterly. Unforeseen difficulties may cloud the earnings picture temporarily, but companies are not expected to adjust the pay out for just that short period.

If earnings are steady from year to year and the company pays out one third, it is safe to say coverage will be assured.

Note the downside on using dividends as compared with growth stocks. Unless the securities are kept in a tax deferred or pension account, you must pay current taxes on the dividend, though there is a benefit for long-term holders of stocks/. Capital gains taxes are paid only when the stock is sold.

Buy a Company with a High Yield

Background

Some investors in the corporate mode actually pick high dividend payers in the following fashion:

They buy the ten highest paying dividend stocks among the thirty that comprise the Dow Jones Industrial Average. The method produces

a) The highest income possible from the country's most elite companies, and

b) Downside protection in the event the market weakens.

Note the downside on using dividends as compared with growth stocks. Unless the securities are kept in a tax deferred or pension account, you must pay current taxes on the dividend, albeit with some tax advantage for long-term holders. Capital gains taxes are paid only when the stock is sold.

Intrinsic Selling Character

Your rationale for selling the stock is a reversal in the reason for buying. Absent that, the selling flag could be a major percentage market loss from a predetermined market high.

I-1209-AX

Bank Loan Activity and Costs and Direction

Background

Bank Loan Activity

Bank loan volume is an indictor of how the business cycle is going. The trends are relatively sensitive to business activity and the direction of interest rates. When demand for bank loans is on the way up, interest rates will move along that same track. Reduced loan demand will then soften interest rates.

Indication of short term bank loan demand or the lack of it is also visible from an Inverted Curve Yield. Should short term rates have gotten inordinately high or low in relation to longer term rates, this curve will become evident. Banks may have ample funds for the longer term and are somewhat wary or indecisive as to how to put out shorter term loans.

The Yield Curve is expected to have longer term rates higher than the shorter. That is understandable with any type of borrowing. When you buy longer maturity bonds, for instance, you get a better rate than you would with shorter maturities. But this normal difference may be widened or narrowed or even inverted at times. It is an indication of changes in the supply/demand equation of credit at banks.

It is easy to get an idea of these statistics from financial pages and publications. In addition, look for bank loan and free reserve figures.

The Prime Rate

Background

The prime rate we hear so much about is an important influence on what we think of as interest rate direction and the economy. Yet, It is not an exact figure. It is essentially the rate which large banks charge their best customers. Naturally, some banks will charge their largest and most creditworthy borrowers more or less than what the quoted rate is. Rates are what borrowers are able to negotiate with their banks.

However, it is the perception of that rate going higher or lower that affects the economy. The lowering of the rate indicates the economy is slowing up and that banks want to attract borrowers with lower loan costs. If the rate is going up, the indication is that business is booming and banks are asking for more interest to take advantage of the demand.

However, supply and demand of loans is not the only factor. The Federal Reserve Bank is probably behind the actions with those of its own. The Fed may be making funds more expensive for banks to get. The Fed can raise the discount rate when banks come to the Fed for additional funds. Or bank reserves may have been tightened. Or the Fed may be indirectly affecting the demand for overnight banking reserves via the use of Federal funds. That will raise the Federal funds rate that banks pay. Or the Fed's Open Market Committee may be influencing the money supply with its buying or selling of U.S. Treasuries and bankers acceptances. One or all of such actions would force banks to make loans at higher levels. (Note: The Fed is usually not heavy handed at this. They would not do all this influencing at one time. And some actions are more drastic than others.)

On the other hand, the economy may be stagnant or in recession and the Fed may be trying to lighten up on banks to cut interest rates. The Fed may then lower the discount rate or Federal funds rates. Or the Fed may increase banking reserves.

It is a relatively sensitive indicator. Note: The strategy may be used either for a buying guideline, or for a selling flag, depending on whether your disciplined plan at any time is as a security buyer or seller.

The Federal Funds Rate

Background

Note: The Federal Funds rate is what banks charge each other for overnight funds they need in order to adjust their reserves that are kept in the Federal Reserves system. It is not to be confused with the discount rate which is set by the Fed.

While the Federal Reserve Board does not set the rate they do influence it indirectly. This is accomplished by limiting or expanding banking reserves. When banks are more eagerly seeking their needed reserves, they will pay more for their loans from other banks. When the money supply is being tightened by the Fed the banks will pay more for their overnight banking reserve requirements.

There is really no one Federal Funds rate. What is listed in the media is an estimate of the effective rate. Federal Funds rates are usually higher than Treasury bills and generally run in the same direction. The indicator is also sensitive. Note: The strategy may be used either for a buying guideline, or for a selling flag, depending on whether your disciplined plan at any time is as a security buyer or seller.

Discount Rate Adjustments

Background

Note: The Discount Rate is set by the Federal Reserve Board. It's a heavy handed tool for making adjustments in the amount of credit commercial banks have available for their clients. It has a major effect on the economy and the securities markets and is a sensitive indicator.

The Discount Rate is the charge to a bank for discounting paper it takes to the Fed for credit. Discounts are a signal that the Federal Reserve system is leaning toward credit tightening (if it raises the charge) or relaxation (if it reduces its charge).

One interpretation holds the following to be true: When the Federal Reserve lowers just one of three policy variables: Bank reserves requirements, or brokerage house margins or the Discount Rate, then stock prices will go up. This may not always happen but it can be a good indicator.

Because Discount Rate adjustments are a major tool the Fed uses it sparingly. The Fed tries to be inscrutable. In fact, a lot of experts do nothing but watch their actions as one would read tea leaves. But the Discount Rate is something else. The Fed has other means of subtly changing credit and monetary conditions in the banking system. And it uses these subtler forms more frequently.

Caution: No matter what the Fed does, it is the public's expectation of the results that makes the actual impact. So, if the public feels the economy is really down, drastic measures such as these will not work right away. But long term Fed policy is reflected in the Discount Rate.

It is a highly sensitive indicator. Note: The strategy may be used either for a buying guideline, or for a selling flag, depending on whether your disciplined plan at any time is as a security buyer or seller.

Federal Reserve Actions and Inflation

Background

Note: The Federal Reserve Board generally keeps a sharp eye on the financial markets, in the attempt to keep the economy on an even keel. Monetary policy is the complex instrument the Fed uses to scale it down.

They also watch commodity prices because such prices give an indication of inflation. The latter shows up in the form of higher farm product costs and items that go into the manufacture of food and industrial commodities. Changes in the money supply may not affect the economy until nine months or so later than those in commodities.

Inflation is a problem that sits in the minds of every Federal Reserve governor and its Chairman. The Fed policy is usually to keep inflation down, even it means raising interest rates to do so. Naturally, when you increase rates you are going to decrease business activities. Lean too hard on rates and you will have a recession.

Watch the Consumer Price Index but commodity prices may signal trends before they get down to the consumer level. You will be getting earlier warnings.

The Fed changes in Discount Rate can be a sensitive tool, especially in the bond markets. The strategy may be used either for a buying guideline, or for a selling flag, depending on whether your disciplined plan at any time is as a security buyer or seller.

I-1237-AX

Market Price Relations

Background

Proper price relationships, their readings and their interpretations are essential.

Consumer Price Index (CPI)

Background

Issued about the middle of each month by the Bureau of Labor Statistics of the U.S. Dept. of Labor. It is the broadest measurement used for price levels and the all-important barometer of inflation.

The basic components are in the form of a “market basket” of items. They are weighted in accordance with their relative importance to the average consumer. Housing, food, transportation, clothing, medical care and entertainment are included. Imported as well as domestic goods are in the basket.

There are two other barometers used: Raw industrial materials are followed by the Commodities Research Bureau Index (CRB). The Producer Price Index of finished goods still at wholesale is put out by the government.

Food and energy are the most volatile of the components. So, sometimes economists eliminate this sector to gauge the “core rate” of inflation.

It is a relatively sensitive indicator. Note: The strategy may be used either for a buying guideline, or for a selling flag, depending on whether your disciplined plan at any time is as a security buyer or seller.

Commodity Prices and Inflation

Background

Commodity price moves have been used to measure where inflation is headed. Over the past years commodity prices have signaled some early warnings of growing inflation. Yet, they can be a false positive. Oil and energy prices are volatile and are taken out of the CPI to get at the core of price levels.

Many times price increases do not hold because world economic conditions are poor or stagnant. Sometimes the Federal Reserve watches commodities. At other times it does not.

It is a relatively sensitive indicator. Note: The strategy may be used either for a buying guideline, or for a selling flag, depending on whether your disciplined plan at any time is as a security buyer or seller.

Gold and Precious Metals Prices

Background

Gold prices are usually grouped with those for platinum and similar highly valuable elements that are used as jewelry and, importantly, in industrial production. Platinum and similar precious metals often parallel the price movements of gold, though not always, so they are not sensitive in playing the market for gold pricing.

Gold in itself has speculative interest because it is a safe haven for those who do not want paper currency or feel that the values of paper currency may be diminishing. So, if there is a major war declared in some part of the world, the price of gold tends to go up. Often, if the US is not involved, the flight of foreign currency may go into American dollars or similar hard currency such as the Pound Sterling or Euro. However, this does not always hold true. So gold may or may not be influenced at any given time by foreign disturbances.

Gold pricing is controlled to a large extent by its producers. That means Russia and South Africa or any country with a gold hoard. When any country needs hard currency they either have to borrow it or they sell whatever gold they are producing or have in storage. Consequently, heavy supply on the market can often counteract huge demand, with no apparent change in the price of gold.

Another disadvantage in the use of gold is the fact it does not earn interest. That's true of any precious metal. Gold has been advertised for years as an inflation hedge. And it is—in theory. But over the years, long term holders of the metal, especially those who had bought it at over $800 an ounce, have lost money. Not only in the purchase price, but in terms of non-interest.

Gold need not be bought solely as bullion. Gold mining company stock can move up when gold prices increase. Such stocks move up when costs of gold production goes down, even in a flat market for the bullion. And you can earn dividends from company earnings. So, buying stocks of gold mining companies sounds like a better idea. But remember that a gold mining company's operational fortunes may be influenced by factors that have nothing to do with the price of gold.

The price of gold has always been a factor in the determination of the state of the economy and where it may be headed. When the price of gold falls, the central banks around the world who have gold in sufficient amounts have in the past sold much of their hoards to reduce their deficits. Many central banks no longer feel extensive gold holdings have to be in their national reserves. On the other hand, economists feel that gold does have a validity as a predictor of future inflation when the inflation rate begins to rise. When inflation is significant the price of gold may take on more importance.

Gold reflects weakness in the dollar especially in relation to other world currencies It is considered moderately sensitive. Note: The strategy may be used either for a buying guideline, or for a selling flag, depending on whether your disciplined plan at any time is as a security buyer or seller.

Commodity Indexes such as the CRB Index

Background

The Consumer Research Bureau is a private organization that produces the All-Commodity Index is a widely watched indicator. Some economists believe it can actually be a substitute for industrial production statistics. That's due to the fact that a rise in prices of raw materials can represent increased demand by industry.

The indicator is sensitive and is commonly used. If the commodity index is deflated, it is almost impossible to generate inflation with monetary or fiscal policy. Inflation cannot be sustained unless the CRB begins to pick up. Then you can expect the Fed to do something if they can. And you can expect inflationary price pressures. Be warned: You can still get confusing stories watching these indicators. You must be careful.

There is a CRB Futures Index traded, using the CRB, that also gives some idea of sentiment with regard to inflationary or deflationary pressures in the economy.

The CRB Index trend line is considered sensitive. Note: The strategy may be used either for a buying guideline, or for a selling flag, depending on whether your disciplined plan at any time is as a security buyer or seller.

Commodity Prices and Indexes

Background

Commodity speculation opportunities are not too great when the economy is doing well and it's stabilized.

Good weather and a stable economy with low inflation—or at least relatively low inflation—along with a relatively strong U.S. dollar that accompanies this type of economy, is generally going to make a commodity market that has only a small amount of price movement. Trading profits come with wider swings.

Commodity indexes give the lowdown on baskets of commodities. There are a number of indexes employed for the purpose. Such as the Dow Jones Futures Index, which is—as the name implies—an index based on futures prices for the commodities. The Dow Jones Spot Commodity Index is another. It covers daily cash prices

Reuter United Kingdom is yet another example of such index. And the CRB Futures Index. So you have an idea of how various sensitive indexes relate to commodity prices.

Commodity observers also note also that the Federal Reserve is quite sensitive to economic statistics and producers prices, and acts in an activist fashion to head off inflation earlier rather than later. Therefore, economists continue to create new indexes. They try to watch the Fed as much as others do tea leaves. Keep abreast of all these indexes the best you can, depending on the degree of your time and sophistication.

Commodity prices are always considered sensitive. Note: The strategy may be used either for a buying guideline, or for a selling flag, depending on whether your disciplined plan at any time is as a security buyer or seller.

I-1251-CZ

Industry Operation Changes

Background

Overall Corporate Operation Guidelines.

Several signs of corporate operation and financial changes can provide indicator strategy:

1) Look for flattening sales. Industry revenue growth can show signs of leveling off. It can be a sign of recession if a trend persists for three months.

2) Look at profit margins. Reduced industrial profit margins can indicate more competition for available business. And smaller corporate profits.

3) Look at the ratio of short term borrowing to long term debt. It could show corporations are having cash flow obstacles, either from 1) and 2), diminished sales or smaller profit margins.

4) Look at the long term debt picture. Include interest costs of that debt and whether any increase in rates will further reduce industry profit margins. 2).

5) Look at business investment outlays. Additions to capital stock should at least match the normal growth of the economy.

This can be a sensitive indicator for industries that provide goods and services in these areas:
New orders for durable goods by manufacturers.
The annual rate of plant and equipment spending
Corporate spending for additions to production facilities.

The indicators are relatively sensitive. Note: The strategy may be used either for a buying guideline, or for a selling flag, depending on whether your disciplined plan at any time is as a security buyer or seller.

A 12-Month Moving Average versus Industrial Activity

Background

The strategy attempts to predict which way the economy is going by looking a moving average such as the Dow Jones 30 Average and comparing it with industrial activity.

Since the disastrous 1930s, some economists have claimed that stock market crashes are the beginning of a downturn in the economy. There may be a psychological reason. The fact that investors are worth less because their holdings are reduced, may have an influence. But there have been only about ten or so market crashes. And only one real depression has ever resulted. What you get may be a slight correction in the economy—a small short term recession perhaps—but not any major jar to the overall economy since the average has been around.

Why use a moving average? A moving average shows a figure that includes the current numbers and the rest that make up a period of time. It may be for 10 days, 30 days, 90 days, or a full year. The averaging of numbers makes the figures you get less erratic. If you wanted a 12 month moving average, you would take prices on the first of each month for the past 12 months, add them up, and divide by 12. The following month you add a new figure, but you eliminate one from the previous calculation. And so on.

The strategy is moderately sensitive. Note: The strategy may be used either for a buying guideline, or for a selling flag, depending on whether your disciplined plan at any time is as a security buyer or seller.

I-1284-BY

Economic Signs

Background

Gross Domestic Product

Published by the Bureau of Economic Analysis of the U.S. Dept. of Commerce, the Gross Domestic Product (GDP) is the broadest sampling of the U.S. economy. It comes out quarterly and is revised monthly.

Traders may want to guide their selling decisions on the direction of the economy as reflected by the GDP. Highly visible, it can have a relatively larger influence on markets than most other indicators.

By definition, the Gross Domestic product is the value of the country's total output of goods and services. In the past we measured the Gross National Product. It better matches what happens in the economy. Two thirds of the GDP is accounted for by personal spending

The quarterly and even the annual GDP are not highly sensitive, so it is an important indicator of the consumer's propensity to spend. Yet, the Commerce Department's flash estimate report every three months is always eagerly awaited by traders. To complicate matters with this perceived importance, the reports are generally not accurate and are subject to revision over the following quarters. No one quarter should be taken seriously, but the markets can sometimes be affected by quarterly reports.

Short of a recession, it is not hard to have an increase in the GDP. It can grow on end. Only occasionally, and during a recession will it decline even slightly. It is the size of the increase after allowing for inflation that makes an impact. A quarterly increase of 1% or 4% a year is considered pretty healthy for out economy.

Traders are concerned if the GDP rises too fast. It means the economy may be getting overheated and that the Federal reserve will soon step in to tighten the money supply by raising interest rates. And when the GDP isn't rising fast enough, interest rates may be allowed to fall as an incentive for business.

Note: The individual fortunes of very large companies can influence the activity of the GDP. Should a General Motors and an IBM and another giant or two have a particularly good or bad quarter in tandem, there would be an influence in the figure.

The indicator has sensitivity only when there is a major jump or decline in the figure. Note: The strategy may be used either for a buying guideline, or for a selling flag, depending on whether your disciplined plan at any time is as a security buyer or seller.

Key Economic Indicators

The Key Economic Indicators attempt to forecast three trends:
1) The Leading Economic Indicator (LEI)

The LEI is Published by the Conference Board, a business-sponsored group, each month It is composed of eleven indicators and is a valuable guide that is subject to revisions. It focuses on trends in the business cycle. and measures new building permits, average workweek, new orders for consumer goods, net business formation, M-2 money supply, changes in credit, stock price trends, unemployment, and so on.
2) The Coincident Indicator

It is a ratio of two composites from the U.S. Commerce Department that is released each month. The indicator usually turns down about a year or so before a recession. Commodity prices are considered coincident and not a leading indicator. Also measured are personal income, and industrial production, and so on.
3) The Lagging Indicator

The Index provides a broad view of the economy. Issued by the U.S. Commerce Department each month, it is made up of six indicators that reflect the economic movements. Some of its indicators are: unit manufacturing labor costs; the prime rate; commercial and industrial loans.

The Index may fall in the early stages of an economic upturn. It may continue to go up when a new recession is underway. Thus the reason why it is called a lagging index. (A very sharp rise in the index can mean a full recession is already in force.) It is not a sensitive index.

The Leading Index can be relatively sensitive as an indicator but must be used judiciously. Note: The strategy may be used either for a buying guideline, or for a selling flag, depending on whether your disciplined plan at any time is as a security buyer or seller.

Price Indexes

Background

The two main price indexes, The Consumer Price Index and The Producer Price Index come monthly from the U.S. Labor department. The Gross National Product Deflator is a broad based inflation measurement that does not get as much attention.

The CPI and the PPI do not always move together but they are closely related for an eventual merging of purposes. Producer prices are generally affected first and then are passed along to the consumer. The Producer Prize Index. is composed of finished goods on a wholesale level. Also included are energy and heating oil prices. Some are month-long readings, some mid-month Its trends show up later in the Consumer Price Index. Both the PPI and the CPI should show at least a 3-month trend before they are used.

When there is an inflationary tack underway, avoid stocks of companies that could be hurt by rising interest rates. In the case of insurance companies, lower bond evaluations due to higher rates could adversely impact reserves. And where union contracts necessitate higher wage adjustments, costs of operation can sky rocket.

On the other hand, inflation can help the natural resource stocks. Companies with fixed cost debt may find repayment of debt much easier to make. Real estate holdings may zoom in value. Each company should be evaluated on its own regardless of the basic industry it is in.

Both the CPI and PPI trend lines are sensitive if your corporate mode strategy for holding a stock is directly affected by inflation or the lack of it. Note: The strategy may be used either for a buying guideline, or for a selling flag, depending on whether your disciplined plan at any time is as a security buyer or seller.

Oil and Energy Costs

Background

Aside from its impact on the Producer Price Index (PPI) oil and energy costs have much to do with the economy's inflationary or deflationary pressures. It is more than mere perception. Oil and energy prices are a huge factor in the cost of production of many essential products. Higher costs show up fairly quickly in what we buy at the showrooms, department stores, supermarkets and the gasoline pumps.

You do not have to look further than the experiences that come with OPEC price increases for oil. Our country and the world receive an inflationary jolt that creates havoc in the domestic and international economies that must be constantly dealt with.

Use a three month trend line to see whether a short term increase was an aberration or was non-recurring. Also be wary of unintended consequences when oil and energy prices drop. Transportation industries do very well, naturally. That goes for trucking companies and airlines. But there can be overall industry disaster.

Oil and energy prices are a sensitive indicator if they persist in a trend for three or more months. Note: The strategy may be used either for a buying guideline, or for a selling flag, depending on whether your disciplined plan at any time is as a security buyer or seller.

Consumer Confidence Factor

Background

The consumer confidence level always bears heavily on the economy and therefore the securities industry. A practical method of measuring that confidence can be helpful to investors.

Everyone attempts to forecast the general health of the economy but no economist can consistently hit his or her predictions. But the task is nonetheless an important goal.

In many respects the average consumer who helps create indicators that predict the economy is more knowing, though rather unscientific about it. The consumer creates the input by spending the dollars. Economists are paid to watch the consumer to see how and where the dollars were spent and how much was spent. The results of that spending and observation can be rewarding to investors who are tracking the economy.

Having created the indicators, the consumer can watch for the indicators as well. He or she can latch on certain favorites that will indicate tidbits about consumer confidence. Such as unemployment and even short-term interest rate instruments.

Consumer confidence measurements are somewhat sensitive for the shorter term. Unemployment rates will influence this confidence quite a bit. There are no seriously sensitive indicators here.

The Leading Economic Indicator (LEI)

Background

The LEI is Published each month by the Conference Board, a business-sponsored group. It is composed of eleven indicators and is a valuable guide that is subject to revisions. It focuses on trends in the business cycle. and measures new building permits, average workweek, new orders for consumer goods, net business formation, M-2 money supply, changes in credit, stock price trends, unemployment, and so on.

Of the eleven constituents, only initial claims for unemployment, building permits, and 500 common stocks are consistently rated good. Further Note: The strategy may be used either for a buying guideline, or for a selling flag, depending on whether your disciplined plan at any time is as a security buyer or seller.

Housing Permits

Background

New Housing starts have always been a decent barometer or indicator of the economy, and where it may be heading. Automobile production was also until imports diluted the figure's influence on the rest of the economy. You can use auto sales, but domestic auto production has an influence on domestic industry other than automobiles.

The same with housing starts. They not only create construction jobs and sales of raw materials, such as lumber, brick, piping, etc. They also benefit those who make and sell furniture, ovens and other appliances. They effect the volume of electronic accessories, such as TV sets and VCRs, DVDs, etc. The figures are a bellwether of industry because of the far-reaching consequences of such activity. Figures are released monthly by the U.S. Commerce Dept. They are seasonally adjusted and the rate then annualized. The figures consist of new starts and permits for single-family and apartment units. The permit figure may not be too sensitive because builders may file for them to satisfy contractual and legal needs.

A 3-month trend line can be made of these seasonally adjusted figures, to see how the economy is going. The starts are also usually made when demand appears. Housing starts are directly affected by the level of mortgage interest costs.

Note: The strategy may be used either for a buying guideline, or for a selling flag, depending on whether your disciplined plan at any time is as a security buyer or seller.

Unemployment Statistics

Background

Several parts contribute to the unemployment statistics. First, and most used is the rate that is disclosed by the Labor Department every month. It is generally not too volatile, with just slight changes affecting the way the securities markets work. In fact the figures are not accurate and there are several ways of compiling them. Accurate or not, what is announced is bound to drive the securities market.

If you want the longer view, you would use a trend line gauge to see where employment is headed. But that trend line is not sensitive. It may show a more mobile work force, or growth of unemployment insurance benefits, or the growth of a near underclass. The underclass may never have to file for unemployment. They have never been employed in many instances. But only the monthly figures will affect the market.

The indicator is moderately sensitive. Note: The strategy may be used either for a buying guideline, or for a selling flag, depending on whether your disciplined plan at any time is as a security buyer or seller.

I-1326-CZ

Bond and Interest Direction

Background

Bond movements are plotted to determine longer term interest trends. For this purpose the seven year and longer maturities are used for either corporates or Treasurys. The term “long bond” is taken to mean the longer Treasurys.

While a seven year bond is middle maturity, it can be used for trend lines in the event there is a disparity in the relationship of mid and long term bonds. Usually, the longer term bond will have a greater return than short or middle term for a good reason. The risk factor due to inflation is always a consideration. But there are occasions when this premium due to maturity is not as wide or narrow as is usual. Market characteristics change periodically.

Also, shorter term bills, and notes and may not move in the same fashion as intermediary or longer term debt issues. They may be subject to more aberrations of market place and the supply and demand. Therefore, longer term issues are used as the yardsticks.

Bond movement strategies can be very valuable. For near term (two or three year) rates trends, shorter term bills are highly useful if they show a trend of at least three months in either direction. For decisions on when it is time to get a home mortgage, a three or four or more-month trend in the long bond will give the trend line for that decision.

Further Note: The strategy may be used either for a buying guideline, or for a selling flag, depending on whether your disciplined plan at any time is as a security buyer or seller.

Treasury Bill Rate Movements

Background

The 3-month Treasury bill rate is often used as a short term interest direction barometer, although the 1-month and 6-month bill have a similar use for many investors.

These short term instruments must show a clear trend in the direction of rates to be a useful tool. A number of temporary irregularities may occur: Example: an abnormal short term lending conditions and their impact on supply and demand for the instruments.

Interest rate prices depend on too many factors: You have the value of the dollar. And of course interest levels. Then you have oil prices and the international trade gap. Each of which will, in one way or another, affect the movement of Treasury bills. This makes interpretations and certainly predictions of interest rates hard to make.

But remember that your purpose is not to predict rates, merely to follow trends. The question is how long should the tendency for rates to fall or rise in order that the trend to be discernible? Three months are often enough, four or five months are even better.

Treasury bills are bought at a discount. The difference between what you buy them for and their face value represents the return.

Bill rate movement strategies can be very valuable. Shorter term bills are highly useful if they show a trend of at least three months in either direction. For decisions on the direction of stocks, the sensitivity is not as useful. Note: The strategy may be used either for a buying guideline, or for a selling flag, depending on whether your disciplined plan at any time is as a security buyer or seller.

Treasury Note Rate Movements

Background

Bond and interest rate pricing will depend on a variety of complex factors. And a number of yardsticks with which to divine rate movements, from very short term bills to longer term notes (over 1-year maturity) to intermediary and longer term bonds.

Interest levels are governed by perceptions of inflation. Example: Oil and energy costs influence manufacturing costs greatly. so oil and energy have a great bearing on the stability or lack of it in the bills, note and bond markets.

Treasury note rate movements can be used as an indicator of where rates are headed. Which do you use—the bills or the notes—is entirely up to you. There is probably no preference. They are all reported in the financial media so you can spot them. But be consistent in what you use.

There are also interpretations that anticipate the stock market. For example, one that says when monthly rates of 2 to 4 year notes decline to a level less than that of six months earlier, the market will rise.

Rate movement strategies can be very valuable. Shorter term notes are highly useful if they show a trend of at least three months in either direction. Note: The strategy may be used either for a buying guideline, or for a selling flag, depending on whether your disciplined plan at any time is as a security buyer or seller.

Foreign Interest Rates

Background

Foreign interest rates are important to us in several ways. One, if we invest in foreign countries we want to get as high a return as possible.

At the same time, foreign rates compete with domestic rates. given a chance to get a higher rate in Europe, for example, a Japanese investor may go there to buy bonds instead of buying one in the U.S. So, there is a more or less leveling off of rates to a common denominator.

The U.S. has one big advantage in that it is a larger market and you can make larger purchases in the U.S. than you could in most any other region. Nevertheless, there is a competitive angle here.

Remember too, that foreign rates have to be adjusted for differences in the values of currencies. When the dollar is strong, a foreigner buying bonds in this country is getting less than the rate at which the purchase is being made. If the dollar is weaker, that buyer is getting more than the stated rates.

Foreign rates can be an indicator for those of you who want to invest overseas. You don't have to be a large investor these days to do so.

The strategy is sensitive in that it provides an idea of how foreign investors view American market returns. Higher interest here will attract their investments from overseas. Another influence on their decision as to do with the relative strength of the dollar. Their return from American investments must consider any profit or gain their U.S. holdings entail.

Note: The strategy may be used either for a buying guideline, or for a selling flag, depending on whether your disciplined plan at any time is as a security buyer or seller.

U.S. Dollar Strength

Background

It depends on how you measure it. A dollar should be measured against one other currency at a time. Each currency relates to another that way.

The value of the U.S. dollar abroad can have a major impact on earnings of American companies who do substantial business abroad. Petroleum, chemical and pharmaceutical concerns are constantly concerned with the dollar's changing values.

Should the dollar get stronger, the translation of their corporate earnings overseas back into this country will reduce their bottom line. A cheaper dollar means that earnings produced overseas will be augmented when it is translated to the bottom line in the U.S.

Trade-weighted dollars (Euros, Japanese yen and British pounds) can rise or fall substantially rather quickly, depending on the volatility of the currency markets at any time. The concern the multinational firms have for alleviating the problem is ever-present and it often includes hedging in the currency markets.

When you speak of U.S. dollar strength it is always relative to another currency. The dollar could be getting weaker against one while stronger against another. Generally there is a tendency for most to go in one direction, but at different rates. This is due to the fact our trade with different countries will vary. And their domestic economies may be operating in cycles at different stages than ours.

Aside from the question of translating earnings abroad into earnings here, U.S. dollar strength has a major influence on exports and imports. A weaker dollar means our products become cheaper for foreigners to buy. A stronger dollar means higher pricing and lower demand from overseas.

There is another side to the coin. A weaker dollar and more exports also means our imports will cost us more. That means foreign travel will be more expensive. And foreign wines and other merchandise will cost Americans more.

Interestingly, a weaker dollar is supposed to be a boost for American stocks due to the increased potential for overseas business. Yet, the media can focus on a weaker dollar primarily as a sign of weakness. And a persistent focus on this can help undermine investor confidence in the market as well.

The relative cost of the dollar in relation to theirs at home, will influence foreign investors a who buy American stocks and bonds. They must look at interest rates and what they stand to gain or loss from currency translations. American investors must do the same. As the American dollar gets stronger, our investments overseas will return us less. As the dollar gets weaker, our returns will do better in terms of dollars we bring back home.

The strategy is not a sensitive indicator for investors in domestic stocks and bonds. It can be highly sensitive for currency traders and those who invest in securities overseas.

Earnings Estimate Changes

Background

Changes in earnings per share estimates can manifest immediate stock market reactions. The change in estimated earnings will have practically the same impact.

This is notably true when the changes are a reversal of previous expectations or estimates. The extent of the surprise is what creates the degree of exaggerated reaction that usually ensues.

What is important in studying this indicator is the makeup of the estimates or opinions on earnings. Are analysts all over the lot, where average earnings are not close to most individual opinions? Are analysts pretty much in the same close proximity? If the latter is the case, any drastic surprise will have greater mass hysteria value (or at least the mass hysteria analysts are capable of, in the form of market selloffs.)

In other words you cannot take ten analyst earnings estimates and come up with an average that is meaningless. If five say earnings will be $6 a share and five say $3 a share, you cannot take $4.50 a share as the average. But if all are around, $3 a share and the final result is only $1 a share, there will be an exceptionally unfavorable and antagonistic reaction toward the company, its management and its stock.

Information on earnings estimates come from brokerage reports and the media, as well as financial services. The extent you can research what they are for, will depend on your time and the extent of your financial involvement.

There are also services which track changes in estimates of earnings on an ongoing basis. This is designed to give an idea of whether an industry is growing at a more rapid pace than had been anticipated, or to detect recessions, or whether business is suddenly confronted with reduced income.

The indicator is sensitive for individual securities. While it is not as sensitive for entire industries or a group of major companies, it does still have some useful sensitivity for them. Note: The strategy may be used either for a buying guideline, or for a selling flag, depending on whether your disciplined plan at any time is as a security buyer or seller.

Yield Curves

Background

The Yield Curve plots comparative interest rates for an assortment of interest-bearing issues, from a variety of issuers, corporate, federal government, state and local government, and their agencies.

But first: Long term rates are usually at a higher level than short term rates for good reason:

1) Default possibilities increase with maturity. You can measure current corporate and government risk far better than what it may be years from now.

2) If longer term bonds have to be sold before maturity there is always a risk of getting less than face value (should interest rates rise.)

As a result of this difference between short and long term bonds, a normal or conventional curve can be viewed.

A normal curve may show increasing yields with maturity to compensate for risk of interest rate volatility for longer terms.

The Yield Curve is a device to measure any aberrations in the traditional composition of that curve. Supply and demand for various constituents of the bonds that make up the conventional curve may instead become unusual. The Yield may flatten out or become inverted.

Examples
Budget deficits which require heavy long term financing by the Treasury.
Corporate borrowing in commercial paper or other short term paper
There may be a marked reduction of bank loan demand
Foreign demand for bank loans may be off.

The slope of the yield curve is a dominant predictor of recessions at horizons beyond three months. The slope of the yield curve is likely to signal a recession well before the actual onset of a recession.

The indicator is relatively sensitive, though the abnormalities can exist for a while. Note: The strategy may be used either for a buying guideline, or for a selling flag, depending on whether your disciplined plan at any time is as a security buyer or seller.

I-1356-CZ

Yields and returns

Background

The relationship between bond and other debt yields and the maturities of bonds and debts, can produce what is called a Yield Inversion.

As a rule, the longer out the maturity date, the higher the yield you get. The greater the maturity of a bond or debt issue, the greater the risk. The risk can come from inflation over the years. And the risk comes from the action of the marketplace. The longer out the debt issue goes, and it has to be sold on the market, the steeper the discount from the face value of the bond or what you may have paid for it. That's what happens normally.

But there are times when an inversion occurs. Not frequently. Where there is a negative slope. Rates don't increase with time but decrease. To start with the long term inflation scare may not be acute. And then there is the expectation that the Federal Reserve Board will have to influence the increase of short term money. They may feel that the economy is much stronger than they would like to have it over the short term. And they do not want inflation to heat up.

There have been times when a 3-month treasury would yield 4% points more than a 20 year Treasury. And then, there may be a shortage of long term bonds, as compared to the near term. That shortage will cause a demand that will raise the price of those long term bonds. And higher principal amount payments mean lower interest rates.

This inversion is normally bearish for stocks. That's because high short term rates will tend to dampen the economy and the stock market, and that funds will come out of stocks into bonds. Does it always work this way? No. So, the indicator is not as sensitive as some of the others. But it does lead to strategy selections you may wish to make

The indicator is only relatively sensitive, though the abnormalities can exist for a while. Note: The strategy may be used either for a buying guideline, or for a selling flag, depending on whether your disciplined plan at any time is as a security buyer or seller.

Real Interest Cost

Background

This indicator portrays the expansion inclinations and limitations of industry, in terms of true borrowing charges.

The real cost of interest of a loan is its nominal rate, the amount stated, less the inflation factor. One example: If the rate of interest to a company is 6%, and inflation is at 3%, the cost is 3% and is factored into the corporation's plans for the use of the funds. Should inflation be a factor at let's say 4% a year and a company has to borrow at 6%, its net cost would be 2%.

Interest costs are a deductible expense so that is taken into account before the net figure is derived at. The availability of tax credits may enter into the calculation.

The company must also regard what future inflationary pressures may be. If a loan is longer term and cannot be easily refinanced, it could get stuck with a high rate while deflation has become economic reality. Or the inflationary spiral may persist whereby locking in the current rates may make sense for the future. The inflation trend line is important as well as inflationary expectations.

The indicator for locking in interest costs could consist of three month or longer rates changes on intermediate term bonds, rather than short term. If the company is borrowing longer than that, it can look to trend lines in longer maturity bonds.

Note: The strategy may be used either for a buying guideline, or for a selling flag, depending on whether your disciplined plan at any time is as a security buyer or seller.

Treasury Bill Rate Movements

Background

Bond and interest rate prices depend on too many factors: You have the value of the dollar. And of course interest levels. Then you have oil prices. Let's not forget the Trade Gap. Each of which will, in one way or another, or one time or another, affect the movement of Treasury bills. This makes interpretations and certainly predictions of interest rates hard to make.

For example, there is one interpretation that says when monthly rates of 2 to 4 year notes decline to a level less than that of six months earlier, the market will rise. Or fall, if the other direction is indicated. That is not always the case. Nevertheless, you can be sure, there will be Treasury bill rate movements and a trend line that will be sensitive.

The indicator can be very sensitive in a trend line. Note: The strategy may be used either for a buying guideline, or for a selling flag, depending on whether your disciplined plan at any time is as a security buyer or seller.

90-day Treasury Bill Yield

Background

This is one of the more useful indicator strategies in that it can be used for gauging which way the market will go, as well as which way interest rates may be headed. Or whether inflation is on the way.
For the Stock Market

Some investors assign an interest yield standard of let's say, 3%. If the 90-day Treasury Bill yield rises beyond this figure, they will say the stock market is headed lower. While the figure is arbitrary, the use of the standard imposes a discipline for those who wish to use the strategy. Accordingly, should the yield fall below the 3% level, they look for the stock market to rise.
For Interest Rate Direction

If the 90-day Treasury yield rises or falls for at least three months in one direction, the trend can be used for anticipating in what direction rates are headed. Incidentally: The 30-day Treasury bill yield can be used as well for the trend lines watching where interest rates are headed.
Inflation Predictor

A rising 90-day yield can be a harbinger of inflation within the next year.

The indicator is moderately sensitive for the stock market direction. It is much more sensitive for interest level direction. Note: The strategy may be used either for a buying guideline, or for a selling flag, depending on whether your disciplined plan at any time is as a security buyer or seller.

I-1404-BY

Buying/Selling Patterns

Insider Buying and Selling

Background

Insiders of a corporation are their senior officers, directors and large stockholders, usually with 10% or more of the stock. However, insider rules also affect corporate secretaries who have access to privileged information, as well as company lawyers and accountants who have intimate knowledge of what of importance at the company may affect securities prices.

Insider transactions must be reported to the Securities and Exchange Commission every month. If insiders are selling more shares than they buy, the upshot is bearish. If they are buying more than they sell, the company outlook is considered optimistic. The assumption is that insiders know the business better than anyone else on the outside. But there are exceptions to the rule.

Insiders sell more than they buy because much of what they have bought has been through stock option plans. In practice, a ratio of Insider Sales to Insider Buys is about normal if it is 2 to 1. A ratio of under 2 to 1 is considered bullish. If it is over 2 to 1, it can be bearish. But even that can be oversimplified.

What can be important are signs of heavy buys or heavy sales. You can measure the transactions two ways. One by volume and the other by the number of shares. Oftentimes, the number of individuals selling or buying are more meaningful that actual shares being transacted. Another problem. Insider reports are frequently reported late. This helps to desensitize the data.

A disturbing recognition mars the strategy that many insiders do not see the forest for the trees. They are often not the best judges of where their company may be heading. They may get too optimistic about their corporate objectives and possibilities.

On balance, however, insiders provide us with a lucid insight into the inherent value of a company's shares—whereas the market is subject to fear and greed, corrections, as well as incomplete or inaccurate information. Here's why insider trading patterns are both available and valuable.

This can be a somewhat sensitive indicator if care is taken to interpret who is buying and selling, and the numbers within the organization involved. If the insiders are bailing out, it will be too late to make your move by the time it is reported from the SEC. Note: The strategy may be used either for a buying guideline, or for a selling flag, depending on whether your disciplined plan at any time is as a security buyer or seller.

Mutual Fund Purchases by the Public

Background

Whenever the general public becomes bullish they begin to buy stock mutual funds. Such purchases become much greater than redemption's. The opposite happens when the stock mutual fund public gets bearish. Market declines follow heavy selling of stock mutual funds.

Net mutual fund purchases and redemption's are periodically reported in the financial media. It is easy for an investor to measure the sentiment. This is important for those who want to consider contrarian principles. That is because small fund investors usually act the influential part. They are inclined to go to extremes. Get overly bullish or overly bearish, usually at the wrong time. It is easy to look for extremes of one-way sentiment and invest to the contrary.

But here again, caution is in order: Contrarians can be wrong even when they have all the correct reasons. They are more likely to be accurate only at the extremes of market sentiment.

Note: A distinction ought to be made for money mutual funds. They take in funds when investors are going out of stock funds. But sometimes investors who get out of stock funds go instead into bond funds. There is no sensitive indicator strategy to be derived from the activity.

Mutual fund stock purchases as an indicator strategy is somewhat sensitive only at extremes of sentiment.

Price Changes Compared to Trading Volume

Background

If market changes are made on increasing volume, the pattern is decisive If the volume is low during market changes, the action is considered indecisive. Investors who use this strategy indicator generally rely on a 30-day moving average for their signal.

Rapidly increasing volume can indicate a churning market even when there is no discernible trend line. That type of strategy has its uses for certain trading strategies. Decreasing volume will portray an indecisive market despite up and down prices.

You can buy individual securities using this indicator although the sensitivity will be influenced by other market factors. One example: Price rises may occur on special corporate news. Also, price changes and trading volume rises can be due to a special market interest on takeovers.

A number of trading strategies may be more influential at any given time, as related to that of any indicator that takes price/volume into consideration.

While the indicator is somewhat sensitive, it is subject to the type of trading strategy that may be employed. Note: The strategy may be used either for a buying guideline, or for a selling flag, depending on whether your disciplined plan at any time is as a security buyer or seller.

Weekly Mutual Fund Cash Flows

Background

Both stock and bond funds are not part of the money supply. But the Fed watches them because they want to see if there is any panic in the way such invested funds go in or out of circulation and how they may effect CDs and deposits at commercial banks.

The indicator shows the extent of stock or bond market current interest and is sensitive only to that. Note: The strategy may be used either for a buying guideline, or for a selling flag, depending on whether your disciplined plan at any time is as a security buyer or seller.

Book to Bill Ratios

Background

What had been done for autos and trucks in the past has been transferred to high-tech.

Since 1978 the method has been used for the semiconductor business. A comparison of semiconductor shipments to orders has been an indicator for the fortunes of the technology stocks.

The indicator is fairly sensitive. Note: The strategy may be used either for a buying guideline, or for a selling flag, depending on whether your disciplined plan at any time is as a security buyer or seller.

UpTick to DownTick Ratios

Background

If you take the number of shares traded in blocks, and then note the volume of those traded at prices above the previous sale—that is the up tick—and compare the volume of block trades to those sold below the previous sale, you get a good idea of oversold and undersold positions.

This has to be done as close to the market action as possible. That means the indicator is useless after you read about them

Of the two investors who must participate in a trade, one may be more motivated than the other. One buyer may have induced the trade by offering to pay a bit more. There may have been an uptick on that price he paid. Trades that occur on a downtick, at a lower price, may suggest an eager seller.

The indicator has relative sensitivity and cannot be easily used except by the most sophisticated. Note: The strategy may be used either for a buying guideline, or for a selling flag, depending on whether your disciplined plan at any time is as a security buyer or seller.

Advance Decline Comparisons

Background

The relationship between the amount of stocks that rise or fall daily or the total volume of stocks that rise or fall each day, can be a valuable indicator for evaluation. Traders can choose to plot results using either stock numbers or the volume in the aggregate, to decipher the meaning. Plotting of results can be over a ten day trading period or longer, but sensitivity fades beyond ten days. A 10-week period can be of valuable for some traders who want a longer-view perspective.

When done for all the listed stocks, advance/decline lines give a better understanding of what is happening than the thirty that make up, for instance, the Dow Jones Industrial Average, which is less representative. The lines can be viewed for other exchanges as well.

The strategy offers a good idea of overbought (too strong) or oversold (too weak) market conditions that ensue from exaggerated market sentiment. In and out traders find these trends are highly practical tools.

The actual utilization can take several forms. Improvise what you find easiest. In one: A number such as 10,000 is taken. You then add or subtract daily advances or declines and you keep daily ongoing records to see the trend lines. Or you keep a daily running account of up and down stocks for the previous ten trading days. Whenever the total exceeds 1,500 the market is considered overbought. Should your total exceed minus 1,500, the market is oversold.

At one time this indicator strategy could give an idea of “selling climaxes” or “blowouts”. This does not always hold when institutions play a major market role as they do today. Their use of block trades has reduced the ability for traders to spot market climaxes.

Futures Indicators (Such as the S&P 500 Average)

Background

Futures indicators such as the S&P Futures Index can tell us more timely indicator flags than some of the others that concern averages. It can act both as a technique strategy as well as an indicator strategy.

You don't have to trade these S&P 500 Futures issues in order to take advantage of them. Programmers often use it for that purpose. You also can get minute-by-minute trends. You can use them to compare them with what is going on in the S&P 500 Index, and what is happening to the market in general.

You cannot use this indicator effectively if you are not constantly on the top of the markets. There are frequent changes. The next week may be too late to formulate a decision as to what you want to do. The next day may be too late, because these futures change so rapidly.

The strategy is sensitive only when properly used with a decided discipline.

Note: The strategy may be used either for a buying guideline, or for a selling flag, depending on whether your disciplined plan at any time is as a security buyer or seller.

I-1530-CZ

Market Indicators/Signs and Readings

A number of market indicators are of invaluable aid to sophisticated traders because of their sensitivity. They follow:

Corporate Insider Sentiment

Background

Corporate officers and directors of public corporations are required by the SEC (Securities & Exchange Commission) to report the purchase or sale of stocks of their company. The filings are done monthly, with publication by the government agency a couple of weeks

Some studies have shown that corporate insider trading in their own stock can produce better investment results over the years. Yet, many of the investors who trade on this indicator have gotten stale information. Weeks later, or longer.

A further study has shown that this delay does not impair the apparent advantage of following the action of insiders. The closer the timing the better, but there appears to be an advantage up to six months or so afterward.

The indicator is moderately sensitive if much care is taken to understand the purposes of buying and selling on the individual corporate level. Note: The strategy may be used either for a buying guideline, or for a selling flag, depending on whether your disciplined plan at any time is as a security buyer or seller.

Relative Short Interest

Background

Short interest statistics are released monthly by the stock exchanges and Nasdaq and are used to reflect overall market sentiment

The statistics, in effect, show the bullish or bearish strength of the market. Markets with increasing amounts of short interest positions are always a bullish sign. because short sellers have to borrow stock in order to effect the sale. And to cover their position they have to eventually buy the stock as the replacement for what they had borrowed. They naturally hope the stock they buy back will be at a lower price, so they can profit from the transaction. The stocks to be shorted must be marginable, in margin accounts.

In other words, every short position requires a purchase of the stock for coverage of the position. A bullish catalyst for the market, indeed.

However, with the advent of the use of puts, calls and related stock-privilege issues as they are employed today, and with arbitrage strategies so widely utilized by traders, present short interest positions are not as meaningful as before. They are still published and they have their use, provided they are wisely interpreted.

There are ways to put to practical usage these announced figures for both listed and over the counter stocks. For instance, if the Big Board short interest falls 10% in the month while a smaller exchange's positions drop about 1%, it could mean the former's blue chips are thought to be less attractive to traders than the more speculative issues.

The short interest position can be further related to average daily volume of each stock it lists. The ratio determined is expected to give insights on any built-up buying pressure. If the amount shorted is well beyond daily average share transactions, the need for immediate buybacks could cause a bullish flurry of buying activity.

On the assumption it will normally take about two trading days to buy back all the shorted stock replacement without disturbing pricing, the normal ratio is about 2.0. A bullish ratio can be 2.5 (two and one half days), or higher. There is no firm rule to go by. The only time the figures can be significant is if an increase in short interest occurs after it has been dropping for awhile.)

The indicator is sensitive only when other indicators are employed to figure the impact of options and arbitrage in the reported numbers. Note: The strategy may be used either for a buying guideline, or for a selling flag, depending on whether your disciplined plan at any time is as a security buyer or seller.

Adjusted Short Interest

Background

Adjusted short interest positions are taken to eliminate errors or quirks that arise in the evaluation of conventional short sales statistics. The interlopers in the calculation are the influences from options trading and arbitrage which also involve the use of short sales.

The statistics are supposed to reflect the bullish or bearish strength of the market. Those with increasing amounts of short interest positions were always a bullish sign. That is because short sellers had to borrow stock in order to effect the sale. And to cover their position they have to eventually buy the stock as the replacement for what they had borrowed in the original sale. They naturally hope the stock they buy back will be at a lower price, so they can profit from the transaction. The stocks to be shorted must be marginable, in margin accounts.

The use of options and arbitrage serve the same purpose and tend to detract from and becloud the importance of the conventional short selling numbers. But there are overlapping features.

To get at a more representative pattern, the market short interest figure eliminates stocks subject to heavy arbitrage. The information also comes from the exchanges. Newly listed and low volume stocks are also taken out of the calculation.

The adjusted as well as unadjusted figure can be used for individual stocks on which reports are made, as well as the overall market, It is probably more accurate for the determination of general market direction. Especially when the average daily volume relationship is also considered.

The indictor is sensitive only when other indicators are employed to figure the impact of options and arbitrage in the reported numbers. Note: The strategy may be used either for a buying guideline, or for a selling flag, depending on whether your disciplined plan at any time is as a security buyer or seller.

I-1619-BY

Market Price Comparisons

Background

Average Price Discrepancy is an indicator to watch.

A method for analyzing oversold positions is to use average prices for each stock under study, going back six to as much as nine months. The direction of the market is then calculated by determining how many of the stocks being watched are selling below, at, or above their average. If 80% or more of the market's sample is above average, that market could be considered overbought. And oversold if as little as 10% to 20% of the market is currently above average. Anywhere from 60% to 80% can give a trader an idea of an overbought market. And 20% to 40% an oversold condition.

Some would prefer a study of the previous thirty days which is easier to do. Though it will not be as sensitive. The statistics are not readily available free of charge, But it can be culled from the media reports with some effort.

The indicator is somewhat sensitive over the longer period. Note: The strategy may be used either for a buying guideline, or for a selling flag, depending on whether your disciplined plan at any time is as a security buyer or seller.

New High and New Low Comparisons

Background

The number of daily new highs compared to daily new lows is a market sentiment component that will depict a market trend line if closely watched. In addition, it can be an easy indicator to follow, either as a graph or as a numerical reference. Newspapers often total the number of new highs and new lows each day, in addition to listing the stocks. they are given for the larger and smaller exchanges.

There are different formulations that can be developed to get at the interpretation of the numbers. Should 100 stocks hit a new high and 5 a new low, you can create a ratio 100, divided by 5 or 20. If 40 stocks hit a new high and 50 a new low, 40 divided by 50 would give 0.80. If there are 10 new highs and 70 new lows, the ration would be ten divided by 70 or 0.14, an extremely bearish figure.

One day or one week readings will not be helpful. About thirty days ought to furnish sufficient room for a decent trend line observation

The indicator is somewhat sensitive. Note: The strategy may be used either for a buying guideline, or for a selling flag, depending on whether your disciplined plan at any time is as a security buyer or seller.

Indexes to Measure Market Volatility (Such as the Volatility Index)

Background

The Volatility Index gives an idea of how erratic the markets are for different types of issues. It is sometimes called the Anxiety Index. Check with your broker for more information on its use and how you can learn more about its technical intricacies.

It's easy enough to find the calculate the percentage swings of the stocks, the bonds and other trading instruments, indexes and futures because you see the quotes in the financial paper. You can do this quickly by comparing current prices with yesterday's or last weeks. You can compare the volatility of common stocks by just looking at the high and low quotations over a 52 week period. That appears alongside the daily stock quotations in the paper. You find the same for indexes and so on.

The Volatility Index is necessary for disciplining your buying and selling. Stock ABC may have had a low of 20 and a high of 50 over a 52-week period, That is a 30 point high over a 20 point low, or 150% variation. On the other hand, stock XYZ may have had a low of 10 and a high of 15. That is 5 points on a 10 point low, or 50% variation. Clearly, ABC is much more volatile than XYZ.

As a rule of thumb, the more the volatility, the greater the chance of making trading profits. In fact, that is a bona fide trading strategy.

From another viewpoint, if you do not want to undertake the anxiety of volatility you will select from among securities where volatility is minimal.

A further point: When explaining ways of exercising discipline, the percentage leeway before selling flags come up. The percentages vary by volatility. The more volatile a stock, the larger the percentage you will observe for the flags.

Erratic markets mean more attention must be given to the percentage guidelines allowed before selling flags are activated. The more erratic the security, the larger the percentage or leeway can be. Note: The strategy may be used either for a buying guideline, or for a selling flag, depending on whether your disciplined plan at any time is as a security buyer or seller.

Oversold and Overbought Conditions

Background

The Overbought/Oversold Index is also known as the 10-Day Advance/Decline Index. If The indicator reads like this: If it reads over 1500, it can signify an overbought situation. If it's over 2,000 it suggests a market condition sensitive to correction.

Other technical analysts look at the market this way: If a small percentage of stocks trade above their 26-week Moving Averages, the market is considered oversold. It is then expected to go up.

The strategy can be relatively sensitive for the short term. Note: The strategy may be used either for a buying guideline, or for a selling flag, depending on whether your disciplined plan at any time is as a security buyer or seller.

Volume of Puts and Calls

Background

Tracking the use of puts and calls will give you an idea of the nature of the market. Those who want to buy a call-feel the market is on the way up, and they feel that the call will leverage their ability to take advantage of opportunities. They can use less cash to get a hold on stocks that they feel they ought to buy.

Those who sell them calls feel that the market price will not rise enough to take the stock away from them. If the call is not exercised, the original owners will continue to keep the stock. And they would like to earn the fee for the call, whether the call is exercised or not. So you have two different views of the market.

Puts are sold when both the seller and buyer of the put have different versions of where the market is heading. There is obviously a greater erratic aspect to the market envisioned here.

The strategy for a security can be particularly sensitive. Note: The strategy may be used either for a buying guideline, or for a selling flag, depending on whether your disciplined plan at any time is as a security buyer or seller.

M-529-CZ

Acquisition and Merger Trading Opportunities

Background

A wide variety of trading opportunities are available that involve acquisitions, mergers, and the rumors of them.

Buy on News an Unprofitable Operations Being Sold

Background

Many companies experience lower earnings or suffer losses because of marginal or unprofitable divisions or subsidiaries. So the sale, liquidation or possible spinoff (if worthwhile) of these units can have a favorable effect on market action, provided the action makes an impact on the company's overall bottom line.

The usually large bookkeeping write-off that accompanies the move is not usually a problem with traders. The one time write-off is not considered serious, despite the huge figures it may involve. The market, instead, will be looking at earnings figures of the ongoing business operations. The future will be brighter for such companies and the market will immediately reflect that sentiment.

If the news is merely rumor of a sale, liquidation or spinoff of a unit, there probably still will be popular market support in the form of rising prices, though not usually to the same extent.

Once a surprise announcement is made, a trader may miss the opening of a rise in market values. There can be a long-term trend line established, so having missed the beginning of the trend is not important. In fact, buying into these companies at this point is probably the more beneficial.

Pros/Cons

Advantages
Companies who announce the sale, liquidation or spinoff of a non-profitable or marginal operation, usually increase their market value. The extent of the increase will depend on the enormity of potential added earnings.

Disadvantages
A purchaser of the stock after the announcement will have no idea of the market buoyancy.
A purchaser of the stock on rumor of the divestment may tie up funds for a considerable time.

### Trade a Stock of a Takeover Candidate, Just After the Announcement

Background

The strategy has become known as risk arbitrage and the players are the “arbs.” It seeks to profit from the higher price offered by would-be acquirers. The offer is made by an acquiring company or group. The strategy is played by traders, seeking the hoped-for, much-higher price.

At least five types of offers can be classified:
1. A statement from both parties that they are discussing a form of combination. This may mean nothing, and feelers are being sent out to see how the market will react. The trader can learn little from such nebulous statements.

2. A statement from the acquiring company that it already controls over 5% of the target's stock. This is where SEC disclosure has been made. (It is required within 10 business days; pending legislation will reduce the time). The purchaser can make additional corporate inroads during this grace period.
3. An SEC statement that over 9.9% of ownership is at hand, will entail further disclosure of the acquirer's intentions. Some may not be actually seeking more ownership, or working control.
4. The target may or may not know of the impending takeover. If there are behind-the-scenes contacts, the SEC has insisted they be publicly disclosed. Ordinarily, the company will make a statement to this effect, though some will give “no comment” answers throughout preliminary talks.
5. A statement may be made by the would-be acquirer that, indeed, an offer has been made. This may be a complex package of securities and cash. that cannot be easily evaluate. Here are some of the considerations to be made under this strategy:
How much is the offer worth, when securities are added to the cash to be used?
How much profit can be made with the current offer?
How much can be earned, as an annual percentage?
How soon can the deal be consummated?
How much will it cost to tie up funds if the offer is hostile?
How will the offer's potential profits be treated by the I R S?
How likely are counteroffers to be made, from management or others?
How likely would be a Pac Man action by the target, against the would-be acquirer?
How likely are the chances of regulatory or antitrust suits?

Pros/Cons

Advantages
Takeover announcements can set the stage for trading profits based on terms negotiations.

Disadvantages
Should an offer fall through, the trader may find the stock has fallen back below what he may have paid for it.

Trade Stocks in Industries Where Takeovers Have Taken Place

Background

Wall Street calls it derivative thinking. A stock of a company is in the limelight as a takeover candidate, and its price rises to higher levels. The rest of the industry group then takes on new demand from the public, and the rest of the stocks in the group bask in the glow.

The thinking goes: Company A is alluring to takeover-minded companies because of its type of business. Maybe its brand names, that help assure supermarket shelf space. Maybe the company has enjoyed popularity because its business is getting faddish. Maybe the company is in a business where valuable real estate plays a role (restaurants, fast-foods, etc.). But then again, reasons for the attraction may have little sound validity, except that Company A is being highlighted in the press as a corporate suitor's delight.

That center stage will throw a good deal of light on the rest of the industry, its assets and potential. Psychology is an important element in this renewed attention, and the attraction is contagious.

While a bid at higher prices for Company A will raise the Street's hopes and thus the market for the rest of Company A's group, other, individual corporate characteristics will have to be factored into consideration. Some companies are riper for takeover, than are others.
The stock may appear to be cheap to the public.
Management may control only a small percentage of outstanding stock and cannot fight off suitors.
Large blocks of stock may be available from insiders who want out.
The company may be in a turnaround of a cyclic economic or financial pattern.
There appear to be no stumbling blocks in the form of antitrust or regulatory restrictions.

Once takeover fever is rampant within an industry group, a company need not show definitive positive attributes, to warrant the close scrutiny of those who trade with takeover strategy. Some sense is necessary; a company whose major block holder of 51% of stock will not sell the company if he is adamant about staying on. Nonetheless, mood and sentiment is what drives the market.

In this regard, that mood and attention will depend on what is going on in the rest of the overall market. Perhaps, attention is being paid to industries with assets that may have hidden value for resale or for fresh tax depreciation. There may be a current lack of focus on other groups, where the rationale of focus was elsewhere. An interest vacuum cannot exist for long on the Street.

Pros/Cons

Advantages
The psychology of the market is always seeking out what group is right for takeover. If one of the group has been noticed, the rest of the group will follow attract similar attention.
Properly disciplined strategy should be able to protect a trader, whether the takeover possibilities come about, or not.

Disadvantages
The notice given many of such industry members may have been done on the flimsiest of credentials. Caution must be exercised when determining the reasonable validity of takeover possibilities.

Buy a Leveraged Buyout Offer, After the Announcement

Background

An offer by company insiders or venture capitalists to buy out a stock from the public, affords a trading opportunity. However, it may not be comparable to that with conventional takeovers. The stock price will have already risen from the previous, before-announcement levels. Still, there could be enough movement for profit. Despite the payment of a premium for a stock purchase at this stage, a trader can profit if the transaction is carefully observed and implemented.

Note: The insider's offer may be for cash and a combination of securities which will often include debentures of the junk bond variety. The package will be hard to decipher and evaluate, in terms of cash. Yet, the calculation will be necessary.

Cash is always as good. Junk bonds, or any type of debenture with no collateralized backing, will be another story. A $100 bond with the equivalent of a BB rating, is not going to sell at a price comparable to the AAA bonds around. What has been called a $1,000 worth of bonds, may be closer to $700 or so, on closer inspection. True, the yields will be attractive, but yields require payment of interest and principal; this may be doubtful when the company's finances are highly leveraged.

There are two risks:

First, the deal may fall through. The stock may go well below the offer price and certainly below what you may have paid after the announcement. Insiders may have overestimated their ability to arrange shoestring financing. Banks may have balked and the prospect of selling junk bonds to the public may have turned sour with a soft bond market for this type. Perhaps insiders have realized that they are unable to meet the debt service required from their projected future cash flow, and the deal has bogged down.

There may also be a possibility that the failed LBO will attract a wide audience of acquirers. This is one of the ways the trader can often get bailed out, at prices far beyond what the insiders have offered to the shareholders.

Secondly, the stock price movement has to be sufficient after the offer, to make it worthwhile for the trader who has bought at that point. LBO offers may not be as liberal. Unless a takeover bid arises (as it at times does), the shareholder either takes the offer or has little other recourse. Attempts are made, from time to time, to organize a class action. The latter has not been successfully employed for LBOs.

Pros/Cons

Advantages
Buying on the announcement of a buyout may reduce total profitability, but the method saves futile attempts at guessing potential LBOs.
One the LBO proposal has come from the insider group, the outside takeover may tend to bid up the price beyond the original.

Disadvantages
It has been difficult for shareholders to insist on more, if the LBO terms are comparatively low. Class action suits of this type have not been appealing enough for lawyers to take on a contingency basis.
LBOs take awhile for consummation. The financing search alone is time- exhaustive. All this can be costly in terms of the funds being tied up.

Trade a Stock of a Company That Has Just Announced a Major

Acquisition

Background

This strategy deals with the action of a company that is doing the acquisitions. At least a temporary drop in price may accompany the news of the company's purchase of another. The concern is that the acquirer will do badly in the process.

With some acquisitions, prices of the acquirer may advance. The public here will perceive a significant synergism, as a result of the takeover. Or, the price may be conceived at a bargain. many times, however, the opposite is true.

The acquirer may make one or more of several possible mistakes, in order to consummate the deal. Either can prove disastrous:
There is a proven wrong assumption that the skills of management in one business can be readily transferred to another. In addition, corporate culture conflicts may preclude hoped-for advantages.
The price may be too high. Acquirers often vie with each other for potential takeover targets.
The deal may necessitate going into heavy debt, to raise the funds needed.
Funds used may drain whatever cash flow the company needs for one or more of its present operations.
The consummation of the takeover may, as it too often does, result in corporate indigestion and result in serious consequences in the not-distant future.

The strategy produces shorting stances, where stock is held or where it is borrowed. This is done before any problems arise from the takeover. The stage at which it is done, will depend on the trader's conception of the problem:

Example: Overpaying is not a sensitive element. The consideration is subject to conjecture as to what is expensive or not The possibility of suffering the effects of corporate indigestion, also is not a definable risk factor. We may know that about one-third of mergers/acquisitions spell trouble, but how do we measure its portent in each case?

The shortage of cash flow due to a drain from the deal's terms, and certainly, the need to incur outlandish amounts of debt, both give us a picture of impending doom. When that picture becomes sharp, the trader is on somewhat safer ground for the short-selling position.

If the stock rises on news of the acquisition, the short-selling opportunity is enhanced. If it has moved sideways, the picture should still be well in focus. If the stock falls sharply on acquisition news, the short selling may not be a feasible ploy until the future, when the problems of restricted financial conditions come to fruition.

Pros/Cons

Advantages
Companies who have made a substantial acquisition will often experience corporate problems that are directly related to the takeover. This permits short-selling techniques.

Disadvantages
Short-selling is a risky strategy, even for the experienced; it is dangerous for the unsophisticated.

Trade a Company that Has Just Escaped a Takeover

Background

A company that has just escaped a takeover may already have lost its battle for independence. In one way or another, it is going to be a different corporation than it was before the takeover battle.

The company will most likely be suffering from one or more of the following problems:
It may have given a large cash dividend to shareholders, to leave less cash around for the acquirers, were they to be successful in their bid. This has left the company in tight financial straits.
It may have taken on enormous debt from banks and bonds, to scare away the acquirer, more likely to buy as much as it could of the acquirer's stock. This counterattack has become a standard fight-back tool where the target has the available funds or the credit.
It may have given its shareholders the right to buy convertible senior securities at very substantial discounts from the market. While those securities may be senior convertible preferreds, and not further debt, a dilution of future earnings has thus been created. This is one of the “poison pills” managements may undertake in desperation.
It may have “restructured” corporate assets that had been very much in plans for the future. This may have been done merely to counter arguments that the acquirers had been making, and which may have been counter to well-laid planning.
It may have sold off one or more of its more profitable subsidiaries or groups, to make itself less alluring to the potential buyer, or to pay off some of its Pac man debts. In short, management has begun a liquidation of its business, in a desperate effort to stay independent.

Because of these problems, the company will invariably be subject to further takeover battles. The company has already been signaled to the world as a potential plum. The next would-be acquirer will think they can do a better job in the acquisition attempt, where the original suitor had failed The target company can be compared to a wounded lion, where hunters are ready to pounce for the kill.

Management, knowing this, may opt for a leveraged buyout. In this manner, they will be able to keep their executive positions and independence, what they probably felt they were in danger of losing in the original takeover attempt. Obviously, they will need some personal funds and a source of outside capital, as a nucleus for the LBO (Leveraged Buyout)

A trader therefore has several options, once a target company has, at least temporarily, won its battle for independence:

1. A long position can be taken to take advantage of the depressed price that has probably ensued with management's success. The price probably soared on expectations of a takeover, and then dropped when the deal fell through.

2 Should a second offer come along, that trader will be in a profitable situation to get much higher prices from the would-be acquirer.

3 If the company had incurred severe financial problems from the battle, a short position could be undertaken. This would probably take place after a rebound from the depressed stock position under 1) above.

The trading strategies are sophisticated, and are best used by traders who are equally at home with positions on either side of the market.

Pros/Cons

Advantages
A company is practically a sitting duck for another takeover bid, despite the fact it has just won a takeover battle.
Companies who have successfully fought off a takeover, may have severe operating and financial problems that can be the basis of trading positions on either side of the market.

Disadvantages
Such trading requires experience of trading in long and short positions.

Intrinsic Selling Character (of the Group)

Trading opportunities permit a purchase of a stock because of special investor interest. The time to sell is when that particular interest is no longer acute. Apart from that plan, there is always an alternate guideline to sell, should the market price fall by a predetermined price from its market high after your purchase.

M-562-AX

Analyst Reports and Their effects on the Markets

Background

Analyst predictions of corporate of long-term fortune and estimates of their short-term earnings play an essential role in the market action of their security prices.

Trade a Stock on Changes in Analyst Projections

Background

Estimated earnings get the most attention. What are significant are changes in estimates. These could be significant. While actual forecasts may be off, trends in thinking are the clue.

The market often responds to changes in earnings estimates. A company earning more each quarter than that previous may not perform well as another company with relatively poor earnings that has just announced a pickup in its bottom line. Changes from bad to good news may hold more value for analysts than would continued growth with a company whose earnings they take almost for granted.

Earnings estimates from any one analyst may change frequently, at times drastically. As a rule, stocks rise on estimate increases. Changes that fall below estimates often produce price weakness. Clearly, the element of surprise, as well as change, will influence the analysts and the market. In short, absolute numbers may not be as vital as the trend.

Note: Analyst and company management predictions are off the mark quite often. The phenomenon is due to the nature of the earnings estimate. Like weather forecasting, the further out the time frame, the less accurate the prediction.

Company management itself may not accurately know how their earnings will be reported until close to the end of the reporting period. Business factors beyond their control may be responsible, or their accountants are attempting to cope with bookkeeping options. Estimates just one quarter ahead may be easily off base.

Analyst earnings estimates are usually close to each other, but at times can be far apart. Five analysts may be thinking about $2.00 a share while another five may see $4.00 or so a share. Taking a average of $3.00 a share from the disparity would make a meaningless estimate. Pros

Pros/Cons

Advantages:
Both the professional and the man-in-the-street take analyst earnings predictions seriously. The market reacts to them whether they are accurate or not.
Because of the tendency of analysts to become victims of group think (see below), Contrarian thinkers may get a market advantage.

Disadvantages:
Analyst estimates are usually well off the mark. If management has a problem estimating earnings, analysts can't be expected to do better with secondhand information.
Analysts are inclined to predict earnings within a range of those from their colleagues. Whatever the reasons, one may be a psychological fear of straying from the crowd. Wall Street suffers from a persistence of me-too-ism. Warning signals should fly when analysts appear to be thinking the same way about a corporate profit or loss figure. (Contrarians may us this to advantage).

Trade a Stock On Analysts' Perceptions of Price Direction

Background
Aside from changes in more or less estimated earnings per share, analyst longer-term mood and shorter -term sentiment can be a bellwether of a security's direction—even the whole market. Analyst perceptions are what cause such moods and sentiments. When analysts also are influential, their perceptions constitute a valuable strategy.
Earnings estimates from the companies or analysts themselves may well be on the upside or on the downside, while analysts in general may look at the market on a more or less even keel. Their perceptions may be noncommittal either way. Changes in earnings direction usually stir them to more decisive thinking and action.
The preponderance of thinking will be an additional clue. The celebrity of the analysts involved can be a major factor in determining meaningful perceptions.
Just as average investors and traders, analysts can get bored with a security. Perhaps the story or the concept behind it has lost appeal.
Fads infiltrate the research department as easily as the consumer market. Even increasing earnings may not stir researchers up if the growth has become expected. New ideas or concepts will be more exciting.
Companies who feel their securities are not priced as high as they would hope are aware of this phenomenon. Their corporate public relations departments contact analysts with frequent updates on corporate activity, especially when the news is bullish. They attempt to come up with the fresh ideas that will stimulate research thinking.
Companies often invite analysts to visit their headquarters, sometimes in groups. Plush hospitality will help arrange the atmosphere for the communication of what the company feels Wall Street ought to know. Low expectation stocks fit in this category.

Pros/Cons

Advantages:
Analyst perceptions, as reported in the press and in their written material are a clear road map of where securities recommendations will be oriented. It will also be obvious when there is no clear-cut perception to warrant action.
Traders may anticipate interest in a company's securities, should they learn an invitation has been sent to a group of analysts, including those whose recommendations carry weight on the Street.

Disadvantages:
It is easy to misread analyst perceptions. The preponderant of possible distractions can affect the way their thoughts will develop in the real world. If this were not the case, the marketplace would be too simple.
The company news at field trips may not be received as favorably by analysts as management would have hoped. Companies miscalculate, from time to time, how otherwise upbeat news to them can translate into disappointment for analysts.

Trade a Stock That Has Disappointed Analysts

Background
Securities that have disappointed analysts generally suffer from depression. They will have sold off more than the earnings failure itself, and they will remain laggard for a longer while. They can present excellent trading strategy if that strategy is followed through and properly implemented.
Analysts are not immune from the group think syndrome. They are a close group who lunch together and commute together and talk business to each other all the time.
Depression, as is overoptimism, is a professional hazard that few successfully avoid. If only relatively a small number of bellwether types have been disappointed, other analysts who may not have been directly involved can still catch a bad case of negativism fever. Badmouthing of securities can thus readily spread.
Moreover, for psychological reasons, many tend not to go against peer opinion. It's easier to be wrong when you are a part of the crowd; you can be in trouble if you have stuck your head out too much.
Overreaction is visually the case. It's as if insult were added to the injury of poor earnings. After all, analysts do get egg on their face when their estimates are proven wrong. In most instances, their optimism also was overdone.
The biggest disappointments appear to be over short term results; for example, quarterly earnings shocks rather than those which are semiannual or annual. Most of these errors may, in reality, not be fundamental to a company's outlook, but they are perceived on the Street at their psychological worst.

Pros/Cons

Advantages:
Gauging ana
Oversold con
Direction of a

Disadvantages:
It will be diffic
Knowing whe

feel comfortable enough for act

Intrinsic Selling Character (of the Group)

Analyst comments permit a purchase of a stock because of special investor interest that apply to that security. The time to sell is when that particular interest no longer fits the investor's original purpose. Apart from that plan, there is always an alternate guideline, to sell, should the market price fall by a predetermined price from its market high after the purchase.

M-576-CZ

Trading Corporate Bonds

Background

Corporate bond trading opportunities are varied, mostly for sophisticated and knowledgeable investors. They can be used for both those with short-term and longer-term investment horizons.

Trade Corporate Bonds on The Yield Curve

Background

Corporate bonds of all quality categories can be traded as are government or governmental agency and local bonds, but with a different strategy slant.

The yield curve relationship of corporate bonds to governments and agencies, U.S., state or local, also holds with corporate. A comparison of returns from AAA corporates and governments can also be a trading device. A premium always prevails on AAA corporate in relation to those which have some governmental guaranty or backing. When the premium rises far beyond logic, corporate become a better buy.

Corporate bond income is fully taxable, except for pensions and pension-type funds. These investors or traders can look at the yield curve as a practical clue to the use of the strategy.

As is the case with the governments and their agency issues, an essential fundamental in trading is liquidity. For most governmental issues this presents little problem. Corporates are a different matter. The trader who wants some modicum of liquidity has to look to those which are listed, primarily those on the New York Stock Exchange.

Corporate bonds are rated by credit rating services (i.e. Standard & Poor's and Moody's) which allows for determination of risk. The AAA's are the highest quality; “Junk” bonds are lower, (BB or lower), but not necessarily the lowest. Corporate bonds are backed solely by the ability of the company issuing them to make good on its promise to repay principal and make timely interest payments. In this respect, the strategy is tied primarily into moods and sentiments behind the company, and only to a lesser extent on interest rate levels.

Certainly, when interest rates are low, corporations will pay less interest on their coupons, and secondary markets will reflect the reduced interest levels. When interest rates are high, corporate bonds will have to pay a higher return as well. Any doubt about the ability of a company to repay its principal and interest will lower the value of the bond, no matter what the prevailing interest rates. A company must remain solvent to fulfill its debt service.

With the spate of takeovers and buyouts which rely on a corporation selling new debt to the public, existing bondholders can suddenly find themselves holding a lower-rated issue. The market value of those holdings will fall, whatever level interest rates are commanding in the money market. Corporate bonds can also be bought on margin.

Pros/Cons

Advantages:
Because corporate depend on two factors, moods and sentiments of the market and interest levels, interesting trading chances can develop in all markets.
Listed bonds can be easily followed in daily and weekly newspapers.
Bonds can be followed on the basis of their issuer's corporate news.

Disadvantages:
Despite listing, corporate bonds do not have exceedingly high liquidity.
Current merger/acquisition scenarios often put existing bonds into a lower rating category because of the addition of fresh debt to capital structure.

Trade Heavily Discounted Corporate Bonds

Background

Corporate bonds which sell at a huge discount are the basis for trading strategies that can produce potential capital gains.

In the case of takeovers, where new debt is piled upon existing debt, as well as cases of bankruptcy, debt can fall to inordinately low levels, with yields at a level much higher than overall interest levels should warrant. Added risk has dropped the prices, to compensate for risk with extraordinary returns. That is, if the bonds will continue to pay debt service.

There is yet another bond market condition which can suit trading strategy. These are bonds that sell at a deep discount, not because they were issued as the “junk” variety nor because they have become part of a bankrupt company's corporate structure.

Bonds may sell at a deep discount simply because they were issued at a time when the going return from such issues was at a lower level than interest rates are today. A bond that had a 4% coupon, and came out at par may today sell at half of its face value. The reason? Simply that comparable bonds at the current market come out at about 8%, and the bond has adjusted to market levels. In short, buying bonds when interest rates go down will result in lower values.

On the other hand, buy a bond today when interest rates for the particular grade return 8%, and hold it until such time as interest rates drop to 4% and you get the reverse market action. Such bonds will rise in value, above par or face value, if the bonds are to reflect comparable interest returns.

Of course, maturity has lots to do with how a bond rises or falls with interest levels. Still, the general rule is: Prices drop when the market for rates go up; prices go up when the market rates for interest goes down.

Note: bonds may be sold at a slight discount from, or a slight premium over face value. This is just a marketing aid for underwriters because of the attraction one or the other may have at the time. (There is a tax angle which may be attractive to some types of buyers). These slight discounts or premiums are not part of this strategy.

Pros/Cons

Advantages:
Appreciable changes in interest rate levels can leverage earnings for an astute trader.
Indicator flags for closing out a transaction can be distinct.

Disadvantages:
Interest rate trends are not easily forecast. Fortunes have been lost by banks and other money market managers who have guessed wrong on rate direction.

Buy Junk Bonds in Bear Markets

Background

The higher income of debt securities are helpful in a bear market. It helps keep a floor under the bond plus the fact, when earnings are reinvested in a dollar averaging program (facilitated in mutual funds) you get more value from lower pricing. Or in a non-fund, from reinvesting the dividends as soon as received.

Many do not realize that junk bonds do not react to interest rate changes as do other, better grade bonds. They are dependent on the economy. During recessions the default rates can increase. But they give more yield.

Ideally junk bonds should be bought during a boom and in diversified portfolios, using mutual funds. And using mutual funds, they are to be bought with low management fees. The funds provide diversification as a defense against defaults. And also, the reinvestment feature helps “ladder” rates. That takes advantage of any volatility in those rates over the years, should the investor wish to remain in the holding for awhile, despite the risk of interest rate fluctuation.

Pros/Cons

Advantages:
Appreciable changes in interest rate levels can leverage earnings for an astute trader in junk bonds.

Disadvantages:
Interest rate trends are not easily forecast. Fortunes have been lost by banks and other money market managers who have guessed wrong on rate direction.

Buy High-Coupon, Long-Term Bonds

Background

High-coupon bonds, issued by companies when interest rates are high are quite attractive. They usually are issued by public utilities who have extensive long term debt structures, and who must borrow heavily to replace debt that matures.

The only question the bondholder has is whether interest rates are going to rise further. Long-term bonds can be erratic. High coupon bonds reduce some of the risk as most of the erratic behavior generally turns of the bond discount, if the coupon is historically high. If there is sufficient reason to believe rates are not going to sharply rise again, the high-coupon holdings can become extremely profitable.

Another pitfall, aside from interest rate direction, are the refunding or call provisions many of these issues have. Sometime after the original underwriting of the bond, the company may have the might to call in, or redeem, the bond. This is usually at a price somewhat higher than the face or maturity value. Sufficient time is given the bondholders before this provision comes into effect.

The trick, of course, for the issuer, is to be able to reduce its interest obligations. The objective of the bondholder is to find bonds without call provisions, or where the call will not make a perceptible difference in their goals that bondholder has designed.

Bonds, for example, issued with a 9% coupon at about par ($1,000 face value), will be worth considerably more, should interest levels for a comparable maturity fall to 6%. If interest rates go higher, the issuer won't bother exercising the call; should rates drop and the profit potential appear for the holder, that call provision is to be considered.

A problem: Some bonds have a “funnel sinking fund” provision. That means all of the issuer's outstanding debt will be subject to a once-a-year sinking fund requirement. The company will be permitted to choose which of its outstanding debt obligations it wants to reduce. The highest-cost, high coupon bonds, will get the nomination for the redemption.

It is, therefore, essential, that buyers of high coupon bonds be certain of their call provisions (if any) and funnel sinking fund provisions (if applicable). As incentives for bondholders in varying markets, corporations will not include calls or the funnel sinking fund snare.

Pros/Cons

Advantages
Short of drastic inflation, historically high coupon rates of bonds bought at issue, can have diminished risk.
Sufficient non-call, or distant call date issues permit adequate election of worthwhile issues.

Disadvantages
It takes time and extreme, time-consuming diligence to find which issues have special funnel sinking fund redemption's.
The bondholder should be sure the high coupons will be still high in the near future, as interest rate levels may still be on the upside.

Trade Short-Term Bonds

Background

Many traders of bonds want to transact only short maturities. The prime reason for their action are the activities of the Federal Reserve Board. The actions of the Fed in controlling the money supply and interest levels, will move bond prices. The most volatility will be in the longer-term issues. In fact, bonds often behave more erratically than common stocks.

Some traders welcome the bigger swings in pricing of long-term bonds. Others prefer to avoid that volatility. They confine their interests to the shorter term. Both strategies are acceptable, provided the discipline for each strategy is carefully enforced.

Short-term bonds, by definition, can be one, five, ten years, sometimes a bit longer out. Intermediate term generally has to run about ten, fifteen years or so. No hard-and-fast categorization is made. The longer-term run about twenty years and more out from the present.

Note that short-term and long- term here are not concerned with the original maturity of the bond. Example: An originally long term, twenty year maturity bond, coming due next year, is considered short-term. As bonds get close to maturity date and their redemption value (usually face value), their market price gets close to that value.

To traders who want this strategy, it makes little sense to go too far out because the premium in return for the long term may not compensate for the added risk they feel they are to undertake. The yield curve can be used here, to determine the added return versus risk.

Traders who want to play on major interest rate swings, will choose, instead, the longer-terms, where big swings cause sharper bond moves and better profit potential Traders viewing the yield curve in such instance, may feel longer maturities are worthwhile.

Nevertheless, those who wish to avoid volatility may decide to focus primarily on the short term issues.

Aside from yield curve discrepancies, and volatility risks, another determinant in the use of strategy may be the inflation factor. With signs of more rampant inflation, traders will be more likely to look for short term opportunities. At a hint of a lessening of inflation pressures, the loner-term maturities take on new attraction.

Pros/Cons

Advantages
Less volatility in shorter-term bonds help reduce risk.
Minimization of volatility makes it easier for a trader to designate suitable selling flags.

Disadvantage
Less volatility reduces the profit potential per transaction, should the trader be able to get the benefit of interest rate changes.
Sudden economic influences may have an adverse impact on the trading position.
Federal Reserve Board attempts at stabilization could defeat strategic goals.

Trade Short Term Debt to Hedge Common Stock

Background

The relationship of the market action between short term debt and common stocks is familiar to all market traders. Though not always, short term debt securities are strong (their prices go up as their interest rate levels go down inversely), when common stocks are under pressure.

The reasoning is logical. When traders no longer are interested in common stock to keep prices are buoyed, their interest will turn to debt securities. Their first attention will be given the short term debt issues, since their purchase does not constitute a firm, trendy commitment.

At times, both the short term debt issues and the stock market will boom, at least, simultaneously. Economic and fiscal factors may make this a reality. Interest rates are dropping quickly, and this can be a signal for the purchase of what are called interest-sensitive stocks (banking, insurance, utilities, etc.) This is no guarantee the rest of the common stock list will move up too, it often doesn't, but there may be a move in tandem.

The classic move, however, is for debt issues, especially shorter-term, to move up, when the market is weak. This being so, it is wise to hedge purchase of short term debt when there are commitments in common stock purchases. Any losses for future weakening in the common stock market is expected to be offset by a strengthening in the short term debt market.

The strategy must be used in the purchase of common stocks that represent actions of the overall market. It cannot be used for special situations, other than with interest-sensitive stocks, as noted above. Moreover, two distinct selling flag categories must be used, one for the common stock and the second for the debt. The first to be flagged, should be activated.

Pros/Cons

Advantages
The usual inverse relationship between short term debt and the overall market for common stocks is clear enough for strategy use.

Disadvantages
Short term debt and the common stock market do not consistently behave as they are expected.
Sudden economic influences may have an adverse impact on the direction of either of the two parts of the inverse equation.
The continuous moves by the Federal Reserve Board to stabilize the economy serves to defeat much of the marked relationship being sought.
The strategy is not as sensitive as other hedging techniques available to a trader.

Buy Premium Bonds

Background

Premium bonds are those you buy on the market at a price over 100. Most bonds are issued at 100, (or par). Occasionally new issues are sold at a slight discount or a premium. But as a rule, the discount or premium on a bond occurs after the issue has been floated and the market levels for interest rates are put in play.

The coupon rates always remain the same. If you buy a 5% coupon bond new, at par or 100, your current yield is 5% on a payment of $50 a year for every $1,000 face value. If rates fall below 5% you are still getting that $50 a year, but the yield is now $50 divided by a price above $1,000. So the yield is currently lower than 5%.

By the same figuring, if interest rates rise, that $50 a year will be divided by a price below $1,000 so your current yield is higher than 5%. You have not been effected. You are getting the same amount each year.

The parties who are affected are those buying the bond when rate levels have gone above or below 5% on that issue.

Why would you buy a premium bond? For one thing, the yield may be good, given market conditions, better than par and discount bonds. Many investors have a prejudice about them because they feel they are giving away something. They think they can only get bargains with bonds at a discount, forgetting that yield and yield to maturity are big considerations. So premium bonds are often neglected and that means a better buy for those in the know.

Perhaps you like issues on their yield to maturity or the possible call. Yield to maturity is the current return as expressed when holding it until maturity. This figure is not the same as current yield. In the case of premium bonds, yield is still favorable, taking into account that the maturity is at par.

Premium bonds usually have less price volatility when rates move either up or down. They must move with interest rates the way all bonds do, but volatility is softened somewhat.

There are no capital gain possibilities as with a discount bond as you get the face value at maturity, but the other aspects are inviting. Note: If you sell a premium bond before maturity, see if there are capital gains consequences. Check with your tax accountant.

And always avoid calls, because the premiums given may be insufficient to compensate for your purchase price.

Pros/Cons

Advantages
The usual inverse relationship between short term debt and the overall economy is clear enough for strategy use.

Disadvantages
Short term debt and the economy do not consistently behave as they are expected.
Sudden economic influences may have an adverse impact on the direction of interest rates and the inverse equation.
   Intrinsic Selling Character (of the Group)
   Bond-related observations require close watch of interest rates. Look at those sensitive interest-related indicators you will be comfortable using. Choose the one you want in advance. It will materially help in your choice of security at the purchase, and will help determine the point at which you will be selling. Thus, create the guideline you want to use to determine that selling flag.

M-600-CZ

Trading Government and Municipal Bonds

Background

Government and municipal bond trading opportunities are varied, mostly for sophisticated and knowledgeable investors. They can be used for both those with short-term and longer-term investment horizons.

Hedge Long Term Bonds with Short Term Bonds

Background

Yields of short term and long term bonds will vary by years to maturity. As a rule, long term bonds have larger yields than the short term. However, this spread will vary constantly. Sometimes it's greater than the usual average variation. Because it does, some traders may find profits by buying one type while short selling the other. It may be the purchase of a short term bond and the short sale of a long term bond, or the purchase of a long term bond and the short sale of a long term bond.

This trading strategy is not as tough as when you are involved with options and futures. Still it requires close attention to the market, so it's not a strategy for everyone.

You should be familiar with what is known as Positive Carry. When you buy long term bonds by borrowing at short-term rates that carry a lower cost, you profit by the interest savings Naturally, when interest rates are rising, your shorter-term costs may exceed the original return on your longer-term holdings.

To protect yourself against a bond call, buy a callable bond with a low coupon which trades at par or close to it. A low coupon means the issuer is paying a relatively small amount for it. Your yield may be much higher because you may have bought the bond at a discount, but that low coupon means low issuer cost. As a rule, lower coupon bonds are the last to be called.

Pros/Cons

Advantages
The usual inverse relationship between short term debt and the overall economy is clear enough for strategy use.

Disadvantages
Short term debt and the economy do not consistently behave as they are expected.
Sudden economic influences may have an adverse impact on the direction of interest rates and the inverse equation.

Hedge by Trading Debt and Common Stock

Background

Short term notes and bonds will frequently move in the opposite direction of the stock market.

Therefore, when buying common stocks, especially those not sensitive to interest rate levels (such as utilities) the investor may buy a T Bill (usually a 90 day Treasury) as a short term hedge. Should rates go down, the value of the debt will rise.

Some stocks rise when interest rates go down. Insurance companies, utilities, finance companies, and banks are examples.

Stock index use hedged by such short term debt holdings, may even be more logical a strategy. It gives a broader reflection of the market and therefore serves as a better vehicle.

The use of futures on stock indexes provide further leverage. This could be indicated where the stock being purchased may be unduly hurt by a rise in interest rates. Those very heavily in short term debt or in need of new debt financing, or companies engaged in residential and industrial construction are additional examples.

Note: Debt hedging van also be used by commodity traders in a broad fashion. Commodity futures can fall because of higher carrying charges. Holding market sensitive short term debt will bring on an opposite reaction and a countervailing protection for the commodity speculators.

Pros/Cons

Advantages
The usual inverse relationship between short term debt and the overall economy is clear enough for strategy use.

Disadvantages
Short term debt and the economy do not consistently behave as they are expected.
Sudden economic influences may have an adverse impact on the direction of interest rates and the inverse equation.

Trade by Spread Between Municipal Bonds and Treasurys

Background

Traders and those who consider themselves investors, ought to be alert to the spread in the after tax return they can get when they hold municipals and Treasurys. Assuming the tax exempts are of good quality, they sometimes offer a higher net return than Treasurys. Tax exempt bonds have income that is free from Federal income tax, and state and local taxes if they are issued in the state in which the investor lives. Treasury bonds are taxable on a federal level but not on state and local levels. Ordinarily you get a little less return from holding the tax exempts. Sometimes, you get more actual return on tax exempts, even before you take the tax deductibility into mind.

Most people who invest in tax exempts make a choice by maturity and quality whenever they buy or trade. They may want a relatively short term or a medium term bond. Or they may want an issue that runs 15 to 20 years out or longer. The longer the maturity the more return they get.

The other side of the equation is risk. As interest rates go up there will be higher risk due to longer maturity. The longer it takes to get your money, the larger looms the specter of inflation.

That could be large enough to upset the equation as the value of your matured bond may bring in less purchasing value than you had anticipated. The longer you wait the higher the risk.

If the bond is corporate and not U.S. government or a top-rated state or local government, the risk also has to do with credit standing. Quality is always important. You take it for granted with the U.S., but you cannot with state and local governments or with corporate bonds. There are rating agencies such as Moody's and Standard & Poor's who rate bonds. And you can go with their evaluations

Pros/Cons

Advantages:
The yield curve and bond markets are techniques that make frequent trading opportunities for an astute trader.
Interest rate changes occur all the time, so that aberrations in relative returns form frequent inordinate spreads.

Disadvantages:
Bond markets are sensitive for sharp sell signals. Some leeway must therefore be given on the question of the magnitude of change in a spread that warrants a sale. A trader could be blipped out of a position too soon.
Discrepancies may last for a period of time, and that can tie up funds a trader may wish to use for faster transactions.

Trade the Yield Curve for Long Term Governments

Background

The yield curve presents interesting trading possibilities It compares yields to maturity of a security type, in relation to the maturity date of each security. The curve can often be used for trading in long term governments for better than usual return.

Example: There may be a 4% point yield difference between a 90 day Treasury bill and a 20-year Treasury bond. The lather's return will be normally higher to compensate for the risk of having a longer-term commitment.

At least two factors make for this difference. One is inflation, The higher the rate, the less attractive it is for a bondholder. Another is market fluctuation due to continual changes in interest rate levels. The higher return on longer-term bonds reflects this.

Yet, 4% is a steep difference. When such a spread appears, it can pay for many short-term bond (and certificate of deposit) holders to move into longer-term issues. That 4% difference ought to make up for the added risk. In addition, this action gives the trader the chance to lock in potential capital gains, should general interest levels drop.

A trader will have to decide what the spread ought to be as an incentive. Many unfortunately, make this decision on the spur of the moment or on a suggestion in the media or financial report. A more disciplined way is to set up an Indicator Sell Signal the trader feels will be significant, and stick to the plan.

Note: The Yield Curve Indicator strategy for selling flags permits a wide range of spread. The exact flag will depend on the trader's judgment. What makes it work on balance is the discipline used in adhering to whatever the flag is to be. The flag should allow for a wide discrepancy in the curve before action is to be taken.

Whether the trader is right or wrong in judging future interest rate levels or curve spreads, discipline in watching a spread in a consistent manner should usually suffice as proper strategy.

Pros/Cons

Advantages:
The yield curves are a sophisticated attraction that move in a way that makes for continual trading goals.
Interest rate changes never have an impact on varying maturities in the same way. This makes for frequent trading opportunities.

Disadvantages:
Yield curves are not sensitive Indicator sell strategy by themselves. Thus some leeway should be given on sensitivity of changes, or the trader will be blipped out of a transaction too early.
Curve discrepancies may last for a period of time, which may tie up a funds inordinately long for it to be a satisfactory trading strategy for some.

Trade U.S. Treasury Bonds on Margin

Background

Trading U.S. Treasurys can be profitable if the account is heavily margined. This is usually done with intermediate to longer-term bonds.

Margin financing on Treasurys can be done with relatively small amounts of equity. These issues are not subject to SEC or Federal Reserve Board regulations. Some brokers permit their favored clients to maintain accounts with as little as 5% to 10% equity; some are given 100% credit. The leverage is thus exceptional.

Minimum borrowing for a margined Treasury account will range from $50,000 to $100,000. With 30% margin, the trader needs $30,000 in cash or equity, and with 10% margin, only $10,000 to handle $100,000 in bonds. The way to go is with extended leverage, if the risk is acceptable.

Another important consideration is the cost of borrowing. It should be no more than the return from the bonds themselves, taking into account transaction costs. If not, the trader will have to make up for interest shortages and transaction costs from the gain on the transaction.

Traders buy on margin if they feel interest rates will be in a downtrend. This translates into higher bond prices. When interest rates go up, bond prices are going down. Several indicator strategies will give the trader some idea of the trend but these are not going to be of distinct value in a heavily margined account. This adds to the risks of using the strategy (see Pros/Cons).

The strategy ordinarily ought ot be used by those who are in constant contact with the market. Professionals with an interest in the money market will do best. The man-in-the-street will have a problem with the odds for success.

Treasury bond dealings liquid, so that market positions can be taken without some of the problems in other markets where liquidity becomes a factor (e.g. options and futures).

Pros/Cons

Advantages:
Small bond price changes will make substantial differences in holding values.

Disadvantages:
The slightest blip of price can wipe out a trader's equity.
It is extremely difficult to catch short term trends, required accounts be heavily margined.
Borrowing costs can work to significant disadvantage.

Play the Spread between Junk Bond and Treasury Yields

Background

The spread between junk bonds (which by definition are lower-rated corporate bonds) and the highest rated Treasurys. can be substantial. The added income the bondholder gets from the spread is supposed to take care of the added risk.

Sometimes, the spread is much greater than normally. and this spread can be played well. Sometimes the comparisons are made with CMOs or collateralized bond obligations which are of lower quality.

In making the consideration the interest levels are one consideration. Another is the ongoing default rate for lower-quality bonds. Both factors are taken together.

Advantages:
Small bond price changes will make substantial differences in holding values.

Disadvantages:
The slightest price blip can wipe out the trader's equity.
It is extremely difficult to catch short term trends, if required accounts are heavily margined.
Borrowing costs can work to significant disadvantage when accounts are margined.
   Intrinsic Selling Character (of the Group)
   Bond-related observations require close watch of interest rates. Look at those sensitive interest-related indicators you will be comfortable using. Choose the one you want in advance. It will materially help in your choice of security at the purchase, and will help determine the point at which you will be selling. Thus, create the guideline you want to use to determine that selling flag

M-624-AX

Following “Insiders” and “Smart Money”

Trade a Stock that Institutions Follow

Background

The strategy is predicated on several assumptions concerning institutional trading:
That money managers have a better idea of the market than the general public.
That they get analyst recommendations earlier.
That they often control price movements due to their volume trading.
That they impart a sort of self-fulfilling imprint on the market.

In truth, all of the above assumptions are close to the truth. This fact does not make the strategy of emulating them as simple nor as successful.

Institutional investors account for the bulk of the trading on the stock exchanges. In 1984, this was about 50%, and in 1964, only about 6%. Measurement is by block trading; that is, one with over 10,000 shares each. Banks, insurance companies, foundations, pension funds, trusts, et al fall into this category that awes the average individual investor Yet, institutions need not swallow the smaller participant, provided, proper precautions are kept in view.

Services offer a tally and report on institutional action, but they are expensive and are recommended only for the substantial, active trader.

Traders following institutions try to fathom their actions on the tape, looking for the 10,000 plus share transactions. Apart from getting lower pricing or better commissions, the financial newspapers do report on what the institutional investors are buying because the buyers and sellers of large blocks of securities can be identified. So you can follow the securities that the professionals are dealing with by following the events reported in the media.

The trader can broadly size up institutional direction by comparing activity of the reported averages of stocks the pros deal in. For example, those in the Standard & Poor's 100 Average, The companies in that group are much larger than those than in the Standard & Poor's 500 Index.

Important: The strategy ought to be solely for use in the purchase or possible short sale of securities, as indicated from watching the institutions. The latter may have no disciplined program for the sale of what they have bought. Their sale may be decided only on their subjective thinking at any given time.

Pros/Cons

Advantages
Institutions make the market by triggering market prices. It's helpful to
Institutions often get research department input before the general public.

Disadvantages
It is hard to expertly decipher institutional action. Moves may have little
Traders cannot follow the institutions blindly. as they are often slow to
They are not able to sell huge holdings quickly enough, despite the use of block trading, They may be tipping the market action too soon.
Institution-watching can be a pitfall when they all try to sell at the same
The trader may over-trade when emulating them. Typical large portfolios
Traders have different tax environment than institutions.
Institutional favorites are relatively higher priced.

Trade a Stock that Institutions Do Not Follow

Background

Some make it a practice not to buy a stock in which institutions are currently interested, while still others set a limit on the extent of institutional holding in the stock.

One example of a guideline to follow: Trade no stocks where more than 10% are institutional shareholders. (The percentages are listed in the widely used stock guides, which list the total number of shares or percentages of holdings by these major players.

The prime idea behind this strategy is to make purchases before heavy demand from mutual funds, pension funds, insurance companies, trust companies, etc. will lift the market. The objective: Let the institutions come in when you are ready to get out. Market levels will be buoyed by that time. The result will be higher price/earnings levels, which often is a factor in a trader's outlook.

If a trader does not want to be restrained by capitalization restrictions, as are the institutions, there is no alternative but to invest in what those the latter must avoid. When you have millions to invest, many of the smaller good buys, must be passed by for technical reasons. Some money managers deal only in blocks of 50,000 shares or more and small stock issues just cannot meet this requirement

If a trader does not want to be confined to trading dividend-payers only, then smaller companies will more likely be on the menu. Institutions cannot hold such stocks

Another goal is to avoid some of the disadvantages that accrue to participating with the big investors/traders The large shareholders throw their weight of numbers into the market, and the resultant action may be more than traders can stomach.

In addition, some believe institutional money managers do a relatively poor job, They would therefore want to make their own market decisions. Note: Those who follow the institutions cannot be automatically wrong, while those who avoid institution-like issues automatically correct. Each strategy has its good and bad points. The differences lie in the way the strategies are pursued and the accompanying discipline maintained.

Pros/Cons

Advantages
Because institutions must shy away from smaller, more thinly capitalized companies, the whole area is left open to traders who deal in smaller numbers.
Avoiding the mad rush of professional favorites, buying and selling helps prevent damage that can ensue when markets are as sensitive as they are.

Disadvantage
Smaller companies that have no or little institutional following will require more individual attention by traders. Analysts will not be as attentive and the markets may not be efficient.
Smaller companies are generally more speculative, a risk/reward equation the trader ought to weigh.
Companies with less capitalization or with thin floats offer hazards, to traders with a smaller number of dollars to commit to the market.

Trade a Stock with the Company Insiders

Background

Corporate insiders are different than “smart money” investors. The latter are on the outside, looking in, seeking special situations. The former are, by SEC definition, top officers, directors, large stockholders (who may have been holders for years), accountants and even secretaries to top officers.

On balance, corporate insiders sell more than they buy of their company's securities. Much of what they buy is a function of their stock option programs. Therefore, a ratio of insider buys to sales is normally about two to one. This is true of studies of an individual company or of the overall market.

A ratio of more than two to one is considered bullish, both for the company or the market. Under that ratio, the signs are bearish.

Heavy buys are more significant, especially if they are made on the open market, rather from corporate option exercising. That means company insiders are highly optimistic, or there may actually be a bid for a takeover, or the company is ready to build a defense against a prospective takeover.

Heavy sales are not always noteworthy. People often sell to meet personal demands for funds, for college tuition, home purchases, and so on. Observations are never cut and dry.

Also noteworthy: The percentage of a holder's shares sold, and how much is left, as well as repeated transactions that color the statistics, The amount paid under options, if they are decidedly less than the market price, will also influence the usefulness of the figures.

Furthermore, insiders are not always good market forecasters. They may be too close to operations, to take any devil's advocate view of the corporate future. In fact, studies show that management's forecasts are not that much better than analysts. If this insider technique invariably worked, there could be no end to the ways manipulation of the markets would be employed by the dishonest.

Note: The number of insiders buying or selling, is more significant than is the total volume bought or sold. For instance, blocks of stock may be sold by executives, to help pay off loans with which previous stock purchases had been arranged. Shares may be sold by individuals for tax reasons at year end. At the same time, institutions may be selling stocks for little reason than to “dress up” their portfolios for annual reports.

Caution: The ability to make money on such buying/selling is predicated a great deal on the speed with which the information can be gathered. Insider buying and selling is stale information by the time it is published by the SEC and data base services.

Pros/Cons

Advantages
Surveys show that insider transactions generally provide some clue to what a company's market fortunes will be.
More excessive insider selling can be a bearish sigh for a company's securities, while heavy buying can be a sign of bullish prospects.

Disadvantages
Insiders may miss important turns in their company's fortunes, as they may be too close to get proper perspective.
Information derived from SEC filings on buying and selling may be too late for significance.
Statistics must be evaluated fully because of influences that may have inordinate effects on the usefulness of the interpretations made.

Trade a Stock with the Smart Money

Background

Smart money people buy into companies for the long term, or for prospective takeovers in the near future. They are not necessarily wheeler-dealers, but may be simply seeking undervalued opportunities that can turn a handsome profit. And following these people is a valid strategy.

The plan requires patience. The purchase differs from the quick takeover of the risk arbitrageurs. Instead, these investors, just as the man in the Street, can fall in love with their holdings. They may have taken time to get a better idea of what they are buying but some may buy on whimsey just as smalltime investors do.

Some may look to market-neglected issues, which they feel are too low priced. Corporate assets may be far undervalued. In additional many of these investors tend to dollar average to get costs lower if the market temporarily turns against them.

Any holder of 5% or more of a public company is required to complete a 13D form with the SEC inside of ten business days. Further changes of holdings must be also reported. Holders of larger amounts have to give details of their intentions. Holders of less than 5% may file if they wish.

There may be reasons why such buyers want the public to know of their intentions to buy or the fact they have already bought the stock.
Those who have a reputation of past success will draw a crowd on their shirttails.
Those whose actions have burned the public will alert the public to their presence as well.

Those who have made “sweetheart” deals with management for greenmail in the past will also be duly noted by the public.

Studies show that on balance investors do profit from these situations. Caution: When smart money bails out of deals, it will be done quickly and perhaps not on the open market. This may impair the market and leave no time for the smaller investor to get out without getting hurt.

Pros and Cons

Advantages
The average investor gets the benefit of the studies made by the smart money investor
Such situations often lead takeovers which can be profitable.

Disadvantages
The small investor is always at the mercy of the “smart” investor and can be easily hurt because their aims may often be diverse.

Intrinsic Selling Character (of the Group)

You buy the security because others are doing so, according to your strategy. Your plan is to sell when that reason is suddenly reversed. Apart from that, your guideline should consider an option made in advance, for a sale if there is a major reduction in market value from a predetermined market high while you have been a security holder.

M-632-CZ

Trade the Feel and Quality of the Market

Background

There are a number of strategies that involve moods and sentiments with regard to the market direction.

Trade Market Direction

Background

Some traders like to seek and smoke out market direction to follow. This strategy differs from the bellwether stock selection, as one example. Bellwether stocks retain their characteristic in all markets and often for years on end. Market direction moves faster and is more changeable.

This strategy is more concerned with the market leaders of the moment, whether it be an individual company or possibly the industry. And it may be very short-lived leadership.

One or two industries generally lead any market, up or down. The same is true of securities. The latter may not have been very significant in the market for weeks, months or even years. But at any given time they may pick up the pack on the up or downside. When they do, they pull similar companies in the same field along with them.

Traders like to call this phenomenon “leadership” (At least on the upside). When there are no leaders around to speak of, traders become wary. They feel the market is not moving fast enough for a profit spread to be utilized.

Market leadership derives from several factors:

1) A takeover in an industry will spotlight the possibility of other takeovers in the same industry.

2) Fortunes in an industry may improve (or get worse) because of economic or fiscal influences. Lower interest rates, for example, may improve profit outlooks. Or sharply lower profits the downside.

3) Increased profits or sharply lower profits by one company in an industry may signal the same for others in the same business.

There is a psychology imposed on the trader who watches for market leaders on the up or the downside. Because market leadership is always fleeting. Trading sophistication is needed as well as attentiveness.

Pros and Cons

Advantages
Profits can be made trading only with distinct market moves.
It is easier to trade stocks already highlighted.

Disadvantages
Market leadership is fickle. Selling flags must be highly sensitive.
It is easy to get whiplashes using the strategy because it is subject to fleeting moods and sentiments.

Trade on Transaction Incentives

Background

When two parties make up any securities market transaction, one is usually more motivated to make the deal. The extent of disparity or motivation between buyer and seller will furnish a clue to the sentiment of the market for a security. This phenomenon holds as well for the entire market.

If a trade takes place on a price uptick from the previous price, the buyer has thus shown the motivation to pay more to make the deal. If the trade takes place on the downtick, it is the seller who was motivated to get less in making the deal.

When the SEC researched this using 10,000 share block trading a number of years ago, it agreed that this observation was correct. When trading on the uptick predominates, there is a “positive” flow of money into the market. When trading is mostly on a downtick, the reverse flow is true.

In other words if you calculate the dollar volume of shares on the upside and for those on the downside, you get a positive or negative amount that will indicate the flow of funds. And the investigation will hold true for securities, industry groups, stock types or the overall market.

Looking at upticks and downticks by themselves without volume comparisons could be misleading. The stock tables may show little or no change in the price of a stock from day to day. But comparison of volume on the upside, as against that on the downside, can show a one-sided degree if incentives to buy or sell.

Pros and Cons

Advantages
Sufficient evidence shows the method works as strategy

Disadvantages
Considerable time is involved for the average investor to use.
The raw numbers in themselves will not be too sensitive and require further investigation.

Buy a Stock to be Placed on a major Index such as the S& P 500

Background

Stocks to be put on the list are in the limelight to major a degree. It takes some ability to get placed in terms of size. And the fact it is being considered is a public relations coup.

Generally the stock gets stronger in the market when it is being considered or actually placed. The idea is to be able to anticipate the placement which is sort of an inside transaction which borders on legality issues if you happen to be close to the actual consideration. In other words, if you are in-the-know, you may not be legally allowed to act. On the other hand, if you have deduced probabilities from rumors and what you may have read, you can act on that.

Pros and Cons

Advantages
Sufficient evidence shows the method works as a strategy

Disadvantages
Considerable time is involved for the average investor to use the strategy consistently.

Intrinsic Selling Character (of the Group) Follow the guidelines you have pre-established for buying and for selling and stick closely to them. Apart from that, your guideline should consider an option made in advance, for a sale if there is a major reduction in market value from a predetermined market high while you have been a security holder.

M-633-CZ

Trade Commodities

Background

Trading commodities opens a wide variety of opportunities of profit, with a selection of specializations to fit particular expertise.

Trade Precious Metals

Background

Buying and selling precious metals such as platinum and similar, highly valuable industrial use raw materials and ores can be part of excellent trading strategies. Their values are linked to industrial demand more than they are to their function as collectibles. In fact, some are essential to the defense industries and to high-technology companies.

Any changes in demand from industry or supply can create trading situations. To complicate matters, most of the supply comes from outside the United States.

A major problem with gold investment is that there is no way to come up with intrinsic value. When buying stocks, if you buy on what we call a corporate mode basis. There are basic truths about the company on which you can set value. If a company makes $1 a share, you can derive some measure of worth, no matter what prevailing price/earnings values are in fashion. But with gold there is no way to establish value except for supply and demand forces. While supply and demand is also important in getting at market evaluations for stocks, the ability to generate earnings and dividends does supply useful parameters.

When it comes to bonds, the fact a projected interest payment is due helps create parameters of value. Prevailing interest rates will be the deciding factor. Still, with bonds as with stocks you are way ahead of gold in your ability to set pricing standards at any time.

Trade Gold as it Relates to the U.S. Dollar

Background

Conventional wisdom holds the following adage to be true: Gold prices generally rise when the dollar is weak and fall when the dollar is strong. That is due to the fact that the U.S. dollar has become an international standard of value. Foreigners usually will hold dollars or gold just as readily. In fact, it may be easier to hold the dollar in order to spend it, though it is easier to hoard gold.

Having said that, let us look at the actual causes of gold rising or falling. It may have little to do at any one time with the pricing of the dollar.

The dollar does get weaker or stronger to a degree in opposite moves from gold but the price of gold is also subject to the supply of gold. When it comes on the market in heavy volume, the price will weaken no matter what the dollar is doing. Russia and South Africa are big gold exporters because they are big producers. If they need money fast and sell more than usual, the price will be weaker.

Interest levels in the U.S. have a lot to do with the demand for dollars. If that is up, gold will be relatively weak. The foreign currency markets are also tricky.

True, gold gets more valuable if there is a war overseas and it becomes a haven for awhile, rather than dollars, if the U.S. is involved.

Trade Commodities to Diversify Stock Holdings

Background

There is an underlying theory and contention that when the stock market gets hit hard and prices fall, commodity markets will rise in price. The theory holds that it pays to keep a percentage—perhaps 10%—of your portfolio in commodities, as a hedge. However, this does not always ring true in practice.

One research project over twenty five years showed that a mix of holdings: 54% common stock, 36% bonds, and 10% commodities would have reduced risk and also increased value. The compounded growth would average 10.3% a year, compared to a portfolio that was 60/40 stocks to bonds and no commodities. In bad markets, which occurred seven times, the commodity-enhanced portfolio would have had an average loss of 6%, versus 10% where no commodities were used.

Many hedge bets with commodities that go up when the stock market goes down Of course, many investors believe they already are doing this when, for example, they divide their assets into three parts; stocks, bonds and cash.

In the search to cut long-term volatility and produce good results, some investors have focused on small-cap stocks, international equities and real-estate investment trusts to diversify. The theory is that these often move in a direction opposite to such indexes as the S& P 500 and the bond market.

Intrinsic Selling Character (of the Group) Inflation and deflation are an essential part of the buying/selling points to consider in commodity trading. Directly related to this fact also is supply and demand, Look to the specific indicator strategy that should be your guideline for your purchase and let that be the selling guide as well. You must be alert to the indicator signs you choose because the indicators involved are very sensitive.

M-660-CZ

Trading Corporates and Corporate Derivatives

Background

Corporate stocks and bonds and their derivatives provide a wealth of longer-term and short-term trading strategies. The different characteristics of the securities are put to good use:

Trade a Convertible Bond for Appreciation/income Hedging

Background

Convertible corporate bonds provide income and the chance of conversion into common stock. Should the common's value rise, that conversion or “strike” price will provide capital appreciation.

Convertible benefits include:
Higher cash rel
Relative safety
Bondholder pre
Leveraged ber

The strategy entails consideration of several factors. These must entail market features of the bond and of the common stock, in addition to the condition of the overall market and the present and future state of the economy.
The yield diffen
The conversior
The likelihood t
The volatility of
The maturity d
Call features w
The bond's cre

Convertible bonds move to an extent with prevailing interest levels. Primarily action parallels the market of the corresponding common stock. When the conversion price is close to the common's market, price becomes all-important. When the conversion price is a distance away, interest return is more in command as a trading determinant.

At times of rising interest rates and diminished stock market following, convertibles tend to look more like bonds than the hybrids they are. As with any bond, higher interest levels translate into lower market value. In other words, when interest rates are generally high, and the common markets weak, a trader can lose at either end of the strategy's equation.

Traders who have doubts as to which way the market and the economy are heading, can use convertibles of companies with cyclical performance. Convertibles can also be useful for hedging takeover possibilities.

Pros/Cons

Advantages
The trader gets the best of both the bond and the equity markets.
Convertibles are a hedge for markets moving sideways.
   Disadvantages
   The trader will
   Those who hav

Special Note: Selling flags must also take into account the dual personalities of convertibles. Selling on the basis of the conversion should be set up as if you are holding the common stock. When conversion is made, the selling flag will be in place as if you were ready to sell the corresponding common stock, even though you do not actually own it.

However, while the bond is being held, and the bond is in no way near the conversion point (and may never be, for that matter), look to interest rate levels as your standard.

Trade High Dividend Stocks

Background

Picking a high dividend stock can be tricky. That is because companies may reduce their dividend for any number of valid reasons which may have little to do with not earning enough to pay it. They may feel they are better off using the funds to reinvest in the business. The fact they have to pay taxes on income in order to distribute the dividend may have more than a passing influence.

So in picking a stock that is already paying a high dividend or may be ready to do so, you must have some intuition as to what management is thinking. In some cases it is not hard because the dividend is so entrenched, it has become part of the corporate scene.

The amount of pay out is important. If it is too high, there may be future problems. And if the company is going on an acquisition binge the dividend may also be in jeopardy.

As a trader you can also trade for a reduction in the dividend, should it appear to you that the dividend is too high to be continued and that it may be shortly reduced or discontinued.

Intrinsic Selling Character

The sale of the security must be the reverse of what strategy prompted the purchase of the security.

Also, the purchaser may choose an option to sell, in advance, if there is a predetermined fall in price from a predetermined market high.

Trade a Stock Resistant to Inflation

Background

The best way to select securities that are inflation-resistant is to keep away from corporate structures with huge amounts of debt. To hone that point further, keep away from stocks where the companies have to periodically refinance their debt. Longer-term debt at fixed cost is acceptable; liberal call features on bonds are a saving grace; shorter-term debt can be a noose ready to do its damage.

High prices, by which inflation is recognized, has a bearing on the strategy, of course. However, the basic factor that hurts or benefits a company during an inflationary spiral is the extent of ability to withstand the higher interest rates that go with inflation.

True, a company may be able to live with higher interest costs if its inflation-enhanced revenues outpace costs. After all, the real cost of money (interest rate less inflation rate) is the bottom line. Nevertheless, a common denominator in selecting an inflation-resistant stock is the relative interest cost of corporate debt structure.

Right behind in importance is the ability of a company to raise its prices to keep margins intact while operational (as well as interest) costs rise under inflationary pressure. Where costs cannot be passed along due to competition, the going can be rough. Until recently, the cost of energy was a major cost worry for many manufacturing firms. Transportation companies, particularly, benefit with reductions in the cost of fuel.

A few of the industries that can do well during inflation, provided corporate debt structure is not onerous.
Food and nonfood retailing
Beverage producing
Food and lodging
Office equipment
   Pharmaceuticals
Tobacco producing
Oil drilling/services
Transportation

Caution: Many companies in the above-listed groups may do extensive business overseas. Pharmaceutical firms, for instance, derive much of their sales and earnings from foreign markets. When inflation is relatively high in this country, and interest rates are accordingly steep, the flow of funds from overseas into the U.S. can make for a very strong dollar. This will translate into lower overseas earnings, as expressed in dollars in this country.

Pros/Cons

Advantages
Ebb and low of inflation produces viable trading opportunity.

Disadvantages
Misused strategy will result in impetuous trading and out, with lack of discipline.

Trade a Financial-Problem Stock

Background

The first instinct of a trader, and certainly a longer-term investor, is to avoid companies with problems. With so many around that have alluring prospects, why bother with anything less than best? This line of thinking is particularly the case when there are corporate financial problems with which to contend. Companies with poor balance sheets, with insufficient working capital, and loaded with debt, are always avoided by investors in the corporate mode.

That is as it should be. These companies are not yet in the bankruptcy courts.

They have not yet voluntarily petitioned the courts, nor have they been forced to enter them by creditors. Companies already in the bankruptcy courts are protected from creditor harassment until possible corporate reorganization may be effected. Instead, these companies appear to be in financial straits, and may possibly end up bankrupt.

Those who buy and sell using the moods and sentiments of the trading mode, can be just as skittish about dealing in stocks with backgrounds of financial headaches. Yet, such stocks can make beneficial trading results.

The companies can be recognized by an assembly of financial problems that scare many investors and those seeking windows of trading opportunity:
A poor marketing picture
Ever-narrowing profit margins
Negligible or nonexistent earnings
Poor cash flow
Working capital impairment
Steep corporate debt structure

Still, some traders may see in this bog of problems a way to profit over the shorter-term, and possibly longer. The marketing difficulties can be temporary, and profit margins can always turn with a better revenue base. Earnings and cash flow can improve. The straitened working capital position may return its vigor once marketing, sales, and earnings are returned to health. Valuable intangibles and tangible assets may be able to resolve the debt crisis.

What is important in the use of this strategy is the fact the company ought to be safe from at least imminent bankruptcy. Many companies present a poor financial picture and are avoided like the plague. They are not ready to throw in the corporate towel and are far from being forced into bankruptcy.

Their securities may have been oversold, or laggard. They are relatively good selections for a trader who can see market turnarounds within this pessimistic market indulgence. Trading plans can be designed with conventional selling flags, as a means of protecting against much further market weakness.

Note: Where a trader feels there is imminent bankruptcy, these stocks become excellent short-selling transactions. Once a company is in bankruptcy, markets may remain sluggish for a considerable period. Trading within the context of Chapter 11 proceedings may be inadvisable.

Pros/Cons

Advantages
Stocks of financially- ailing companies are attractive vehicles for both long and short market positions.
Suitable selling flags can protect a trading position from excessive market deterioration.

Disadvantages
If the stock's market remains sluggish, the time frame may be intermediate and not as short-term as some traders would prefer. Unless suitable selling flags are used, a trading position could lead to a time-consuming court proceeding, with a tying up of trading funds.

Buy a Sound Company's Stock When there are Heavy Losses

Background

In this strategy the company's position is strong. Their marketing picture is satisfactory. Their profit margins adequate. The earnings and cash flow competent enough to suit their ongoing operations. Their working capital comfortable. Their corporate debt reasonable. The market perception only has been affected.

What has caused their heavy losses may be:
A write off of a business operation, division, or subsidiary that had been a money-loser for them.
The sale of a division or subsidiary, requiring the write-off, on the books, of the values held for that division or subsidiary.
A write-off of assets or inventory that management feels is not worth what they are listed for on the books.
A charge that has to be made to reserves. This can be the case with insurance companies or banks, who have to beef up their reserves due to regulatory and business reasons.

When billion dollar activities mark big business write-offs of huge proportions are no longer rare. The general public and much of the Street often view these staggering sums and are influenced by the weight of the numbers. Psychology aside, the picture may not be as grotesque as it does on first blush.

Write-offs or one-time heavy losses can generate profitable trading on the long side or the short side of the market. The use of either will depend on:
Whether the trader is in the stock already or is thinking of making a transaction.
The enormity of the psychological damage inflicted on the stock
The time the trader thinks it will take for a rebound.

In a very short time frame, the trader may be inclined to think in terms of a short position, either hedging any stock already owned, or on a conventional short sale basis. At the other end of the time spectrum, a trader may not want to take a substantially long stance. A long position here would be designed with sensitive selling flags. This would aim to take advantage of a possible sharp but quick rebound.

Note: Despite first impressions, there is really no contradiction of strategy involved, using the same strategic premise to short or long the stock, whether or not the trader is already a shareholder. The importance is in the decision for a choice in either direction, plus the selling flags to frame the objectives that were chosen.

Pros/Cons

Advantages
Heavy-loss, but sound-company strategy produces useful profit potential, when such planning is properly designed.
Selling flags can direct proper strategy.

Disadvantages
Misuse of a disciplined objectives and selling flags can prove costly.

Trade a Raw Material Producer's Stock.

Background

The cost of producing and processing ores and allied raw materials is a factor in the economics of inflation and deflation. Product demand for what they produce is an ingredient of inflation or deflation. The economy looks to these raw materials for a source of low cost supply.

The raw material producers are at the opposite end of the rooter's grandstand. When their product is priced low enough to please the rest of industry and the public, they have their probable buy signal. A low selling price for their product and horrendous losses. This generally happens when a recession is on and demand is low for their products. Raw material producers can be in other industries, such as steel, paper products, and oil and gas.

Raw material producers in the mining and ore field have even a worse time of it. They must then cut their costs to the bone in order to survive. Not only do they have a domestic problem but their foreign competition with lower costs, can be a major ongoing problem: Only a few domestic raw material producers can cut costs enough to remain in the black when demand for their products is off.

These companies need not be the mining producers but processors just a step or two beyond the basic sources. they are all in the same boat. It is a sign they can also add to prices without too much concern from their customers who then are more interested in getting fast supplies than perhaps just prices. The hope of these producers is a turnaround in the economy and worldwide industry.

Raw materials producers have a big advantage during a turnaround in the economy. They then command the power of pricing. They can pass on higher prices when the economy is booming, just as they have to cut when times are bad.

Pros/Cons

Advantages
When raw material producer cycles are available, it is easier to trade the stock of the companies.

Disadvantages
Trading discipline is often misused especially when time comes to sell the stock because the industry may be at the top of its economic cycle.

Trade a Cyclical Stock

Background

Selling flags must take into account the dual personalities of convertibles. Selling on the basis of the conversion should be set up as if you are holding the common stock. When conversion is made, the selling flag will be in place as if you were ready to sell the corresponding common stock, even though you do not actually own it.

However, while the bond is being held, and the bond is in no way near the conversion point (and may never be), look to interest rate levels as your standard.

The specific flag should depend on the nature of the bond, the time frame for conversion, and other market-related points. A trader ought not to use a highly sensitive interest indicators that will blip out the trading position too easily, if the primary interest was in conversion and not the holding as a bond.

Industries are often materially affected by the varying shades of economic cycles. Few can do as well in one environment as in another. Some are subject to booms and busts at regular intervals.

The ore mining industry is a perfect example of what occurs when the economic slump gets bad enough for severe cutbacks in commercial activity, or when there simply an overproduction of supply. Copper and other metal ores, for instance. The basic or heavy chemical industry is not quite as sensitive to worldwide economic and supply conditions but it is similarly dependent on cycles. The so-called “smokestack” industries, such as steel and heavy equipment are similarly effected.

Financial institutions which rely on earnings on the spread between the cost of their funds and their lending charges, closely rely on lower interest levels to increase profit margins. They depend, too, on stable or growing demand for loans. A weakening of the economy can mean less revenue, despite wider margins.

There are inflation-oriented and also disinflation industries. One booms with inflation because costs are relatively stable while revenues grow dramatically with a rising price index. With a diminishing of inflation pressure, others find their stable or slightly lower costs of doing business does not square with reduced revenues. Inflation can cover up lots of managerial errors.

The disinflation companies are the utilities, banks, insurance companies. Food processors and retailers benefit from lower costs.

Turnarounds are sharpest where there is overcapacity. Higher margins are quickly possible. A cheaper U.S. dollar for multinational companies can make a sharp reversal in prospects. In short, the rebound comes from a directional change in problems that had caused the industry recession: Overcapacity, high interest rates, poor exports, expensive U.S. dollar, high inventories, low commodity prices, high competitive imports, and any number of causes.

All make interesting trading opportunities because of the timing and comparative speed with which securities weaken or pick up market. strength. Market activity when earnings turn down is often predictable, but securities prices do not exactly move in exact relation to actual or expected enhanced earnings.

For a company to bounce back, the financial picture must be reasonably healthy. Each serious economic downturn weeds out the financial weaklings. Changes may make an important line of products obsolete or may produce alternate products to heat up competition for such producers. For them, there may literally be no tomorrow.

The smokestack types cannot stage a comeback unless the Gross Domestic Product rises sharply. The machine tool group and heavy equipment producers may find many turnaround companies have no need for massive new tooling or new industrial equipment. Not yet, anyway. It could take time before an economic upturn can help them. What may be good for overall industry may not immediately translate into prosperity all-around. Pockets of recession will persist. It is only when the boom has been underway for awhile that these depressed industries begin to get out from under their recessionary doldrums.

The markets have moods and sentiments for each cycle, for each industry, for each company within that industry. Prices of some stocks, for example, may rise at the first hint of a turnaround. Companies may still be in the red, but it is the hope of the rebound that the stocks have taken off. Institutions who are picking and choosing one group, then another, may have decided to buy into the group in advance of reported pickup. In fact, the institutions may well desert the stocks after the favorable earnings have been reported. Traders may look to convertibles for market insurance. Some studies have shown there to be six stages of the business cycle. The typical cycles have run about four to five years but this can range over the lot:
1 Deep Recession—when bonds are the best opportunity.
2 Recession but Somewhat Upbeat—when stocks may be good buys
3 Upbeat Recession—when commodities may be good buys
4 Expansion—when bonds still have room to rise but with caution.
5 Top of expansion—when stocks and commodities may begin to peak
6 Going Close ot Recession—defensive stance

In short, every cycle has an identity of tis own. What makes the strategy attractive is that it provides wide swings on which to trade.

Pros/Cons

Advantages
Cyclic stocks provide wide market swings and profit potential

Disadvantages
Attempting to guess the bottom and top of a market will impair trading potential.

Buy a Stock After the Company Has Declared Bankruptcy

Background

There are many investment bargains in bankruptcy. Provided you buy into them after bankruptcy, not before. You can buy common stock or convertible bonds or preferred, that can eventually give you common stock.

There are some risks nevertheless. But many of the risks can be offset when investors diversify. They also reduce risk by looking for bankruptcy situations where the company is producing cash flow. There has to be cash flow to pay off creditors, albeit not 100 cents on the dollar. The key to evaluating a bankrupt company is not earnings, but cash flow. (That is earnings plus depreciation and amortization.)

You also look for a bankrupt situation with assets that can fetch a good price if sold off. It's an investment procedure that takes patience. And discipline to pursue that patience.

Trade Overall Market Specialization by Indexes

Background

Some traders avoid buying and selling individual securities. They feel there is an added complexity in attempting to fathom the market's moods and sentiments can do for any one issue. By turning their attention, instead, to the overall market, such traders believe they can focus more on a complex but broader picture.

The economy, the flow of funds in and out of the U.S., the value of the U.S. dollar, the movement of interest rate levels, all combine to make their mark on the stock and fixed-income markets. It is almost impossible to really make heads or tails significance from them. To add yet another layer of confusion, is what industry-only traders hope to accomplish.

Whenever a trader tries to time the purchase of an individual security in a large portfolio, the entire market is, in effect, being time. Especially so, when portfolio models are employed This is usually not the case with those who manage smaller portfolios.

Buying and selling the market is simple. Stock indexes, index options and index futures contracts present an assortment from which to choose and finely tune strategy. Those interested in a cross section of blue chips can choose the various indexes can referring to the financial media for guidelines.

Many have been devised by a variety of financial organizations. Standard & Poor's 500 Index options, or the Standard & Poor's 100 for even more selective blue chips. The Major Market Index can provide the 20 bluest of the blue. The Value Line Index has 1700 stocks that cover the spectrum, unweighted, and include over-the-counter issues.

Those who seek overall market representation by industry, are able to trade indexes that are confined to popular groups.

Caution: Index, option and futures contracts are not easy for the average trader. Some aspects of their use are even more complex than others. Whatever one finds complex in the market, ought to be avoided. It is tough enough to profit from securities when one feels he or she knows it all.

Index mutual funds can be a way of getting the market's average performance They are designed to represent the holdings of the index they are using as their benchmark. Aside from just offering no more than average performance, something that makes sense when money managers do not achieve that, the index funds save from a reduced amount of in-and-out trading.

Sector mutual funds are a means of trading a variety of industry groups without having to pinpoint a particular security.

Pros/Cons

Advantages
Overall market specialization peels one layer of confusion from the determination of selections for trading.

Disadvantages
Trading overall markets is no panacea for avoiding securities market confusion.
Avoiding individual securities for trading runs counter to scores of strategies that are applied to cope with erratic market moods and sentiments.

Trade a Stock Index for Leverage

Background

Instead of buying the overall market with a portfolio of different stocks in various industries, a trader can duplicate general market activity with a stock index. It would take a sizable list of round lots to simulate a comparable cross section of the market, and lots of money with which to do it. With indexes, you have the whole market, or a segment of it with minimal capital outlay.

Varying index characteristics color the use of each. The trader can select a small section of the market Inasmuch as there are many overall markets: blue and not-so-blue chips, average listed companies, more speculative companies, both listed and over-the-counter, it's easy to pick and choose.

How to get started? There are so many, the best suggestion is to look over a list of all that are available for purchase on the various exchanges. Look them up in the financial newspapers or get listings from your broker or over the internet. Start with the Standard & Poors 100 as an example. It is an index representative of the 100 largest companies in the U.S.

The so-called second tier issues may react to a totally different tune than do the bluer chips. The Standard & Poors 500 will include the second tier because it has 500 of the largest corporations in the U.S. represented.

Smaller traders can snuggle up to, or stay away from the institutions that control so much of market volume. Judicious use of indexes. is the answer to any decision to get close without fears of being trampled. This is done simply by choosing those which represent larger and smaller segments of the economy in the U.S. and even overseas.

Pros/Cons

Advantages
Stock indexes help fine tune a trading objective because each has some market definition that is unique from another. Indexes permit trading in market representation, with minimal capital and more ease. A basket of stocks would have to be bought to parallel the market.
Interesting arbitrage opportunities are always available because of the arcane alternate markets that open up.

Disadvantages
Stock index trading is highly complicated by its variety of choices, making it a specialty for the sophisticated only.
Arcane alternate markets are too complicated even for some professionals who are not specialists in that particular type of transaction.

Trade a Stock Index as a Hedge in Trading an Individual Stock

Background

Traders try to hedge their positions in several ways. Hedgers are wary of adverse overall market reversal whenever they buy an individual stock As bullish as they may be on a specific issue, they can be hurt by whole- market sentiment that can about-face in a minute.

Or, they may be ready to short an individual stock, but sudden market euphoria can instead boost that stock's performance. What should have been a weak prospect could become stronger; remember the old adage about a rising tide lifting all boats.

Stock indexes, in an opposite-trend orientation, can be a hedge against such unwanted market influences. When shorting a stock amid concern that the market itself may be too bullish, a trader can buy an index. When buying a stock for a long position, the trader may use indexes- related techniques, in a way that affects a short position. A bad turn in direction desired for the stock can be overcome by the alternate trading action.

Many traders believe it is easier to pick a whole market's direction than that of an individual stock. They are dealing with a broader strategic brush. So, if they choose a stock for a specific goal that may not be reached, they get added assurance that any error will be offset, at least to a degree.

Interestingly, option volume and pricing can given indications of insider knowledge of impending takeovers. Although it is illegal for insiders to trade on information that is not available to the public, and the SEC cracks down on offenders where it can, the practice is prevailing. A pickup in volume in a smaller, specially- hone index or subindex can alert a trader to some potential takeover possibilities involving one or more stocks in that index.

Often, the price spread will widen between futures contracts on, for instance, the Standard & Poor's 500 Index and the traded index. Traders will then sell a few stocks included in the index, and buy the futures contracts. Other times, a trader may sell futures contracts short while buying a selection of index stocks. (This has been called “basis trading” and has lured speculation where, potential profit margins are narrowing). Naturally, this game is for the most sophisticated professional.

Pros/Cons

Advantages
Index/individual stock hedging is made available in ready-to-use form.

Disadvantages
Index hedging is highly sophisticated and extremely difficult, even for the most astute professional.
Many aspects of trading represent a zero sum speculation.

Trade a Debt-Laden Stock in Inflationary/Deflationary Cycles

Background

Trading opportunities develop with changes in the degree of relative inflation and deflation. The rise in fall or consumer demand is one factor; business loses some of its steam during deflationary turns. That picks up with renewed inflationary pressures. Consequently, the cycle repeats.

But also, interest rate levels adjust to each arm of the cycle. When inflation is rampant, interest rates go up. There is no other way to attract fixed dollar investments. Furthermore, the Federal Reserve Bank will use its influence on interest levels to dampen inflationary impulses. When inflation begins to cool off, interest rates come down. Smaller fixed income returns begin to look better. The Fed lightens up its reins on the economy.

Common stocks of debt-laden companies feel the direct impact from such moving cycles, in terms of business and the cost of carrying debt. They often feel the burden in not-so-obvious ways.

One possibility: Where interest costs are fixed, the relative cost of debt service goes up as inflation goes down. Debt cost of 10% a year is not high when inflation is running at 9% and more a year. If debt cost is still 10% a year, but inflation is at a 4% rate, the company could be in trouble. They may need ever-higher revenues and profits with which to make up that cost differential in a competitive world. They may have been achieving it during rampant inflation. Their fixed debt may therefore have been comparatively benign.

In deflationary economies, fixed cost can be unbearable if revenues suffer, and if interest rates do not fall fast enough. Debt cost of 10% a year is simply too high if inflation is running much less. So, what Wall Street may perceive as a boon to a company may actually be a hindrance. Yet, some industries (e.g. raw material production) may actually suffer as inflation rates go down. Their product commands less in the market, while their debt goes higher, in terms of real cost.

As soon as interest rate levels subside in a deflationary cycle, companies with substantial short-term debt will try to refinance their borrowing, and those with longer-term debt will call it in for redemption, if at all possible. Those who are stuck with long-term, high-cost debt they cannot refinance can be in serious trouble.

Debt-laden companies therefore present a strategy that depends on the rate of inflation. Each security may feel the effects differently, in a rise or fall of the consumer or industrial price index. Some are in more debt; some have debt hard to refinance Others are not able to enhance revenues and earnings. Those companies who are able to temper or accommodate these problems can overcome the cycle effects.

Traders can select issues for long and short-selling positions, as the problems are perceived. At the outset of a trend, some perceptions may be incorrect. The relative risks of being in debt may not come to light until all factors are put into play: Company revenue changes, real costs of interest, and ability to refinance. Interest rate and inflation direction estimates are hard to make, and some industries are too difficult to forecast in terms of changing revenue cycles. The strategy therefore requires close attention.

Pros/Cons

Advantages
Relative interest burdens present real problems during inflation or deflation and can directly affect the market action of a security.
Interest rate and inflation/deflation figures are readily attainable.

Disadvantages
Several positive and negative factors may crop up for each stock, so that a definitive picture off a stock is hard to get.
The strategy requires close investor attention.

Trade a Discounted Closed-End Fund

Background

The funds invest in common stock as a rule, and to a lesser extent, in preferred and bonds. Some specialize by type of security, though this is would not be the usual today. Most of the funds which specialized in specific industries (airlines, railroads, etc.) no longer do so. Many hold a disproportionate amount of their portfolio in a few stocks This is one of the features which distinguishes the closed-ends from the open-ends, or mutual funds, which have to be fully diversified.

The other major difference between the closed-end fund and the mutual fund lies in the capitalization. The closed-ends do not continually sell shares to the public, nor do they redeem shares on demand. The mutual funds sell fresh shares and make redemptions, on the basis of net asset value. The no-load funds have no sales commissions up front. Closed-ends are bought and sold at the regular commission schedules.

When more funds come in than go out in the form of redemption, the mutual funds invest the surplus. The mutuals in today's markets keep growing and have ever-greater available cash. Some have to restrict new sales after their size makes them cumbersome; Still by definition, the mutuals have open subscription lists at all times

The closed-ends are restricted to the original capitalization. They are permitted to sell fresh shares from time to time, but in the manner of any other corporation, after registration with the SEC. They do not pay income taxes if the bulk of their income is paid out to shareholders.

Many closed-ends are bought at a discount from their net asset value Furthermore, discounts have been narrowing because demand has been growing. The reasons: Some funds have converted into the mutual fund format, which automatically brings a discount up to par. Other closed ends with their smaller capitalization and more specialization, move up rapidly as their investments rise in value. Moreover, a rising stock market will move the funds, just as any stock will appreciate. These all explain the narrowing of discounts from asset value

A group of operating companies give much of the advantages of closed-ends, but are not. While they are taxed like ordinary corporations, their investments are made much the same way as the closed-ends, in a limited portfolio of special situations. Moreover, most sell at a discount from their estimated breakup values.

Pros/Cons

Advantages
Discounted closed-ends can be profitable on the basis of several market factors.
The funds offer a managed portfolio.

Disadvantages
As is the case with other managed portfolios, these funds do not make consistent gains.
Discounts are not as liberal as they once were and it may take time for them to regain past levels.
Management costs are fairly high.
They are usually not energetically covered by brokerage firm research departments.

Intrinsic Selling Character (of the Group)

The sale of the security must be the reverse of what strategy prompted the purchase of the security. Also, the purchaser may choose an option to sell, in advance, if there is a predetermined fall in price from a predetermined market high.

M-738-CZ

Trade Seasonal Trading factors

Background

Over the years traders have discovered certain patterns have evolved on a daily, weekly, monthly and seasonal basis, which they claim has value to them as security traders. many may be true while others may be speculative. But they do get a play and work more often than not, according to their advocates.

Trade on Seasonal Rallies

Background

Some traders believe in summer rallies in the stock market. For many years the market has for the most part moved higher in May. The study generally began about May and ended in September after Labor day. But then again every season has been said to have a bullishness of its own. In fact, the winter rally is considered even more robust.

The truth is, the talk about seasonal rallies has to be taken with a grain of salt despite the exuberance of their devotees. There is no consistent pattern. And, it would make little sense if there were two three and four seasonal rallies. Add to that are such additional observations as the January Effect and the October Effect. and then there is no end to the theories. The market would always be going up, if that were the case.

True, there are some seasonal influences. For instance, the flow of funds into IRA accounts which may be heavier just before the April deadline. But there are not very sensitive impacts of this type, if they have an impact of any import.

Trade a Stock on Daily Market Patterns

Background

When there is a massive stock advance or decline toward the end of the trading day on a major exchange, the tendency is for the momentum to carry through to the next day. A decided upwards move or a down move just before the bell is usually extended when the market reopens. (Markets can decline in the last hour as professionals close their trading positions for the day).

Overnight or early-the-next day orders carry the sentiment that had developed the previous afternoon. Unless a special news event comes up to change that sentiment, that trend will feed on itself.

Psychology is such that the public and money managers, too, may ruminate on previous session market action. Those sentiments generally persist, unless severe market overselling or overbuying had caused that mass stock movement.

Trading in most stocks can be done around the clock, off and on formal exchanges even for listed stocks. With domestic trading coast-to-coast and with the world exchanges, a stock can be transacted in some area or another for twenty four hours each day.

Studies also have been made of the significance of market openings. The first thirty minutes after the opening can be noteworthy. The opening and closing trading segments are thus most important for market watchers.

A look at stock volume by the half hour is enlightening for those traders who prefer strategy based on an active market. The first segment usually has the most activity, with the last a close second. From 11 A.M. to about 2 P.M. there is less price movement. The lunch hour is not the time most securities followers place their orders, though it may be the time the nonprofessionals check their prices at their brokers. The segment from 1.00 P. M. to 2. P.M. and possibly to 2.30 P.M. has the least activity. A general review of the market is made by professionals thereafter, with volume building up until the close.

Of course, market generalizations do not always work as predicted. News impact from a company, or an industry, or economic and political headlines, are going to change volume as soon as that information is received.

Pros/Cons

Advantages
Various students of volume trading will take advantage of the pickup that occurs at certain trading periods.
Market sentiment runs in trends, as short in time as a half hour or an hour, or less.
Keeping track of professional position closings in the last hour or previous closing-trend continuations the first thing in the morning, can lengthen trading odds of observers.

Disadvantages
Daily market volume characteristics are often subject to exceptions and outside influences.

Buy a Stock for Trading Before the End of the Month

Background

Studies show the market is a little stronger just before the end of a month and just after the start of a new month. The pattern is not always correct, but odds seem to favor its use.

Statistics permit a honing of strategy: The stock can be bought the last day of the month, and the first four trading days after the first of the following month. The sale is made at the end of the fifth day. If the period ends on a Thursday, traders will sell near the close on Friday.

The strategy can be used for transacting individual stocks, or for industries, or the entire market. For industries, sector funds can be used (mutual funds that specialize by industry), or the several subindexes. (Subject to mutual fund transaction rules). Whole markets can be represented by various indexes from those composed mostly of blue chips to the run-of-the-market types.

The strategy may be adversely affected by any attempt at an automatic sell, though the stock may yet be in an up-trend. It would appear to be more logical to create conventional, highly sensitive selling flags, and use the strategy primarily for its attempt to buy securities at more favorable levels.

Caution: If everybody chose to select the strategy each month, the weight of numbers would preclude any success. Efficient market advocates, of course, maintain the strategy is based on random figures, despite what random walkers claim is insufficient evidence.

Pros/Cons

Advantages
Sufficient statistical evidence would indicate the use of the strategy works on balance.

Disadvantages
The odds for success are not predominantly positive
Wide use will impart a self-defeating aspect to the strategy use.
Unwise use of selling flags may ensue.

Trade The Holiday Effect

Background

Over decades, this strategy has apparently worked reasonably well. It suggests the purchase of a stock about two days before any major holiday. Statistics show the market has a tendency to rise just before. This provides another instance of efficient market fans claiming the statistical evidence is merely a depiction of random walk. Efficient market or not, the traders who employ this strategy find figures on their side.

A day or two before Thanksgiving may thus be a good time for the buy, with the transaction completed by a sale shortly after the weekend is over. The expectation: The Friday-after-Thanksgiving bull market.

There is some logical explanation behind the statistics.
Stock transactions take five days to settle. This time element may have some arbitraging possibilities, vis-à-vis cash settlement. Nuances are vague, but probably sufficient to make some impact on the supply/demand equation behind price determination.
Upcoming holidays evoke a buoying sentiment that could make a more bullish outlook that can sway that supply/demand factor.

There is also a countervailing or contradictory factor, Impending holidays, with many starting their time off a bit early, will also diminish trading volume. This often makes for a sideways market at best. Prices tend to drift with this lack of volume.

Strategy can be used for stock transactions, or for industries (using sector mutual funds, or subindexes), or with various market indexes that run the gamut from the blue chips to the run-of-the-market types

Caution: If large numbers of traders were to select this strategy at about the same time, the concentration of one-sided action would negate any potential success. What may have been true in the past could be almost impossible with everybody on one side of the transaction. The supply/demand equation would be impaired.

Note: The strategy could imply that a special selling arrangement or selling flag will be automatically set for a sale after the holiday. This implementation of sale could be false reasoning. There is no way anyone could be sure when any upward trend will be cut short.

Pros/Cons

Advantages
Sufficient statistical evidence indicates the strategy works on balance.

Disadvantages
The odds for success are not predominately positive.
Wide use of the strategy can become self-defeating as the supply/demand factor is unbalanced.
Unwise use of selling flags may ensue.

Trade Stocks the Third Friday of Certain Months (on Witching Days)

Background

The market has shown a marked pattern for softness during the four days prior to the expiration of options, such as on the Chicago Board Options Exchange. Stock options expire on the third Friday of the month. The survey thereafter showed market gains, as compared to the averages.

Market frenzy is even more evident on the days the stock index futures contracts and the stock index options expire on the same day. That happens on the third Friday of March, June, September, and December. The effects have an impact on the market of the market, individual stocks, their index options and related futures contracts.

Example: The stock index option is the right to buy or to sell popular index (e.g. Standard & Poor's 500 Average) at a specified price and date. The value of the stock index future contract is related to the value at a future date of a traded stock index e.g. that same S & P 500 Average).

The last hour of trading in the index-futures play can make a maelstrom of the market, conventional stock issues included. Money managers attempt to lock in profits they may have been hedging. Short or long positions are taken and there is no consistent pattern that can be blueprinted in advance for the aid of a trading position. Only during the final close out hour or so, can the flow of the market be discerned. Sharp traders who instigate the hedges, and those who can adeptly follow, can make the most of the edging and the resultant volatility.

The statistical evidence on ordinary monthly cycles goes back only to 1981 because that is when additional put and call options were made available to the public. More and more institutional money managers entered the market to arbitrage their trading. That strategy is chiefly useful for stock, index, and other financial arbitrage. Traders who want to buy stock or calls could wait until the day after the options expire; those who want to sell stock or options, or buy puts, or deal in futures, could also wait until then.

On the other hand, the stock index-futures relationships and effects, in March, June, September and December, are so readily noticeable, the exchanges and the SEC have been alerted. Markets can advance or fall all over the tape. Caution: Stock index-futures risks are enormous and are not to be undertaken by anyone without the experience and the funds that are needed.

Transaction expenses for indexes, options and futures are relatively high, while profits can be modest and taxable (unless deferred). So many institutional managers are getting involved, the margins are becoming yet smaller.

Pros/Cons

Advantages
Traders seeking a volatile market can look to monthly patterns brought on by expiration of options.
Those who want even more volatility can look to patterns in March, June, September, and December.

Disadvantages
Markets are extremely volatile.
Experience, with substantial funds are needed, especially if stock index-futures contracts are to be employed.

Trade a Stock for the Day-of-the-Week Effect

Background

Researchers have frequently studied and have found n marvet action. A study of one average such as the Standard & Poor's e rage going back to 1928, confirmed the consistency. The S & P lis^{t}eLn ad Over-containing a smaller sample of stocks behaved differently for some re In one survey the market was off 62% of the time, on Mondays. Thi,ryet had risen 62% of the time on Fridays. Theoretically at least, it would be bette (Cn stocks on Mondays and selling on Friday afternoons. As noted below, this can leaddIsuse of selling flags.

Surveys have also statistically shown Wednesdays generally to be better than Mondays. This is possibly correct because of a cyclical pickup in any bearish sentiment from early in the week.

Obviously, these statistics apply more to overall markets and indexes. Individual security transactions would prove to be less sensitive to the significance of the statistics.

Random walk believers claim the results of these investigations are not conclusive. In fact, their research has indicated that apparent positive conclusions are explainable by efficient market hypothesis.

Note: If everybody were to use the same strategy on certain days of the week, any advantage would be canceled out and a possible adverse effect may occur.

Further notes:
A strong closing on an exchange may mean a strong opening the next day.
Opening hours are most active in trading. Review of market may be made about 2 PM.
More buying Monday and more selling on Friday.

Caution: The strategy may invite the attempt by traders to automatically sell an issue that had been bought a few days earlier, without giving any attention to an up-trend may still be underway. The strategy should be a means of getting better pricing for purchase. Therefore, conventional sell signals are suggested.

Pros/Cons

Advantages
Statistical evidence appears to indicate that the day of the week has in the past produced cycles that can guide a trader.

Disadvantages
Such evidence is hardly conclusive and is, in fact, refuted by those efficient market proponents.
The strategy may induce a trader to use doubtful selling flags.

Trade the January Effect of Bonds

Background

Researchers claim that over recent years bond markets have been relatively strong during January. This parallels what many traders in common stocks have also claimed. The stock market phenomenon has been publicized in the past but the bond version has been not bruited about as much.

Tax considerations can have an influence to make January more bullish for stocks early the year following one in which there may have been a lot of tax loss selling. (That does not explain why the public would be buying so much to induce a stock rise, if they were not getting it of stocks in December to establish tax losses).

Bonds however are another matter, unless there had been bond sales to establish losses in December, and the investors are back again in January. Bonds are tied into interest rate movements and are not calendar sensitive as much as stocks may be.

Trade the January Effect of Stocks

Background

Low-priced, low P/E stocks (price to earnings) often rise just after the first of the year. So do small capitalization and over-the-counter stocks.

This will happen if everyone expects them to. And there can be bonus money around to help. There could have been tax-loss sales in December which lowered those prices for a rebound a month or so later.

Very subjective but it makes for something to talk about. In logical theory it does not hold on a consistent basis.

As with other monthly effects on the movement of stocks, This circumstance could be the outgrowth of January tendencies for recovery. Still, there is no clear, easily explanation and some market followers feel.

In the vast majority of years, a poor January market presaged a poor stock market average for the year. A good January month was a favorable sign for the rest of the year.

Why is January such a recognizable barometer? It's hard to guess, except for the fact market sentiments can get the market off on the right or wrong foot early on. And, after all, market sentiment is what the stock market reflects.

One survey shows that low-priced speculative stocks do better in January. Perhaps they were oversold for tax purposes in December. Traders may be getting back into them. The theory claims that year-end bonuses may be put into more speculative issues in January.

Pros/Cons

Advantages
Statistics show that bullish or bearish characteristics are found to prevail by month or season.

Disadvantages
Except in a few instances where there may be economic or market-oriented explanations, the statistics for the market patterns are not overwhelmingly conclusive.

Trade a Stock by its Season

Background

This is not comparable to the seasonal effects of buying a stock, but has to do with the nature of the company's business.

Although everyone looks to annual earnings as the criterion of a company's profitability, custom or habit has invariably inculcated the manner in which the public looks at a company.

When looking at quarterly earnings per share, comparisons ought to be made with the same quarter of previous years. This evens out the seasonal factor of a company's business.

Example: If a company does most of its business during the Christmas shopping spree, it's more than likely that the results of that quarter of the year will outshine any earnings from the rest. And, if a company were to derive most of its revenues from selling cold remedies, its fall and winter sales would be great, while spring and summer sales would be laggard.

Or, if a company sells antifreeze or snow-melting salt, winter would be a barn burner. The rest of the year would be time for hibernation, if the main business were products principally for cold weather Oil and energy is used to a greater extent during the winter time in the United States. So, whenever headlines blare out the news of a current cold wave, oil, gas and similar energy prices tend to rise, and with it, the stocks of energy companies. The overall use of oil, gas and coal for heating may be average overall, but a strengthening will take place, on balance, in the markets for those industries.

Note: If a company must sell its products at Christmas and it has a poor sales experience, or if it must sell its line well in cold weather, but winter is comparatively balmy, there will be a major problem. Then, the news of a poor selling season, is also news that the annual earnings' report will be severely damaged. This condition has little to do with strategy. The latter merely directs the purchase of a stock whenever the company goes into its best-selling time of year.

This isn't logical, but for some reason, studies show that market psychology forgets the true meaning of the seasonal factor. It looks only to the calendar. Therefore, the time of year does affect the performance of individual stocks and the market.

Caution: Many of these observations are subjective. Stocks bought on a seasonal factor should have selling flags that are relatively sensitive. As noted above, if the season is a poor one, the market will stumble.

Pros/Cons

Advantages
Though the logic dictates otherwise, seasonal business increases will generally help or impede the market action of stocks.

Disadvantages
Daily news impact, economic conditions and normal operational activities will exert greater influence on the market of a “seasonal” company. Only in the absence of more important influences, will the seasonal tendency be pronounced.

Intrinsic Selling Character (of the Group) Whatever the particular strategy is for the purchase, the reason for selling is determined by the guideline you chose for buying. It is the reverse circumstance, or a possible downturn in a maximum predetermined market high. Because of the seasonal pattern, the observation for the selling flag must be sharp.

M-768-BY

Trading on News Reports About Companies

Background

The extremes of news about companies and the markets open trading windows of opportunity all the time. The ability to act quickly with appropriate strategy can become profitable provided the strategy is well-implemented.

Buy on Bad News About a Stock

Background

Bad news often drops a company's stock beyond the level the news itself would warrant. Good news, in fact, may often force the stock to higher levels than it should. It's when the news is seemingly bad, that buying opportunities arise.

A trader should have some inkling what the bad news is about. A company taking a surprise Chapter 11 bankruptcy proceeding provides one piece of bad news. Reported lower earnings, or fresh, though not catastrophic losses, or spending and salary cuts for efficiency, all provide varying degrees of this kind. If the company apparently is not going down the proverbial drain, bad news often means overdone pessimism on the Street, and better buys.

A technical rebound could, and often does take place, no matter how serious the news. An extreme of pessimism can be followed up by a period of excessive optimism. Where there is a major problem, the enormity of the corporate problem may take time to sink in. In the meantime, a trading situation can be made to bear fruit.

A carefully watched trading strategy is always possible when bad news is announced. Suitable selling flags can complete the trading transaction with minimal damage, no matter how serious that news proves to be.

If the news does have to do with a bankruptcy filing, that initial selloff can be severe enough for a major rebound. Percentages used here before selling flags are imposed, however, should be larger than they would ordinarily be, given other less onerous bad news. You do not want to be signaled out too soon.

Note: This strategy permits the credible use of short selling strategy. After a rebound, chances for a selloff are increased.

Question: What happens if a trader is in the stock and then the bad news comes about? Suitable selling flags would have been in place.

Pros/Cons

Advantages
Bad news often produces oversold conditions and buying opportunities.

Disadvantages
Selling flags can be easily misused. Care must be taken, to make sure suitable selling signals are instituted, whether the trader is short or long of the market.

Trade a Stock on Possible Corporate Bad News

Background

The future well-being of a company can be damaged by fresh regulatory rulings, or major law suits and adverse court adjudication's, or possible confiscatory action, perhaps even by a foreign country. These are not surprises, but might be guessed or hinted at, or read about as a possibility in the footnotes in the financial statements.

It does not mean the trader was completely surprised or fooled or negligent in the reading of the footnotes or the media. Sometimes those financial statements are not overly forthright in the presentation of a contingent problem. Or management itself may not have understood, or had access to, the complete enormity of the problem. No matter, ordinarily a strictly short-term trader feels the contingency is not going to hurt.

Sometimes it takes months, even years, for such contingent problems to become full-blown. Time frames of this kind will guide the trader. Strategy can be selected to anticipate the full impact or damage upon the market. Conjecture of what may happen need not prevent suitable trading.

Strategy is easier when regulatory or court rulings are imminent. The astute trader will cover both favorable and unfavorable outcomes. The extent of market reaction, either way, will color the type of selling flags that are to be in place before that possible piece of bad news arrives.

One effect could be a heavy selloff at the announcement. This can be a buying opportunity for a fresh stock commitment. If the stock has been held in anticipation of that bad news, a sensitive selling flag would be a means of getting out with minimal damage.

Traders like to hedge their position, with the adept use of short sales, put purchases, writing of calls, and related option and futures activity. Protection of the position can come in many ways.

Pros/Cons

Advantages
Almost any contingency can be protected, much as an insurance company is able to protect policyholders. This is done with well-placed selling flags that permit a stock to be held, or to be sold, when that contingency becomes reality.

Disadvantages
The strategy requires the ability to withstand peer pressure, in security choice.
Most traders may not be able to maintain positions until selling flags are activated.

Trade the Market on General Bad News

Background

Extremely bad, shocking news, generally of a political nature or an assassination, can create a selloff with far more repercussion than the news itself warrants.

Poor economic disclosures are often not surprises; a downturn in the economy can be seen over some months. Some indicators that are used for strategy may have sharp moves, but never the kind that can produce impacts that rank in the serious-news category.

Attempted or actual assassinations, or presidential illnesses have caused this phenomenon. A breakout of war that directly concerns this country would be another.

Existing shareholders are cautioned to design their selling flags not to be influenced by certain types of news, such as the aforementioned. Example: A strategy has a sell signal with a percentage from a high of 20%. A sudden, serious presidential illness is announced, and the stock drops a quick 20%. What action should be taken?

The trader should list in advance the type of calamity that will permit overlooking price action. War, presidential illness or incapacity, or assassination are exclusions. If the trader wants to buy into a market at this nervous, oversold stage, the use of options on stocks, or indexes, or options on indexes, or futures on them, can give highly leveraged profit potential. In such cases, the markets will sharply rebound. Conventional selling flags, with small-percentage sensitivity, will take care of any future corrections due to strength of the expectedly strong rebound.

Pros/Cons

Advantages
Temporary, shocking news of a political nature, will throw a market off beyond reasonable dimensions. This opens excellent buying opportunities.

Disadvantages
Crowd psychology may induce a shareholder to sell out holdings too quickly.

Buy When an Unprofitable Business Operation is Sold

Background

Many investors love to buy into a company on news that management has decided to get rid of an unprofitable operation. Once out of the way, the idea is the company will be able to earn more by not having losses detract from their otherwise profitable operations.

Keep in mind that a purchase on such news is not relatively cheap to what it may have been before the announcement. The stock will take a boost because of it. In fact, some buyers may choose to wait for a week or two for the news to digest. This is on the assumption that prices will be somewhat lower in a week or two. But perhaps not.

Investors using this strategy are looking at the longer term, where buying a little cheaper will not be as important as the fact that you have bought to get involved with the stock. In fact, this may be a strategy you want to use in the corporate mode. With an unprofitable operation out of the way, the investor in the corporate mode is perhaps seeking growth of earnings or cash flow. And if so, a suitable long term objective can be set in motion.

Trade Companies after Huge Write-offs

Background

Many times write-offs are used as gimmicks by new managers who have little personal reputation to lose. And a lot to gain if those write-offs, or at least parts of them, are written back into the books as earnings in future years. It may be hard to figure out when those write-offs may come back but it will be at least a year or so after. Even if they are genuine write-offs, the fact the mess was cleaned suppressants the company with a clean slate of books, so to speak.

Intrinsic Selling Character (of the Group)

You have a guideline that covers you if news gets worse. That is, you sell if there is a predetermined fall in price from a maximum market high that you hope your strategy to buy will achieve.

M-789-CZ

Options Trading

Options Trading and Strategies

Background
If used wisely, options provide a leveraged means to profit from varying conditions and situations that occur in the markets. They do take focused strategy and discipline for maximum practical results because of the enormous risks involved.

Buy a Call Option For Leverage

Background

The call option costs less than the underlying stock. Depending on the number and type of variables for its use, the cost can be as little as a fourth of the common's price. Dollar-for-dollar, the trader can accordingly get a leveraged amount of equity in market action. The call option's value can double for every 10% or so in the rise of the underlying stock.

One example of the leverage: A trader buys a call and places into a money market fund the cost difference between that call and the 100 shares of underlying stock. If the stock goes up more than the cost of the option (and commissions/taxes), the trader is ahead.

Instead of buying 100 shares of ABC, Inc., at $40, for $4,000, the trader pays $400 for an ABC40 call. Each call is for 100 shares of the underlying stock. Should the stock go to 50 before the option expires, that call would be worth $5,000. The trader would have a $600 gross profit, before commissions/taxes ($1,000 profit, less $400 for call premium). The amount in the money market fund ($3,600) would have been earning extra income.

Other examples: Instead of buying 100 shares of stock at $40, for $4,000, the trader could pick up 10 ABC40 calls for the same amount. Were the stock to go to $50, the gross profit would be $6,000, before commissions and taxes.

The risks are obvious: If a call is not used, the premium paid for it is lost. Premium and transaction costs are relatively high, particularly for the shorter maturities. On the other hand, all you can lose in the market is the price you paid for the call. Some observers claim people who buy call options lose money over 80% of the time. So, traders use call leverage only when they feel strongly about a stock's market direction.

The impact on a call price of a one point change in the stock price, depends on many elements that are not readily evident.
The current price of the stock,
The length to maturity of the call, the strike price,
The relationship of the call's price to the strike price and the market.

If a stock is close to the striking price, one dollar change can equal about a 50 cent change in the call price. If the call is deep out-of-the-money, every dollar has little effect. At the other extreme, If the call is deep in-the-money, each additional dollar value for the stock will equal almost a dollar in the call.

Volatility is a key aspect of the option consideration. Option buyers do not like relative quiet market movers. Calls are a wasting asset that lose value with time. Volatility before their expiration makes them more profitable instruments. (Remember: buyers may liquidate their position with an offsetting transaction in the same option).

Option volume and prices can act as an indication of takeover bids. If insiders wish to take advantage of information about a prospective acquisition (though the SEC says it is illegal), they would attempt to leverage their purchases with options.

Warning: Income tax regulations must be investigated closely. Tax consequences vary with the nature of the option and the kind of purchases and sales.

Option arbitrage is the currently model-oriented. The Black-Scholes Model is but one of several that are widely used, and which constitute a good part of academic research in financial literature.

The purpose of the models is to hedge portfolios for maximum profit.

Pros/Cons

Advantages
Call options take substantially less capital for trading a market direction a trader wants to follow.
Options permit arbitrage on the basis of relative leverage and value.

Disadvantages
Options are relatively expensive to use.
Options have short maturities and lose value with time.

Buy a Call to Limit Risks

Background

A trader who does not want to be exposed to market risk on an individual issue, will look to options as at least a partial solution. This is an important consideration whenever markets are volatile

Should a stock move up, the trader has bought an insurance policy that did not have to be enforced. The cost of the call or premium, and the transaction costs, have constituted the charge for a “policy” that may have had to be used in a down market. Moreover, the ability to leverage is always an added attraction.

Example: Instead of buying 100 shares of ABC, Inc. at 30 for $3,000, only about $300 may have been needed for a call on those 100 shares. A drop in the stock's price will reduce the value of the call; a big reduction will cut the value of the call drastically. The trader in this case can lose only the $300 plus transaction costs. The buyer of the call can liquidate the position with offsetting trades in the same option.

Note: The premiums and transaction costs of options are high, the shorter maturities even more so. Moreover, income tax regulations can cause serious consequences, depending on the nature of the option and the type of buy or sale. Furthermore, corporate takeovers can complicate call recapitalization values

As a result, calls can prove to be an expensive form of insurance if they are not carefully used.

Many models have been developed for the use of options to limit risk in portfolios. One example is the well-known Black- Scholes Model, that is often used or adapted, and at times, disputed. Its intention is to take positions in options, opposite to stocks in the portfolio. It takes into account various inputs that make up call pricing. It considers:
The market price of the underlying stock. This is clearly a major part of the model.
The constant changes in the stock's rate of return. However, there has always been lots of conjecture as to how that rate is determined.
The exercise price of the option
Option maturity
The risk-free interest rate assumptions.

A number of other models limit portfolio risks. The purpose of the models is chiefly to determine option pricing and to replicate portfolios in an effort to enhance returns while limiting risk.

The need to implement so many contingent values makes the use of models suspect, except for the provision of rough parameters. Extensive research has been done in the area and published in academic financial publications.

Pros/Cons

Advantages
Calls can make worthwhile limits on risks
Sufficient evidence indicates that models offer some ground rules in the attempt to achieve a “risk free” portfolio with the use of different options.

Disadvantages

Calls are high-cost in terms a of premiums and transaction costs

Models used to create portfolios with options are widely used, but subject to dispute amongst researchers.
The use of underlying stock values may be overlooked in the incorporation of input for model composition.

Use a Call to Hedge a Short Position

Background

Short sellers may buy a call. When they borrow to sell or use their own holding, they use the call as a hedge. Should the stock go up, the profit from the call's opposite market position helps offset the loss from the stock position. Should the stock's price fall, the cost of the unused call would have been worth the assurance.

Example: ABC, Inc is at 50 and is shorted. The call (for 100 shares) will cost about $5. Should the stock fall to 44, the trader is already ahead $1 a share (The $6 difference between 50 and 44, less the $5 premium). Commissions and fees must come off the profit.

Note: Buyers of options can liquidate positions with offsetting transactions in the same option.

Caution: Premiums and commissions/fees are high, in relation to profit potential. This cost is even more exaggerated for the shorter option maturities. Further warning: The Options Clearing Corp., which clears and matches trades, and the exchanges where the options are traded, have to approve stock recapitalization values. This can complicate hedges done in contemplation of corporate takeovers.

Price behavior of common stocks and options, particularly when option (and stock index) futures are used for hedging, reach panic characteristics near the option expiration dates. Arbitrageurs and hedgers, in attempting to close out their positions, often induce extraordinary imbalances in both markets.

Note: Income tax regulations have to be checked, as tax consequences rely on the nature of the options and the purchases or sales.

Pros/Cons

Advantages
Option strategies can gain profits in declining as well as bullish markets.
Call hedges are a valuable hedge in both markets.

Disadvantages
Transaction costs are high, so that this form of market assurance is costly.
The matching of trades in a recapitalization due to a takeover, may complicate the hedging strategy.

Buy a Call to Lock in a Stock's Cost

Background

Calls are used to lock in the cost of buying a stock sometime in the future. This could be necessary for a trader who does not have the funds at the moment, but feels the stock is worthwhile controlling at the current market.

The strategy fulfills another essential function; it permits the maintenance of disciplined selling flags. Example: Stock ABC, bought sometime earlier, should be retained in the portfolio. However, the selling flags that go with the strategy employed have yet to be flagged. Stock XYZ looks highly interesting to the same trader. A purchase would be recommended, but there are no fresh funds available.

What happens ordinarily is that a trader may feel it's time to get out of ABC, and use the proceeds to buy XYZ. The rationale for doing so will convince the trader of the logic:
“Why not take a profit in ABC; you can't go broke that way.”
“XYZ may move faster than ABC from this point on.”
“I've held ABC long enough; the market is bound to drop sooner or later.”
“Besides, XYZ looks like a takeover candidate.”

This type of thinking, of course, is what destroys trading discipline. Each strategy should have selling flags that are to be obeyed.

With traders who disdain the use of premature sales to create buying power, the call can be an excellent tool.

An example: A trader needs $10,000 with which to buy 400 shares of XYZ common at $25 a share. If the stock is optional, for about $1,200, four 4-month call options (100 shares each) will tie up the same number of shares at the same price. Should the price of ABC common go up during the four months, the trader will still call in the stock at the lower level. Chances are, the trading strategy on ABC will have been flagged some time earlier, and the proceeds will have been made available.

If the market were to remain about the same, or drop, the cost of the call would be considered an insurance policy. Besides, traders do not use this strategy unless they are fairly certain of the chances for XYZ common to move on the upside.

Note: As with other options, transaction costs are relatively high. Moreover, if strategy is used to lock in the price of a possible takeover candidate, there can be complications. The Options Clearing Corp., which clears and matches trades, and the exchange where it is traded, have to approve recapitalization values under corporate takeover terms.

In addition, income tax regulations should be checked out. Tax consequences vary with the option, and purchases or sales.

Keep in mind: The purchase of a call does not eliminate the need for disciplined use of selling signals, based on the selling flags that apply to the underlying stock.

Pros/Cons

Advantages
Call options not only offer leverage, but they permit a lock-in of a price on a stock that could not have been bought earlier.
Calls that lock in prices will help maintain selling discipline in other holdings.

Disadvantages
Options are relatively expense to use because of their transaction costs.
Selling flags should be based on the activity of the underlying stock under option.

Buy a Put to Hedge Against a Stock's Price Drop

Background

A trader may want to lock in a profit already in hand. Or, a stock has just been bought and the trader would like to protect its price. Buying a put will accomplish either aim.

Example: ABC Inc. has been bought at 30, and it has now risen to 50. For a put that controls 100 shares, at-the-money, the trader will pay about $200. For every 100 shares of stock worth $5,000, the trader has thus bought an insurance policy for a $200 premium, plus transaction costs. The trader is ahead, once the stock falls to about $48. (Remember, buyers can eliminate a position with an offsetting transaction in the same option).

Or, a trader may feel a newly- bought stock may drop due to some market aberrations. The put will offer some protection if the market acts erratically after the purchase is made.

Income tax regulations are complex and must be investigated. Consequences are governed by the type of put. The use of at-the-money, in-the-money, and out-of-the-money exercise/market relationships can be put to tax advantage.

Anyone who would incorporate the use of a put to protect a market position and profits, may feel the option technique will suffice. Theoretically, no percentage of the high need be conceded. This is not true.
The value of the put is not easily calculated They can be bought below, at, or above the purchase price. With the maturity variations, each case introduces a totally different set of variables in the consideration of value.
Put options are of short duration. The selling flags may not occur in time to coincide with the option maturity.
Transaction costs of puts are relatively high, especially in the shorter maturities.
There would be no discipline on the trader, in his employment of the put.

Pros/Cons

Advantages
Puts are valuable for protecting a stock's paper profits.
The use of out-of-the-money, or in-the-money exercise/market variations can temper tax obligations.

Disadvantages
Puts are not practical means of substituting for conventional selling flags, due to relatively high transaction costs.
The substitution of a put for a conventional selling flag will destroy strategy discipline.

Buy a Put to Limit Risk

Background

A trader may feel ABC common is going to fall in price, but is not quite sure, or secure enough in his belief, to actually sell the stock short. It may be at $50 a share, while a put may cost $2 (or $200 for the rights, at-the-money, on 100 shares).

The possibilities:

Should the price drop to 48, the put would begin to have value (also consider transaction costs). If the stock, instead, rose to 55, or 60, or more, the maximum loss to the trader would be $200. Had he purchased 100 shares of the common, there would have been a $500 loss at the $55 per share level.

Reminder: Option buyers can liquidate their position at any time with an offsetting transaction in the same option.

Keep in mind also, takeovers can complicate some uses of options. The Options Clearing Corp., which clears and matches trades, and the exchange on which an option is traded, have to approve recapitalization values of those options. This has caused problems for traders in the past.

The use of exercise/market variations adds sophistication to the employment of the puts. Whether the purchase is made at-the-money, or in-the-money, or out-of-the-money, is included in the strategy. As with all options, transaction costs are relatively high, particularly for the shorter maturities. In addition, income tax regulations must be fully investigated. Tax liabilities may be offset to an extent, by their judicious use.

Pros/Cons

Advantages
Puts are a valid way of reducing risks

Disadvantages
Transaction costs are comparatively high.
Puts are not to be compared with conventional selling flags, as a means of maximizing transaction profits.
Misused puts can destroy selling discipline.

Buy a Put for Leverage

Background

A put can be used to leverage profits where a trader strongly feels a stock price will have a sharp drop. If ABC common is selling at 45, about a $300 premium (at-the-money) will buy an ABC45 option to put 100 shares of the stock.

The stock falls to 40 within the option's life over the following months, the trader will realize a profit. It would total $200, less transaction costs ($4,500 less $4,000, or $500, less the $300 premium and transaction costs).

It would have taken much less dollars to control the price status of the put, as compared to the common. Taken another way, the trader could use the same amount of dollars to get a lock on the short side of the market for more common stock. A $300 premium to control $4,500 worth of stock provides enormous leverage.

At the same time, should the trader be proven wrong, and the price rises, the maximum loss would be the $300 premium on 100 shares. Had the common stock itself have been shorted, the loss would have been far greater, depending on how high the stock rose before sale. Once the rise (without transaction costs) exceeded $300, the account would be in the red unless it were closed out.

Buyers can liquidate a position with an offsetting transaction in the same option.

Transaction costs are always a factor, in the determination of when the strategy is worth while being used. The costs are proportionately high for the amount of funds in use.

Of course, puts can be bought as well, in-the-money, or out-of-the-money. These variables create any number of possibilities in the use of the puts. This is especially the case with income tax planning stratagems.

A note to those who use puts in arbitrage: The Options Clearing Corp., which clears and matches trades, and the exchange where the option is traded, have to approve recapitalization values. This may complicate purported option values when trading takeover situations.

Pros/Cons

Advantages
Using puts for market leverage is a logical market technique of the short sale enthusiast.
The sophisticated use of at-the-money, in-the-money, or out-of-the-money variations, will add to profit potential.

Disadvantages
Misused options strategy can defeat selling discipline.

Use a Spread to Limit Risks

Background

Spreads are used to increase portfolio earnings. They can accomplish two major aims: Protect short sales, and help anticipate price declines.

Puts or calls are simultaneously bought and sold, at different prices. The trader is a buyer and a writer at the same time, in the same underlying stock. Traders who are not sure of the way the market is headed will use spreads, if they feel the market will be volatile enough to make either the put or the call profitable. The options may have different exercise prices and/or different expiration dates.

Example: The trader can write and sell an ABC January call at 40, and buy an ABC January call at 50, while the current market is 45. Or, he can write an ABC March30 call, while buying an ABC June 30.

Any number of variations can be implemented, to suit the stocks, their volatility, the nature of the overall market at the time, and so on. Stock indexes, options and futures, are commonly used.

The spread can be with two puts instead of two calls. In either case, the trader becomes a buyer and a writer of the same option. The spread may involve in-the-money options. This will increase the chances of being assigned the option; the buyer has an incentive to do so at the start.

Moreover, if recapitalization of a company takes place, as it may on an acquisition or tender offer, a further of the market picture may take place. The Options Clearing Corp., and the exchange on which the options are traded, will have to approve recapitalization values.

This action may not work in favor of a trader's specific position, nor intentions.

Pros/Cons

Advantages
The spread attempts to limit risks of dealing in options.
The type of option use serves to hone market objectives

Disadvantages
Spreads are even more complicated to use than conventional options.
Bid/ask prices may be far apart at times.
The use of spreads, as with other forms of options, may tend to destroy discipline for selling of stocks that underlie the option.
When writing options, there is no longer any control over the flags that may have indicated a timely sale of the stock.

Use a Straddle to Limit Risks

Background

The straddle allows the buying and writing of both a put and a call on the same stock. The options have the same exercise price and the same expiration date.

Whenever little change is expected in a stock's price level, a trader may be inclined to be a writer. A premium will be earned, and there will be less chance of the option being exercised. But, if a rapidly rising (or falling) price level is anticipated, a trader would rather be a buyer of straddles

An example of buying a straddle:

If ABC's common were expected to be volatile in the near future, with the price now 25.00, a trader may pay a $250 premium for an ABC January 25 call, and a $200 premium for an ABC January 25 put. Allowing for transaction costs, an appreciable move in either direction will possibly provide a profit. The actual insurance cost is $200 plus $250 dollars, or a total of $450, or a 4½ point market variation.

If the straddle position is maintained until expiration, and the price of ABC common stays with 20.50 and 29.50, the trader will lose a portion of the insurance investment. The closer the price is to 25, the greater the loss. At 25.00, both the options will expire, worthless. His total cost: $450 plus the transaction costs.

An example of selling a straddle:

If the trader thinks the ABC common, now at 25.00, will move only sideways in the near future, the trader can write an ABC January 25 call, for a $250 premium, and also write an ABC January 25 put. for a $200 premium. (Note: These premiums serve only as an illustration; the amounts are approximately what they may be).

If ABC common stays between 20.00 and 29.50 and only one of the options is exercised by a buyer, the trader will have a profit. The total premiums earned, $450, less than a loss on the exercised option, will leave a positive net amount. However, the trader would have to close out the other position, or take the risk of holding that position until its expiration.

Any number of variations of these examples can be implemented. Stock indexes, options and futures, are commonly used.

If takeovers involve recapitalization complications on the value of puts, objectives may be clouded. Remember, the Options Clearing Corp., and the exchange on which the options are traded, will be required to match trades.

Furthermore, keep in mind the proportionately steep transaction costs in options. In addition, tax implications should be considered.

Pros/Cons

Advantages
Straddles allow earnings from premiums, above any losses that from transactions.
Options can help a trader benefit from a being more or less stable.

Disadvantages
The procedures are difficult to implement without expertise.
The writing of options destroys strategy discipline that has to do with the underlying stocks; control is the buyer's.
Bid/ask price spreads may often be out of balance.

Trade a Stock's Rights or Warrants

Background

Stock rights and warrants are a form of option that are a bit easier to use by the man-in-the-street as well as professional Not many of them are around but the use of options always has been a lure to traders

Rights generally come to holders at a better price than the prevailing market. The discount can be 5% to 10% and there are no commissions or markups. What is more, there are no income taxes on the receipt of the rights, only if they are sold. Shareholders with the rights can sell them for trading on a “when issued” basis The longer the expiration date, the more valuable the right. A conversion date may be extended or terms liberalized, though this rarely is given by the issuing company.

Warrants cannot be called. Unlike rights, they have a longer life. They may be in force from five to twenty years and longer. Originally, they came attached to the stock but are detached sometime after issue and then traded, mostly over-the-counter. As is the case in considering rights purchases on the open market, buy them only if you would buy the stock itself.

To those who are concerned about dilution of interest: a subscription to rights does not dilute equity of subscribers. Non-subscribers lose their percentage ownership in the company. Warrant conversions into stock do cause dilution.

Traders can buy the common with rights on low margin in special subscription accounts. These entail no interest charges and you often get time to pay. Traders will have margin requirements

Warrants provide a lock on the common, at a set price. Should the price of the stock rise substantially, the warrants offer leverage. In this respect, warrants are a call on a future purchase at current pricing.

They are primarily a speculation, in that they:
Offer no voting rights.
Pay no dividends, even when the common does.
Offer no claim on corporate assets. Nevertheless, warrants can be an exciting trading strategy. To a lesser extent, rights can be actively traded during their shorter maturity.

Pros/Cons

Advantages
Rights give shareholders better purchase terms for the common.
Warrants are a good trading issue because of their longevity.
Warrants can provide a trader with leverage.

Disadvantages
Trading of rights and warrants can break down discipline. They are to be bought on the market as would be the underlying stock they are converted into.

Intrinsic Selling Character (of the Group)

Price direction of an option is closely connected with that of the underlying security. Therefore, the trading sell guideline should be established in advance and closely adhered to, with the understanding that option price will always be related to that of the underlying security.

M-841-BY

Price Multiples and Returns

Background

Relative price multiples and returns, as related to earnings or book values do not always have standard meanings at all times. That is because earnings are often not standard. neither are definitions for corporate assets. Nevertheless, they are universally used, correctly or not.

Buy a Stock with a Low Price to Book Value Ratio

Background

Many on Wall Street like to buy stocks whose assets are available at a sharp discount, related to its market price. The strategy can also be used in the corporate mode, as it makes good sense to buy assets cheaply. To traders, the strategy is to use the concept for shorter-term in and out transactions.

The apparent advantages of buying assets at a discount are:
Discounted assets can lure would-be acquirers who would like to sell them, or restructure the company for their maximum utilization.
Stocks of this type appeal to those in the public who think any discounted asset makes the company a takeover candidate at higher prices.
Stocks selling at such a discount may eventually be bought back from the public by management and other insiders with leveraged buyout ideas. The going-private offer would be at higher-than-current prices.
Asset-discount stocks are relatively immune to inflation. They may, in fact, benefit from it in most instances.

Whether the assets are truly cheap, or takeovers are practical, companies whose stocks have been called cheap on an asset basis, are in the public limelight. This makes them vulnerable to rumor and legitimate play that makes their stock volatile. And it makes for a better- trading issue.

While asset-discount stocks are comparatively inflation-proof, other market related ratios may not be. Price/earnings discount stocks do not have this protection. This apparent advantage aside, questions are many as to the advantages of asset-discount stocks. Stocks have sold on this basis for years. The random walk theorists claim this is understandable. Such assets, they say, are not really worth more in the eyes of the trading public. True, every so often, a would-be acquirer may come along and offer more, as an inducement to make the holders part with their shares.

On balance, however, picking stocks because of cheap assets may lead nowhere of consequence:
There can often be a difference in value between holding assets for operations and their real replacement worth, or what they can fetch if sold.
Different assets can produce different amounts of earnings by different managers. Each management will have its own priorities over its preferences for income production, capital building, risk-taking, etc.
Stock prices conventionally reflect estimates of future earning power, and the ability to produce dividends from it.
Efficient market theory would hold that the market price of a stock already has discounted the true worth of the assets.

On the other hand, some advantages owe to other factors:
The ability, thanks to the tax code, to write up newly-purchased assets for depreciation,s a major plus. More income can accrue to the company for business expansion or dividends.
The business synergy from ownership by management better able to implement existing operations.

In any event, assets to price considerations or what is known as Price/Book ratio is a better gauge than P/E ratios. The book value is essentially what the company is worth in a liquidation. The lower the price of the stock as compared to its net worth, the more of a value is perceived by the purchaser.

Pros/Cons

Advantages
The public constantly screens for companies that sell for less than what is perceived to be true asset value.
Periodically there are takeover offers for these stocks at prices above current market.

Disadvantages
Many asset-discount stocks remain in this category over years, and do not received takeover or leveraged buyout offers that would give the shareholders more than the market.

Buy a Stock with a Low Price/Earnings Multiple

Background

One of the Wall Street's most honored maxims is to buy stocks with a low price relative to its earnings. A survey of professionals who manage money for others found that about 40% of their stock choices are made on the basis of price/earnings. When they invest on behalf of pension, mutual funds, insurance company portfolios, bank trust departments, etc., P/E multiples get the major share of their notice.

Price/earnings ratios are figured by dividing the market price by earnings per share. A stock selling for $50, with earnings of $3 a share, has a P/E of just under 17,

Price/earnings calculations are simple; The way they are set up as parameters can become complex. One figure may be the historical P/E of that stock going back one month, a year or two, or longer. Or, the multiple may be compared with those of other stocks in the same industry. Or, with stocks of companies who are not in a similar industry. Each of the stock averages has its own price/earnings, a composite from the stocks that make up the averages.

Most of those who pick stocks on the basis of low P/E, make their comparisons with the past. They sometimes buy when a stock is 20% or less above the historical low of the stock's P/E cycle, on the assumption they cannot get the absolute bottom. No hard and fast rule exists; what they think is low is subjective at best.

The use of what can be deemed a low multiple is a form of contrary opinion. The idea is to pick stocks whose price/earnings are lower than they used to be, or lower than others. Contrarians believe that those who are willing to pay more will be proven wrong over time. They claim markets rise higher or lower than they should, with P/E the indicator. Low P/E is thus supposed to bring better results.

Deeper investigation of the use of P/E strategy presents sufficient evidence for extreme caution:
Very low P/E figures may signify a corporate problem There can be good reasons why the market values a stock as low as it has.
Inflation rates affect P/E. The higher the rate, the higher the P/E will be. Earnings in the future will be higher in set dollars, merely to keep abreast of the cheapening dollar.
Bull market sentiment buoys what can be considered normal P/E levels. Weak market sentiment, on the other hand, will see P/E assigned lower figures by a bearish public.
The use of P/E does not help where production costs are the real key. Gold mining shares are one example of producers who can do well when their output's market is soft; low-cost production was the answer.
Some markets have little to do with earnings, so that P/E loses much of its significance.
Lower interest rates may spur a market to greater heights than will any increasing earnings in that market.

Over-ardent P/E use has produced a counterculture. Devotees may buy low P/Es of medium sized companies only, and only with ample diversification. Other suggest a mix of low and high P/E stocks. Still others have built their case for buying only high P/E issues. And each claim to prove their positions are correct.

Caution: The main problem with price earnings is that it complicates strategy discipline for the eventual sale of what has been bought. That is because P/E. is far too subjective a strategy.

Buy a Stock with a Low Price to Cash Flow Ratio

Background

Inasmuch as cash flow is a more finely- tuned extension of reported earnings, and often more important to a company, some traders look to market multiples that take it in account. Its historical relationships, and parameters can be implemented much the same as with price/earnings.

They find it makes better sense to consider cash flow ratio because it tells more about projected operations. Knowing a company is selling is eight times its earnings means far less than eight times cash flow. In the final analysis, it's cash flow with which a company pays its dividends, debts, and expansion needs.

Cash flow's definition is composed of: Earnings, to which bookkeeping depreciation allowances have been added back; and an adjustment made for cash expenditures for replacement of what has been depreciated. Cash flow after such needs means more for dividends and further expansion.

Price/cash flow may be more affected by the rate of inflation, because of the need to take into account higher replacement costs, the inventory factor and the need for increasing revenues to keep pace with higher costs.

While the use of cash flow makes the earnings multiple more rational, the misuse of the strategy is still rampant. In one respect, price/cash flow figures are not as incorrectly implemented; the figures are not bandied about as much as P/Es are. Price/cash flow is not usually a part of almost every analytical report or financial publication article. It is P/E that is so frequently compared, for the stock itself, or for the stock and its industry or the overall markets.

Nevertheless, when traders use price/cash flow, they are interjecting a standard that is often too variable to be a constructive guide. What is low today may not be considered so tomorrow, or next week or next year. The market's moods and sentiments will have materially affected the parameters being used.

Moreover, the public may not fully appreciate a strategy they read and hear little about. They are more apt to take leads from price/earnings, though price/cash flow has more to tell them.

Caution: The main problem with price to cash flow ratios is that it complicates strategy discipline for the eventual sale of what has been bought. That is because the ratio is far too subjective a strategy. Though more accurate a strategy for choosing securities to buy, it nevertheless makes it extremely difficult to have a disciplined strategy with which to sell what you have bought because of the nature of the strategy.

Pros/Cons

Advantages
Screening for stocks which sell at a relatively low price, compared to its cash flow, will trading prospects more visibility.
Cash flow has more significance to a company than does earnings.

Disadvantages
The public does not follow price/cash flow, as it does price/earnings, so that a good deal of impact for trading opportunities may be lost.
Price to cash flow ratios are not easy to find, as such, and must be painstakingly calculated.
The multiple is not sensitive for market objectivity.
The ratio can be misused in a way that will destroy e of discipline for selling flags.
Price cash/flow (as price/earnings, too), ought not to be used as a selling flag.

### Buy a Stock Whose Estimated Earnings Growth is at Least Twice its P/E

Background

Extrapolating current price/earnings into the future presents a number of problems arise, due to the impossibility of determining:
Future inflation rates.
The level of interest rates in the future, compared to possible stock returns.
The reinvestment of dividends in the years ahead.
The time frame to be taken.
The level of acceptable price/earnings in the future.

This strategy imparts another criterion, that the growth rate be twice as high as the P/E. This is an arbitrary figure. If the P/E is 15, the growth rate must be 30% annually, if the P/E is 20, then the growth rate has to be 40% annually. A look around the stocks traded in the current market will not find too many which qualify.

A more serious problem: It's difficult to pick out a stock that has been growing at a 20% clip, for instance, over the past three to five years, and hope to see it grow at the same pace for the next three to five years. In fact, some researchers have claimed that the efficient market theory holds for earnings, just as they claim it does for market pricing.

They say, and there is indisputable evidence, that Murphy's Law applies to even well-run firms. That a company that appears it can sustain a past growth rate, will eventually run into problems, many not of that company's making. Domestic and foreign competition, the economy, consumer tastes, at least one of them may change sales and earnings in a way that will adversely affect corporate fortunes.

The company may do well enough to get swallowed up in a takeover, and lose its individual momentum; even its product-line identity. A search back for the growth leaders of yesterday will show that many were relatively small and medium-sized companies which were gobbled up by industry giants.

With extended growth, that rate of growth will be hard to sustain. If this is so, how in the world can earnings growth be estimated with any modicum of accuracy? Reflection of past fast-growth situations will attest to this probability that good times do not last too long in earnings growth.

The arbitrary use of the twice-the-P/E standard is not the problem itself. While arbitrary, the standard can be adjusted, should it be hard to find the fast movers. And the strategy does provide some guideline on which to focus objectives.

Nevertheless, the strategy is not sensitive to markets. Without proper selling flags, it will be hard for a trader to discipline transactions. When, for example, will a trader know whether the original goals have gone astray? A company may grow at a rate of 35% one year, 40% the next, and 15% the third. The annual rate is 30%, but can the shareholders be certain that third-year downturn was not a fleeting hiccup?

Caution: Price/earnings strategy that is used to buy securities, cannot be logically used for selling flags. The lack of objectivity and sensitivity precludes any semblance of the required discipline.

Pros/Cons

Advantages
The strategy furnishes a rough guideline for selecting stocks

Disadvantages
Price/earnings projections are subject to many variables that make it difficult to accurately predict future stock prices.

Buy a Stock with a Low Price to Sales Ratio

Background

Researchers, particularly those in academe, have put their computers to work in screening processes for almost every aspect of stock selection. Although they have no key to the mint, they have come up with interesting correlation's. And, for every researcher who has claimed to have found some secrets held by securities markets, their are doubters. The efficient market theory with its random walk philosophy, has usually been able to counterclaim almost every theory put forth. The jury is out on all sides.

Buying a stock because of its low price, compared to its annual sales, does appear to be a more arcane strategy than price/earnings.

Some advocates of this strategy suggest buying securities in a company where the total market value should be 75%, or less, of sales.

There is a logic to this, a reasoning that is the common denominator in all price/earnings, or price/asset, types of strategy. A low- price-to-sales statistic is a sign of an unpopular stock. Any stock that sells at a lower price than the rest of the market or its industry, is not as alluring to the public as it should be. The reasons why may be quite valid, or they may be due to a quirk, or negligence. Fad-oriented issues may have temporarily taken hold instead.

Some screen for this strategy by determining the dollars and cents needed for the purchase of one dollar of sales. Past statistics are compiled, for a historical relationship that is a lot like that used for price/earnings.

Caution: Many of these stocks represent risky, problem-loaded companies. The same warnings are sounded for low price to earnings, or low price to cash flow stock selection candidates. Furthermore, the methods are too subjective for any more than a selection process. It would be senseless to attempt to use this non-sensitive process for any selling flag for the completion of the buy/sell transaction.

Caution: At what point would it be timely to sell a stock that had been bought because it has a low price to sales relationship? Many of these continue to sell in this fashion, while their stock prices scale a wide price range. The strategy does not provide a suitable guidelines for sales.

Pros/Cons

Advantages
The price/sales screening is as another way of selecting stocks which are not in public favor.

Disadvantages
As is the case with all low price to sales, or earnings, or asset relationships, the procedures are hard to implement for the completed buy/sell transaction.
Misuse of strategy can lead to a lack of discipline.

Sell Low P/E Stocks as their P/Es Rise

Background

Traders say they will buy low P/E stocks, that is, if they can truly describe what low price/earnings really is. The term is relative.

The all-important, universal question is: What is low or high when it comes to price earnings?

You can take an average P/E for an industry. If your stock is lower than the average, and wait until it rises above average, and then you can sell. But discipline is hard to manage because it is hard to describe P/E. Based on estimated or actual earnings? The most recent twelve months of earnings? Or prorated quarters of earnings? The actual numbers will vary by the choices you make.

Are you describing purely operating earnings or a mixture of operating an other non-operating earnings?. Are any of the earnings non-recurring, that cannot be counted on from year-to year? In other words, are you comparing apples with oranges? In real life, price earnings is not a practical tool, despite the common usage it gets.

Caution: P/E may help you select securities by assisting in the screening process. It offers nothing but confusion for the selling process.

Intrinsic Selling Character (of the Group)

Securities bought on the basis of low price to such variable standards as earnings or book value will require a better, firmer, more consistent standard for the security's sale. Therefore, at the time of purchase, an alternate selling strategy ought to be chosen, other than a price relationship to earnings or book value. Also, a selling flag should be established in the event of a major fall in price from a predetermined market high.

M-864-BY

Earnings and Dividend Yield

Background

The two strategies can be easily followed with the utmost discipline as follows:

Trade a Stock on the Basis of Dividend Yield

Background

A stock with a reasonably large and secure dividend yield can be traded every time the yield goes above or below a specified level. That level is arbitrarily set by the trader. It can be the stock's historic yield over some previous representative period. That will depend on past price volatility and experience with the increases (or decreases) in the amount of previous dividends.

The deviation in dividend yield must be wide enough to warrant a strategy implementation. A company that keeps increasing its dividend, while its stock rises in practically the same proportion, is not a likely candidate for selection. Some swing in the relationship between dividend and price is a necessity. A deviation is needed.

The best candidates, for use of this strategy, are stocks whose dividends are continually on the increase. Growing companies, sound financially, with a record of paying out a substantial amount of earnings, are the ones to investigate. The stock prices of these companies are often volatile, where public interest can go to extremes of optimism and pessimism. These moods and sentiments will depend on current expectations, interest rate levels, economic conditions, and so on.

Moreover, the move above and below the set yield norm has to be enough each time, to warrant the commission/transactions costs. A slight dip below or rise above the norm, will be costly.

It must be assumed that the dividend is amply covered by earnings, and that it is likely to continue. Any imminent or possible future dividend cut will negate the strategy's use. Some traders will insist that a company pay out no more than 60% of its earnings.

Keep in mind: The trader is not interested in income as the price objective. The strategy is predicated solely on price moves either above or below the dividend parameter used. The strategy is merely the guideline for action.

Example: Whenever the yield is below a 6% yield, the trader will sell the stock. At the point where the yield equals or exceeds 6%, the stock is bought. The selling flag is always based on this yield indicator.

In this example, past experience with the stock would have to indicate enough potential of a swing in price, for overcoming transaction fees. Actual costs will depend on the volume of stock traded and the specific client/broker relationship.

In another version of this strategy, once a purchase is made, the selling flag is determined by another indicator Sell Signal, which has to do with changes in interest rate levels.

Pros/Cons

Advantages
Dividend yield has attractive strategy purposes, using at least two basic indicator flags.
One aspect of the strategy is a specific filter-type, while the other is a selection aid, that works with conventional indicator flags.

Disadvantages
Misuse can impair the discipline behind a selling flag objective.

Trade a Stock on the Basis of Earnings Yield

Background

Earnings yield is composed of a stock's earnings per share, divided by market price. This distinguishes it from the price/earnings ratio, which is market price divided by earnings per share.

Market mode strategy employs earnings yield as part of a trading system. (Earnings yield can be used in the corporate mode in a different context).

The decision to make a stock purchase derives from two investigations:
One. An evaluation of the dividend to see if it is amply covered by cash flow from earnings. A pattern of good dividend pay out for at least five previous years is a must. Corporate debt should be in no danger of impairing future pay out.
Two. A comparison of earnings yield, versus that of a AAA corporate bond, or another fixed income parameter, that have under one year to maturity.

The earnings yield will grow in several ways:
Increasing earnings with no market price increase.
Increasing earnings with a market price drop.
Decreasing earnings with a market price fall that is more than the percentage of earnings decrease.

As long as the earnings yield is growing, and can be favorably compared to yields from fixed income alternatives, the trading position can be kept.

The strategy can be implemented in two ways:

One is a form of filter system where the selling flag can revolve around the differences in alternate fixed income yields, and the earnings yield. The stock can be sold if the income from a specified alternate investment (AAA corporate bond, or a Treasury T-bill, etc.) rises a certain level beyond the earnings yield. Consideration is given the risk of the shareholding, the nature of the alternate risk, and its maturity.

The second implementation is done with a conventional indicator sell signal. A trend in the interest rates of a specified bond or of other interest-level indicators can activate the sale. The trader will have to make a decision on the comparison of equity and fixed income expectations. The alternate, fixed income source can be compared by risk and maturity.

The trader's decision will be based on objectives, but as a rule, the strategy is used for stocks which are not considered growth vehicles. The differences between equity and fixed income will be smaller than with such growth equities.

Pros/Cons

Advantages
Earnings yield strategy offers two variations on the market relationships of dividend yields
Both filter type and conventional indicator selling flags can be utilized.

Disadvantages
Misuse can impair the discipline behind the strategy.

Intrinsic Selling Character (of the group)

Dividend yield and earnings yield make an excellent strategy for buying and selling choices. Plan the guideline in advance so that the choice is always mathematically clear

M-889-CZ

Short Selling and its Techniques

Background

Short-selling is the antithesis of the commonplace philosophy of the average long-term investor or short-term trader. Both commonly are seeking their holdings to rise in value. The short seller, on the other hand, is hoping for the market to fall. That is because the short-seller has sold holdings, hoping to cover the transaction at a lower price in the future.

Even if not short-sales candidates, such securities may still be erratic in sales and earnings, or they may be reaching ever-higher prices which may make them sensitive to quick selloffs.

Short- Sell a Stock of a Company With Heavy Short-Term Debt

Background

When companies are on the verge of a business down cycle, loaded with heavy short-term debt, some interesting trading possibilities evolve. When a business cycle brightens, the same can arise.

Some managements find it hard to resist the chances they may have to borrow, whenever they feel interest rates are going to soon weaken, This affords them an opportunity to refinance their longer-term debt at lower cost.

Others take on short-term debt because it generally is cheaper. They feel they can maneuver their finances, or wait perhaps, until they are able to go into the equity market for capital. In any event, this mode of borrowing is temporary for most.

Debt of this type may have been taken on for marketing programs where cash flow has not yet been forthcoming and may not be in the near future. Much of the short-term debt may have been taken on for takeover bids. This may be due to a purchase of another company, or for warding off acquisition, or for the purpose of bailing out an individual or entity who just acquired control, and who needs to use company assets to pay for it.

However, planning of this type can often go awry. Business cycles and their attendant interest rate levels, are not easily predicted by management or by economists. Companies frequently get stuck with unmanageable short-term debt, no matter what they may be paying for it. As good as intentions were, management can find itself pressured by debt that has to be continually refinanced at a time when lenders are concerned about business conditions and corporate operations.

Stocks of heavy-debt companies are always candidates for short-selling technique strategies. Current corporate performance should have no influence on strategy usage. The technique may be the conventional short-sale with the trader's own or borrowed stock, or one of a variety of option techniques

Caution: Short-selling is a dangerous game at best. The impact of sudden good news about the company or the market can produce disaster, unless suitable signals are activated in time. Substantial, unlimited funds can be lost, while the profit side of the transaction is limited to a stock price falling to zero. The strategy ought to be used only by expert traders who can stay close to the market's action.

Over-the-counter stocks can be “rigged” in the sense of being over-promoted by one or two dealers. While they can drop precipitously, as support is withdrawn, they do not make suitable short-sales at that point.

Note: All stocks cannot be shorted Some do not have the required market liquidity. Also, they have to be marginable for inclusion in margin accounts. Further, short-sales can only be covered by the uptick rule. The latter depends on where the shares are bought and sold.

In addition, all transactions can be treated only as short term gains for income tax purposes. Also, the stock being shorted must go down more than the dividend, for a break-even. Another point: The charge for borrowed securities has to be taken into consideration of the strategy.

Pros/Cons

Advantages
Companies with heavy short-term debt are walking a tightrope, especially if they are entering a business down cycle.
Sophisticated traders are able to use hedges, to help protect their positions.

Disadvantages
Risks of short selling are high, at best; should the stock show strength for a period of time.
Short selling techniques require extensive knowledge.
Temporary bullish news about the company or the economy, may bolster the market to the trader's disadvantage.

Short-Sell a Stock Ready for “Surprises”

Background

Traders can often anticipate short- selling opportunities, by looking for contingent “surprises.” These can come from a variety of sources, including:
A sudden drop in corporate cash flow, of a nature that must lead to a serious financial squeeze.
An apparent acceptable takeover bid from an acquirer, that suddenly falls through.
Corporate activities that may be subject to an imminent recession's effects.
Corporate activities that frequently lead to surprises. Example: A drug firm having to recall an important product because of a report of severe side-reactions.
Adverse regulatory, infringement or other legal decisions, despite what the company may deem as “not material.”
Announcements about a competitor's major new product line.
Evidence of extensive insider selling of corporate stock.

Some reminders are in order: Not all stocks can be shorted. Market liquidity is important, and a stock must also be marginable for inclusion in the account.

All transactions can be treated only as short term gains for income tax purposes. If the tax consideration is an important factor, some of the short-sales that can extend a conventional time frame, may make the transaction inadvisable.

The charge for borrowed securities ought to be taken into consideration, if the position is to be held for awhile. The profit potential may not be too great to start with, if proper coverage signals are designed. Furthermore, a stock being shorted must go down more than the dividend for a break-even.

Short sales on listed stocks can be covered only by an uptick. Over-the-counter stocks, while they do not bear uptick regulations, can be “rigged”. This is where only one or two dealers make a market. Should such dealer support be suddenly withdrawn and the market falls, the short-sale transaction may be impossible to perform.

Pros/Cons

Advantages
Corporate and market surprises can create excellent short-trading situations.
Traders who use hedging techniques, can help protect themselves from part of the risks.

Disadvantages
Risks are high in short-sale transactions. The upside moves can prove calamitous, while the stock cannot fall to any more than zero.
Extensive sophistication and market knowledge is mandatory. The activity is suggested for use only by experienced, full-time traders.
Temporary bullish moves by the stock can cause heavy losses. It can take time for the public to recognize the short-sale potential a trader may see.

Short -Trade a Stock With a Large “Short Interest” Position

Background

The month-to-month short interest figures for stocks that are listed are reported about one week after they are toted up. The figures appear about the middle of each month.

Increases in the figures, by company or the entire market, has always been taken as a bullish sign. The assumption is that previously borrowed stock will have to be replaced, to cover the short transaction. If the short interest outstanding for a stock is unusually high, it means there will be more urgent buying to cover.

Short interest figures may be more of a psychological factor, than they had been in the past. The role of puts and calls, and allied issues, serves to mask what the figures mean.

Risk arbitrage and hedging of position is a constant phenomenon. This involves buying one stock of a company involved in a merger, and selling short the stock of the other.

Odd-lot short-selling statistics offer contrarian strategy opportunities. The strategy assumes that the odd-lotters are generally wrong. Moreover, it does not get muddied by the presence of sophisticated hedging techniques.

Short-Sell an Over-Popular Stock

Background

Stocks are often overpriced for reasons that have little to do with the way their companies operate. Deep-seated market moods, or fleeting market sentiments, are what make up their market rationale. The average individual as well as professional may get caught up in a faddish concept that helps direct their thinking.

One study of analysts found that over 85% of their reports suggested recommendations in the “neutral” to “solid buy” range. Only 2% to possibly 5% of the reports ever contain strong sell advisories. This certainly has to produce optimism among clients, far out of proportion to reality.

Stock prices are created primarily by new holders of a stock. They clearly expect that the stock they have just bought will go up in value. Yet, again, this cannot be the average outlook of the market. Remember, there has to be a seller for each buyer.

Corrective market forces are not equal. This is contrary to those who hew to the efficient market theory that produces the random walk. There are discrepancies in the theory, along with its valid contentions.

Just one example: Pension and similar institutions provide about three quarters of trading volume. They can sell what they do not want to hold any longer, but they are restricted in their use of shorting techniques. This makes for an incomplete corrective factor in an efficient market.

Institutions frequently hold on a bit too long to overvalued stocks because of blind faith, or habit induced by peer pressure, or for their own “window-dressing” purposes. The latter helps to “dress up” a portfolio with the “right” stocks, for the public's view at quarterly or annual reporting periods.

A trader who can seek out stocks that are in over-demand for any reason, and who shorts them, obviously has the advantage over the restricted money managers and the individual who has become over-enthusiastic. The strategy must be carefully implemented with proper selling flags ((or covering flags in a short sale), inasmuch as its contrarian viewpoint is accurate mainly at extremes of popularity.

Some reminders: Many stocks cannot be shorted. Market liquidity is required, and a stock must be marginable. In addition, transactions can be treated only as short term gains for income tax purposes. If the tax consideration is an important factor, some of the short-sales that can extend a conventional time frame, may make the transaction inadvisable.

The charge for borrowed securities ought to be calculated, if the position is to be held for some time. The profit potential may not be too great to start with, if proper protective devices are designed. Furthermore, a stock being shorted must go down more than the dividend for a break-even.

Caution: Short sales on listed stocks can be covered only by an uptick. Over-the-counter stocks, while they do not bear uptick regulations, can be “rigged”. This is where only one or two dealers make a market. Should such dealer support be suddenly withdrawn and the market falls, the short-sale transaction may be impossible to perform.

Pros/Cons

Advantages
The strategy uses a contrarian approach at the extremes of a stock's popularity.

Disadvantages
Risks are high in short-sale transactions. The upside moves can prove calamitous, while the stock cannot fall to any more than zero.
Extensive sophistication and market knowledge is mandatory.
The activity is suggested for use only by experienced, full-time traders.
Temporary bullish moves by the stock can cause heavy losses.
In a contrarian stance, it can take time for the public to recognize their overzealous pursuit of the issue.

Trade a Stock with Erratic Sales and Sales Backlogs

Background

Many industries experience booms and busts over relatively short periods. Automobile manufacturing, ore mining, household appliance production, are but a few. Cycles may be of longer or shorter duration, but trading openings are available each time they occur.

Inventory problems are normally a plague for most, at the bottom of a cycle. To ameliorate this, managements always attempt to keep inventory to a minimum. Sales downturns need not cost more in terms of aging inventory that ties up working capital. The adverse impact of a business cycle is not only attributable to lower revenues, but also from this higher cost of keeping product ready for sales. (Note further on how this differs from having backlog).

In some businesses, the size of the backlog reflects the coming sales outlook For instance, in the semiconductor business, stock market values of producers move sharply in either direction as incoming orders fluctuate. A ratio has been established by some researchers, whereby new orders and actual shipments are compared and plotted. The higher the new orders, the rosier the outlook for that industry, and for industries which depend on semiconductors.

The electronics industry relies so much on semiconductor components, you can gauge its prospects with the orders they have placed for them. The fortunes of manufacturing and testing equipment businesses that use semiconductors will also be directly related.

What holds for the backlog in semiconductors will be true of any industry where shipments are made some time after an order is booked. Airplane manufacturing, arms production, boat building, industrial and commercial construction, are a few.

The need for inventory in such cases, and its attendant working capital requirement, is acceptable practice. The bigger the backlog here, the better situated the business is in its operations.

The trick is to find the trend of sales, or sales backlog, and compare it to see what has been historical, and what it current. That trend will help fill out the strategy. This will help determine whether the trading transaction should be on the long side (a purchase), or a short selling technique.

An alert trader will simultaneously receive insights into how other strategies could be used, given information on sales and backlog trends that concern their suppliers.

Caution: Because information may be stale by the time it is received from the media, a trader is at a disadvantage. Corporate mode strategy might be an alternative, as it goes into the investigation of operations at the corporate level.

Pros/Cons

Advantages
Backlogs have a direct bearing on sales many companies will report in the near future.
The knowledge of what they are and their trends can greatly assist the trading transaction.
Backlogs of orders by suppliers give a good indication of the prospects of the industries and companies that depend on those supplies.

Disadvantages
The market is acutely sensitive to backlog information. A trader must be alert and quick in the use of effective selling flags.
Backlog data is slow in reaching the news media and market. By the time it is reported it could be too late to make a timely sale (or purchase)

Intrinsic Selling Character (of the Group)

The reason for covering a short must be exactly opposite that for having made the short transaction. You must have a firm guideline for the event that will trigger the covering, even though there may be several likely incidents that may bring that about

M-919-BY

Market Highs and Lows and Deal on Momentum

Background

Many specific strategies can be used for either market laggards or market winners. The truth is, securities never remain in such conditions or momentum forever, and must be handled accordingly.

Buy a Stock That Has Reached a New High

Background

A minority of traders pursue a strategy of buying new highs. Yet, it has a valid logic, provided strict selling discipline is created and implemented. The strategy is not as demented as it may first appear.

The assumption: A stock's market momentum will continue in one direction, in this case upwards, until some market mood or sentiment develops to initiate a reversal.

That reversal is inevitable; stock prices don't climb forever. On Wall Street, short-term players are always prepared to take quick in-and-out profits, no matter what a stock's potential. The trick, then, for any player, is to get out of the holding in time, before the other players make much of an impact in their exit.

Market timing is a favorite vocation for market professionals, and an avocation for the average securities dabbler. Few can really say they have mastered the knack. It is almost impossible to get out of a stock when it hits its exact peak. About the only way a practical optimum can be accomplished, is with suitable selling flags.

New-high strategy is the contrarians' delight, the makings of their potential profits. They believe securities never should be bought even remotely near a most recent high. Common logic, it would appear at first blush, is on a contrarian's side. Why buy when it is just a matter of time before the steam will run out of the upward move?

Nonetheless, traders who use a new-high strategy can exploit that momentum until it runs out. The only precaution: Be sure the holding will be sold quickly enough, once that trend reversal occurs. This takes proper planning and fully maintained discipline at all times. And, not many can claim to have that ability

A stock has to reach a new high just once, to qualify for this strategy. A trader may wait until the stock hits highs on two or more successive days. However, this may present a problem, inasmuch as new highs are of a fleeting nature. Waiting for that extra day or two diminishes the time in which the momentum can be exploited.

Note: Daily new highs can be an indication of corporate takeover, but new-high strategy is treated differently than that pertaining to takeover rumors.

In a way, the strategy follows the reasoning behind tape reading. A trader who reads tapes or is involved with securities transactions, can sense market direction. He or she is actually playing trends that account for new high transactions.

Caution: Traders ought to engage in this strategy as a full-time endeavor. The most attentive and conscientious broker will find it hard to manage discretionary power from clients trading new-highs. The broker has too many other accounts that must be watched. So from a practical point of view, the trader should be in constant touch with the broker. Limit orders are possible as an alternative, provided careful pricing revisions are made, at least once and possibly more each day.

Pros/Cons

Advantages
There is never any reason not to follow a stock's momentum in any direction. This market condition is the only way short term success can be achieved.
The use of sensitive selling flags can help add to the odds for success.

Disadvantages
Trading new highs is sophisticated and takes broad experience and close contact with the market.
The strategy requires a trader's full attention.

Trade a Stock Among the Five Most Active

Background

The five most active on a major exchange such as the New York Stock Exchange on any trading day, represent special types of potential strategy. Any of the top five, or even ten or fifteen, most active, will give a picture of important events in the market. They will screen and focus attention to specific reasons for extraordinary volume. And opportunities.

A close look at the cause of activity will furnish a trader valuable insights.

A takeover offer or similar major announcement may be imminent in one of the stocks on the list. Or, a leveraged buyout by management and an outside financing group may be in the works. Rumors may be hot and heavy. Perhaps, an accumulation of shares is being made by the prospective acquirer. Or in fact, a takeover offer already has been made, and the market is reacting to it. Or, the extra-large volume shows transactions due to fresh offers and/or counteroffers from prospective acquirers of the stock. Or, adverse news about a takeover has built the volume on the downside.

Heavy institutional buying or selling may be taking place for a variety of reasons those institutions may have. Good or bad conventional corporate news may have initiated the action It can be merger/acquisition or leveraged buyout news that has induced institutional action Whatever the reason, the buying or selling by the institutions will take place over a number of days, since institutions deal in large volume. They generally have to buy in or sell their huge blocks of stock in piecemeal segments.

The most active may be blue chips or second tier companies. Aside from takeover reasons, this distinction will tip the trader off to the of market's sentiment. Is it more or less speculative, or cyclical? Does the market currently react to interest rate influences? Are any high-tech stocks represented in the group, and if so, what does that mean? Is the market in a defensive or an aggressive mood?

One or more of the five on the list may be there because of recommendations by influential analysts on the Street. These reports may have induced institutional moves that have carried the market. Money managers account for at least three-quarters of volume on any trading day.

Whatever the reasons, the five most active, on the up or the downside, generally have wide market swings. Stocks often remain in the five- most- active group for more than a day or two. Quick trading strategy can be implemented.

Note: The strategy here has only one purpose: To take advantage of market moves in either direction. It makes no difference what has caused the volume. The trader in this instance does not have to identify reasons for extraordinary volume, be they mergers/acquisitions, bad corporate news, etc. The top-five volume list is a screening device on which the trader takes a long or short position, conventionally or hedged. Stocks are traded quickly.

Volume-based strategies are highly speculative, even though the stocks selected are relatively liquid. Understandably, only those with sufficient experience should attempt to undertake the strategy.

Pros/Cons

Advantages
The top-five volume stocks on the New York Stock Exchange are a signal of speculative activity with wide market swings, and an invitation for astute trading.

Disadvantages
The strategy requires extensive experience and full-time, close market attention.

Buy a Laggard Stock

Background

A stock that performs poorly is considered a laggard. The standing can be judged by comparing a stock to the rest of its industry or to the overall market. The time frame need not be long. While the depressed or poor showing can last for years, it could be only a matter of months, and possibly, just weeks for a market turnaround.

Those who select laggard stocks feel it is only a matter of time before Street interest will be aroused. Added demand, perhaps only fleeting, will create profit potential. Special bullish news may or may not trigger that interest. Effects of the current financial news need not be a prime factor.

All securities have a popularity of some duration, at some time, and for good reason. The big marketplace players, and money managers, attempt to seek out whatever industry may have been overlooked for awhile. They will then buy into them until they get what they feel is a suitable play. Even the most depressed industries, with the worst of earnings prospects, will occasionally flutter about in the limelight Their stardom or fad may be short-lived, but some upbeat trading will transpire while it does.

Or, one company in an industry group may have impressed Wall Street with its ability to cut losses, or get its profit statements back into the black. While this may not have been the case with the rest of the industry, the result could be a rising tide that lifts all security boats.

Caveats: The question arises about time frame. Will the depressed stock or stocks recover soon? How soon? And, if they stir about, how long will it last? Are there good reasons why the stock or stocks ought to be avoided, apart from their laggard state?

Depressed markets that owe to an industry down cycle, may, nevertheless, gain sudden favor. In fact, some of these stocks may have already recently taken a quick bow on the popularity scene, and have fizzled out—again, Though they may now be truly recovering their financial and operational health, they are simply not playing a role for the present.

A company in serious financial trouble still may present an opportunity for the trader looking for an upside reaction. Short of imminent bankruptcy, the strategy can be employed to make the most of an upturn. The only precaution is the creation of suitable selling flags and their proper implementation.

Finding laggards is easy; discovering which will make appreciable market noise is another problem. A stock at its 52-week low is a definite candidate. Highly volatile stocks on that list qualify for an even closer study. A stirring of interest from institutional buyers is always an excellent positive sign.

Analyst-neglected stocks are always potential laggards. If no analysts are about to tout a stock's prospects, it will be easy to remain a wallflower. This can be the case for years on end, if analysts continue to overlook a company. Well operated and financially sound, it may simply lack glamour. Companies with this bad luck fail to grab the attention of the movers and shakers that make the securities market.

Many laggards reach a point where they have truly hit rock bottom. A lack of interest in them reflects an abject market condition. And, while new lows are still possible, chances of a turnaround are yet feasible Studies of companies which have not done well, or have been neglected by the public, do indicate a tendency to do better than the general market, given sufficient time. This often happens due to the lower base on which percentage rises take place,

Pros/Cons

Advantages
Stocks at or near bottom will usually bounce back at a better-than-average pace.
Laggard stocks are easy to screen.
Observation of institutional trading of laggards can assist in their choice.
The creation of sensitive selling flags can reduce some risk.

Disadvantages
Laggards may remain depressed for relatively long periods of time.
Any market upturn may be almost negligible, or hard to profitably transact.

Buy a Stock at its 52-Week Low

Background

When a stock has reached its lowest point over a lengthy period of time, it may be ready for a sizable technical upturn.

The period taken is often 52 weeks because it is listed in the major financial publications and financial newspapers. If any other time frame were more universally published by market observers, that could just as easily be substituted for the 52-week range. One year may not be sufficient for determination of what is really a laggard stock but it does provide reasonable parameters for the use of this strategy.

In effect, the strategy takes into account the psychology of having a daily posted figure for all to see. There may be reasons why the stock is at, or close to its bottom for the past year. It may have to do with corporate misfortune; perhaps disappointing profits or poor industry prospects. The company may be at the edge of bankruptcy, or a cataclysmic lawsuit, and the public is well aware of it.

It could be that the Street just has no interest in the stock at the moment, or in the type of stock, or its industry. In fact, the company may be doing extremely well, operationally and financially, but the price of the stock is still languishing. With no interest from enough buyers, no matter what favorable news, the stock will languish Many of the factors that go into the making of a laggard may or may not be present in this case. The overriding factor in the use of this particular strategy is the presence of a low or near-low in the stock's price, going back fifty two weeks.

What there is definitely present here, is the published statistic that shows a company's common stock is at, or is nearly at, its 52-week low. The stock's course may be affected by its notoriety in the financial media. The psychological state created may thus make some impact on the thinking of stock buyers who are looking for a turnaround.

What will make a trader with this strategy different than most, is the use of a selling flag that will complete the transaction plan. The flag will be designed on the premise that any flare-up of popularity may be short.

Yes, the stock is a laggard, but its sensitivity to the sentiments of the market may be a bit sharper at this point. The reason could be the listing of its 52-week low. Particularly volatile stocks are to be closely watched for use of this strategy. (e.g. Those with a 50% or greater variance between high and low).

Of course, continued new lows are possible. Again, whatever happens in the market may have little or nothing to do with the corporate fortunes involved. The company could be doing well or especially poorly. Selling flags should take this into account by being sensitive to market conditions.

Pros/Cons

Advantages
The strategy is as easy to follow as the stock tables in the morning newspaper.
Chances of some upturn are more likely, once the public has been made aware of the new low.

Disadvantages
Stocks at the low for the year may fall further, despite little corporate reason for it.
If there is no immediate turnaround, funds will be tied up longer than the trader would wish
Volatile stocks can present problems, if not attentively observed.

Trade a Stock on Above-Average Price Movement

Background

Some traders believe it is best to buy a stock when its price momentum is greater than it had been, and where the momentum exceeds its own historical movements, and/or that of the overall market. This trend should usually be strong. The idea is to stick with a good performer.

Stocks selected with this strategy may not be reaching current new highs, and they are treated somewhat differently than they would normally. Whatever their price history has been in the more or less distant past, these stocks are now showing better-than-market near-term or intermediate-term activity.

The strategy is usually the stock's 10- week moving average. It provides more sensitivity than a mere comparison of a year's high or low, by showing change over the ongoing, relatively near-term. A degree of change, or lack of it, will be noticeable for the purpose of the strategy.

Another measurement is the periodic comparison of the current price with the stock's average price, taken over the previous three or six months. Friday closing prices each week can be the basis of calculation.

For a different, revealing slant of the nature of the momentum, further comparison can be made with various market yardsticks. Comparison can be made, for instance, with the Standard & Poor's 100 Average (which contains the major blue chips) and the Standard & Poor's 500 Average (which contains the not-so-blue major companies). Comparison may be made with broader representation of averages, such as the Value Line 1700 or The Wilshire 5000

The strategy makes the most of a stock's relative strength, on the assumption that relative value is all-important. It judges a stock's historical activity or its performance with others, instead of looking at stock moves as an absolute. If a stock rises along with the rest of the market, it means little. Only when it moves up faster than it usually does or faster than the rest of the market, then it may be worth buying.

Interestingly, studies have been done by random walk enthusiasts that claim that relative strength shown from time to time is but an example of an efficient market at work. In other words, that strength is a haphazard occurrence. The random walkers' claim may or may not be true; the jury is out for a decision either way. No matter. If selling flags are sensitive and they are closely observed, relative market strength can be taken advantage of.

A trader has to subscribe to a financial publication that gives 10- day moving averages, or do the accounting. Where an ongoing average is needed for 3-month and 6-month intervals, the work must be done by the trader, or researcher.

Pros/Cons

Advantages
Studies show that stocks move better when they have the momentum for move.
Traders have a variety of comparisons they can make, in order to determine noteworthy above-average price movements
The use of different points of comparison and various averages, permits a trader to fine-tune the parameters to be used.

Disadvantages
The movements may be so small that only highly sensitive selling flags will be worthwhile.
For the most part, the trader will be required to do a considerable amount of clerical work.

Trade a Stock on Below- Average Price Momentum

Background

Unlike those who buy stocks when they have above-average price momentum, some traders feel the opposite makes sense. They contend that a lack of momentum is a harbinger of better performance. There is no contradiction here, if selling flags and discipline are watched for each.

The momentum is comparative and not specific. The stock price may be rising, but comparatively slower than the stock's past performance indicates. The stock may be rising at a much slower pace than that of the rest of its industry, or whatever index or average is being taken as the parameter (e.g. S & P 100, or S & P 500, Value Line 1700, or Wilshire 5000).

These traders believe the strategy makes contrarian logic. Those who seriously devote their attention to momentum theory look at the relative strength aspects. Those who take the opposite tack do so on the premise that the majority is wrong. Traders using below-average momentum strategy are likely to be longer-term players than those interested in above-average strength. The interest that has to spark this type of trading, may lag for considerable time. Funds will therefore be tied up longer.

Once an upward trend does set in, here ought to be little difference in time frame. The selling point is when one of the strategy selling flags is activated. These lie in about the same time frame once the trend is on.

The screen here is the stock's 10- week moving average, or an ongoing average based on weekly price closings, back either 3-months or 6-months. There is no preference in time frame choice; whatever is easier to obtain is what the trader ought to use.

The 52-week high/low range does not give sufficient nor exactly comparable information on which to base a screen for either high or low momentum. Value for the variance is merely to determine volatility and not for selecting eligible issues for transactions.

Note also, arguments by efficient market theorists about the random walk character of some of the observations made for strategies of this kind. The fact some stocks exhibit relative momentum, or lack of it, is just an exception to normal actions of an efficient market, so the claim goes.

Pros/Cons

Advantages
Under-average momentum will sooner or later attract market interest, and with it, profit potential.
A contrarian- like advantage develops, particularly if the under-average momentum has persisted for some time.

Disadvantages
Selling flags must be highly sensitive as any move will be most likely tentative and over fairly quickly.
It could take some time for below-average momentum to get back on track for any meaningful, albeit slight move.
A considerable amount of clerical work may be needed for the statistics.

Trade a Better-Acting Stock in the Strongest Industry Groups

Background

Many traders bank on the conviction that strong-acting stocks will continue to get public interest and support for a period of time before they stagnate and start heading lower. They feel demand will persist for additional upward movement long enough for profit potential to develop.

Such strengths appear to periodically hop about, from industry to industry; sometimes (not always) on logical grounds. Earnings of the spotlighted group are either heading up, or soon will be, because of fiscal or economic developments.

At other times, there is no accounting for a pickup in demand for stocks, except that institutional managers have focused on them for a quick play. After the institutions take their profits (or losses) they go on to another issue they like.

Stocks that are subject to faddish interest on the Street generally continue their strong movements for relatively short periods. Since institutional attraction which caused the demand is temporary, it is just a matter of days or weeks for the strength to often into weakness. Funds will be needed for the next attempt to get a play out of a stock group. They will have to come from holdings and not merely from fresh funds the institutions may have received.

Some theorists reason: Stock volatility or Beta coefficient, can help select the stock. A Beta of more than 1.0 shows above-average volatility; a figure of under 1.0 indicates less than average volatility. Those that moved within narrow ranges in the past, may not provide enough profit potential in the near future. In the absence of Beta statistics (available from brokers or services), the trader may want to use the 52-week high and low figures. Stocks that have greater percentage variances are more volatile and are capable of better movement.

Example: A stock that has had a low of 10 and a high of 20 over the past year has experienced a change of 100% over its low. One that has had a low of 10 and high of 15 has experienced a 50% move. In the $10 to $20 range, a variance of over 50% is considered high. (When it comes to volatility, lower-priced stocks are more volatile)

Those who champion random walk pricing explanations for market performance believe the past activity is more or less haphazard. If efficient market followers are correct, the volatility of a stock for a short period, will have little to do with past performance. Whether you believe in the efficient market or not, over the near-term many unseen fiscal, economic and competitive influences could propel the market into varying patterns that have little relationship to the past.

Caution: The strategy is sensitive and requires flags that can activate sales quickly, should the market suddenly turn against a trader.

Pros/Cons

Advantages
Volatility approximations are relatively easy to get from the highs and lows published in the financial press and from brokers or services.
High volatile stocks move substantially, for full profit potential in trading accounts.

Disadvantages
Selling flags must be sensitive to quick market movements. Even sophisticated traders should be wary.
Volatility strategy can be dangerous unless a trader uses strict discipline on selling plans.

Trade a Stock on Advance/Decline Characteristics

Background

This is referred to sometimes as the “head of the market” strategy. The relationship between stock price advances and stock price declines are charted. The comparison can then be made on an ongoing basis for the previous ten weeks, and usually on up or as long as thirty weeks

Advances and declines each trading day are easy to follow; the financial newspapers list them by totals of issues that were up or down that day. Some list them as well in terms of total dollar volume, each on the up and the downside. Specialized financial publications and services provide them already charted, though they can be calculated by the trader. Special charts can be kept for observing shorter intervals: 5 days, two weeks, and so on, to suit individual objectives.

Daily advances and declines give a good idea of overbought and oversold market conditions. Moreover, they give insights for the general direction and intent of the market.

For instance, a major stock average, such as the Dow Jones Industrial, may be up or down significantly. This will be the result of major moves by a few of the blue-chip companies in its make-up. Aside from these market leaders other stocks within the Dow may be reacting differently. Some may have less strength. Others may, in fact, be weak. The advance versus the decline figures can thus give a much better view of market conditions that the Dow cannot provide in every instance.

Traders can tell whether what appears to be market direction is broadly based or not. If bullish, they can be cheered by increased ratios (by number or dollar volume) of advancing issues. If bearish, they can be reassured by the increase in the number or the dollar volume of declining issues.

Advances and declines had been valuable indicators of selling climaxes. When the market fell sharply, and carried with it a good part of the trading, and if this condition persisted for a couple of days, the so-called climax had been reached. Of course, this did not always ring true in actual practice, but this definition of a selling climax was almost axiomatic.

The use of stock indexes today, with its options and futures side products, have pretty much outmoded the use of advance/decline strategy, It can still be used on occasions Stock indexes have been created in a way that gives views of the market for various groups or grades of securities. That is possible owing to the wide variety of available averages and their individual compositions and makeup, Such as The Standard & Poor's 100 or Standard & Poor's 500 or Value Line (1700), or Wilshire 5000, Each give representation of a whole spectrum of stock types, from blue chip to run-of-the-market. The S & P 100 contains more major companies than the S & P 500. The latter furnishes a better picture of the major-trading market. The Value Line contains over-the-counter securities and is unweighted. It provides a yet broader market perspective. A list of 5,000 issues gives a yet broader view.

Pros/Cons

Advantages
The statistics are easily available as such, or gleaned from the financial pages of the daily newspaper.
The trader can get a fairly good inkling of market direction.

Disadvantages
The strategy is less sensitive in many ways than would be one using stock indexes of different types.

Momentum Investing

Background

Bull markets are good for momentum players. They use a strategy premise that trends continue for a long time. And they are easily spotted and observed. If a stock or industry overall market has done well for awhile, it will continue to do so until the trend stops or changes directions. You get out then.

Momentum strategists do not say buy low and sell high. Instead they buy high but sell even higher. When the market is going up in a long-running boom they stay with it. It can be tricky when the market is peaking or the bull is maturing. Beware when the momentum stops. You have to be out quickly.

It can be disciplined in many ways. You stay in until the time to get out is flagged. It must be disciplined or you will have trouble when the momentum turns around to your disadvantage. The strategy can work for individual stocks and for mutual funds, especially sector funds. (except for in-out trading restrictions on mutual funds). ETFs or exchange-traded funds can be ideal.

Momentum investing holds a belief that earnings will grow greater than had been anticipated and it s the a major factor behind booming stock markets. Studies have shown that the market takes good news into account slowly but surely Research shows that a momentum stock outperforms the market for anywhere from six months to a year after good news.

Momentum strategy is good as well for investing in smaller companies that can grow 30% or more a year. The theory is simple. Buy stocks that increase earnings at a fast rate. However, it is not easy to detect increasing earnings by quarter. (That is why analysts hesitate to raise earnings estimates too quickly. Furthermore, earnings have to be clarified, as to operating revenues from non-recurring income from sales of assets and from balance sheet maneuvering that may affect earnings. Most analysts do not do this.)

Caution: Be careful of momentum stocks in a down market. If a stock is owned predominantly by momentum investors, it can sink like a stone.

Intrinsic Selling Character (of the Group)

Use whatever specific strategy you selected and employed for the purchase of the security. Then create a guideline for the sale and stick to it. Be certain the selling flag includes a maximum fall in price from a predetermined high. Remain alert because of the nature of the strategy.

M-945-BY

Trading Security and Market Types

Background

The various types of securities that can be traded add sparkle and interest as well as profit potential to the enlightened investor.

Trade a Conglomerate

Background

By definition, a conglomerate is a melange of companies held by one parent. The companies are usually in different industries. Conglomerates can be faddish in the financial community. At times they are considered the best way to invest because of their perceived safety and growth. Since the companies they buy are usually in different industries, it is felt that a downturn in one will be offset by a boom in the fortunes of others. This all make sense in theory, at least. And because many of the companies under the parent may be in growth industries, at least when bought, the parent and investors will be getting the best of all potential and safety to boot.

In real life this has not worked out as planned. Mergers and acquisitions to make up the conglomerate usually brought on more indigestion than growth. The management to oversee the individual companies is usually lacking. And somehow, all types of industries seemed to turn down at once during depressions.

This brings on trading opportunities. During the acquisitions there is euphoria. When the reality of the marriages sets in, there is gloom. This makes for a erratic market and brings many opportunities for trading strategy.

Trade Paper and Print Industry Stocks to Suit Economic Cycles

Background

The paper and forest product business is a commodity business in many ways. And it's usually tied up with the Gross Domestic Product because of it. When the economy turns up, the use of paper and paper products also prosper. During recessions, the opposite is true. So do companies who are in the lumber and timber business and who process these raw materials. You therefore have a trading strategy that can be adapted to the economic cycles.

Buy a Stock Whose Company Brand Name is a “franchise”

Background

One of the assets a company has may never appear on the balance sheet. It has to do with brand names. Some, such as Coke, and McDonalds are a classic example. To a lesser degree, many companies own a name that in itself is what helps create earnings. Go into a retail store and ask for products by name and you will see how brands can be essential to most company progress. Change franchise product names overnight, and that company would be hard-pressed to match earnings it had been enjoying. So some traders operate on the strategy they will deal only with companies with such franchises.

Trade a Raw Material Producer's Stock

Background

The cost of producing and processing ores and allied raw material is a factor in the economics of inflation and deflation. Products they produce is an ingredient of inflation or deflation. The economy looks to these raw materials for a source of low cost raw material.

The raw material producers themselves are at the opposite end of the rooter's grandstand. When their product is priced low enough to please the rest of industry, they have their problems. Low selling price for their product means low earnings and often horrendous losses. This generally happens when a recession is on. Demand for their product is weak.

Raw material producers must then cut costs to the bone. It is often tougher for them than most others. They contend in most instances with foreign countries who produce the same product, frequently below cost to keep their economies from complete stagnation. Only a few domestic raw material producers can cut costs enough to be in the black.

The hope of these producers lies in an upturn in worldwide industry, and an appreciable rise in demand of their product.

Companies may be one or two steps removed from these ore miners and basic processors. They do further processing but are really a part of the raw material-producing group. They swim in the same boat as their suppliers.

At the outset of a rebound, their higher costs of supply makes little difference and, in fact, is a legitimate sign of the healthy economy they need in order to prosper As long as such raw material costs are in a rut, industrial demand will not be enough to produce a genuine upturn required for their earnings increases.

Indexes depicting raw material costs thus always have special import for companies who dig and those who process those materials. Most lose money, some quite heavily, at the bottom of their industry's boom and bust cycle. When demand increases and prices rise, they are able to make respectable earnings once again. Their costs may rise too, but not as high as their prices; earnings are leveraged.

Pros/Cons

Advantages
Trading can be more readily accomplished where raw material producer cycles are available.
Buying signs and selling flags are relatively easy to create.

Disadvantages
Trading discipline may be misused, especially on the sale of the stock.

Avoid Legislated Stock Market Risks

Background

These are market risks that are determined more by acts of Congress or government agencies and, to an extent, state governments and agencies.

They go beyond the normal risks of markets which are affected by the economy and allied influences. Legislators or regulators do this primarily by attempting to adjust tax levels to what they may feel is currently expedient. To an extent, this effect is more noticeable when it comes to municipal bonds. There is an exemption on the federal tax on income of state and local bonds, but revenue bonds can be tax-regulated in many ways.

This is also true of any business that is regulated, such as insurance, a public utility and the like. You may have an investment in a business whose rates are set by a government body. Such as phone rates, electric or gas rates, cable rates, etc. You may never know when such regulations will become severe enough to make an adverse impact on company earnings.

Trade a Stock of a Second-Tier Company

Background

The common stock of the less-than-blue-chip companies may perform better than the blue chips. Companies are usually smaller, are listed on major exchanges, or are unlisted, over-the-counter These are the types not generally bought by institutions.

To qualify further for this classification and its strategic use, the total market capitalization (the number of common shares times the market price) should be at least $120 million. It is difficult to trade second-tier companies that are too small, or whose markets are not liquid enough. Note: Companies with smaller capitalization can also be the basis of a practical corporate mode strategy).

These smaller “grey chips” may have better, though erratic earnings growth. One survey found that this type of company tends to grow at a rate of about 5 percentage points more than do larger, more stable companies.

They appeal to those traders who want to avoid stocks in which institutions do comparatively substantial trading. Some traders will eliminate consideration of any stock, of which institutions hold more than 10%. Aside from the market idiosyncrasies that may come up because of institutional trading, traders want to avoid issues that are being bid up by the institutions.

These stocks are generally more volatile than the blue chips. This gives a wider market range on which to trade. Risks are commensurate. Moreover, such stocks may give trading opportunities in one direction, at the same time the blue chips are stagnant, or off in another direction the trader does not wish to track.

The “January Effect” is said to be more pronounced for the second-tier stocks. Surveys seem to indicate that the smaller companies tend to outperform the larger companies this month. It can be that the weaker companies were subject to more tax selling the previous December. Another answer: Added volatility of these smaller company stocks make for a better rebound.

Pros/Cons

Advantages
Second-tier stocks provide a trader with a distinct market in which to trade, as compared to that of the blue chips.
These stocks are more volatile, broadening trading possibilities.
These grey chips are not favored by institutions, and may thus present lower market pricing.

Disadvantages
Second-tier stocks are risker to trade because of their volatility.
Care must be taken in the creation of suitable selling flags, because some of this stock type will not have ample market liquidity.

Trade Only Stocks in a Major Average Such as the Dow Jones Industrial Average

Background

Those who prefer the blue chips in the Dow Jones Industrial Average, want to take advantage of the characteristics of the component companies:
The thirty stocks in it are well-known.
They enjoy strong trend lines, up or down. The trends are often stronger than that of an average stock on the New York Stock Exchange.
The stocks in the index are highly liquid, and permit trading at all times in a variety of strategies.
The Dow Jones Industrial index is itself part of the fundamental statistics and charts that the financial media use for dissemination of market information. There is no shortage of statistical information that may be needed for trading.
The Dow Jones list provides sufficient choice by industry. The leading representative smokestack, industrial commodity, and high-tech companies are included.
Full participation in trading any of these stocks is possible in recessionary or boom cycles, and inflationary or deflationary periods.
The variety of issues among the thirty, give a full supply of relative strength and volume figures, for trading in those areas.
The use of a blue chip from the Dow Jones Industrial's thirty, helps the trader concentrate attention on scores of strategies that are best suited for this type.
The Dow Industrial is heavily weighted toward the cyclicals. So, the choices offered can represent a trading objective for all types of markets and conditions.

Those who want to take advantage of the Efficient Market, will eagerly seek out the Dow Jones blue chips. They all fit the requirements that smaller, second-tier, issues do not, on any given day. Therefore, an assumption can be made that the market is always efficient, and finely tuned to specific strategies employed within that context.

Pros/Cons

Advantages
The thirty stocks in the Dow Jones Industrial Average can provide a trader with scores of different selections
There is maximum availability of information on such blue chips

Disadvantages
Stocks in the Dow Jones list are institutional favorites, and must be avoided by those who stay clear of institutional issues.
Devotees of the Efficient Market theorem feel that the stocks in the Dow are especially unlikely to fulfill trading objectives, on the basis of their past earnings and movements.

Trade a Bellwether Stock or Industry

Background

The stocks of a few companies are considered bellwether because they lead the rest within their industry, even the overall market.

Traders may find such stocks interesting because they attract a market following. They have recognized market- leading stature. They get a big play when a market turnaround is imminent. If the market leaders prosper, the others cannot be far behind. When the market leaders are in trouble, so are the rest.

Some of the bellwethers literally help make the market. For instance, General Motors is only one of the thirty stocks in the Dow Jones Industrial Average. To that extent, it exercises some influence on the figure and is considered a Bellwether.

IBM is in the same league. In fact, IBM has, in recent years, taken on much of the leadership role that GM had previously enjoyed. IBM also carries its weight in the computation of the Dow Industrials Average, but more than that, what IBM does is the market. Microsoft would belong in the same category.

Certain industries can play a role as market leaders as well. The semiconductor group acts much the way the machine tool industry used to, and to an extent, does to this day.

What can you do? You can trade Bellwether stocks because of the attention they get and their representation in the market to reflect the market.

Pros/Cons

Advantages
The bellwether stocks can be a microcosm of the entire market and a means of creating trading strategy.
They are market leaders, often showing direction of the market itself. Short sales can be a viable option.

Disadvantages
As market leaders, a trader can sometimes be crushed in the melee caused by institutions are active in the market for such stocks.

Trade Stocks in Worldwide Markets

Background

Foreign stock markets present attractive trading possibilities at all times. When the U.S. markets are dull or weak, and offer little trading opportunity, there is bound to be a bourse overseas, where a chance to profit is on tap. The U.S. presently represents only about half or so of the world's financial markets.

There are problems that may be peculiar to a foreign country. The bookkeeping of public companies overseas can be from good to questionable and downright atrocious. The trick, is to pick out the country to trade in first, for whatever reasons make sense. Then, pick the stocks (or bonds or currency).

The European Union has an agency comparable to the American Securities and Exchange Commission, which is a vast improvement over what went for securities supervision in some of its members in the past. But outside the European Union and Japan, regulation is hit-and-miss.

Economic and political conditions always add more speculative elements to security transactions. This is especially true in third world countries where governments are unstable, or where confiscatory policies or nationalization can strangle private enterprises.

Two profit (or loss) sources derive from worldwide securities markets.
One, the fortunes of the stock itself, That is, the rise and fall other stock in terms of the foreign currency.
Two, the rise or fall of the value of the U.S. dollar, as related to that of the currency where the stock is held. As the dollar gets cheaper, the gains overseas will be augmented by those from currency translation.

There is a relationship between the market here being sluggish and the overseas markets generally being buoyant. Funds simply flow from this country when better trading potential is available elsewhere. And, with that increased demand, those overseas stocks will begin to boom.

No matter how well the stock does on the foreign bourse, proceeds must be translated back into the value of the U.S. dollar. The worldwide trader must be familiar with the indicator strategy that governs the value of the overseas dollar.

Caution: Should the U.S. dollar rise in value faster than do foreign stocks, overseas profits will be reduced.

Active traders have been able to buy and sell on a twenty four hour schedule. If the markets are already closed on either coast in the U.S., there will be at least one market actively trading, whether it be in the Far East, Australia, South Africa, Great Britain, or on major European markets. This is an ideal arrangement for those dealing in foreign currency and gold.

Some invest through the medium of mutual funds in this country, who specialize in making overseas investments. Still others prefer to buy American Depository Receipts. The latter are traded over-the-counter in this country and give equity participation without the ownership of the stock itself. Dealings are only in U.S. dollars, so the currency-trading factor is eliminated.

Information is needed on the treatment of profits and losses under the. tax laws.

Pros/Cons

Advantages
The use of foreign securities markets effectively doubles the availability of trading selections
Astute trading can bring in profits from both holding the issues and from repatriating those dollars.

Disadvantages
Overseas investments are riskier, because of currency, economic and political factors.

Trade Energy-Related Shares

Background

Where energy costs represent a large percentage of operating costs, the slightest changes can exaggerate a company's bottom line and cause serious operational and financial problems. Whole industries can suddenly be made hostage to costs of fundamental raw materials. In such instances, management often has few alternatives but to pay the increases that must eventually take their toll.

Crude oil charges greatly affect the costs of oil refinery products (for raw industrial materials as well as energy), gasoline for transportation, power sources for electric utilities, and heating fuel for industry. However, hard and soft coal costs are a basic concern, though not as blunt.

Environmental concerns have restricted some of its applications, but many industries still depend greatly on its use as fuel or industrial raw materials. Cost containment, especially when oil and natural gas substitution is not feasible, is still essential to many industries. Energy-related prices can be volatile. Because they are they present enormous trading possibilities. Checking energy prices, especially oil pricing, can give leads as to security trading opportunities.

Pros/Cons

Advantages
Energy cost changes have a direct effect on the fortunes of many firms.

Observing the costs as an indicator strategy, will effectuate the use of this strategy.

Disadvantages
Only a few industrial groups are sensitive to energy costs. Moreover, there can be other influences on their well-being (e.g. debt structure of airlines), so that energy-related indicators are to be judiciously employed.

Intrinsic Selling Character (of the Group)

When you buy your security, list what event will constitute your selling flag. Also list an alternate sale, owing to a fall in price from a predetermined market high. Your actual selling flag is whatever of the two occurrences comes first.

T-320-AX

U.S. Treasury Bills, Notes and Bonds

Background

The U.S. Treasury issues come in three maturity classifications: bills, notes and bonds. They can be bought through banks, brokers, or directly from the U.S. Treasury. Or in the marketplace if already issued.

Bills have a maturity of less than one year. Bills are traded at discounts, one the basis of their yield. No interest payment is made during the term of issue, or at maturity. Bills are sold at a discount, the actual amount and maturity, determines the yield, as the maturity is at face value. (The difference between the purchase price and the maturity is considered the interest.)

Treasury notes have maturities of over one year, on up to about five years. Some that are under ten years are still referred to as notes. The minimum face value is $1,000 ($5,000 in two and three year maturities), with interest semiannually. Notes are traded in 32nds of a point, with the yield quoted in basis points.

Bonds have a longer-term maturity and are sold in $1,000 denominations). Interest is p[aid semiannually. They are quoted in decimals and basis points.

Caution: Trading a treasury bond on margin is most speculative. The slightest upward blip in interest rates (corresponding to the equivalent fall in price), will wipe out equity.

Many investors use what is called “Treasury Direct” ways of payment and reinvestment of bonds It's operated by the Federal Reserve Bank. This is especially helpful for reinvestment, or “rollovers.” No certificates are issued to show ownership. Ownership is recorded instead on the books and is called “Book Entry.” T-bills and notes (as well as bonds are now traded electronically.

Pros/Cons

Advantages
The Treasury bond is a safe, relatively high-yield, liquid investment.
Margin trading with a Treasury bond can be highly leveraged.
Treasury bond income is free of any state income tax laws that may be in effect in the investor's state of domicile.

Disadvantages
Treasury bonds do not return as much as other, if perhaps riskier, fixed income issues.

Treasury Inflation-Protected Securities (Inflation Bonds)

Background

Inflation Bonds are the effort by the U.S. government to attract inflation-sensitive investors in greater numbers. The inducement is that the repayment of the bonds at maturity will be tied to the inflation index from the time the bonds were issued.

The feeling is that investors will look more to the bond market if they feel their principal will not have purchasing power loss when the bonds mature. The bonds become more attractive.

Investors in bonds always have to factor in the inflationary consideration. Only in the 1920s and 1930s have there been periods where the spread was largely in favor of the bond investor. During World War I and World War 11, the inflation hits were heavy to the bondholders disadvantage.

Pros/Cons

Advantages
Index bonds can help the typical bond investor overcome the specter of inflation.

Disadvantages
The treasury puts these out at a lower rates than conventional bonds

T-323-AX

U.S. Government Agency Bonds

Background

The bonds are issued and guaranteed by agencies of the U.S. Government. Income is taxable by federal and state/local governments except for certain exceptions. (Check with your accountant or tax adviser for current tax regulation.)

The most popular of the government agency inspired or backed bonds are the Ginnie Maes, for Government National Mortgage Association. Ginnie Mae offers a certificate that represents a share in a passthrough pool of FHA and VA-backed home mortgages. New issues are in units of $25,000, and increments of $5,000, but Ginnie Maes can be bought on the market for as little as $10,000; in investment trusts in denominations of $5,000 and $1,000 increments; in mutual funds, for far smaller amounts.

The guaranty comes in two ways: One, all the mortgages in the pool are FHA or VA insured. And two, the Government National Mortgage Association itself offers to make up any deficiencies.

Caution: The pools in which them the mortgages are put are cut into risk slices and time-slices to create different classes. You must be careful you are getting the slice that is close to your risk and income tradeoff.

Markets for Ginnie Maes move with interest levels. When interest rates go up, the investment's value will drop, should they have to be sold.

Moreover, the bonds can be called before maturity. This could happen if prevailing interest rates drop drastically. The call would entail repayment at face value. Yet, if interest levels allow, investors/traders may find they have holdings at premiums over par. And, they might be tempted to hold on to them.

Pros/Cons

Advantage
Ginnie Maes offer a yield above a Treasury bond or any other U.S. Government-backed issue of comparable maturity.

Disadvantages
It is hard to get a true fix on the interest return from the portfolio, whose mix differs as mortgages in the pool are repaid in varying degrees.
The repayment of principal each month necessitates the constant reinvestment of funds, sometimes at ever-lower return.

Other agency debt paper is available, and some are attractive to all sorts of investors, institutions and the general public. (Fannie Mae and Freddie Mac are also mortgage-backed securities.) Government guarantees are not made on Fannie Mae, and are only on interest paid by Freddie Mac.

Mortgage securities are packaged in pools of home mortgages. The yields reflect mortgage interest rates at the current market, though the mortgages may be written at different rates in the past. The medium is perfect for lenders who wish to rid themselves of the risk of holding fixed-rate mortgages in a gyrating interest market. The secondary market has been an attractive method of assuring the financial health of lenders. They thus permit the public to take the interest rate risk.

The issues are actually “passthrough” certificates. The holder gets a prorated share of principal and interest as homeowners make their monthly payments. The agency guarantees that the principal and interest will be made, no matter the punctuality of payments from homeowners. The returns are comparable, and sometimes higher, than those from AAA, longer-term corporate bonds.

Pros/Cons

Advantages
Passthrough certificates and notes from U.S. guaranteed or backed agencies, units or systems, are a way of getting higher-then-average returns.

Disadvantages
In some instances, there is no explicit U.S. government assurance of backing.

T-329-BY

General Obligation and Revenue Municipal Bonds

Municipal bonds come as both general and revenue types:

Background

General Obligation Bonds

Municipal or tax-exempt bonds are issued not only municipalities but also by state governments, counties, schools and fire districts, as well as their related agencies. The bonds offer the pledge, that repayment of principal and interest will be made with the full taxing power of the government issuer. Should a problem arise, where there is some doubt that the issuer's cash flow will be able to make the payments, the full taxing power of that issuer will be used to make up the shortage. This obligation makes the G. O. bonds different from revenue bonds

All interest is free of Federal income tax liability, in keeping with the constitutional guaranty concerning state taxing rights. Investors domiciled in the states of issue are permitted to earn that interest free of any state or local income taxes there may ordinarily be on income.

Tax-free bonds are relatively safe. The extent of risk depends on two factors; their general obligation or revenue status and the financial foundation of the issuer. General obligation bonds, with their guaranty of taxing power behind them, are, nevertheless, not always safer than revenue bonds, where repayment of interest and principal must come solely from the issuer's project.

Some G. O. bond issues may be pre-refunded if the issuer has the cash, in such instances, U.S. Treasury bonds are bought to secure the outstanding tax-exempt issue, to enhance the bond's credit rating.

Maturity is another element in bond pricing. The longer the maturity, the higher the return New issues of tax exempts are now registered; that is, they are listed in the name of the holder, the way a common stock certificate would be. In the past “bearer” bonds were issued where no name appeared on the bond. Whoever held or holds the bond must clip its coupons for deposit, and redeem the bond itself at its maturity.

Some bonds have call features. This means the issuer is able to redeem them at a bit over par or face value. When a bond is bought, the investor should inquire about any existing call feature, and if so, what the yield is to that call date.

The investor has to be ready for surprise calls. This is done by checking the bond call notices with your broker. Issuers are obligated to notify the public well in advance of call dates. If bonds are registered in the bondholder's name, the notice will come from the paying agent.

If the first call date is in the offing, chances are the market price of the bond will be close to, and possibly over par, while under call value. Interestingly, discounted bonds with call features may be found. These have qualities that more than likely discourage a call; for example, low coupon interest rates. If the call option date is so far in the future, the call is not a practical consideration.

General obligation bonds return more than do tax-exempt revenue bonds, for reasons of comparative safety. It is obviously safer to have the full taxing power of the state, country or local government behind the bonds. Unlike a private business entity, were a government body to fall short of its debt service cash needs, the taxing power should be sufficient for the raising of funds to cover that issue's full obligation.

And, unlike a private business, a bankrupt government would generally need only a small percentage of added tax revenue to be made whole. Furthermore, any state, would no doubt step into the breach, were any of its major government bodies unable to pay its obligations. That state would do so because it could not afford to have its own credit standing impaired.

General taxing power means the most when it applies to a state government. It means less as the obligation wends down to the lower taxing bodies, such as counties, cities, the fire and school districts, and so on. The bondholder pays for the added assurance of a general obligation bond, and within that category, for the added assurance of full-backing by taxation.

Caution: Full taxing power does not guarantee that politicians will readily increase the tax rates. There are, after all, more taxpayers who vote, than there are bondholders within that state who may be effected by the payment difficulties being experienced by a state or local bond issuer.

In the final analysis, the bonds credit rating should also be used as a guideline, for determining risk factors. That rating would take into account the rating agencies estimation of how taxing power could be practicably utilized in an emergency.

Further note: All bonds are directly affected by interest rate movements Pros/Cons

Advantages
General obligation bonds provide ample practical backing for the average bondholder.

Disadvantages
Were financial difficulties to become endemic, even general obligation bonds would go into, at least temporary, default.

Revenue Bonds

Background

Revenue bonds are issues that are put forth by state, county or local agencies, but without a formal guaranty that they are ready to stand behind them. The repayment of principal and interest is to come primarily from the revenue being generated by the project that is being financed. Not enough revenue to repay the bondholders, and the latter simply will have no payments. (They are not always tax exempt. See your accountant or tax adviser.

Many governments do feel they have some moral obligation for servicing their debt and have in the past. Nevertheless, the obligation is generally limited to a specific project's revenues.

The various turnpike, bridge and power authorities, college dormitories, educational facility, health care and nursing home operations, and industrial park developments, are but a sample of the usual issuers of these bonds.

Because of this lack of specific backing on revenue bonds, but available from general obligation bond issuers, revenue bonds tend to return more for a given maturity.

Within the revenue bond statistic, variations are noted as to subindex classifications. An issue that is guaranteed by a corporation with a AAA-credit standing will show a lower return than one backed with a lesser credit standing. Some revenue bonds offer a higher credit standing at credit-rating services than do many general obligation issues.

That is understandable, as political limitations often make it hard for taxing power to be increased for the repayment of bondholders. More taxpayers vote than there are bondholders. Money managers and fiduciaries look to credit ratings as their guideline.

However, many localities have issued so many industrial development bonds, there have been problems and defaults. Small communities have backed industrial and utility projects, some for billions of dollars, where there was a concern that a viable revenue-producing operation could not implement the grandiose plans.

Caution, The size of many revenue bonds, and to a lesser extent, the G. O.s, are so small, they are not rated by the agencies (A fee is paid by the issuer for the rating; the issuers are aware that most buyers will insist on having them.

Note: All bonds are directly affected by interest rate movements. Further note: The federal tax exemption does not apply to revenue bonds for many projects. Again, consult your tax adviser.

Pros/Cons

Advantages
Revenue bonds can increase federally tax-free (and state/local, where domiciled) income.
Revenue bonds generally but not always offer more percentage return than do the general obligation issues of the same maturity.

Disadvantages
Revenue bonds do show a higher incidence of default than do the general obligation variety.
Note Bonds cannot be sold short, but they can be hedged with several trading strategies.

T-340-AX

Collateralized Mortgage Obligations (CMOs)

Background

Sometimes known as Kitchen Sink or cash flow bonds. they are backed by the interest and principal payments from pools of mortgage loans, some recycled. Some have been rather exotic. And a few originally had AAA ratings some from government agency mortgages guarantees.

The big come-on was the promise that you would not be having your principal or interest at risk. That is may not be the risk. Most investors in the past have not been sophisticated enough to realize that they may be getting the principal back when they are not expecting it and that the actual return will not be as promised or estimated.

Make a distinction between CMOs such as Fannie Mae or Ginnie Mae, which are simple mortgage-pool securities, and those which have gotten into esoteric “tranches” These include amortization classes or PACS and targeted amortization classes or TACS, and interest only tranches and inverse floaters, principal only tranches, residuals, Jump Zs etc.

Pros/Cons

Advantages
Income is always estimated to be higher than would be available with U.S. Treasury notes of five to seven year maturity.

Disadvantages
There is no way the actual return can be foretold in advance. Early repayment of principal will always be a possibility.
It requires a good deal more sophistication than an average government agency investment and is therefore is too speculative for most investors.

T-335-AX

Corporate Bonds

Background

Corporate bonds can be attractive vehicles for longer term investors, but especially for short-term traders who are seeking quick market turns. The bonds run the gamut of issue types, aside from conventional, straight bonds that mature in twenty to thirty years. They therefore whet the appetite for all manner of trading strategy.

A few of the many corporates, either secured or unsecured (debentures) are as follows: Optional marketing, redeemed in about five years; Equipment certificates, on everything from tank cars to barges, airplanes, etc.; Mortgage bonds, on anything from buildings to whole factories; Floating notes, with interest rates periodically set by benchmark rate levels; Inflation-index bonds; Zero coupons, where huge discounts from maturity value replace annual interest cost; Eurocurrency bonds, floated by the company overseas; Yankee bonds, or foreign issues floated in dollars, and so on.

Returns from corporates run higher than they do from governments or government agencies, even when they are triple-A rated. Those seeking that extra premium within a risk/reward equation, will keep the extra income goal in mind. In this regard, overall return may be the important consideration, and not the corporate bond ratings. Portfolios with low-rated bonds can often outperform those with the triple-A's, after the accounting for defaults and bankruptcies. The major credit-rating services give opinions on the larger corporate issues.

Bonds trading is influenced b rising and falling interest rates. However, they may not be primarily used for this effect. Interest rate indicator strategists are better advised to use U.S. governments for that purpose. Corporate bond markets are influenced by their creditworthiness to a large degree, in addition to the normal money market considerations. Trading applications are tied into the behavior of the bond and/or the company issuing it. A turn in a company's fortunes, and its effect on the corporate credit rating, will make a big difference in the way the market will view the bond

The easiest way to review a corporate bond rating is to check its credit-rating designation. While debentures are riskier than mortgage-backed bonds, the rating will take that into account, along with other credit-standing factors.

Corporate bonds can mature in a sequence of years (serial bonds), or they can be issued for a sequence of years (series bonds). Debentures are not collateralized' they are sold on the “faith and credit” of the company Income bonds “trade flat,” in that the interest is adjusted to corporate earnings, instead of a fixed amount. Term bonds (serials) require sinking funds for annual repayments. Corporate shorter-term debts and notes are sometimes sold with floating rates. Quarterly adjustments are made to conform to market interest levels. These are attractive for those who do not want to anticipate erratic money market conditions.

Caution: Call features must be investigated before purchase, and closely followed afterwards. Should a bond be trading well above par or its call price, that call provision will diminish the value of the holding. High coupon debt, when interest rates are falling, tempts corporate treasurers to take action. Bonds are sometimes called when they are considerably below par, for the company to effect a bookkeeping profit on a swap of issues.

Some facts should be considered. For example:

a) When can the bonds be called, if at all?

b) When you see a rating from a rating service is it being applied to the principal and interest or just the principal? There can be a difference.

c) Does the bond have a “put” provision, whereby the bondholders can sell the bonds back to the company under certain situations. For instance, when the company is being taken over. At that time, the backing of the bond may be diminished. A spinoff can do the same.

d) The weighted-average term to maturity of the cash flows from the bond, where the weights are the present value of the cash flow divided by the price.

Pros/Cons

Advantages
Corporate bonds furnish relatively high income with trading possibilities

Disadvantages
Adequate risk consideration must be made at all times.

Convertible Corporate Bonds

Background

A convertible bond gives its holder the right to convert into the common stock of the corporation, at a set conversion rate. The two parts of the equation, the convertible bond on the one hand, and the common stock on the other, are thus always interrelated. If the price of ABC common drops, so will the conversion value of the bond, but there are factors which tug at each side of the equation in different ways: The length of time available for conversion, the action of the common stock, the trend of interest rates, are but a few.

The convertible bond yield is usually higher than the dividend on the common. If the common's price is off, the risk on the downside for the bond is less. When the common rises in value, conversion advantages are magnified. The trading situation arises when the common stock goes beyond the conversion or strike price.

The return on the convertible is generally less than it would be with a straight bond from the same company. Naturally, there is a premium to be paid for the conversion leverage prospect.

The yield from the convertible is more than the common's dividend will offer. Furthermore, the bond will get first crack at earnings if there is not enough with which to pay the common dividend.

The convertible rate will be locked in, should interest rate levels drop after the purchase. Therefore, when interest rate levels fall, a floor for the bond's value will have been established.

The market for stocks will turn bullish with lower interest levels, and the convertible's value will go higher. The better the market, the closer the point for conversion

The convertibles can be margined and sold short.

No taxes are incurred on the exchange into common stock, and there are no fees for the transaction done through the company's agent. The conversions entail lower commissions than with common (or even convertible preferreds).

Convertibles attract the public when the market is lackluster. Those who harbor doubts on the direction of the market, can use the convertible as an insurance policy or hedge. There is still a measure of risk, but that has been dampened. The higher yield than would be available from the common is one feature, though that yield will be less than with a straight bond. A crack at capital gains, though diminished somewhat, is still an inducement.

Traders must be careful in that convertible prices may be less volatile than that of the common. The strategy has to be based more on the common's volatility, and the eventual effect that will have on the bond. Nevertheless, convertibles are exciting for traders who want the benefits of the stock market, but not the same extent of risks Convertible mutual funds and zero coupon convertibles also have made an appearance.

Rule of thumb: The yield on the convertible should be no more than 25% less than on a comparable bond. Stock volatility is essential. The more volatile, the better the chance of eventual conversion.

The conversion premium ranges between 15% to 30% for many issues. A $1,000 bond converting into $750 worth of stock has a $250 premium, or a 33% conversion premium ($25 over $750). The higher the conversion premium, the more it will trade as a bond. That means the convertible will react to interest rate changes more sensitively. Also, do not buy a convertible if the common is selling at the top of the cycle in a cyclic industry. This complexity has made convertibles ideal for arbitrage strategy.

Caution: Check for call provisions. Many do have the company option. If the bond sells well above the call price, and the common is over the conversion price, activation of that corporate option is more likely. Bondholders will swap for the stock if the conversion price equals the common, or where the stock yields much more than the bond Some convertibles provide sinking funds. Also: Companies like to issue convertibles when they want to be able to offer lower quality bonds at a lower cost.

Pros/Cons

Advantages
Convertibles offer trading strategies because of their market complexities.
Convertibles offer the best of both the bond and stock markets.

Disadvantages
Convertibles usually have limited marketability.
When interest rates rise sharply and both bonds and stocks plunge, these “busted convertibles” are dangerous to bold.

Top-Rated Corporate Bonds

Background

Inasmuch as so many bond issues and issuers are in the marketplace, it is essential that the public have a means of determining relative creditworthiness. It takes specialized effort to delve into the complicated procedures that ought to be done. Several organizations, including some investment firms, provide the rating service, on a fee basis. The fees are paid by the issuers, who realize they need ratings to facilitate the sale of their debt instruments. (Credit-rating services, such ass Moody's and Standard & Poors are also used for commercial paper.)

The higher the bond's grade, the smaller the return. However, the major bond rating services often do not see eye to eye, though they are usually close in their opinions. They have different methods of analyzing balance sheets and future earnings/cash flow prospects. That will account for the differences with what actually must be a subjective credit investigation. The job is difficult, because the rating services must take into account contingent managerial actions.

Caution: Credit rating services are not infallible. Even triple-A bonds are never wholly secure as to principal and interest payments. No guarantees are possible, even where a private insurer has backed timely repayment and interest.

Yet, the best way for the ordinary investor or trader is to use published ratings. Some investors buy non-rated bonds, where risks are higher, and the returns better. These are usually small issues of hospitals, nursing homes and retirement facilities who cannot afford to have a credit-rating company perform the service on their behalf. (Default rates have been high in this non-rated category).

Pros/Cons

Advantages
Income and principal are kept at minimal risk

Disadvantages
Ratings are subject to analytical error, and can be revised downwards in the future.
Bonds cannot be sold short, but they can be hedged in many ways.

Insurance-Backed Corporate Bonds

Background

Insurance support, if available, will give bond underwritings better rankings from the credit rating services, (e.g. Standard & Poors and Moody's) and will result in lower interest costs. Insurance coverage can come from private corporate guarantors, predominately the insurance companies and commercial banks. The insurance is written within groups created for the purpose. Many large commercial banks provide the coverage in the form of letters of credit.

Insurance gives the issue a triple-A rating. The guaranty is only for payment of principal and interest, never for the vagaries of market price. Clearly, risky bond issues will not be able to buy the coverage. Guarantees are available for tax-exempts, and increasingly, to debt securities backed up by packaged mortgages. The cost of insurance is always less than the savings incurred in the sale of the debt instruments with a higher credit standing. As a rule, the insurance is only about half the difference in interest costs.

Institutional investors, bound by their fiduciary responsibilities to buy higher-rated securities, are hereby given a larger choice of debt instruments, as triple-A bonds are not the norm. But caution still must be exercised. Insurance has to be from a company or group of companies that will be able to reimburse issuers for loss, should several clients get into difficulties at the same time. This has already happened in mortgage-backed securities.

Should the guarantor's credit rating drop, so will the bond's. Rating agencies do assess the insurer's ability to withstand heavy claims, their capital, the quality and diversity of business, reinsurance policies, and so on. The SEC has guidelines on tax-exempt and other securities coverage, where the insurers are to make more disclosure as to the extent of their guarantees.

Unless the purchaser's action is governed by a fiduciary commitment, the need for the insurance support may be superfluous. The bondholder does pay a price for the insurance. In effect, it's about half the difference in yield between the possible lower yield and the yield after insurance backing. Those who can adequately diversify their holdings and use lower rankings wisely, will get better returns from the risk/reward equation. And there will be little peace of mind should heavy defaults quickly wipe out the reserves the bond insurers maintain.

Pros/Cons

Advantages
Bond buyers can get better diversification of risk with the use of insurance-backed issues.
Fiduciaries and money managers, who may be restricted by the type of bonds they may buy, can now select from a larger assembly of issues.

Disadvantages
The savings of using insurance-supported issues goes primarily to the issuer, and not the buyer who is able to adequately diversify by credit ratings.
No buyer can ever be sure that, in the event of a major avalanche of defaults, the insurers will be able to meet all their obligation
Note: Bonds cannot be sold short, but they can be hedged in many ways.

Lower-Grade Corporate Bonds

Background

Deep discount bonds are given the designation “junk” bonds. These are usually corporate bonds to which have been assigned lower ratings

The bonds may have been originally underwritten at a sharp discount, to adjust the return high enough to attract the public. Or, the bonds may have been issued at, or close to par value, only to have subsequent corporate problems reduce the credit rating. The lower that creditworthiness, the steeper the discount.

These bonds are affected by general interest rate rise and fall, but the huge discounts are primarily due to the adjustment of the return to the rating as a bond. That return must be enough to attract and keep holders. They sell at a discount chiefly because their chances of default are relatively high.

Much present-day new-issue use has come from takeover offers. Would-be acquirers offer packages of cash and securities which often include bonds of this caliber. In leveraged buyouts, the company itself creates new bond issues for the insiders' benefit.

Junk bonds are therefore at the other range of bond quality from those top-rated. The term “junk” is a misnomer. When used originally among knowledgeable investors the term was not derogatory. Today, the term has been bandied about so much by the media, the masses believe it is an investment type to be avoided at all costs.

So many bond issues and issuers are in the marketplace, it is essential that the public have a means of determining relative creditworthiness. It takes specialized effort to delve into the complicated procedures that have to be done. Several credit-rating firms provide the service, on a fee basis and arrive at the ratings.

They usually are close in their opinions, though they have different methods of analyzing balance sheets and future earnings/cash flow prospects. That will account for the differences with what actually must be a subjective credit investigation. The job is difficult, because the rating services must take into account contingent managerial actions. Caution: Rating services are not infallible. Even triple-A bonds are never wholly secure as to principal and interest payments. No guarantees are possible, even where a private insurer) has backed timely repayments repayments and interest.

Yet, the best way for the ordinary investor or trader is to use published ratings. Some buy non-rated bonds, where risks are higher, and the returns better. These are usually small issues. Default rates have been high in this non-rated category).

Fiduciary and other investors who are regulated by the quality of investments they are permitted to select for clients are not able to buy the lower-grade bonds. But average investors can, and they can profit from them provided they realize that there is a greater chance of an eventual default as to principal and/or interest.

However, the lower the bond's grade, the greater the return. The idea for investors who own these bonds is to diversify so that an occasional default will not severely impact overall performance. The idea is to get a greater return than would be possible confining investments solely to the top rated bonds.

Junk bonds have many followers who feel the risk is worth taking. Fully diversified junk bond portfolios can make money, despite an occasional default in or two issues. Moreover, there can be rating improvements, should a corporation's fortunes turn around. (Note: Mutual funds that hold such bonds help provide the diversification more easily for small investors.)

Lower-rated tax-exempts are never called junk bonds, though some are equally at risk. These are generally the revenue bonds of smaller issuers, whose project does not have any prospects of achieving the cash flow for debt service. Pension fund and similar institutional investors must also stay clear of these lower-rated issues, but individuals can find them Fine opportunities.

Pros/Cons

Advantages
Junk bond returns are relatively high after taking default into consideration

Disadvantages
There can be problems unless they are bought well diversified.
This will be difficult for smaller investors who ought to buy junk bond mutual funds instead.
Note: Bonds cannot be sold short, but they can be hedged in many ways.

Discount Corporate Bonds

Background

Discount bonds, taxable or not, provide a trader with strategy that can augment income and result in capital gains. The bonds need not be considered “junk” or of low value.

Bonds bought at a discount and held to maturity will receive face value. In the interim, if interest rates fall, the value of that bond will increase and the discount will narrow. In either instance, the bondholder can achieve the capital gain, in addition to income.

Both corporate and tax-exempt bonds are issued in denominations of $5,000. However, they are always quoted in terms of “par” or face value of $100.

Each of the bonds has a coupon. If it is 4%, it means each $5,000 unit will pay $200 a year in interest, in semiannual payments of $100 each. Payments of the old bearer-type tax-exempts were in coupon form. The coupons were to be clipped for presentation for cash. However, newly-issued tax exempts are all in registered form, that is, in the name of the holder. All corporate bonds are registered.

In the above case, were prevailing interest rates to rise to 5%, that bond would have to fall in value. It would fall just enough to bring the current yield to 5%, and the holder would then have a discounted bond. On the other hand, were prevailing interest rates to fall to 3.5%, that bond would go to a premium, in order to accommodate the market.

Yield to maturity is another consideration, but that will be a function of how long it will take for the bond to mature. In addition to the current yield, a new bondholder buying at discount is getting the benefit of the difference between cost and face value at maturity, or the first call date on callable bonds. That calculation also enters into the account. Bond charts and computers provide the yield to maturity, given the coupon percentage, the price of the bond today, and the time to maturity or call date.

The longer the time to maturity, the more likely there will be a discount, assuming the coupon rate is the same. No matter what the original time to maturity, as a bond gets close to redemption its market price will encroach on face value. There cannot be much discount when there is but a year or two until the face value is redeemable. The difference will be no more than the approximate income return for that short time.

Note: The yield to maturity includes capital gain, even with tax-exempt bonds. Only income on the latter is considered exempt.

Buyers of discount bonds give up some current income, in return for future capital gains. Therefore, the example above for determining how discount (or premium) bonds arise, is not the way the market is exactly determined. Interest rate shifts do have a direct influence on pricing, but there is some give-and-take between current yield and yield to maturity, and also yield to call. Buyers who are primarily interested in the longer-term capital gain feature, have an advantage with discounted bonds.

Pros/Cons

Advantages
Bonds bought at discount provide capital gains for buyers who sell at face value or at prices higher than cost. This is over and above the interest return they get semiannually.
Those who can work with interest rate movements, will find discount bonds a practical tool for shorter-term trading.

Disadvantages
The profit from the discount is built into the longer-term bond over time; trading on the ebb and flow of interest rates must be the practical means of appreciable profit.
Note Bonds cannot be sold short, but they can be hedged in many ways.

Premium Corporate Bonds

Background

Premium bonds are those bought over par or face value. So, a price of 101 represents $1,010 in market value, with a face value of $1,000, or $5,050 in market value for a $5,000 bond. Should interest rates rise, the bond will drop in value, to where it could be a discount bond.

Why would a buyer pay more than face value? There can be several valid reasons:
The availability of premium bonds gives the trader a larger selection for profit potential. When interest rate levels are low, many bonds that were issued with higher coupons, earlier at par, would be currently selling above par. When rates are very low, most existing bonds will be at premiums.
The bonds offer the maximum current return, even after allowing for the premium. If held to maturity, the amortization of the premium is made each year, and the term to maturity can be quite long.
Traders who are concerned with the ebb and flow of interest rates, are only cognizant of trend lines. It matters little to them whether the cost is above or below par (except for amortization), so long as they can take advantage of indicators that relate to interest levels.

A bond selling at a premium is not necessarily a better credit risk. Discount bonds may have a better credit ratings than a premium bond. The only reason for the premium is the fact the market for the bond has taken into account the interest coupon on it, the term until maturity, and the overall market level of interest rates, for that type of bond.

Note: The premium on bonds tends to be reduced as the maturity or call dates approach. Example: A year or so before the bond will be redeemed, the premium will get close to face value, and differ only to the extent of interest payment equivalents.

Pros/Cons

Advantages
Premium bonds offer the holder maximum income for the particular type of security.
Corporate bondholders may be able to amortize the premium as a tax deduction. (Check your accountant to see if you can.)

Disadvantages
Tax exempt bonds at a premium may not permit optimum tax arrangements.
Note: Bonds cannot be sold short, but they can be hedged in many ways.

Zero Coupon Corporate Bonds

Background

Bonds ordinarily have interest coupons attached for payment every six months. The stripped bond is bought without coupons, the interest factor imputed by the size of the discount from face value. The higher the interest, and the number of years to maturity, the greater the discount. Its cost/return is testimony to the value of interest over time.

Zeros are available for corporate, U.S, Government, and state and local tax-exempts. They come with many titles and acronyms, depending upon the issuer. But essentially they are all similar. They are issued in units of $1,000 and sold at a discount from that figure.

Zero bonds are traded on the market to a restricted extent because the issues are relatively small, and liquidity is limited. The value of a zero bond, at any given time after issue, will be dependent on the interest rates prevailing for securities of similar maturity and type.

Tax-free municipals have been offering hybrid issues. Some actually change from zeros to interest-paying bonds. The idea is to start paying actual interest when the bondholder may need it after retirement.

Zero bonds are now underwritten for almost any conceivable form of investment, including oil and gas programs, More realistic zeros are being created for conversion into common stock. Some are being developed into mutual funds. Here, however, the buyer should ask why someone ought to pay a mutual fund management fee when no future management is needed. A management fee of 0.7% for a 20-year fund, for example, is equal to a front-end fee of 13%.

If the issue is not-tax exempt, the bondholder is required to pay income taxes whether or not the cash is received. This makes no difference in IRA or Keogh and similar pension accounts. It must be considered by those who are investing subject to taxation; they will have to dig into their pockets for taxes on moneys they have earned but do not have in hand. Having to pay taxes upfront will diminish the apparent return the bond provides.

Caution: If the bond has a call feature, the bondholder loses a part of the anticipated return-to-maturity. Moreover, markups on the sale of zeros are comparatively steep. They have been figured on the bond's face value and not discounted, original cost.

The Perceived Risk of Zero Coupon Bonds

Most investors are afraid of risk which explains why they like zero coupon bonds. The latter have a built-in return until maturity, no matter how much the market may fluctuate.

However, zero coupons do rise and fall in value. If you were have to sell them before maturity you will discover that fact. Furthermore, the secondary markets are not liquid and there will be loss due to that as well.

Pros/Cons

Advantages
Zero coupon bonds can lock in interest rates over a long time frame.
Because there is no need to anticipate what future rates may be, the zero bond maturity can be selected to tie into a specific future goal.

Disadvantages
The bondholder may fix a rate in advance, only to find that rising interest conditions are soon reducing the value of the zero instrument.
Where income taxes have to be paid each year, (even when there is no cash flow from the bond), the bondholder return is reduced.
Should funds be needed before maturity, and the bondholder has to sell prematurely, the secondary market may not be liquid enough for a satisfactory price.
Note Bonds cannot be sold short, but they can be hedged in many ways.

T-349-AX

Savings Forms of Deposits

Background

There are several form of savings that are considered conventional in that the dollar amounts are not subject to market gyrations nut earn interest or dividends as they sit on deposit.

Certificates of Deposit

Background

Certificates of deposit can be bought for as little as three months, and as much as ten years, though most banks no longer want to extend themselves that far out. Normegotiable CDs are sold as most of the public sees them-available from thrift as well as commercial banks, directly or through brokers

CD. rates are strongly influenced by the Treasury's weekly auction of three-and six-month bills. Banks often set up the CDs and also their money market interest from those figures. There are never any commissions added.

Rates for the longer terms will naturally be higher. Returns on “jumbo” CDs, about $100,000 and more, command better returns. Note: Penalties are assessed for premature withdrawal of funds.

Rates vary by bank and by region. Caution: The way interest is calculated will make a difference in yield. “Daily interest” does not automatically mean that the bank places interest earned each day into the account. To do that the bank has to have “interest compounded daily.” It does mean the bank may compound the interest quarterly or annually. The rule: The shorter the compounding period, the better.

Further, quotes of annualized interest is misleading when the CD is for a term under one year. No one knows what the renewal rate will be on a six-month CD. It can be higher or lower. Therefore, no one can be sure how much annual return will be if two six-month CDs are bought back-to-back.

Federal Deposit insurance Corporation guarantees on CDs are limited per each account. However, a number of different accounts can be kept insured at one bank, if the accounts are in different names. This must be considered by buyers of the jumbo-size certificates.

Most certificates of deposit are sold in amounts that can range on up to millions. These are negotiable; they can be sold before maturity on active markets. Their yields are correspondingly higher than what the public gets for smaller denominations and the rates vary by region of the country, in addition to the individual bank and its size. These negotiable CDs are bought by institutions and money market funds.

Negotiable 90-day CDs will return slightly more than will commercial paper of the same maturity.

Pros/Cons

Advantages
CDs are attractive short-term investments for all manner of investors and traders who wish to place funds for a little while.
Risks are relatively small for the rate differences possible with CDs.

Disadvantages
Buyers of CDs must pay a penalty if they wish to redeem the certificates before maturity

Indexed Certificates of Deposit

Background

These CDs are sometimes sold by banks and by brokers. They tie the principal amount you get back from your deposit at maturity to a stock index. If the market climbs there is a formula for giving you more than face amount. In effect, it is like owning an index fund except that you also get your interest from the CD. (The dividends payable to index owners is usually less than that earned on an ordinary CD.)

What buyers of this Indexed CD may not know is that there is a possible taxable claim by the IRS. If the account is tax deferred, such as an IRA or a Keogh or profit-sharing retirement program, there is no tax paid each year. But in conventional accounts, there can be.

That is because here are two aspects to this Indexed CD.

1) Part is a zero coupon bond which offers you a definite maturity amount. Zero coupons have imputed interest payable every year even when no interest payments are declared. There is no cash dividend, only the gain that comes from your having bought the zero bond at a discount.

2) Part is a call option on a stock Index, which is exercised if the index has gone up.

Advantages
CDs are attractive if the market rises substantially after purchase

Disadvantages
Buyers of CDs must pay taxes currently if the account is not tax deferred.

Money Market Mutual Funds

Background

Money market funds are an excellent way for investors and traders to keep funds parked until there is a need for them. They buy heavily in U.S. Treasury bills, federal agency issues, large-denomination bank certificates of deposits, time deposits, bankers' acceptances and commercial paper. Much of the non-government holdings are those of major American and foreign banks. Commercial paper has been from topnotch corporations.

Some money market funds deal only in short-term tax exempts, so their return is also tax-exempt. (Note: Money market funds who may have some tax exempts in their portfolios may not pass that exemption along to the shareholder/taxpayer.

Money market funds come in all sizes. Unlike the utility that being small has in the operation of a conventional mutual fund, the large money market funds enjoy the value of being larger. The more assets they have with which to buy, the better the rates they can get from borrowers.

The practicality of the funds is clear. No sales commissions, with small initial payments to get started, the ability to write checks (usual small minimum amounts per check), telephone or telegraphic transfers, periodic statements and daily reinvestment of interest, are what the public finds important. Moreover, the funds bookkeeping is on a constant, $1 per share basis; funds are not subject to the vagaries of daily- changing money market pricing. All brokerage firms use money market funds as part of their central asset management convenience. Mutual fund distributors permit free exchange privileges between funds.

The lack of Federal Deposit Insurance coverage, normal with commercial and savings banks, has not been a problem for the shareholders or the funds. Since the money market funds started growing so rapidly there have been no catastrophes.

T-355-AX

Mutual Funds

Background

The conventional funds, growth, income, or “balanced” in orientation, are bought by those who do not wish to pay too much attention to buying, holding and selling of securities. At the same time, investors want diversification that they feel they are unable to achieve on their own. Investment funds may be limited, or they may lack the time they feel they must devote to the market. Many forms of specialization can be realized Some strategies can be employed by the more sophisticated type of market trader, for the use of funds, much like individual securities.

However, the conventional mutual fund strategy is to buy these open end investment companies on the basis of their net worth, generally with no sales charge, and get the benefits of diversification within a general framework of specific objectives: Growth of capital, optimum income, or a proper balance between growth and income. These goals are not always accomplished, as any review of fund performance will indicate. Very often, funds as a group will do poorly, in relation to the Standard & Poor's 500, and similar averages.

The vast majority of funds today are no-load. There are no sales charges. The few who do have a charge, are able to do so on the premise that their market performance warrants it. However, this is not always the case, especially when sales commissions come out before the first dollar is put to work.

Management fees and the cost of fund operations are another consideration. A charge of about one half of 1% of assets can amount an exorbitant management fee, where assets are huge. Many funds charge less as their assets increase, so this exorbitance can be minimized as the fund grows.

Furthermore, some funds have greater expenses of doing business. Allowable Fees and expenses should run no more than 0.50% to 0.75% of assets per year Some funds have a larger-than-usual portfolio turnover. because they a lot. The more portfolio transactions, the larger the transaction costs. Unless such trades are profitable enough, the shareholders will be at a disadvantage. There was a time that fund managers were permitted to lavishly use portfolio assets for the payment of advertising and distribution costs. under Regulation 12b-1.

The SEC is the principal watchdog for the industry, A few states place a cap on fund expenses. Caution: Mutual fund shareholders can easily receive taxable income without the benefit of actually receiving income. In distributing the previous year's profits, many of the more aggressive funds will have inordinate short-term gains that are treated as ordinary income To make matters worse, the investor or trader may not have been a shareholder while those gains were being recorded.

In fact, all income or capital gains distributed to a shareholder will be taxed, whether that shareholder has been in the fund one day or a whole year. It makes no difference once the shareholder has gotten the dividend. If possible, therefore, buy mutual funds after the distribution. Note: Tax-deferred I R A or Keogh accounts do not have this problem.

Investigations have shown that a fund's size will make a difference, in that it will affect the fund manager's tactics. The smaller funds are said to have a better performance record, and some managements place a cap on their sales of shares when a certain asset size is reached. Yet, some may be too small. The explanation is simple: Small funds are very aggressive in order to compete.

They are forced to buy younger, faster-growing companies, faced with their capital limitations. When the small growth companies are doing well in the market, these small funds will shine. However, when the market treats the smaller growth companies poorly, the funds suffer.

Pros/Cons

Advantages
Mutual funds offer diversification and management to those who cannot provide it on their own.

Disadvantages
The funds do not offer better results as often as it would be desired Index funds often outperform active management,

Special Note: Selling Your Mutual Fund

Sell your fund primarily if it isn't operating as your primary reason for having bought it. Remember, the fund (managed or indexed) is only a tool or technique for the implementation of your strategy. It is to be used only for that basic objective for which you originally sought it.

Sector Mutual Funds

Background

The sector funds are mutuals which specialize by industry. Traders may wish to use specialty funds. This allows a strategy around the industry group, when finely honed selectivity is needed. Subindexes for trading are limited to just a few industries or as many as fifteen groups.

These are not a refuge for investors who want to shy away from the hurly-burly of securities picking, holding, and then selling at some indefinite time. The sector funds are literally tailor-made for those who are familiar with the detailed moods and sentiments of the markets. Rather than diversify a fund portfolio to even out the ups and downs of industry holdings, these funds do the opposite. That can be exciting for those who look into profit from moods and sentiments.

Traders who deal in sector funds realize that each industry group may have a fleeting but powerful market move, to be exploited for whatever time the group has in the trading spotlight. Traders appreciate the fact that sector funds can be top market performers, and the worst soon after. They can perform as the most volatile; groups whose market health will take turns. What is up today, can be in tomorrow's doldrums. For those who wish, there can be an element of diversification. Rather than attempt to choose the top industry group, the trader may aim at what would appear to be the best two or three.

However, many sector funds have small sales charges. They may also impose charges for frequent trading within a month. Aside from that they are more expensive because there is more activity involved in the management of any fund which has a relatively large amount of purchases and redemption's. Some funds, not the sector variety, go out of their way to shun funds they know will be invested only a short while. They feel the expense of handling those quick in and out transactions will be far more expensive for shareholders than they ought to be. Furthermore, SEC regulations may prohibit the extent of trading funds may even allow.

Pros/Cons

Advantages
Sector or industry mutual funds are perfect for traders who want to hone their buying and selling around the ups and downs of industry groups.

Disadvantages
Trading industries with the use of mutual funds can be highly speculative, as the groups may have just temporary market attraction. The trader must be able to select the ones about to move up.
Proper use of the strategy dictates strict discipline on the sale of what has been bought.

Special Note: Selling Your Mutual Fund

Sell your fund primarily if it isn't operating as your primary reason for having bought it. Remember, the fund (managed or indexed) is only a tool or technique for the implementation of your strategy. It is to be used only for that basic objective for which you originally sought it.

Collateralized Mortgage Obligation Funds

Background

The Collateralized Mortgage Obligation (or CMO) mutual funds are invested primarily in securities from packages of residential or commercial mortgages The funds invest in issues backed with the full faith and credit of the U.S. government. These include: Government National Mortgage Association (Ginnie Maes), Fannie Maes and Freddie Macs. The funds will invest to a lesser extent in Treasury bills, notes and bonds. The bonds have triple-A ratings.

Some of the funds invest exclusively in Ginnie Maes, rather than a combination of U.S. agency mortgage packages.

CMO funds have relative price stability. This compares favorably with long-term bond funds. They also behave like shorter maturities, paying higher than 10-year Treasury notes and ordinary money market rates.

The advantages of the mutual fund lies in the fact they can be bought in any denomination, for as little as $1,000. The securities can be bought directly only in much larger denominations. Also, the principal that is constantly being repaid plus the interest, can be reinvested, or taken as monthly payments. This is generally done without a sales charge. Further, there is easy, no-charge redemption, as with most conventional mutual funds.

Prices vary with the market, as with ordinary mutual funds. When interest rates are rising, therefore, the fund's value will decrease; when interest rates fall, the fund's value will rise.

Funds now are offering free check writing privileges for shareholders. The large mutual fund distributors/managers permit transfers to and from the CMO funds and the others. In fact, the use of the fund can be implemented with strategies trading sector funds.

Pros/Cons

Advantages
Collateralized mortgage obligation bond funds provide substantially higher return than that possible with U.S. Treasury notes and bonds and money market funds.

Disadvantages
If the purchaser has the minimum with which to buy such bonds ($25,000), the fund management fee can be avoided

Special Note: Selling Your Mutual Fund

Sell your Lund primarily if it isn't operating as your primary reason for having bought it. Remember, the fund (managed or indexed) is only a tool or technique for the implementation of your strategy. It is to be used only for that basic objective for which you originally sought it.

Corporate Bond Mutual Funds

Background

With the advent of interest in “junk” bonds, many investors are turning to corporate bond mutual funds. These funds provide higher interest return and the means of hedging against risk that will attend this source of increased income.

In this respect, corporate bond holders are little different than those who buy conventional mutual funds. There is the advantage of diversification and management that a fund offers. In the case of corporate bonds, there is more of an element of sophistication. The type of holder is not the same as is the case with the ordinary mutual fund buyer.

However, they are different in several other aspects. Diversification and the ability to dollar average on the cost of reinvested earnings.

1) Diversification

Junk bonds, by definition, have lower ratings. There is always a distinct chance that the corporations issuing the bonds will eventually run into financial problems. Most may not be able to pay their debt service for any period just beyond the horizon. At the same time, the yields that can be gotten with them are much better than elsewhere.

For those who do not mind undertaking the risk, corporate bond mutual funds provide the security type that is hard to replicate in any other way. A fund that can diversify its holdings by company and industry, will provide holders with some assurance against catastrophic credit losses. In a portfolio of a hundred or more equally weighted bond issues, were one or two companies to go bankrupt and become worthless, the rest of the portfolio ought to be able to produce enough return to overcome any loss experience.

Surveys of this group of fixed income issues show that bondholders can profit overall, with a well-diversified portfolio. Some trouble will develop here and there, and that is to be expected. By the same token, the high return should more than cover for any losses.

In the face of a serious recession, however, it is possible that diversification of risk may be hard to count on for portfolio protection. A few major defaults could materially affect a bond fund portfolio.

2) Dollar Cost Averaging.

Should interest rates rise, the inverse happens with bonds—they fall. However, when their relatively high returns are reinvested each month, the reinvestments buy more shares at the lower price. The process has already been studied and it is known that after as little as five to seven years or so, the cycles of bond interest rate changes tend to even out the ultimate cost of the bond holding. This can only happen when funds are kept. It is hard to reinvest proceeds from individual bond holdings. In other words, Interest rate movements mean little when you invest for the long term.

Comparing bond fund yields to bond “distributed yields.” Why is there often a difference? This is due to the fact the bond fund may include premium bonds. And there are higher than usual expenses. Their current pay outs will be greater than their yields to maturity Sometimes the difference can be 1% point. The ordinary yield is often called the SEC yield because the regulatory agency provides the formula to be used. That is computed from the yield to maturity of the fund's portfolio over the previous 30 days, and adjusted for expenses. That may include a sales load if there is one.

Pros/Cons

Advantages
The corporate bond fund provides diversification of high-risk, high-income bond ownership.
Reinvestment privileges can reduce the eventual cost of the investment despite up and down interest rate cycles.

Disadvantages
Should there be a drastic fall in business activity and a serious recession that will have an impact on the overall economy, should a number of lower-quality bonds could go into default.

Special Note: Selling Your Mutual Fund

Sell your fund primarily if it isn't operating as your primary reason for having bought it. Remember, the fund (managed or indexed) is only a tool or technique for the implementation of your strategy. It is to be used only for that basic objective for which you originally sought it.

Municipal Bond Mutual Funds

Background

Buyers have several reasons for holding municipal or tax exempt mutual funds, rather than holding them directly. As with corporate bond mutual funds, the advantages are diversification and the possibility of dollar-cost averaging.

1) Diversification:

A mutual fund helps diversify against risk, especially if some are revenue bonds, and their credit ratings range about the A or lower levels Should one holding entail eventual debt service problems, only a small portion of the portfolio will be affected.

Initial purchases of a share of the funds' large portfolio can be made with payments of as little as $1,000. One bond, providing no diversification, will be somewhere around the $5,000 face value ($1,000-face value tax-exempts are occasionally available).

Those who seek the benefits of a money market fund with tax-exempt status, can also buy funds of this type. They have all the characteristics of a money market fund, with constant and stable dollar value.

Fund distributors/managers permit telephone and telegraph transfers of funds, for cash or transfer into one of their other mutual funds.

The bonds are available without a sales commission and can be redeemed at any time without penalty or charge. Interest payments can be reinvested in the same fund with no fee. Moreover, many funds permit check-writing free of charge (over a small minimum). Automatic withdrawal plans are another utility for fund holders

Portfolio management for the mutual fund is expected to take into account the fluctuating interest rate levels that affect bond prices. If fund management believes rates are going to be lower, they will accumulate more short-term issues and wait to commit into the longer-terms when rates are higher.

In practice, bondholders can often duplicate the advantages of having a mutual fund. Management achievements are not as brilliant as desired; professionals have just as much trouble anticipating interest rate trends as the average nonprofessional bondholder. Most buyers of tax-exempts are able to put together their own portfolio with just a few issues, to duplicate the diversification they may want. Credit ratings can guide the most unsophisticated. Most bond funds are over-diversified simply because they have so much to invest at a given time. Note: Much of the credit standing of a state will be tied into that of one of its major cities. A state would have to come to the rescue of one of its major cities on the verge of default.

There can be a question with funds, of the accuracy of appraisals of individual bonds. In the calculation of net asset or redemption values, it is hard to get a fix on the true market value of issues that do not have active markets.

2) Dollar Cost Averaging.

Should interest rates rise, the inverse happens with bonds—they fall. However, when their relatively high returns are reinvested each month, those reinvestments buy more shares at the lower price. The process has already been studied and it is known that after five to seven years, depending on prevailing rates, the cycles of bond interest rate changes tend to even out the ultimate cost of the bond holding. This can only happen when funds are kept intact. It is hard to reinvest proceeds from individual bond holdings.

Should you hold bonds separately or in a bond fund?

Bond mutual funds, as just noted, have their monthly reinvestment feature. This provides a “laddering effect” which offsets the danger of rising interest rates over time. They are notably useful in long term accounts because those monthly reinvestment privileges permit the benefits of dollar averaging. And dollar averaging with such long term investments helps keep investment costs to a minimum.

If you have sufficient funds to diversify on your own and can do your own “laddering” to anticipate interest rate maturities you will need, fine. But you will need lots of bond management expertise to do that.

Pros/Cons

Advantages
Municipal bond funds offer diversification of risk, in addition to an assortment of advantages and conveniences than can accrue to mutual fund ownership.

Disadvantages
Aside from the conveniences of bond custodianship, coupon clipping, and check-writing and transfer privileges, even modest bondholders may achieve as much diversification on their own with higher-grade bonds.

Special Note: Selling Your Mutual Fund

Sell your fund primarily if it isn't operating as your primary reason for having bought it. Remember, the fund (managed or indexed) is only a tool or technique for the implementation of your strategy. It is to be used only for that basic objective for which you originally sought it.

Yield-Enhanced Mutual Funds

Background

Wall Street has developed a high-yielding hybrid type of funds that mixes safety with risk, to optimize return. They can be identified by the use of the word “plus” in their title. The funds hold U.S. Treasury bills, notes and bonds, in addition to government agency issues. These have all the trappings of secure return and go a step further. They may add, for instance, options trading, to add to the return that bonds alone do not offer.

These may be no-load but most are sales-load funds, where the minimum investment is only $1,000. (If no-load, there may be a deferred sales charge on certain redemption's within Five years of purchase). The funds provide monthly dividends and quarterly distribution of earnings and automatic reinvestment of income.

The funds have been popular in the past. Yields have run higher than it would be possible from holding the top-rated governments and other debt issues.

That extra income has been coming from an accounting quirk that treats option writing premiums as income, instead of a return of capital. The fund writes calls which permit a buyer the right to purchase the bonds at a set price. When bond prices are off, or if they remain stable, those options will expire unexercised. That leaves the fund with its bond holding intact, and with “income.”

Should bond prices rise sharply, the call buyer will exercise the option and buy the bond below the then current market. The fund that wrote the option will not be able to profit from that market rise. What is more, new bonds will have to be bought for the portfolio at higher levels than the ones exercised under option. So any high current yields, that include e call premium income, will be at the expense of the fund's overall performance.

Price premiums on high-coupon issues may also be shown as income and are not being amortized until redemption or sale. This also misleads the return.

Where there is a sales charge (it will cut into principal that is on hand for investment. Some pay sales commission every year after the initial sale. Moreover, annual management and distribution fees run high. Conventional funds expenses can be about 0.5% to 0.75% of assets each year, but the argument here is that option-writing requires more compensation for managerial effort.

Further, the so-called yields have not been truly comparable to returns from alternative sources and from mutual funds in governments.

Pros/Cons

Advantages
Enhanced returns under active management can possibly add to returns that only bond ownership can offer.

Disadvantages
Enhanced income comes from option writing, at the expense of the capital gains potential of holding volatile bonds.
Sales commissions and management fees are high.

Special Note. Selling Your Mutual Fund

Sell your fund primarily if it isn't operating as your primary reason for having bought it. Remember, the fund (managed or indexed) is only a tool or technique for the implementation of your strategy. It is to be used only for that basic objective for which you originally sought it.

Foreign Mutual Funds

Background

The investor or trader that wants the advantages of a mutual fund can get a major extra feature from foreign funds. Additional profits can come from the translation of the stronger Foreign currencies into dollars, upon completion of the transactions.

But when the dollar gets very strong in relation to other currencies, few investments will grow sufficiently, to overcome losses in the currency translations. Whatever profits from securities could be eaten away by dollar conversion.

If the dollar does not have to be repatriated, at least temporarily, the full growth can be worthwhile. But for the most part, currency fluctuations are a factor to be reckoned with.

Another feature of foreign markets is their wide selection When, for instance, stocks in the U.S. are not doing well, too bearish or too lethargic, there is bound to be at least one overseas market with an upswing, or where activity and volatility are made for optimum speculation.

There are two types of funds: Those who mix foreign and domestic securities and those who invest solely in foreign issues. Equities and bonds are bought. Sales charges are the rule.

Currency market predictions are especially hard to make, so that overseas securities investment can be a complex puzzle and even well-researched buying and selling can be tricky.

Pros/Cons

Advantages
Overseas funds give diversification by securities markets and countries, so that domestic market limitations need not stifle trading opportunities.
Holding investments overseas can benefit from fluctuations in the value of the U.S. dollar.

Disadvantages
Currency fluctuations can produce losses when the dollar gets weak, in relation to foreign currencies.
Aside from a few countries, overseas securities regulations are only fair and sometimes poor.

Special Note: Selling Your Mutual Fund

Sell your fund primarily if it isn't operating as your primary reason for having bought it. Remember, the fund (managed or indexed) is only a tool or technique for the implementation of your strategy. It is to be used only for that basic objective for which you originally sought it.

Mutual Funds with Life Insurance

Background

Mutual funds with life insurance are actually variable annuities. The latter are deferred contracts which invest primarily in mutual funds and also provide a life insurance policy which will pay the estate of the owner of the contract upon the death of that owner

Questions to ask before buying an equity-indexed annuity:

Since every equity-indexed annuity is different, consumers should be prepared to ask their agent or broker plenty of questions before deciding if they should invest. Here is a list of seven important questions to ask:

1. What is the annuity's term?

In general, equity-indexed annuities (and other annuities, for that matter) require tying up your money for anywhere from five to ten years. Like any stock-market investment, however, the shorter the term, the greater your risk that the market won't perform well over the holding period.

2. What exactly do you earn when the market goes up?

Equity-indexed annuities credit you with anywhere from 50 to 100 percent of the price gain of the market—excluding dividends. Since you're not earning dividends, you won't earn as much as you might by investing directly in the market. The percentage rate you earn (called the participation rate) may change from year to year. Make sure you check with your agent.

3. At the end of the term, how does the company calculate your gain? Some equity-indexed annuities use the market price on the day your annuity matures. Others look at the market price on each policy anniversary and pick the highest one. Some policies credit you with a portion of each year's market gains—if there are any. Others simply average the gains. Make sure you ask which method the policy you're considering uses.

4. Are there any limits to how much you can earn? Often, equity-indexed annuities put a cap on how much you can earn during the year. change the cap each year.)

5. What happens if stock prices decline? If the market drops one year, you'll be credited with no gain that year. (Of course, if you “surrender” the program before the maturity date, you'll have to pay the surrender charge, so you may end up taking a loss.) The crediting method the company uses will determine what happens in subsequent years, especially if the market doesn't return to previous levels.

6. What happens if you want to quit the annuity early? Some policies will give you the guaranteed minimum return, while others will credit you with all or even part of your earnings, minus whatever surrender fee was established when you bought the policy. Getting out early may mean taking a loss.

7. What if everything crashes? Equity-indexed annuities do carry a guaranteed minimum return, but only if you keep the policy until its maturity date. The guaranteed return is usually at least 3 percent, but that may not be 3 percent of what you paid into the policy in the first place. Some companies guarantee you'll get at least 3 percent of 90 percent of what you spent. Also make sure you check on how that minimum return is computed. If, for example, you get at least 3 percent compounded annually, that works out to a little more than a 0 percent gain after seven years.

Special Note: Selling Your Variable Annuity

Sell your Variable Annuity primarily if it isn't operating as your primary reason for having bought it. NOTE: POTENTIAL PENALTIES INVOLVED ARE A CONSIDERATION. Remember too, it is only a tool or technique for the implementation of your strategy. It is to be used only for that basic objective for which you originally sought it.

Money Market Mutual Funds

Background

Money market funds are an excellent way for investors and traders to keep funds parked until there is a need for them. They buy heavily in U.S. Treasury bills, federal agency issues, large-denomination bank certificates of deposits, time deposits, bankers' acceptances and commercial paper. Much of the non-government holdings are those of major American and foreign banks. Commercial paper has been from topnotch corporations. (see T-349)

Some money market funds deal only in short-term tax exempts, so their return is also tax-exempt. (Note: Money market funds who may have some tax exempts in their portfolios may not pass that exemption along to the shareholder/taxpayer.

Money market funds come in all sizes. Unlike the utility that being small has in the operation of a conventional mutual fund, the large money market funds enjoy the value of being larger. The more assets they have with which to buy, the better the rates they can get from borrowers.

The practicality of the funds is clear. No sales commissions, with small initial payments to get started, the ability to write checks (usual small minimum amounts per check), telephone or telegraphic transfers, periodic statements and daily reinvestment of interest, are what the public finds important. Moreover, the funds bookkeeping is on a constant, $1 per share basis; funds are not subject to the vagaries of daily- changing money market pricing. All brokerage firms use money market funds as part of their central asset management convenience. Mutual fund distributors permit free exchange privileges between funds.

The lack of Federal Deposit Insurance coverage, normal with commercial and savings banks, has not been a problem for the shareholders or the funds. Since the money market funds started growing so rapidly there have been no catastrophes.

Tax efficient Mutual Funds

Background

Mutual funds whose managers trade stocks excessively produce reduced after-tax return. Many shareholders have no idea of how much extra taxes cut into their actual return.

Tax managed funds are not actually tax exempt portfolios. They contain taxable securities as far as their interest or dividends are concerned. They are, however, managed to minimize capital gains within a non-retirement portfolio that ordinarily is not tax deferred. This is done by the manager being tax-conscious.

a) Using a longer-term investment objective which reduces the number of trades that can result in capital gains.

b) The choicer of stock s to sell in order to minimize the effect of capital gains on the overall portfolio.

Pros/Cons

Advantages
tax-managed funds are an ideal means of keeping funds invested with discipline and with an eye on minimizing taxes.

Disadvantages
tax-managed funds do not permit managers from looking at true objectives for necessarily holding to their original strategies.

Special Note: Selling Your Mutual Fund

Sell your fund primarily if it isn't operating as your primary reason for having bought it. Remember, the fund (managed or indexed) is only a tool or technique for the implementation of your strategy. It is to be used only for that basic objective for which you originally sought it.

T-375-BY

Closed-End Funds

Background

Closed-end funds differ from mutual funds in that they do not constantly offer shares to the public, nor do they redeem shares on demand. Instead, they are structured as any other publicly held company. They have a fixed capitalization and their stocks are bought and sold on the open market, with no direct regard to their daily net asset value, just as other stocks are traded. That is, they owe their primary pricing to supply and demand.

Their difference from the mutual funds and ordinary corporations, lies in the way they invest their assets. They buy for investment only and not usually for control of the day-to-day management of their holdings. They tend to be longer-term investors than are money managers at mutual funds. Also, they do not diversify as fully as do mutual funds. And they may have large blocks of ownership in more issues. Some specialize by industry. Others in bonds, or convertibles. Still others concentrate on foreign securities. Closed-ends are being used for the creation of venture capital funds.

The closed-end historically sell at a discount from their net asset value. There are no hard-and-fast reasons, and tradition appears to have taken over from logic. Closed-ends are not often picked up by researchers for sufficient focus and recommendation. They have known for their high cost of administration.

In addition, they are considered to be worth less on liquidation than their market price warrants. Any takeover fever would preclude much of this argument holding up. However, that discount from net asset value always has fluctuated, depending on the mood of the securities markets and/or the values of the securities in fund portfolios. Discounts often have little relation to corporate portfolio performance.

Some closed-ends have converted to an open-end status. This conversion automatically brings the price up to the net asset value. Any hint of a change in status will bring down the discount and the closed-end's price up.

Professional short-sellers use the narrowing of the discount gap for their activity, though this can be risky in the absence of very closely designed selling flags. A bear market for many of the fund's holdings, and a tightening of a previous discount, would combine to make the short selling strategy more logical. Liquid markets would be a necessity here.

Note: several operating companies qualify as near-closed-ends without being actual investment companies. Without the restrictions the SEC places on the latter, operating companies can own as large a percentage or type of another that they may want. They generally hold large blocks of issues and frequently make purchases and sales. And, they take advantage of the exclusion on taxes of common and preferred stocks they own.

Two problems often plague closed end funds. One: They usually sell at that discount from their net asset value, Second: they have high expense ratios.

Are closed end funds better than open end funds?

As a rule closed end funds could outperform open end or mutual funds in some segment of the market in which they may specialize. One reason is that managers have no worry about redemption's by shareholders. Unlike mutual funds these shares are bought in the open market and are not issued by the fund. They also are not subject to the pressures of having fresh money given them for reinvestment when they would rather not be reinvesting.

The preference of the closed end is that it usually trades at a discount to its net asset value while open ends are bought and sold at the net asset value. Investors hope the stock's discount narrows. The ultimate aim is for the closed end to become an open end fund and those make a profit for the shareholders who bought at a discount.

A disadvantage for the closed end is that you pay a commission for buying. When you buy closed end bond funds, you should look to see how secure the yield is. Many closed ends have pre-funded bonds bought when rates were higher. Therefore their current yield's may be unrealistically high. There may be an appearance of high yield in the face of the bonds being called. They will have to be replaced at much lower yields.

Pros/Cons

Advantages
Closed-end funds offer many of the advantages of mutual funds, with the added benefits of being able to trade in blocks of ownership.
The funds usually sell at some form of discount, on which a trading strategy can be designed.

Disadvantages
Discounts may be meaningless as a source of investment value, unless the company eventually becomes open-ended, or trading is done around the widening and narrowing of that discount.

Leveraged Closed End Funds

Background

These are closed end funds or investment trusts that are partially financed with short term borrowings. They are risky because they can be whiplashed when interest rates go up.

Let's say you have a corporate or tax exempt bond portfolio on which you are getting 10% return. And you decide to borrow funds with which to buy more of these 10% bonds. Let's say your loan costs you only 8%. You have a 2% spread which adds to the profit you were making for shareholders.

But let's say interest rates rise to 11%. You lose money. The technique works only in a stable or lowering interest rate market, where you can borrow at cost less than you invest in.

Pros/Cons

Advantages
Provides relatively high earnings and profit opportunities.

Disadvantages
Funds are highly leveraged so that losses on the downside can be appreciable.

T-376-CZ

Speculative Investment Funds

For those who wish to invest in funds other than mutual funds or closed ends there are additional possibilities:

Hedge Funds

Background

A hedge fund is a speculative investment pool. It is not publicly owned, and is not a mutual fund. It does not have the restrictions that are on a mutual fund, and that is one of its advantages. They are not easy to get into, when they are popular. That is, when they make money. Which they do when things go right. They can also lose money—a lot of money—when things do not go right.

You can't easily decide to get into a hedge fund You must know who is operating one. And you must be able to come up with the investment, which can be a sizable amount of funds. What is more, you must know your way around securities terms. You can't say you were a babe in the woods if things don't turn out favorably for you. Furthermore, you will have to show a good net worth, so you can afford to take the risks of investing in that sort of medium.

Not all hedge Funds sell short as a major way of making profits, though some managers do it all the time. The term hedge means that they may go long or short stock. When you short stock, you are selling stock that you have borrowed. You can only make money if you buy it back for less on the open market. You must repay the shares you borrowed. Short sellers can make money when stocks or market fall, and they can lose their shirts if they have chosen wrong, because they have to cover their loan while the market is booming.

Hedge funds may be in stocks or commodities, or in exotic options. Others deal in all manner of commodities: copper, grains, cocoa, and others. They get involved with speculations where managers have a free hand, and where you do not find the usually stringent SEC regulations. They are for sophisticated investors who know, or ought or know, the risks with which they are getting involved.

Sample hedge fund objectives
Undervalued equity-domestic
Undervalued equity-foreign
Bankruptcy and distressed situations
Short and long relative Values
Trend following
Deal and takeover arbitrage
Convertible arbitrage
Debt position arbitrage

Pros/Cons

Advantages
Hedge funds are generally able to take opportunities on the short side that most mutual funds are not permitted

Disadvantages
Hedge funds are extremely speculative and volatile.
The funds should not be used by those who seek the ordinary advantages of mutual fund or closed end entities.
There are generally restrictions as to how and when such units may be sold. Look also to your original strategy and consult your accountant.

Limited Partnership Units

Background

Limited partnerships are created for two purposes:

1) To provide a vehicle for investment where registration of securities can be simplified and where general managers can operate the venture without the hassle associated with public companies, and

2) To provide the tax benefits that accrue to a limited partnership. All net losses or gains of the partnership are automatically passed along right to the limited partners and the general partners. Corporate profits are passed along as dividends only after taxes are paid on the income. And corporate losses cannot be [asset directly to stock holder's. Therefore the interest in this form of structure.

Many real estate ventures and oil and gas prospecting has taken the form of limited partnerships. Most are privately operated. A few master limited partnerships are available.

Problem in the resale. No good after market unless they are publicly traded (only a few are). And you can not be active or you take on the general partners' responsibility

Roll ups are a euphemism for a situation that causes lots of grief to those who bought into limited partnerships and then discovered the partnerships did not work out as well as projected by promoters and general partners. This happened a good deal in real estate and to a lesser extent in the oil drilling business.

The purpose of the roll up is to merge into one partnership the many units under a general partner's or promoters' umbrella. This goes somewhat on the assumption that there is strength in numbers. Certainly this isn't a situation where there is economics of large scale operation that promises savings.

The roll ups are supposed to offer liquidity to partnerships. So the reasoning goes: Why not trade in the junk you have for something that may pay off in the future? Investors never win out in these. General partners do. There isn't much many of the limited partners can do. They can't walk away without incurring tax liabilities where they have gotten tax write-offs in the past.

There is always the option for liquidation which may or may not work out for investors. Tax problems will not be resolved this way. But liquidity could be enhanced and costs could be reduced immeasurably.

Pros/Cons

Advantages
Provide good tax advantages over corporations

Disadvantages
The partnerships cannot be easily sold.
There are generally restrictions by the partnerships, and tax penalties, as to how and when such units may be sold. Look also to your original strategy and consult your accountant.

T-379-AX

Real Estate Investment Trusts (REITs)

Background

Real estate investments can be made on a closed end mutual fund principle. You buy into a diversified portfolio of commercial or residential real estate, shopping malls, and or mortgages in real estate. Each one specializes in a different area and that is what makes the choice of this technique strategy interesting. It can be profitable and it can be risky, depending on the type of real estate investment the REIT makes

REITs compare with mutual funds but they differ to a degree. First, they can be bought over the counter or on a stock exchange, so they look a lot like closed end investment companies. There is a difference in the way they distribute their dividends. They must distribute at least 95% of their earnings every year, in order to be tax free. That makes them similar to mutual funds in this respect. They can't pass along losses so they are not tax shelters. They can pass along depreciation and some do.

There are other ways of participation in real estate. You can invest in a pool of Ginnae Mae mortgages in the form of unit trusts. You can invest in limited partnerships that own a number of real estate properties. Or you can buy real estate directly.

But the advantage with REITs is that they are more liquid. They can be bought and sold easily. And, the market may even price these REITs at a discount of their portfolio. This may not have practical value for you unless you use the technique to formulate a trading strategy. You trade on the basis of the size of discount, the way you would with a closed end investment trust.

REITs do not reinvest earnings but under tax regulation must pay out most earnings to avoid corporate taxes. As noted, REITs have to distribute the earnings (now at least 95% of their net income) to in order to avoid paying corporate taxes to the IRS. The trick however, is to build capital to buy or service their properties. So REIT accountants sometimes manipulate the books to minimize the dividend payment while keeping to IRS mandates. The aim is to reduce the need to pay dividends and still not pay tax penalties. These have some form of prospective dividend growth.

Because of the nature of REITs more and more come to the public market when real estate starts to be become overvalued. This is due to the fact investors tend to buy after prices are up and they have taken notice of that fact.

It also happens because those who set up the REITs are real estate investors who feel prices are high enough for them to sell. And that sale is in the form of packaging of these investment trusts. In fact, the owners who sell their assets in this manner often put the less attractive properties into the REITs while they retain those holdings which they feel have more promise for the future.

Pros/Cons

Advantages
Provide relatively high earnings and profit opportunities from arise in real estate values.

Disadvantages
The REITs are not a good buy if real estate is falling.

Special Note: Selling Your REIT

Sell your REIT fund primarily if it isn't operating as your primary reason for having bought it. Remember, the fund (managed or indexed) is only a tool or technique for the implementation of your strategy. It is to be used only for that basic objective for which you originally sought it.

T-384-BY

Unit trusts

Background

Several forms of unit trusts make them interesting but also difficult for an unsophisticated investor who may believe they are just simple funds that are easy to access.

Corporate Bond Unit Trusts

Background

Corporate bond unit trusts are a means of getting top interest return with a diversification of risk. To get that top return, the ratings of the bonds are usually below the topmost triple-A. Most of the corporate unit trusts are not considered junk bonds Whatever risk there is by not selecting the highest ratings, are expected to be overcome with the diversification created within the unit itself.

Some of the corporate unit trusts offer private insurance against default on principal or interest payments. The insurance entails a fee which the holder may feel is not warranted, given sufficient diversification of the portfolio by region and industry.

Investments can be made with as little as $1,000. A sales commission of from 3½% to 5% may be included, along with an annual custodial charge. Unit trusts provide the convenience of having a bond portfolio The bonds are usually packaged for two maturity objectives. One is intermediate term, about 15 years. The second is longer-term, about 30 years.

Interest remittances are made monthly or semiannually, at the bondholder's request. Some units offer reinvestment privileges and there are generally no redemption charges. As is the case with all unit trusts, there is generally a limited market for the units which may be placed for sale.

Note: Bond purchasers who buy unit trusts because of their quest for diversification, may be able to achieve the same objective on their own, and with a minimum of outlay. Bond credit ratings can act as a guide. The 30 or so issues that are placed in a unit trust may actually be over-diversification and, in fact, just so much extra window dressing. A choice of ten to fifteen issues that are widely selected by industry group, all with ratings of double-A or better, should suffice.

Note: Attention should be focused on closed-end bond funds, which some may feel will provide a parallel with the objectives behind the purchase of corporate bond unit trusts. The aims of ownership are not similar. The bond closed-ends are often used to trade interest level changes, as they are sensitive to such fluctuations. Corporate bond unit trusts, as opposed to corporate closed-end bond funds, are not bought with an eye to trading interest levels

Pros/Cons

Advantages
Corporate bond unit trusts offer diversification and bookkeeping and custodial services.

Disadvantages
Corporate bonds can be bought directly at a savings and where diversification can be achieved with modest outlay.
Trading in bonds, to suit changes in interest rate levels, cannot be done with unit trusts.

Special Note: Selling Your Corporate Bond Unit Trust

Sell your Unit Trust primarily if it isn't operating as your primary reason for having bought it. Remember, it is only a tool or technique for the implementation of your strategy. It is to be used only for that basic objective for which you originally sought it.

Municipal Bond Unit Trusts

Background

The Municipal Bond Unit Trust is composed of a fixed portfolio and requires no ongoing management. The purchase can be for as little as $1,000 There is a sales charge, up to 5%, but no management fee. Custodial charges are made for storing the bonds, clipping semiannual coupons, and making their distribution to holders on a monthly or semiannual basis

Municipals are bought packaged by those who do not have minimum cash of about $5,000 or so for the direct purchase of one bond, but this reason would be unusual; most buyers of the packaged bonds spend at least that amount. Buyers usually seek bookkeeping convenience and diversification. In some units, interest can be reinvested in similar issues, to provide the effect of compounding. A choice can be made of either intermediary-term or longer-term maturities.

Redemption of units are free of charge. There is no active market for these trusts, however, and a seller may not get what their inherent value may warrant.

Two versions of municipal bond trusts are in vogue. One contains a portfolio of issues that come from one state, usually where that state imposes an income tax. If the holder is domiciled in that state, the bond is exempt from state and local as well as federal taxes. Since some states do not have adequate, attractive selections, this may be too much a limitation.

The second version features private insurance on principal and interest payments of the issues, which imparts a triple-A rating. Most of the individual tax exempts have lower ratings. The insurance may be on each bond or on the entire portfolio. (Insuring each bond is more expensive, and is practical only where the custodian may, in an unusual instance, remove a bond from the portfolio for sale in the open market)

Aside from convenience, the purpose of the unit trust is to diversify risk. It is more practical not to pay for insurance, once that diversification is acquired for inclusion in a trust.

Note: Diversification of risk is not hard to achieve when buying bonds directly. Ratings give an idea of relative risk. The purchase of several bonds from different states will add to risk diversification. Also, it is unlikely that a state will permit one of its major cities to default on a bond issue. If that state did not “bail out” a major locality, it would have a severe credit crisis of its own. Yet, in many cases, local bond ratings are lower than that for the state. This can make for better yields on the local units as compared to the state's, with no noteworthy change in practical risk.

Pros/Cons

Advantages
Municipal bonds can be diversified and held with the convenience of bookkeeping and custodial services.

Disadvantages
Bonds can be bought directly at a savings, with the use of credit ratings to achieve diversification.
Trading strategies cannot be used when bonds are in a unit trust.

Special Note: Selling Your Unit Trust

Sell your Unit Trust only if it isn't operating as your primary reason for having bought it. Remember, it is only a tool or technique for the implementation of your strategy. It is to be used only for that basic objective for which you originally sought it.

T-391-AX

Classes of Stock

Background

A fundamental determinant for all, whether a longer-term investor, or a short-term trader, is when to buy common stock or when to get a fixed income security. The selection is not as easy as it may first appear. The public has had drummed into them for years the dogma that common stocks are for growth of capital. As a bonus, the thought goes, the investor will build a defense against the ravages of inflation. Fixed income, on the other side of the coin, may give steady income, but without the growth factor and without the inflation defenses.

But this need not be necessarily so. At least, it is not so for every investor or trader, whether a modest dabbler in securities or a professional with hundreds of millions to transact.

Surveys indicate that stocks have returned little more than 9% to 10% per annum over the years, and maybe less in the future. Short-term cycles where bulls have been on their rampage, must be eliminated for accuracy. Over the same time, bonds have returned somewhat less. Therefore, debt issues which earn substantial income after income tax adjustments, will be tempting.

Statistics are not an incentive to a trader. Trading strategies are supposed to bring in more than that 9½% each year, in exchange for the extra risks when dealing in common stocks. Those who want long-term results will, however, have no problem in arriving at a decision. The choice will probably be clear: Those not sure of the selection will be acquainted with the benefits of non-equity holdings. Those positive that their selection should be non-equity, know about the benefits too.

People who buy bonds do not have all the reasons to feel fixed income securities are a permanent bonanza. Unless proceeds are invested immediately, the holder does not benefit from compounding. On the other hand, bank certificates of deposit, mutual funds and some of the trusts can have their returns reinvested. Then there are the questions of callable bonds. Corporates and some of the government agency bonds may contain the feature, which permits the issuer the right to redeem the bonds at face value or slightest above. A good return may be eliminated from a portfolio when corporations feel it saves them money to have the bonds redeemed. Furthermore, fixed income securities can have a larger element of risk, though they have first crack at assets during bankruptcy or liquidation. Whenever bonds can be locked in at relatively high interest rates, they are a bargain to be acquired. Get 7% to 9% on a bond, especially after tax, and you have a big bargain, provided the risk is reasonable.

Common stockholders also look for dividend income, to varying degrees. One expects, in fact, that dividends will have far greater impact on common stock price than earnings. It is stock return, in the final analysis, that makes the potential value all stockholders want for the future. Yet, studies show the opposite: Stock prices seem to be more sensitive to earnings, and not dividends. Therefore, slight changes in earnings can have exaggerated price effects. This phenomenon helps explain why the public views common stock and bonds/fixed income issues the way they do, despite the closeness of their ultimate returns.

Investigations show that many investors shy away from stocks with big yields. They prefer to reap capital gains, rather than income, because of the lower capital gains rate. But this is an academic and not overriding factor. More likely, the public equates growth with lower dividend, lower-yielding type of stock.

Special Class Stock

Background

Common stock and preferred stock as the two main classifications of corporate equity. Common stock can come in various classes that make a distinction on voting rights primarily and to an extent how dividends are to be paid. If you do not care about voting rights, then this will not make a difference to you. Those who want control of a company are very much interested.

Different classes of common stock are issued primarily in connection with voting rights. Preferred stock classes have to do with income participation or dividend rights, and allocation upon asset liquidation.

In corporations where there are voting and nonvoting shares, the purpose is to keep control of the company with minority ownership. The device has often been used where family corporations have sold stock to the public. Only the tightly knit managers and insiders are permitted to vote the shares. The different shares may be called class A or class B. Their only difference is the voting for directors; participation in earnings is usually on a share-for-share basis, irrespective of class.

In some instances, conversion from nonvoting into voting shares may be made over time, and by formula that is designed to keep current management on for a while.

The action took the price determinants out of motor car industry operations and earnings and placed them into the electronics industry. The obvious greater growth potential for the special class, from its operations derivative, certainly has more appeal to shareholders and traders.

The question of equal voting rights has persisted for years. Does the nonvoting common entrench management to the detriment of the public stockholders? Studies show that it makes little difference, on balance. Investors and traders may want to design strategy about the type of stock they prefer to buy or trade, but there is no pattern either way.

What does make a difference is the way strategy can be built around a special class. When common is tied into a giant company's diverse operations, a sort of arbitrage potential presents itself.

Sometimes some large blocks of an inside family's owners come into the market from their nonvoting status, and this is an evaluation consideration.

Pros/Cons

Advantages
The use of special classes can produce trading potential.

Disadvantages
Aside from the classification of stock, there appears to be little practical difference between holding and/or trading nonvoting or voting shares.

Public Utility Stocks

Background

Public utility stocks, whether common or preferred, are a security type in themselves.

Utilities today do not have the enormous plant-building projects of recent years.

New nuclear power plant construction is avoided and ready sources of power from nearby utilities with excess supply the industry is winding down its new plants. Lower oil and other energy raw material cost is bring in more cash without the specter of having to streamline operations continually. In fact, many are experiencing excess capacity, and can expand easily. Most utilities today face the prospect of having to manage excess cash flow. One solution is to raise dividends even higher.

Furthermore, Wall Street is beginning to look at utilities with an eye on the market value of their plants and assets. They have traditionally been kept on the books on cost basis. Many of these older plants have been depreciated on the books to low levels, even completely. They are still efficient and low-cost producers.

It is expected some utilities may diversify into other industries, using excess cash, or reduce a portion of their heavy debt structure. Diverse expansion does not seem likely, as it would stymie the rate structure stance that utilities must maintain with their local regulatory commissions. Debt structure will more likely be refinanced whenever lower rates are available.

Caution is always in order. A rather common perception is that utilities have almost a guaranteed rate of return. This is not necessarily the case in practice, as more competitive markets and less regulation are two-edged influences. Nevertheless, the perception has an effect on markets.

Political pressures continue to result in shortfalls between the rates of return utilities feel they should be getting and what they actually earn. Many costs, including added taxes, are not completely passed along to customers. However, the impression remains with the public that profits are guaranteed. Whatever problems may arise are those which have to do with miscalculations, such as catastrophic nuclear power developments.

Caution: Though reduced in recent years, regulatory supervision is affected by political pressures at all times, and can result in adverse rate action, should utilities make what the public feels are exorbitant profits.

In short, public utilities have an earnings property that gives them a distinctive market trait. They have all the markings of preferred stock, even bonds, with the attributes of common stock. Growth of earnings and rising dividends are essential growth factors that benefit shareholders of common. Stability of income is the type that allure holders of preferreds and bonds. And, benefits to be gotten from lower interest rate levels are what every bondholder wants to lock up.

This combination of features make utility stocks ideal trading vehicles for any variety of strategies. They can be treated entirely as the common stocks they are, or interpreted on the markets as preferred stocks or corporate bonds.

Pros/Cons

Advantages
Public utility common stocks have the traits of preferred stocks and corporate bonds, and can be traded with a variety of strategies.

Disadvantages
Regulations, while not as stringent as in the past, are still subject to political pressures that can make for “surprises” that can ruin investor/trader objectives.

Warrants and Rights

Background

Warrants give the holder the right to subscribe to a specified number of shares of a related security, usually common stock, at a preset price. That price is usually at the same or somewhat higher price than that prevailing on the underlying security, at the time the warrant is used.

They are not as fashionable as they once were, as the public has a wide assortment of stock and index options and related futures instruments, with which to employ trading strategy.

Warrants are usually attached to that security or are part of a package of securities. At some point they are separated and they trade on their own for a prescribed number of years, sometimes in perpetually. Warrants cannot be called for redemption, but they can have their exercise price reduced to encourage redemption The redemption period can be extended as well, at the option of the issuing corporation.

Warrants provide leverage, in that they rise or fall in value at a faster pace than the corresponding movement of the underlying security. They generally are in bearer form, pay no dividends, and have no claim on a corporation's assets. Moreover, they lose value as their expiration dates are approached. What makes them valuable, and speculative, is their leveraged relationship to their underlying security. They move up more, and fall in price more, than the corresponding security.

Several rules of thumb have been devised for the selection of a suitable warrant with which to trade.
Buy a warrant only if you are interested in trading the corresponding security. The warrant's price will depend on that of the security. That means sufficient volatility. Slow-moving securities are not in the trader's interest.
Buy warrants if they are packaged with bonds, and both may be used for the conversion into the stock. Some packages permit conversion on the basis of the bond's par value. If the bond sells at a discount, there is a further leverage factor.
Buy warrants with market liquidity. That means the corresponding stock has to have a broad market.
Buy warrants only where the price is not too far over the exercise price. A rule of thumb is that 20% to 25% premium is the maximum a trader ought to pay.
Buy warrants that are going to be in force for at least five years. Short-life-span warrants introduce too much of a risk factor, to an already speculative strategy.
Buy warrants where there has been no history, and there is little likelihood, of a stock split or a stock dividend. The conversion price of the warrant may not be changed even though the split or dividend will reduce the price of the underlying security.
Buy warrants of companies that appear to be sound. Reorganizations have, in the past, done re-valued warrants out of existence.
Buy warrants to trade for an eventual sale and not to buy the underlying stock. To sell the warrant, selling flags must be tied in to those that would be used if the underlying security were being held.

Note: Some warrants can be sold short, Provided there is a liquid enough market. Some warrant and option-heading techniques are also possible.

Rights are given stockholders for the purchase of more of the same security at a price somewhat lower than that of the market

Pros/Cons

Advantages
Warrants offer traders highly leveraged profit opportunities.
Option hedging and short selling trading is possible.

Disadvantages
Warrants are speculative, as they are to be traded only on the basis of the value of the underlying security, and the conversion price which may never reach a profitable level.
Warrants can be hurt by stock splits and stock dividends.
Some of the market forces can be controlled by the issuing corporations, including reorganization, warrant calls (occasionally), warrant extensions, and so on.

Preferred Stock

Background

Preferred stocks have special strategic value and are not used as they once were. At one point, they were bought instead of common because they had more assured, often higher return. Also, they had preference over earnings and asset allocation upon liquidation. Today, the purchase of buying preferreds may entail these considerations, but other overriding reasons may induce their employment.

Preferred stocks are appealing to corporations because of the tax break (check with your accountant). Preferred dividends for individual stockholders may not compare favorably with those of bonds and even common stock, but corporations do benefit on an after-tax basis. New preferred issues and the prevailing markets are priced below what an individual would like on like risk. Inducements such as put and adjustable rates are now being used more and more for enticing purchasers

Incidentally, corporations issuing preferreds are not able to deduct the dividends from taxable income as they do interest they pay on their bonds. They use preferreds because they bolster the balance sheet. They become part of capital and equity, as compared to bond and loan obligations that must be repaid.

Preferreds pay quarterly dividends. They have no maturity date, as a rule, and the company has the right to call them in. They are rated for their creditworthiness if the issuer is large enough to warrant the expense.

Purchasers ought to look for issues where the corporation has little outstanding debt, and where there are restrictions on the amount of dividend on the common before preferred obligations. Sinking funds are an additional safeguard. Credit-rating standing is always important. Any lower-rated issues should be avoided unless a strategy has been devised to incorporate their use.

Several types of preferred are available:
Different Levels: A corporation may have several issues of preferred stocks, of different types and varying coupons and returns.
Cumulative: Any dividends that may not be paid because of insufficient earnings in one year, will accumulate for payment in future years when funds are earned.
Non-cumulative: If the dividend is not earned, there is no obligation to pay the shareholders that year. If earnings are sufficient in following years, the company still has no obligation to make up for years when dividends were not paid.
Participating: Some preferreds are allocated, by formula, a portion of a company's earnings.
Adjustable Rate: Issues where dividend rates are pegged to interest-rate or related parameters (see
Convertible: Rights in the preferred, for conversion to the corresponding common stock of the company, under preset conversion terms

The day of the “junk” preferred issue has arrived. For example, dividends may be paid with additional preferred stock, in lieu of cash. The issuer may also be able to exchange the preferred with bonds, and the interest on those bonds may be paid with additional bonds.

Note: Preferred issues that are not convertible into the corporation's common stock will trade along with the market for bonds. Selling flags should be created with this in mind.

Preferreds won't drop in price as much as their common-stock, while they rise much slower. Their values are tied into their dividend returns. Those who seek income usually buy bonds. They get better protection, should the company get into difficulty or go broke, as bondholders have better priority. Preferreds are better tax-wise when bought by corporations.

Pros/Cons

Advantages
Give investors a way to invest in funds for the longer term, where fund objectives are not hurt by short term investors who go in and out of their positions.

Disadvantages
Funds will not be readily available if needed.

Convertible Preferred

Background

Convertible preferreds are supposed to hedge the choice of security, by providing fixed income and the chance to participate in market growth of the corresponding common stock. Where market outlook is fuzzy, and interest rate trends hard to decipher, convertible preferreds may well be the answer. They leave a door open in each of the two worlds.

Convertible preferreds have become a frequent medium for takeovers. They often comprise at least part of the packaged offer that the acquirer makes to tempt the target's shareholders. The dividend is attractive and the security leaves room hope of future capital gains.

The preferred portion of the convertible may contain terms that will vary with issue, for instance cumulative or non-cumulative dividends. Conversion rights may be for another preferred issue or money market notes, or an issue of longer-term bonds, or an issue of convertible bonds, and so on. Any number of conversion privileges and corresponding security can be designed.

Acquirers like to issue preferreds when they are pressured to come up with more and more funds amid the frenzy of heated takeover battles. Remember, preferreds are ot a fixed obligation. They will remain outstanding until they are converted, and this gives management a sense of permanency when debt structures may be under stress.

Convertibles are offered where the quality of preferred may be suspect. They act as a sweetener where straight preferred, or adjustable rate preferred, may remain unattractive to shareholders looking for the highest bids from would-be acquirers. Convertibles may also be offered where terms are not as liberal and the capital gain lure is being made to balance that insufficiency

Trading convertible preferreds has to be done with an investigation very much similar to that in the evaluation of convertible corporate bonds. They have the advantage of lower commissions and better margin terms (if they are marginable).
The conversion premium. It is the percentage difference between the conversion value and the convertible's market price. If the premium is over 25%, the return should be excellent or the prospect of the common stock's growth should be strong. At the other end of the premium range, a premium of 10% or 15% could permit a much lower yield. The further away a convertible's price is from the conversion price, the more it will act as a preferred stock. That means it will react intimately with interest rate levels and interest direction.
The time left for conversion. Some may have a relatively short period, others are permanent. If the conversion privilege is for a short while, the security would be best overlooked. If the common stock has trading (or corporate mode) possibilities, other strategies can be used.
Limited marketability of these relatively small issues will make for erratic markets. If the number of outstanding shares are too low for effective trading, the issue ought to be overlooked.

If the conversion value is not close, the preferred will act as a fixed income issue and will require selling flags that are sensitive to interest rate levels and direction.

Pros/Cons

Advantages
Convertible preferreds offer the security of the fixed equity and the fixed income markets
Convertible preferreds can provide leverage if the underlying common stock moves substantially. when there is no clear-cut strategy available for use of the underlying common stock.

Disadvantages
Convertibles have limited marketability
When the convertible is priced far from the conversion value and the underlying common has no growth potential, the preferred will have to rely on its fixed income status.

T-404-BY

Stock Indexes

Background

Stock index trading gives a trader the means of participating in a wide segment of the entire stock market With a choice of indexes, an investor can hone the segment of the market wanted most. Large groups of top blue chips, or not-so-blue chips, or the more-or-less speculative, or intermediary-speculative stocks can be traded in the same transaction.

There are a wide selection of stock indexes listed in the financial section of the financial newspapers daily as well as the internet. They cover every segment of the market, every taste, every objective you may have.

The choice of index will provide whatever quality or volatility desired, whichever a trader feels will perform better for any strategy he may wish to employ. In addition, weightings, or lack of weightings of any stocks included in an index give further traits that a trader may wish.

Index trading can also be an insurance policy, when there is doubt about individual stocks to buy and sell. What money managers like to avoid the most is underperforming the averages. What better way to be on the safe side, to at least equal average performance, but to trade indexes. It has been estimated that about 80% or so of market trading is done for representation of the entire market and of industry groupings.

Random walkers or followers of the efficient market theory, use stock indexes for other than just achieving average performance. They believe the index, which reflects the entire market, is more accurate a picture.

Their assertion is that no one can consistently outperform the market anyway. No matter what a stock or a stock picker has done in the past to merit applause, random walk enthusiasts are sure tomorrow's chances of success are still a toss-up, and that active portfolio management will not improve upon the results. If anything, the passive portfolio will return more, thanks to the elimination of much of the stock commissions and taxes from the excessive trading in active management.

Of course, indexes do not pay dividends as do the stocks in them. Those who want to participate in a whole market basket of stocks, and get their dividends as they are distributed, will instead buy an index mutual Fund (or ETF—exchange traded fund). A very large, diversified portfolio of common stocks in a mutual fund is a sort of stock index, but not quite. It is an open-end fund which tries to match the performance of a specific stock market index. That is, they may attempt to emulate the particular index they are following.

To shareholders in these mutual funds, or to anyone trading a stock index, this makes a decided difference in objectives. One will have a different mix of securities than the other, because it represents a small number of shares.

Pros/Cons

Advantages
Stock indexes are a means of at least achieving the average results of the overall market, that compare to whatever formal index is to be as a benchmark.
Stock indexes allow fine tuning of trading the market, in the choice of the index to be traded or emulated.
The availability of index mutual funds makes participation easier.

Disadvantages
Those who are not efficient market enthusiasts claim that stock performance can be improved with the proper portfolio management.

Exchange Traded Funds such as Standard & Poor's Depository Receipts (Spiders)

Background

Index funds such as Spiders (which are based on the Standard & Poor's 500 Average) have been traded on the American Stock Exchange since January 1993. Their shares rise and fall with the S&P 500 index and can be bought and sold similarly to any other stock.

Their management costs are about the same. But, if they are to be traded frequently the commissions will make a difference in your net results. There is no automatic dividend reinvestment with spiders. However, Spiders are more liquid. They can be traded while the trading day is underway.

On the other hand, a mutual fund related to that S& P 500 average would have its price set on its Net Asset Value after the market closes each day.

Should a large order of Spiders be sold, the investor would receive stock that make up the S&P Index and not cash. But there can be a delay of any taxes accruing from portfolio changes in the index, though they are relatively small bites. The taxes are not due until the Spiders are sold as there is no capital gain distribution. The taxes are due only after the Spiders are sold.

Note: The S&P 500 Index mutual fund usually has a small fee, of about 0.20 to 0.30 percent a year. There are trading fees, however. And you do hot have an automatic reinvestment of your dividends.

Advantages
Stock indexes are a means of at least achieving the average results of the overall market, that compare to whatever formal index is to be as a benchmark.
The Spiders permit an investment without the purchase of the mutual fund index.

Disadvantages
You do not get automatic reinvestment of dividends from equity
Commissions can be high for frequent traders who do not require such frequency

Index Mutual Funds

Background

An index fund is made up of a basket of all the stocks that are in the index itself. It would be difficult to put all the stocks of any of the funds used. For example, the Russell 2000. Or the S&P 500. But close representations are made.

Redemption's from the index fund or the conversion of share classes or capitalization changes in the shares also require that the index fund be managed in a mathematical manner. But the share selection is not active as with the conventional fund.

Furthermore, index funds provide diversification.

In fact, maximum diversification is available more cheaply and effectively. There are so many types of index funds available that you not only get diversification by number but also by types and size of stocks.

Do all index funds perform equally well with managers?

In recent years the S&P 500 index has outperformed most investment managers The comparison between the two is not as conclusive in the use of indexing for smaller companies However, overseas investing may be better accomplished with indexing.

Pros/Cons

Advantages
Index funds are an ideal means of keeping funds invested with discipline Disadvantages
Index funds can permit over trading in an attempt to time the market.

Special Note: Selling Your Mutual Fund

Sell your fund primarily if it isn't operating as your primary reason for having bought it. Remember, the indexed fund is only a tool or technique for the implementation of your strategy. It is to be used only for that basic objective for which you originally sought it.

Exchange-Traded Funds

Background

ETFs or exchange traded funds are baskets of securities, such as mutual funds. They have grown apace since they first appeared and now represent a large, growing segment of the total amount invested in fund indexes. New issues appear almost monthly, if not more frequently. They track an index the same way conventional mutual funds do. What makes them different is that they are traded on an exchange like ordinary securities.

Because they are listed, the trading has become more sophisticated. To the extent that there are now options listed on these ETFs, they are highly utilitarian. The growth of indexes follows from an investment fact of life: Often the performance of an index-based fund or ET will surpass that of the expert stock pickers. Secondly, chances are that the cost of operating that fund will be far less than if you turned over that job of securities management to a professional. So you are ahead on two fronts; performance and cost of management.

Select the ET that matches, exactly, the strategy you have in mind.

The question whether to use an index mutual fund or an ET depends on several factors. As a whole, ETFs may prove slightly less expensive than mutual funds (but only slightly). Moreover, they are much less likely to generate taxable capital gains if you hold them in accounts subject to such taxation.

Use an index mutual fund if:

a) You may not have sufficient transaction amounts to warrant in and out brokerage costs that have to be incurred with each transaction.

b) You want the benefits of an automatic reinvestment plan. Mutual fund sponsors will better be able to help you make permanent arrangements.

c) You add to or withdraw from your funds frequently. With ETFs you would be exacting brokerage costs

Use and ET if:

a) You are dealing in large transactions so that brokerage costs are low

b) You want to trade shares often for shorter terms

c) You wish to buy shares on margin

d) You may use ETFs on indexes which can employ more sophistication to market strategy techniques.

e) You wish to take the risk that the shares may sometimes trade slightly above or below net asset value. (mutual funds are always at Net Asset Value)

Pros/Cons

Advantages
ETFs funds are an ideal means of having low-cost indexes invested with discipline

Disadvantages
IT funds can permit over-trading in an attempt to time the market.

Special Note: Selling Your Mutual Fund

Sell your ET fund if it isn't operating as your primary reason for having bought it. Remember, the fund is only a tool or technique for the implementation of your strategy. It is to be used only for that basic objective for which you originally sought it.

T-411-AX

Insurance Company Offered Investments

Guaranteed Investment Contracts (GICs)

Background

Guaranteed Investment Contracts, or GICs are not as popular as they once were. These are investment contracts, usually from from insurance companies, sold to retirement plans. They have been popular because they offer higher interest than elsewhere. But to offer higher rates, the issuing companies had to put the funds into corporate bonds of lower quality.

Some bonds were of such low quality, the issuing companies got into trouble when the bonds defaulted.

GICs are acceptable provided they are invested by sound companies with excellent balance sheets.

Pros/Cons

Advantages
Provide relatively high earnings and profit opportunities.
Ideal when interest rates fall after the GIC is issued.

Disadvantages
The GICs are not a good buy if interest rates eventually rise,

Special Note: Selling Limited GIC Units

There are generally restrictions as to how and when such units may be sold.

Whole Life Insurance

Background

Ordinarily life insurance ought to be bought as a protection against the premature death of the policyholder. Term insurance is the best way to achieve this because it gives maximum protection at the least cost. Some people buy whole life insurance which combines both life insurance and a savings fund. These are generally poor investments because the return set aside by the insurance company must be limited. If it's protection you need, buy term insurance.

You should note that term insurance rates go up as you grow older. If you reach your goals of achieving an estate for your beneficiaries, and you are growing on in years, you can consider dropping term insurance. Some who are going to pay a large inheritance or estate tax may consider using the proceeds of life insurance to pay the tax, so that the other assets need not be dumped by the heirs to raise cash. Incidentally, life insurance proceeds paid to a named beneficiary are not considered part of your estate for tax purposes.

Many investors use life insurance by itself as a tax dodge. It is not, unless you are thinking in terms of a named beneficiary upon the death of the insured.

See your insurance representative or tax lawyer or accountant if you have extensive tax questions or have an extensive estate.

Variable Annuities

Background

A life insurance product that has taken over where IRA, Keogh and 401k programs are no longer useful. As you may know there are earning caps on the deductibility of those payments. Variable annuities have been called an Unlimited IRA or Keogh, (See Mutual Funds with Life Insurance) Variable Annuities can be used for investment purposes because of their deferrals.

First, lets look at annuities. There are fixed ones which pay off a fixed amount after payments are to start. Then you have the variable types when you do not know exactly what the principal is going to be in the future, because earnings will depend on the investments that make up the annuity.

Fixed annuities pay off a set amount when you retire or are ready to take the payments. Fixed annuities are usually not for young or middle aged investors because the inflation factor can eat into their value over the years. They may make sense for oldsters who want a guaranteed amount of income each month.

The Variable Annuity is composed of term insurance, plus combinations of investment vehicles. The purpose of the insurance is to provide a face value to the contract, which pays off should the policyholder die while the contract is in operation. It also gives the entire program the insurance flavor which makes for tax deferral.

The investment technique strategies can be mutual funds or stocks, bonds, or a combination of stocks and bonds. The minimum you can invest is generally $25 a month. The purchase can also be made in a lump sum if you have it. Contributions to annuities are not tax deductible. But investment income accumulates tax free When you start to get the payments back, part is taxable income and part is your tax-free principal.

Most Variable Annuities allow you to allocate your premiums among the different funds the insurance company has set up. They also permit a switch of funds about 4 or 5 times a year, at no charge. Furthermore, unlike switching in a mutual fund, no losses or gains can affect your income tax treatment. After all, the income tax bite is being deferred.

The younger you are the better advantage you get from a Variable Annuity. When you are past 50 you get better deferred income opportunities with tax exempt bonds and U.S. EE bonds. And, of course, the higher your tax bracket, the more you save. If you are in the lowest tax bracket, these investments are not that attractive.

Most of these plans are no load. But they are loaded with charges. There may be no sales charge as such. But the insurance companies or mutual funds who work with an insurance subsidiary, take out their fees each year. It can take at least ten years for the tax deferrals for you get to equal the charges you have to incur.

This ability to switch funds becomes a source of major confusion to investors. The same way it is when you buy any other investment. The best way to overcome this is to discipline your switches with proper strategies.

Variable Annuities are not liquid should you need immediate cash. Withdrawals are taxable. up to the amount of the earnings that have accumulated. There may be a 10% penalty on withdrawals before age 59½. There may also be insurance company charges. At retirement, you may opt for fixed income based on your life expectancy, instead of drawing funds as you need them.

Note: Don't buy Variable Annuities into IRA, Keogh or other retirement programs that already give you tax deferral. You will be wasting the benefit. (You also should not use tax exempt bonds or non-interest bearing investments of any kind when you enter a tax deferred program.)

Also: Look at the insurance company's credit rating. A tip when you deal with any life insurance company. Use one licensed in the state of New York as well as any other state in the union. New York State insurance standards are among the most stringent in the country.

Special Note: Terminating Life Insurance

There are generally restrictions as to how and when such units may be sold along with severe potential monetary loss. THERE ARE STEEP LOSSES for such terminations.

T-416-CZ

Foreign Currency Dealings

Background

There are a number of foreign currency and bond dealings and transactions you may undertake, all of which require a high degree of sophistication and risk.

Foreign Currency Bonds

Background

Eurobonds are debt issues which are sold by a borrower abroad, to raise funds in one or more currencies. Eurobonds are floated in many different European currencies and the Japanese yen (known as Samurai bonds). When used to raise dollars overseas they are known as Eurodollar bonds

The purpose: to take advantage of any difference in interest rates due to economic conditions that affect the flow of funds between countries, principally the U.S., the Western European countries Great Britain, Canada and Japan. For American firms, Eurobond flotation's do not require SEC filings. Many non-publicly owned firms who value their privacy, will choose the unregulated Eurobond market for offerings. The public U.S. multinationals are in the market whenever there are advantages in relative interest costs.

Eurobonds, or foreign currency bonds, can be in dollars or any other major currency in Western Europe, Great Britain, Canada and Japanese yen issues. They take into consideration and compete on the basis of comparative interest rates among countries, their trade experience, currency risks, gross national product, tax bites on bond transactions, and so on. They also compete with Eurobonds in ECUs and Euros.

Eurobond investors/traders are influenced more by foreign-exchange movements than most American traders are. Gyrating interest rates are always a factor. Furthermore, there is always a sort of arbitrage between the value of Eurobonds in dollars and in other currency.

The Eurobond term covers many types of fixed-income issues, shorter and longer term, bills and notes, certificates of deposit, floating and non-floating rates. The greatest growth has been in the shorter range Euronotes. Callable and non-callable features, warrants, zero coupon bonds, fixed and floating rates, and put rights, also are developed in debt structure.

A new type of foreign currency denominated issue is known as ECUs, or European Currency Units, a composite of European currencies. The bonds have the advantage of being registered in the U.S. and can be bought and sold in this country.

Backing with commercial mortgage collateral has been another innovation. In fact, new types, twists, and heretofore unused instruments are the usual. Dual currency bonds are an example of such fresh thinking. These pay interest in one currency and are redeemed in another. Some pay interest in Swiss francs, with redemption in dollars. Others have been created to pay interest in Japanese yen, and offer redemption in dollars. Any number of combinations are possible, in all currencies.

Institutions are major players in this market, along with large corporate buyers, ventral banks, government agencies, and banks, though not exclusively; smaller individual traders are also involved.

Eurobonds offer profit from two sources, aside from interest return. Should the price of a bond go up, and two, the value of the U.S. dollar, relative to the foreign currency, translate into more dollars when proceeds are repatriated. Where local currency is comparatively stable (e.g. Switzerland, Japan), Eurobonds will generally pay lower interest rates. At times, rates in this country for comparable issues will be 2% to 3% higher.

Pros/Cons

Advantages
The Eurobond market is a source of comparative shopping on the basis of interest rates, as well as currency risk.

Disadvantages
Eurobonds are primarily for institutional professionals who can deal full time with the vagaries of the market.

Eurodollar Bonds

Background

Eurodollar bonds are held in terms of the U.S. dollar. These are debt issues that are sold outside a borrower's country, to raise funds in its own or foreign currency.

Bonds are being sold in international markets in terms of West European currencies, British pounds, Canadian dollars and Japanese yen. About half of the new issues are in dollars. The market is primarily made for sophisticated institutional traders, central banks, government agencies, commercial banks, though smaller, private individuals also participate. The borrowers are the well-known, giant multinational companies of the various countries, who seek cheaper terms than they can in their own markets at that time.

Be they Eurodollar bonds or Eurobonds in other currencies, innovation has been the norm, for all maturities in short, intermediate and longer term. The biggest growth presently is in the use of Euronotes, in dollars or foreign currency. These fixed income issue features range from fixed and floating rates, to call features, to debt warrants and convertibles, to zero bonds, to “step-up coupon puttable bonds” and assignments of commercial leases for backing.

The actual selection of bond to buy, whether Eurodollar or Eurobond, will be determined by a mixture of market forces. Comparative interest rates, gross national product, balance of payments, the strength of once currency, vis-à-vis the others, political trends, and any number of market supply/demand influences. These forces cause discrepancies in relative rates. An arbitrage-like resolution will create temporary preferences for each, as long as those short-lived discrepancies exist. Intermingled with all this are complex interest rate swaps.

Non-U.S. dollar currencies are more attractive when there is uncertainty about the dollar exchange rate. Any gap in interest rates and term, that can provide a borrower with cost savings, will result in a transaction in terms of dollars or another currency. Foreign bonds usually pay lower interest rates than the American counterparts, whenever local foreign currency is stable (e.g. Switzerland, Japan).

At times, dual currency bonds will be used. Example: The Swiss franc has been used by American multinationals, where interest is paid in francs, and redemption is made in dollars.

A new type of foreign currency denominated Eurobond, the ECU (European Currency Units) can be registered, bought and sold in this country. The bonds, too, reflect exchange as well as interest rates.

Investor/trader profits come from two sources, aside from the interest. One, any capital gains that can be developed in the longer term issues and, two, the translation of currencies when repatriation is made.

Eurodollar—An American dollar held by a foreign institution outside the U.S., usually a bank in Europe, often as a result of payments made to overseas companies for merchandise.

Eurodollar—An American dollar held by a foreign institution outside the U.S., usually a bank in Europe, often as a result of payments made to overseas companies for merchandise.

Pros/Cons

Advantages
Eurodollar bonds provide traders with a wider selection of debt issues, with its global scope.

Disadvantages
The debt securities are for sophisticated, substantial, professional investors and traders.

Foreign Currency

Background

Several reasons can be behind the strength or weakness of the U.S. dollar, in relation to foreign currencies:
Interest rates in this country being higher or lower.
Governmental stability and that of its finances.
Supply/demand for dollar, for use in international commerce.
Attraction to foreign investors who seek a haven from rabid inflation at home.
Attraction to foreigners who seek to reduce their domestic sociopolitical problems.
Budgetary deficits in this country and also in other major foreign economies.

The value of foreign currency to those in the U.S. is generally in terms of the value of the dollar. That value comparison is often volatile. The trader who deals in foreign securities must, therefore, look to the U.S. dollar just as he does the security being traded. Other traders can focus solely on the dollar, to profit from its erratic swings and longer-term trend lines.

A trader interested in the value of the U.S. dollar can also look to:
Stocks of U.S. companies which do a large amount of their business overseas. A strong dollar is disastrous for them. Whenever the dollar falls their profit potential can be profitably leveraged.
Stocks of gold, silver and precious metal mining and processing companies, can tie into the dollar's value. These stocks often are a better trading vehicle than metal bullion, which require charges for delivery and storage.
Overseas-traded securities, which can furnish double-barreled appreciation. The security itself can increase in value, while repatriation of the proceeds can be on a profitable exchange basis. Of course, this can be a double-barreled sword; overseas profits, if any, can be more than offset by exchange losses.

Overseas bank deposits are a way of achieving the potential of this strategy. Usually, this is accomplished with certificates of deposit. The return in more financially stable countries may not be much, so currency speculation has to be the prime aim.

Caution: Foreign currency values, as related to the dollar, are unpredictable at best. The trader must compete not only with foreign government edict, but with giant multinational corporations, banks and central banks around the world.

It is difficult to get legal redress in the courts for losses in dollar funds at foreign banks. American courts have no jurisdiction. Foreign courts have ruled against plaintiffs in the past and it's unlikely any action can make whole those investors or traders who keep their funds in special overseas dollar accounts. And, of course, foreign currency markets in the U.S. and overseas.

Note the use of travelers checks. When bought in foreign currency, not dollars, they are a means of getting more overseas, should the dollar get weaker before and during a business or vacation trip. Travelers checks are also available in Euros,

A trader must be familiar with a number of factors that affect the relative strength of foreign currencies. The balance of payments for each country has influence, as does the inflation rates. Domestic interest rates have a strong thrust on currency direction, and both domestic and international political factors usually take command. The most sensitive of these are interest rate levels. Money flows easily to where it commands the best return, thus affecting supply/demand.

To sum up: currency transactions are extremely risky

It is almost impossible to determine what way currencies are going to move, and how quickly despite all the commentary in the press. To try and hedge against currency fluctuations is never easy despite the “expert” opinions from all quarters. Exchange rates are not affected by economic fundamentals in the short run. Being able to predict money supplies, central bank policies and other supposed influences do not help forecast the exchange rate. Economists have found that the best forecast of the exchange rate, in the short run, is whatever happens today. Market sentiment rather than by economic fundamentals rules the roost. Exchange rate forecasts are difficult because an analyst never knows the true value of the economic fundamentals.

Pros/Cons

Advantages
Foreign currency speculation is volatile and can produce profit opportunities.

Disadvantages
Currency speculation is a tool only for the most experienced international money market traders.

Foreign Currency Time Deposits

Background

It is now possible to keep a CD account in an American bank that is tied to a foreign currency. It is a way of playing the ups and downs of the currency markets. When the CD matures you get the equivalent of what you put into the account, plus interest, but only equated to the value of the U.S. dollars in terms of the foreign currency.

In other words, you may invest $50,000 at interest for one year. When the maturity arrives you get, for example, $53,000, but only in terms of the currency you designated. You may get more or less than the $53,000. You get FDIC coverage here but only in terms of the dollar investment and interest, and not in terms of the foreign currency equivalent.

Pros/Cons

Advantages
Foreign currency speculation is volatile and can produce profit opportunities.

Disadvantages
Currency speculation is a tool only for the most experienced international money market traders.

T-423-CZ

Options and Short-Selling Techniques

Background

A number of techniques for the use of options such as puts and calls and the use of additional options opens many opportunities for the highly experienced and sophisticated trade. Remember, the emphasis is on highly experienced.

Short-Selling Techniques

Background

Securities pricing is established primarily on the hope that prices will go up after purchase. Few who deal in the market just as eagerly foresee prices dropping. Human nature is to be optimistic when in the securities markets. To change this optimistic view, traders are limited in the way they can anticipate market weakness.

When buyers are overly eager and sellers are not similarly inclined, trading opportunities present themselves. Securities then become overpriced. Short selling potential exists because eventual disappointment is always likely. The short seller takes advantage of such overoptimism.

Selling short protects paper profits in securities owned; it can keep capital gains positions intact. It can also take advantage of sudden changes in the operational or financial fortunes of a company. And, it can help a trader profit from a sudden reversal in the market sentiment for a stock

Short selling techniques can be employed in several ways:
The conventional short sale. This involves selling stock borrowed from the broker, in a margin account. All margin account clients give brokers the right to lend their stock. Less often, the stock is already owned and no borrowing will be needed. (The owner prefers to borrow against “the box” and not to make delivery of the stock, or cannot do so.) The borrower puts up cash that equals the value of the stock, hoping to buy the stock for repayment when the market is lower.
Put purchases, A put option is the right to sell stock at a specified price over a set period. The trader who feels the price will fall, will buy a put. Traders buy more stocks in bull markets and puts in bear markets
Call writing. The option gives someone the right to buy the stock at a specified price in the future. The writer may or may not own the stock.
Bonds cannot be effectively shorted in a direct manner, but several techniques will give the practical stance of a short sale. Example: Short sales with Treasury securities are possible with reverse or repo-purchases Convertible bonds and convertible preferreds, and all marginable stocks, can be shorted.

Some essentials to remember about short selling:
Risks entailed in short selling are many. While the profit to be made is always limited by the fact a stock cannot go below zero, the upside of the market is infinite. A trader who has gone the wrong way can lose everything, unless the position is covered on time. Buying a put is not overly risky, but selling calls can be. The riskiest is to write a call on a stock the trader does not own, and especially, if this naked option is written “in-the-money,” to attract the buyer. That is, the exercise price is already under the market price.
Short sales must be in round lots. The New York Stock Exchange says it must be at a price at least equal to the preceding sale and higher than the last transaction preceding the proposed sale. If the stock is 60, and it goes to over 60, you must wait until it hits higher. This “uptick” rule, dating to the 1930s, is to prevent added selling pressure on the stock. The NASD does not have this rule for over-the-counter issues, nor does the London Stock Exchange enforce that rule. (Check with your broker for current rulings.)
Stocks can be shorted if not owned, or if owned (against the box). If borrowed stock is not easily available, the broker will charge a “rental” fee.
Professionals prefer to sell short stocks that give little or no dividends. The real owner always gets them. All short sales result in short-term gains or losses, unless the stock is already owned against the box.
The stock must be marginable. Minimum collateral is set by the exchange. Commissions and taxes are on the initial short sale and on the purchase/cover, unless the trader already owns the stock.

Caution: The aggressive actions of some short sellers are in the gray area of securities regulation. After short positions are taken, the traders can easily “bad mouth” the target company with calculated adverse publicity and research reports. Organized open lobbying by those in short positions often results in counterattacks by the target companies, who attempt to “squeeze” the shorts by countering with bullish news and strong market buying.

In a short squeeze, a high-volume buying wave drives prices higher. This sparks even more buying by new participants wanting to establish a long position and by existing shareholders who want to increase theirs. It may also “scare” those who are short the stock into covering positions. may be triggered by a news announcement or by an important resistance level being broken. Another characteristic of a short squeeze is that many buyers may demand delivery of their shares, or that they be placed in safekeeping, and therefore cannot be available for lending to short sellers. Since their is a finite number of outstanding shares, your broker may force you to deliver the originally borrowed shares back to the brokerage house for delivery to a buyer. The effect is that you must cover your short position. The choice of proper options can help you avoid some of these risks

Risk vs. Reward in short sales ought to be clear.

There is the risk that the price at which you shorted a security is too low, and the shares rise even higher in value. A certain minimum ratio of equity must be maintained relative to the cost of covering the outstanding short position. A Federal Reserve regulation holds and your broker may have a “house” minimum that is higher than the mandated minimum.

If the shorted stock rises in value, it is possible that a margin call will be triggered and you may have to bring your account's equity ratio back up to the minimum requirement. Your choices are either to deposit the extra cash or to sell shares so that the combination of the sale proceeds and the reduced short position will bring your account's equity ratio back into compliance. This is unlike holding a stock through a price decline in a conventional “long” position, where you only suffer the loss on paper. Shorting a stock may require you to act if prices move against you. How much can they move against you? When you buy a stock, the most that you can lose is what you paid for the shares, the lowest price to which they can drop is zero. But when you short a stock, your reach the 100% loss level when the share price doubles; and if the stock's price continues even higher and you maintain your short position, meeting margin calls, your potential loss could exceed 100%.

When purchasing a put option instead of shorting a stock, you are long the put option even though you are intending to profit by a price decline in the underlying shares. In this way. your potential loss is limited to 100% and your potential gain is unlimited. But one of the features of an option contract is the date by which its terms must be exercised by its owner, after which the contract expires; this introduces the risk that the anticipated price decline in the underlying shares does not materialize soon enough or to a great enough degree to recover the cost initially paid to purchase the option.

Pros/Cons

Advantages
Because most investors and traders naturally are always seeking stocks that go up, those able and eager to anticipate market weakening, can profit from over-enthusiasm

Disadvantages
Short-selling technique is dangerous because of its unlimited loss potential.

Call Options

Background

A call option is the right to buy 100 shares of stock at a set exercise (or strike) price, over a specified period. The options are traded on the open market up to nine months, and then expire if they are not exercised. A charge, called a premium, is made for the right. Purchases can be made below the exercise price (out-of-the-money), at the exercise price (at-the-money), or above the exercise price (in-the-money). The intrinsic value of the option always depends on how much in-or out-of-the money the call is at, and the time to expiration.

A call costs less to buy than the underlying stock. It can be about one fourth of the price, depending on variables, which include the question of the call being at, in, or out-of-the money. Because the trader enjoys an interest in the movement of the underlying stock, at a much smaller commitment, some calls will double in value for every 10% rise in the stock. Examples of leverage:
Rather than buy the common, a trader buys a call and places the difference in cost into a money market fund. Should the stock go up in value, beyond the cost of the option premium, and the commissions and taxes they entail, the trader will be ahead. Note: Buyers of options can liquidate a position with an offsetting transaction in the same option.
Instead of buying 100 shares of ABC, Inc., at $40, for $4,000, the trader pays $400 for an ABC40 call. Should the stock go to $50 before the option expires, the call will then be worth $5,000. A premium of $400 thus produced a profit of about $600 ($1,000 profit, less the $400 premium, less commissions and taxes). Furthermore, the $3,600 difference in original outlay, the $4,000 for the actual shares, or $400 for the call, could be put into a money market fund to earn a return.
Call options can limit risks because of the smaller amount of dollar outlay. At the same time, the call locks in a price the trader wants to be sure of.

On the other side of the transaction, calls can be written for buyers to acquire. The call can be on stock already owned by the writer, or the writer can take a more speculative position, with “naked” calls. Call writers are market bears. Some noteworthy precautions, whether calls are bought or written
A call will not provide common stock dividends. These belong to the call writer, unless the call is exercised. Values from stock splits, stock dividends and cash dividends may or may not alter strike prices.
Position and execution limits are always in force. A maximum amount of contracts a day is imposed on one side of the market. (Check with your broker). (Short calls and long puts are considered the same side.) A daily maximum amount of contracts can be executed in either class, puts or calls, during five consecutive days.
Option premium and transaction costs are relatively high, particularly for the shorter-term premiums. They have to be closely figured in every strategy, or they will eat into whatever profits may accrue.
Income tax regulations are to be taken into account. Tax consequences vary with the nature of the option, the stock purchase, or its sale.
A call is worthless once it expires, compared to the underlying stock, which will retain some value. Added risks: The Options Clearing Corp., which clears and matches trades, and the exchange where the option trades, have to approve any recapitalization values. This happens when acquisitions and takeover terms are complex. A Risk Disclosure Statement from the Options Clearing Corp., is given every trader, before transactions can be made. A prospectus is also furnished to alert traders to the dangers. Remember these additional points

1 Individual volatility is a key feature in trading options. The lack of volatility is not beneficial, as options are a wasting asset. They lose value with time. Volatility will more likely improve the odds of they're being profitable prior to expiration.

2. The purchase of a call does not mean it should be traded indiscriminately. The call's fortunes are always tied to the underlying stock. Accordingly, selling flags should logically be attuned to selling flags that would be designed and activated, were the stock held instead.

3. Models used for the hedging and trading of options have not been proven successful and are continually contested by those who claim the variables cannot make a valid market test. Critics state that options create losses in bear markets, that are not recovered with subsequent bull markets.

Surveys show that securities holders who use options or practice writing options against their portfolios don't do any better than those who do not. They appear to lose out in bear markets and do not recover enough of the losses in bull markets

Pros/Cons

Advantages

Call options create leverage, when used for trading in lieu of buying the common. stock.

Disadvantages
Call options generally have not achieved their goals in actual practice over time.

Put Options

Background

A put option is the right to sell 100 shares of a stock at a set exercise (or strike) price, over a specified period. The option is traded on the open market and expires a few months from its initial writing. The maximum life of the option is nine months. A premium is charged for that right. The longer the right the higher the premium price.

Puts can be bought below the exercise price in-the-money), at the exercise price (at-the-money), or above the exercise price (out-of-the money). The extent to which the put is out or in the money will also determine the premium.

A trader may buy a put to lock in a profit on stock that already is in hand. Or, he may buy a put at the same time a stock has been bought, to protect the price position just after purchase. T his strategy has been used in lieu of conventional selling flags, but the comparison is not correct

Example: A trader has bought ABC Inc. common at $30 and it has risen to $50. For each 100 shares in this particular market, he can buy a put for $2. Thus, for every 100 shares of stock worth $5,000, the trader can buy a form of price insurance for $200, plus the transaction costs. Should the price of the common fall below $48, the trader will be ahead.

Example: A trader may feel that ABC Inc. common is going to weaken, but he is not secure enough to actually sell the stock short. The stock may be at $50, and the put may cost about $2 ($200 for 100 shares of common). Aside from transaction costs, should the stock price drop below $48, the trader's put will begin to have value. On the other hand, were the price to go up, for instance, to $55, the maximum loss would be the $200 cost of the premium, plus transaction costs. The loss on the underlying stock would have been $500 and transaction costs.

Example: A trader who feels the stock's price will fall, will buy a put instead of selling short a stock he does not own. If the market goes up, his loss will be confined to the premium charge and commissions.

Note: Positions can be liquidated at any time, with an offsetting transaction in the same option.

Put writing can be done just for earning premiums. The buyer must buy the underlying shares at the exercise price, if the rights are assigned or exercised by the put buyer. In addition to income some traders will buy the puts to acquire stock at lower prices. This is an extremely speculative strategy; the risk lies in a potentially sharp decline in price of the underlying stock.

Caution: Premium and transaction costs are relatively high, especially for the shorter maturities. Also, the Options Clearing Corporation, which matches and clears options, and the exchange where it is traded, both have to approve recapitalization values. This occurs when acquisitions involve packages of complex securities. In addition, income tax regulations should be closely investigated. Tax consequences vary with the nature of the option and purchases or sales.

In order to attract buyers of contracts, the writer of the put (and calls too), must offer the buyer sufficient incentives. This means that risk-taking is mandatory. The buyer has to believe the pricing of the option is attractive enough for the payment or the premium. At the same time, the writer of the option cannot offer terms that can only leas to assured losses. Therefore, the writer has to be able to provide incentives, while maintaining sufficient odds for a favorable risk/reward equation.

Pros/Cons

Advantages
Put options are a means of creating leveraged and short-selling strategies.

Disadvantages
Put options are for sophisticated traders only because of their complexity.
Writing puts can be an especially speculative trading strategy, when markets are falling.

Naked Options

Background

When somebody sells a call option, he is expected to own the stock being optioned. If the buyer of the call does exercise the option, ordinarily you have the shares for him. And if the call buyer does not exercise, you still have the shares and you have the premium you had changed for the call you gave. You can try to a trick a speculator, by selling calls on shares you don't own. That is called a Naked Option. You will have to come up with the stock that's been called. And this can be expensive for you, especially if there has been a run up in the stock.

Some investors feel they can live with the probabilities that are involved. If you do, better be prepared for surprises. One way, is to sell only a small position The other way is to sell only protected positions. That is a reverse contract that protects you if your call has been exercised.

Pros/Cons

Advantages
Options provide leveraged trading potential.
Options can be used to put a ceiling under risks, in exchange for a limitation on the potential profit.

Disadvantages
Options markets are highly sophisticated and can be used only by those who are completely familiar with them.
Option transaction costs are relatively high, and can eat up any potential profit, should the trader not be entirely aware of the trading position.

Spreads/Straddles

Background

A spread is a combination of a call and a put in the same stock, but with different prices and/or expiration dates. The spread could be made with two puts instead of two calls. In either case, the trader becomes a buyer and a writer of the same option.

Example: Writing an ABC January call at 40, and buying an ABC January call at 50, with the current market at 45. Or, writing an ABC March 30 call at 50, and buying an ABC June 30 call.

Spreads are written to increase portfolio earnings. They can be created to protect short sales, and anticipate price declines.

The straddle lets the trader be a writer and a buyer of both a put and a call on the same stock. Both options will have the same exercise (or strike) price, and a similar expiration date If the market for the underlying stock is expected to do very little for awhile, a trader will be inclined to be a writer. But if big changes appear to be ahead, the trader would prefer to buy the options. An assortment of highly technical strategies are at the trader's disposal.

A long straddle anticipates a wide fluctuation over a short period of time. A short straddle is interesting if no real market action is seen ahead.

Early warning signs can be gleaned by looking at option activity of the different common stocks which can be optioned. Options can move, both in volume and in price, well before the underlying common stock of the takeover target does. The trend of price run up, checking prices of the options and the related stock, going back a few weeks, will provide clues.

Caution: Spreads, straddles and other combinations are best left to professionals who have studied their use, have experienced the markets, and are prepared for the risks. Stock option spreads are considered even more dangerous, because the spreads have been getting too wide for short- term traders.

Pros/Cons

Advantages
Many almost custom-designed spreads and straddles provide a wide assortment of trading possibilities.

Disadvantages
Spreads and straddles add complications to a very highly sophisticated and difficult-to-use group of strategies.
Spreads and straddles provide arbitrage potential because of frequent discrepancies in thin and/or erratic markets.

Currency Options

Background

Currency options can do quite a number of things for the astute but speculative investor. And for companies who have trade dealings overseas and want to minimize the risks of a weakening dollar. Or take advantage of a strengthening dollar. An exporter has to worry what the dollar will be worth a few months forward when his product is received overseas.

Currency options can also help a speculator hedge against exchange rate fluctuations in the form of trading strategies. Interestingly, Forwards also offer a form of insurance for exporters and works out cheaper than an option. But the use of options is growing despite their relatively higher cost.

When foreign currencies get pummeled in trading from time to time what are called “knock out” options or “barriers” are proposed by central banks. Like ordinary options these give the holder the right to trade a certain amount of currency for a preset time period. However they become worthless or “knocked out” if the market reaches an agreed-upon limit.

They are lower in price to buy because of the limitation on the price rise potential. Central governments are thus making an attack on the thermometer and not the root cause of the currency problems they have. Much of what is their own doing. And they certainly do not derail the long term trends in a currency's strength or weakness.

The trading of currency options may have a small impact on currency on occasions but the impact is incidental to the conditions which attract speculators to the foreign currency markets. Moreover, currency traders say the artificial barriers can exacerbate the problems the central bankers want to overcome.

Pros/Cons

Advantages
Options on currency provide leveraged trading potential.
The options can be used to put a ceiling under risks, in exchange for a limitation on the potential profit.

Disadvantages
The options markets are highly sophisticated and can be used only by those who are completely familiar with them.
Option transaction costs are relatively high, and can eat up any potential profit, should the trader not be entirely aware of the trading position. Stock Index Options

Background

The stock option market used to be the only way options on securities could be bought. Today it accounts for only about part of the volume on options.

Stock Index options, as with any option, gives a trader leverage. Not only can the whole market or a segment be duplicated, it can be traded on a more speculative basis for greater profit potential. Many use stock index options rather than trade low-priced stocks, because they feel the risk/reward factor is more in their favor.

The contract gives the buyer the right to, but not the obligation, to buy a stock index at a predetermined price, over a specified time frame. This makes the contract unlike that of a buyer of a futures contract, where there is an obligation to buy. The index option buyer need not exercise the right.

The trader who buys a stock index option believes the index will rise in a bullish market. Leverage comes from the use of a fraction of the capital it takes to buy the securities and, at the same time, losses are limited to the option's cost. The risk is no greater than the premium paid for the option, though the value of the option declines with age and, if not exercised, the option becomes worthless.

At the present time, options can be bought on a variety of exchanges. Consult financial newspapers such as the Wall Street Journal, the Investors Daily, and similar publications for their listings. Make yourself comfortable with their reportage, in print and online, to be certain you are able to be in touch with the reports you need.

Stock-index options give traders the chance to hedge or speculate on the whole market's direction. There is a limit on the number of stock-index option contracts that can be held, to reduce the erratic market effects on option expiration days. Yet, the markets are volatile. Arbitrage is a technique of buying and selling similar securities to take advantage of small price discrepancies in different markets. The options and futures on the index are the securities used most often in today's markets.

Pros/Cons

Advantages
Stock index options provide leveraged earnings

Disadvantages
Stock index option trading is unusually complicated, especially when used with futures contracts arbitrage.
In tests done among experienced traders, odds against making stock index option profits were found to be high.

Stock Index Futures

Background

Futures on stock indexes are bought and sold for a variety of purposes. For its most basic objective: A trader will buy if a rising market is expected; He will sell (go short the market) if he suspects the market may weaken. But trading aims are often much more sophisticated. Traders can also use futures on stock indexes to hedge against stock market swings and to offset positions they may have in securities that are less directly related to the stock market.

Many professionals “preposition” transactions this way. This involves purchasing index options and futures days or weeks before they actually buy a stock. When they do go into the market without pushing up prices too high in advance. Institutions find it is easier, and with less market impact, to go from cash into stocks by way of propositioned index options and futures. Any higher prices that may have been brought on, can also be offset by the profit they will have made on their index options and futures.

Others, professionals and ordinary traders, can hedge their purchases by selling index futures and buying option puts. All of this can be done quickly and with minimal outlay.

Arbitrageurs, too, have tempting choices for strategy from this employment of index futures and options techniques. Markets often get roiled and pricing for issue types get out of proportion when there is heavy use of options, futures and an assortment of techniques which take opposite stances on one security. The arbitrageurs look for the slight differences in values that evolve and then transact to profit from them. They constantly seek out differences between a stock index and prices of futures contracts, in what is known as “basis” trading.

Stock index forward-market technique is also inviting because it is often easier to pick market moves than it is individual stocks. Those who wish to hedge or speculate with specific stocks can have alternate strategies, including put and call options.

Stock index futures appear on various exchanges. Consult financial newspapers for their listings. Make yourself comfortable with their reportage, in print and online, to be certain you are able to be in touch with the reports you need.

Caution: Efficient order execution is essential in any transaction where such slight differences in price are the norm. Otherwise minor trading “hiccups” or “tick slippage” in execution can add up to large costs over time for constant traders, particularly “day traders” who close out their positions at the end of each day. Stop losses help but are not a panacea in such cases. Commissions and taxes obviously must be an ever-present consideration for all traders, large, small, frequent or occasional.

Further, the markets can be absolutely dangerous when futures and options contracts expire the same day. It happens four times a year and makes for exceedingly erratic and often frightening market behavior.

Again: Indexes currently in use can be gleaned from the listing in the major financial newspapers.

Pros/Cons

Advantages
Stock index futures, with options, are a means of adding to market leverage.

Disadvantages
Stock index futures trading is unusually complicated and is to be used only by experienced professional or individual traders.

Commodity Futures

Background

Every commodity has its own market movements, all of which may have only the slightest relationship to each other, apart from the effects of rainfall and optimal climatic conditions.

No physical delivery need be made with futures contracts. If you buy pork bellies or grain or sugar or copper, you don't have to worry that some morning you will have a carload of the stuff sitting on your front lawn. The beauty of the system is that you can always close out your trade. The market has liquidity.

You don't have to worry about interest costs in holding what you have bought and what you may be keeping over a number of months. That interest cost is actually built into the price. You can buy spot and forward with futures.

But one thing you need is the tolerance for risk, and the knowledge that most trades by far are not profitable. As many as four out of five are losses, if you're lucky. You must try to cut your losses quickly and let your winners ride, to make sure that one out of five successful trades makes up for the losses and then some.

Futures investments are not permitted in IRA and Keogh accounts. Managed accounts are, if you are foolish enough to speculate this way with your retirement funds.

Futures prices indexes are closely watched because they give sensitive insights into inflationary or deflationary economic trends. It usually moves in the opposite direction from stock prices. In this respect it is also an indicator of stock movements.

There are many indexes you can look up in the financial newspapers and the internet. One of the more well-known, such as the C R B index, is traded on the New York Futures Exchange. It contains prices of a host of commodities. Because it represents so many it is a good mirror of what is going on in commodities. Also closely watched are such instruments such as the Dow Jones AIG Commodity, Dow Jones AIG Spot, and Reuters UK Indexes.

Some of the futures available that you may want to peruse and further check into:

Financial
Currency
Interest Rate

General Commodities
Food and Fiber
Grain and Oilseeds
Livestock Futures
Metal Futures
Petroleum
Warning. Like all commodity futures indexes, it is speculative to actually formulate trading strategies in commodities unless you are highly sophisticated.

Pros/Cons

Advantages
Commodities futures are a means of adding to market leverage.

Disadvantages
Commodities trading is unusually complicated and is to be used only by experienced professional or individual traders.

### The SecuritiesAid Game “House Rules”

Strategies/Securities Availability

The Player/Entrant can use all the strategies and disciplined programs, both for educational and entertainment purposes, as well as for conventional investment facilities. However, there will be no need to put up a dime of actual money for participation.

The objective is to attract Entrants with the possibility, if not probability, that ordinary investors and even professionals will eventually use the System for employing their own personal funds.

SecuritiesAid Game Functions

The SecuritiesAid Game tutors, coaches and trains investment beginners and also professionals
a) It is constantly available for those who to want to use it for sheer instructional and entertainment purposes,
b) And those who want to test how well their favorite strategies do over time and under strict discipline,
c) And many who wish to see how well they do in competition with others in friendly “fantasy” competition,
d) And for investors for ongoing, conventional use of their own funds.
   (Note Again: The Game uses the same Databases and facilities of the entire SecuritiesAid System)

Virtual Money

Under rules to be established from time to time by The House (or Fictional Broker), each Entrant may be given an amount of virtual money (whenever requested). This will serve as a standard by which the Entrant can measure how well he/she has transacted securities investments over a given period of time.

Securities Employed

Investments made by the Entrant may be in securities of all types, or they may be commodities, listed on American and/or internationally- recognized exchanges, using any of the many available strategies, and their classifications mentioned within the SecuritiesAid Game.

The House (or Fictional Broker) may change the rules from time to time, as to what may or may not be traded, bought or sold on a virtual basis.

Bookkeeping/Accounting

The House (or Fictional Broker) will provide basic virtual accounting on virtual terms, that any ordinary broker would in real life, including a nominal brokerage commission-fee that makes the Game even more realistic.

Competitive Investment Contests

What about other investment contests now extant? Many are currently used to compare the analytical prowess of the investment public and professional managers and analysts.

In fact, many institutions including brokers, newspapers, and financial magazines sponsor stock-picking contests. In the future they may also be sponsored by competitors who may not be licensed by, or infringing upon, the SecuritiesAid Game? How would these programs compare?

An essential point in the comparison:

When contests are usually operated for professionals and amateur stock pickers, results are compared solely on the basis of original choices and not the completed transactions. No one is ever responsible for designating when the all-important sale of the security is to be made. A choice of stock and the increased value may be noted. But the buy/sell expertise is never the criteria.

The truth is, the essential part of the contest is invariably to pick hot stocks. We hear of such outstanding selections all the time. That is relatively simple. The tough part is to know when to sell because securities cool off soon enough.

Pick a hot stock on January 1st and it may still be hot when the contest ends on June 30th or on December 31 st. So when do you sell if the contest is over and you are still holding the security? That represents the short term. What about the longer term?

This is where gurus also have their critical problems.

When do they most likely sell? Possibly when they come up with a new, prospective “winner” and need cash with which to make the purchase. That does not indicate it is actually the correct time to sell what they originally bought. In fact, they most likely may sell when they lose interest or when they get a variety of “holding-jitters”.

Thus they finally do sell—impulsively—and with wrong timing.

In short, in the usual contests you rarely impose responsibility upon the contestant for having completed that all-important buy/sell transaction.

Yet, that is, after all, the normal lot of all investors. And where they so often fail.

Disclaimer

The Game is not to be used for any unlawful, harmful, threatening, or libelous purpose, nor in any jurisdiction where such action or use may be illegal.

The Game is meant to aid and instruct those interested in financial markets and investing. It is in no manner intended to perform in any way that would negatively affect the users' ability to utilize actual financial exchanges. Nor is it designed to interfere with any federal, state or local governmental regulatory commission activity or any regulations that oversee financial markets.

The Game cannot be responsible for the efficacy or utility of the implementation of any of the securities or the strategies mentioned, nor the accuracy of the research done by sources quoted.
a) The extensive content contained herein has been researched over a great number of years by tens of hundreds of independent sources.
b) Individual users may or may not accurately follow whatever instructions may apply to such actions they have, or may choose to undertake on their own.
c) The Game does not provide investment advisory opinion of any kind, nor make any claims as an investment advisor.

There is thus no way individual responsibility can be designated to the Game or its proprietor in any manner. Every investor must at all times take responsibility for his or her investment decisions, after weighing the pros and cons that are publicly available. The Game's function is to solely attempt to address many of those pros and cons in order to make them appear more clearly.

Various services provided by the Game are performed by Third Parties, over whom the Game's proprietor has no control or purview. Such Third Parties must be depended upon for the implementation of essential services employed in the Game, including but not limited to information, communications and user notification. The Game proprietor can therefore take no responsibility for any failure on the part of such parties to perform such services.

There are no warranties that the Game services can be error-free. No guarantees of any kind are expressed or implied in the Game operation. Therefore, the use of this service is at the user's sole risk.

The Game proprietor also cannot be responsible for any personal problems, injuries or damages that a user may suffer as a result of the employment of any Game that involves transactions under conditions that can simulate real life pressures of substantial magnitude.

Furthermore, because much of the Game utilizes high technology, the proprietor is not responsible for any technical problems that may accrue to software, hardware or equipment the user may employ with which to implement the use of the Game.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

What is claimed are:

1. A method for portfolio management comprising:
a. Utilizing an enforced predetermined strategy on the onset of the selection of at least one security;
b. Formulating an intrinsic selling character based on said buy strategy; and
c. Consistently updating a user on said strategy in relation to performance of said security, without user influence.

2. A method for portfolio management comprising:
a. Utilizing an enforced predetermined strategy on the onset of the selection of at least one security;
b. Formulating an intrinsic selling character based on said buy strategy;
c. Consistently updating a user on said strategy in relation to performance of said security, without user influence; and
d. Ultimately, notifying the user on the suggested time to sell.

3. A method for portfolio management comprising:
a. Utilizing an enforced predetermined strategy on the onset of the selection of at least one security;
b. Formulating an intrinsic selling character based on said buy strategy;
c. Consistently updating a user on said strategy in relation to performance of said security, without user influence
d. Screening out as well as highlighting financial information in relation to a particular strategy to inform the user of market or corporate activities; and
e. Ultimately, notifying the user on the suggested time to sell.

4. A method for portfolio management comprising:
a. Utilizing an enforced predetermined strategy on the onset of the selection of at least one security;
b. Formulating an intrinsic selling character based on said buy strategy;
c. Consistently updating a user on said strategy in relation to performance of said security, without user influence; and
d. Screening out as well as highlighting financial information in relation to a particular strategy to inform the user of market or corporate activities.
e. Advising user transactions with financial assisted techniques; and
f. Ultimately, notifying the user on the suggested time to sell.

5. A method as in claim 3, in which purchasing a security with a corporation based strategy wherein market fluctuations and movements are ignored, such that the sole activators are activities of the corporation in question.

6. A method as in claim 3, in which purchasing a security with a market strategy wherein market fluctuations and movements the sole activators.

7. A method as in claim 3, in which notifying the user on the sensitivity of user debt securities holdings.

8. A method as in claim 3, in which screening out financial information is based on predetermined word searches to eliminate and retain the desired information.

9. A gaming apparatus to facilitate the portfolio management comprising:
a. At least one networked access terminal allowing the user to chose a investment strategy structured around the principle that the sell criterion is based on said buy strategy;
b. At least one display screen connected to the access terminal to update the user on the performance of said portfolio along with select financial information relating to said portfolio screen based upon said user selected strategy, with notifications to the user at the time of suggested sell; and
c. At least one input device connected to the access terminal.

10. A method as in claim 3, in which mass concerted action of a securities transaction based on a widely announced, specific recommendation is almost impossible, by allowing users to purchase particular securities with a plurality of strategies to choose from, and in turn dictating a more disciplined user selling point.

11. A method as in claim 3, in which selecting the particular security in relation to market timing is secondary to the user's selection of strategy.

12. A method as in claim 3, in which transacting securities is in the context of a gaming competition.

13. A method as in claim 3, in which selling such securities is augmented by a floor or ceiling price strategy.

14. A method as in claim 3, in which general investment information is provided to further educate the user strategic areas of content.

15. A method as in claim 14, in which such investment information is provided strategic areas of content through popups.

16. A method as in claim 3, in which the step of notifying and updating the user are facilitated through at least one methodology: conventional internet Email, wireless Email, satellite radio, television, cellular technology, Really Simple Syndication, internet and video blogs, satellite transmissions, streaming data, cable transmissions, audio terminals, video terminals, portable handhelds, pagers, text messaging, internet popups, electrical devices capable of receiving data, electrical devices capable of transmitting and receiving data, and other forms of instantaneous or semi-instantaneous forms of communication.

17. A method as in claim 5, in which the predetermined strategy is based on corporate management and company characteristic.

18. A method as in claim 5, in which the predetermined strategy is based on corporate business focus on core business

19. A method as in claim 5, in which the predetermined strategy is based on corporate accounting principles

20. A method as in claim 5, in which the predetermined strategy is based on corporate marketing abilities.

21. A method as in claim 5, in which the predetermined strategy is based on corporate investigation of accounting principles

22. A method as in claim 5, in which the predetermined strategy is based on buying cheap corporate assets

23. A method as in claim 5, in which the predetermined strategy is based on seeking corporate earnings growth.

24. A method as in claim 5, in which the predetermined strategy is based on special corporate guidelines.

25. A method as in claim 6, in which the predetermined strategy is based on a securities acquisition and merger trading opportunities.

26. A method as in claim 6, in which the predetermined strategy is based on analysts' projections and their effects on the markets.

27. A method as in claim 6, in which the predetermined strategy is based on trading of corporate bonds.

28. A method as in claim 6, in which the predetermined strategy is based on trading government and municipal bonds.

29. A method as in claim 6, in which the predetermined strategy is based on coattailing with insiders and smart money.

30. A method as in claim 6, in which the predetermined strategy is based on trading the feel and quality of the market.

31. A method as in claim 6, in which the predetermined strategy is based on trading commodities.

32. A method as in claim 6, in which the predetermined strategy is based on trading corporate and corporate derivatives.

33. A method as in claim 6, in which the predetermined strategy is based on seasonal trading factors.

34. A method as in claim 6, in which the predetermined strategy is based on news reports about corporations

35. A method as in claim 6, in which the predetermined strategy is based on options trading.

36. A method as in claim 6, in which the predetermined strategy is based on price multiples and returns.

37. A method as in claim 6, in which the predetermined strategy is based on earnings and dividend yield.

38. A method as in claim 6, in which the predetermined strategy is based on short-selling commodities.

39. A method as in claim 6, in which the predetermined strategy is based on market highs and lows with a focus on momentum.

40. A method as in claim 6, in which the predetermined strategy is based on security and market types.

41. A method as in claim 6, in which the predetermined strategy is based on security bank loan activity and direction.

42. A method as in claim 6, in which the predetermined strategy is based on market price comparisons

43. A method as in claim 6, in which the predetermined strategy is based on industry operation changes

44. A method as in claim 6, in which the predetermined strategy is based on general economic signs

45. A method as in claim 6, in which the predetermined strategy is based on bond and interest rate direction

46. A method as in claim 6, in which the predetermined strategy is based on yields and returns

47. A method as in claim 6, in which the predetermined strategy is based on buying and selling patterns

48. A method as in claim 6, in which the predetermined strategy is based on market indicators.

49. A method as in claim 6, in which the predetermined strategy is based on market price comparisons

50. A gaming apparatus as in claim 12 wherein a predefined set of house rules are imposed upon the users.
